(19) United States
(12) Patent Application Publication
(10) Pub. No.: US 2007/0141541 A1
(43) Pub. Date: Jun. 21, 2007

(54) ASSESSMENT IN COGNITIVE TRAINING EXERCISES

(75) Inventors: Samuel Chungchi Chan, Alameda, CA (US); Joseph L. Hardy, El Cerrito, CA (US); Henry W. Mahncke, San Francisco, CA (US)

Correspondence Address: HUFFMAN LAW GROUP, P.C., 1900 MESA AVE., COLORADO SPRINGS, CO, 80906, US

(73) Assignee: Posit Science Corporation, San Francisco, CA (US)

(21) Appl. No.: 11/465,290

(22) Filed: Aug. 17, 2006

Related U.S. Application Data
(60) Provisional application No. 60/749,979, filed on Dec. 13, 2005.

(51) Int. Cl. G09B 19/00

(52) U.S. Cl. 434/236

(57) ABSTRACT

A method on a computing device is provided for assessing a stimulus threshold of an older adult by requiring the adult to differentiate between rapidly presented stimuli. The method trains the time order judgment of the adult by presenting upward and downward frequency sweeps, in random order, separated by an inter-stimulus interval (ISI). Icons associated with the upward and downward frequency sweeps allow the adult to indicate an order in which the frequency sweeps are presented (i.e., UP-UP, UP-DOWN, DOWN-UP, and DOWN-DOWN). Correct/incorrect selection of an order causes the inter-stimulus interval and/or the duration of the frequency sweeps to be adaptively reduced/increased, using a maximum likelihood procedure, such as ZEST or QUEST, where two tracks, each with a respective duration and ISI, are adjusted until their values substantially converge, or a specified number of trials is performed. The threshold is determined by averaging the final values of the two tracks.

### CROSS REFERENCE TO RELATED APPLICATION(S)

This application claims the benefit of the following U.S. Provisional Patent Application, which is incorporated herein in its entirety for all purposes: PS.0117 60/749,979 Dec. 13, 2005 ZEST PROGRESSIONS IN HiFi ASSESSMENTS

### FIELD OF THE INVENTION

This invention relates in general to the use of brain health programs utilizing brain plasticity to enhance human performance and correct neurological disorders, and more specifically, to a method for assessing participant thresholds for respective exercises.

### BACKGROUND OF THE INVENTION

Almost every individual has a measurable deterioration of cognitive abilities as he or she ages. The experience of this decline may begin with occasional lapses in memory in one's thirties, such as increasing difficulty in remembering names and faces, and often progresses to more frequent lapses as one ages in which there is passing difficulty recalling the names of objects, or remembering a sequence of instructions to follow directions from one place to another. Typically, such decline accelerates in one's fifties and over subsequent decades, such that these lapses become noticeably more frequent. This is commonly dismissed as simply “a senior moment” or “getting older.” In reality, this decline is to be expected and is predictable. It is often clinically referred to as “age-related cognitive decline,” or “age-associated memory impairment.” While often viewed (especially against more serious illnesses) as benign, such predictable age-related cognitive decline can severely alter quality of life by making daily tasks (e.g., driving a car, remembering the names of old friends) difficult.

In many older adults, age-related cognitive decline leads to a more severe condition now known as Mild Cognitive Impairment (MCI), in which sufferers show specific sharp declines in cognitive function relative to their historical lifetime abilities while not meeting the formal clinical criteria for dementia. MCI is now recognized to be a likely prodromal condition to Alzheimer's Disease (AD) which represents the final collapse of cognitive abilities in an older adult. The development of novel therapies to prevent the onset of this devastating neurological disorder is a key goal for modern medical science.

The majority of the experimental efforts directed toward developing new strategies for ameliorating the cognitive and memory impacts of aging have focused on blocking and possibly reversing the pathological processes associated with the physical deterioration of the brain. However, the positive benefits provided by available therapeutic approaches (most notably, the cholinesterase inhibitors) have been modest to date in AD, and are not approved for earlier stages of memory and cognitive loss such as age-related cognitive decline and MCI.

Cognitive training is another potentially potent therapeutic approach to the problems of age-related cognitive decline, MCI, and AD. This approach typically employs computer- or clinician-guided training to teach subjects cognitive strategies to mitigate their memory loss. Although moderate gains in memory and cognitive abilities have been recorded with cognitive training, the general applicability of this approach has been significantly limited by two factors: 1) Lack of Generalization; and 2) Lack of enduring effect.

Lack of Generalization: Training benefits typically do not generalize beyond the trained skills to other types of cognitive tasks or to other “real-world” behavioral abilities. As a result, effecting significant changes in overall cognitive status would require exhaustive training of all relevant abilities, which is typically infeasible given time constraints on training.

Lack of Enduring Effect: Training benefits generally do not endure for significant periods of time following the end of training. As a result, cognitive training has appeared infeasible given the time available for training sessions, particularly from people who suffer only early cognitive impairments and may still be quite busy with daily activities.

As a result of overall moderate efficacy, lack of generalization, and lack of enduring effect, no cognitive training strategies are broadly applied to the problems of age-related cognitive decline, and to date they have had negligible commercial impacts. The applicants believe that a significantly innovative type of training can be developed that will surmount these challenges and lead to fundamental improvements in the treatment of age-related cognitive decline. This innovation is based on a deep understanding of the science of “brain plasticity” that has emerged from basic research in neuroscience over the past twenty years which only now through the application of computer technology can be brought out of the laboratory and into the everyday therapeutic treatment.

Some cognition improvement exercises, such as embodiments of the Tell Us Apart exercise in the HiFi program described herein, are designed to force participants to identify rapid spectro-temporal patterns (brief synthesized formant transitions) in order to classify consonants by place of articulation under conditions of backward masking from a following vowel. The spectral characteristics of these syllables (as dictated by formant frequencies) closely parallel the patterns that occur in natural productions of the sounds, and they can usually be identified as the speech sounds they are intended to represent. However, since formant frequencies constitute only a (comparatively informative) subset of the range of acoustic cues that accompany human productions of the consonants, sounds synthesized in this way do not closely resemble natural speech in a general sense.

As a result, many participants may be unable to match these synthesized sounds, presented in isolation, with the intended syllables based on their previous linguistic experience, and are therefore unable to progress through the easiest levels of the exercise, which almost certainly involve sound distinctions that are well above their actual thresholds for detection.

More generally, in exercises that use synthesized speech to target specific neurological deficits, it is desired that the effectiveness of a task not be severely limited by the overall naturalness of the speech stimuli, since it is often necessary to reduce the acoustic cues available to the listener to a small, carefully controlled set. Thus, a way is needed to help listeners attend to the set of cues relevant to a synthetic speech distinction so that they can reliably identify sounds and progress through the exercise.

Therefore, what is needed is an overall training program that will significantly improve fundamental aspects of brain performance and function relevant to the remediation of the neurological origins and consequences of age-related cognitive decline. Additionally, improved means for helping listeners attend to the set of cues relevant to a synthetic speech distinction to reliably identify sounds and progress through exercises that utilize such distinctions.

Each of the exercises described generally utilizes one or more types of audial stimuli with characteristic attributes that the participant (i.e., the aging adult) must perceive and respond to in performing trials. Each participant generally has a threshold with respect to each type of stimuli such that when stimuli are presented with intensities below this threshold, the participant is unlikely to exceed some specified performance level, e.g., is likely to answer incorrectly some specified percentage of the trials, e.g., 69%.

However, prior art embodiments of such cognition enhancement exercises do not facilitate the determination of this threshold for participants. Thus, systems and methods for assessing participant thresholds for cognition enhancement exercises are desired.

### SUMMARY

Various embodiments of a method for determining or assessing a psychophysical threshold of an aging adult regarding a frequency sweep exercise, such as the High or Low exercise described herein are presented. A primary purpose of the High or Low threshold assessment is to determine the smallest duration of tone sweeps in a timer order judgment task that a person can respond correctly to above a statistical threshold. The High or Low assessment may be similar to the High or Low exercise with respect to visual presentation, where the differences between the assessment and the exercise lie (at least primarily) in the movement or progression through the task and the data that are obtained from this movement for the assessment. The task is designed to obtain a threshold, which is a statistical rather than an exact quantity. For the purposes of this task, the threshold is defined as the smallest duration of tone sweep (in milliseconds) at which a participant will fail to respond correctly a specified percentage, e.g., 69%, of all trials for a serial order judgment task. In a preferred embodiment, being a computer based task, the High or Low assessment may use a ZEST (Zippy Estimation by Sequential Testing) procedure to progress or move through the task, adjust the duration of the tone sweeps to be presented, and determine the statistical threshold.

As noted above, many aspects of the High or Low assessment may generally be similar, or possible even identical, to the High or Low exercise with respect to visual presentation. However, some aspects of the exercise version of High or Low are not necessary in the High or Low assessment. For example, the progress bar normally displayed on the upper left hand corner, the points bar, and the reward area are not necessary, and so may be omitted. The features or assets that remain the same include the buttons and the “ding” and “thump” sounds that play after a participant responds correctly or incorrectly. Also identical to the exercise version may be the stimulus presentation of the assessment.

One embodiment of a method for determining a psychophysical threshold for an aging adult, utilizing a computing device to present aural presentations to the adult, and to record responses from the adult is described below. Note that in various embodiments, some of the method elements may be performed concurrently, in a different order than shown, or may be omitted. Additional method elements may also be performed. As shown, the method may operate as follows:

First and second tracks may be initialized with respective durations based on an initial anticipated threshold, where the initial anticipated threshold is an initial estimate or guess of a duration for frequency sweeps corresponding to a specified performance level of the adult, e.g., a stimulus duration at which the adult fails to respond correctly some specified percentage of the time, e.g., 69%. For example, in one embodiment, the first track may be initialized to a first duration that is below the initial anticipated threshold, e.g., preferably just slightly below the initial anticipated threshold, and the second track may be initialized to a second duration that is (e.g., slightly) above the initial anticipated threshold. Thus, the initial durations of the two tracks may straddle the initial anticipated threshold.

In some embodiments, an initialization process may operate to initialize other items as well. For example, the initialization process may include initializing one or more of: the first and second tracks' initial stage values (as indicated above), a standard deviation of a cumulative Gaussian psychometric function for the maximum likelihood procedure, or a standard deviation of a prior threshold distribution for the maximum likelihood procedure.

Upward and downward frequency sweeps associated with respective “up” and “down” icons may be provided. For example, a first frequency sweep that increases in frequency over time may be provided, and associated with a first icon, e.g., a button that displays an up arrow, and a second frequency sweep that decreases in frequency over time may be provided, and associated with a second icon, e.g., a button that displays a down arrow. For example, associating the first frequency sweep with the first icon may include aurally presenting the first frequency sweep, and then highlighting the first icon to indicate to the adult the association. Similarly, associating the second frequency sweep with the second icon may include aurally presenting the second frequency sweep, and then highlighting the second icon to indicate to the adult the association. Both the first and second frequency sweeps are then available for aural presentation to the adult.

At least two frequency sweeps may then be aurally presented to the adult utilizing the first frequency sweep, the second frequency sweep, or a combination of the first and second frequency sweeps, in accordance with the duration of a specified one of either the first track or the second track. In other words, one of the tracks may be selected or otherwise determined, and the frequency sweeps may be presented with durations of the selected track. In one embodiment, the aurally presenting may include randomly selecting at least two frequency sweeps to be presented, utilizing combinations of the first frequency sweep and the second frequency sweep. In one embodiment, the first frequency sweep may be referred to as UP, and the second frequency sweep may be referred to as DOWN, and the aurally presenting at least two frequency sweeps may include any of the following possible combinations: UP-UP, UP-DOWN, DOWN-UP, and DOWN-DOWN. Of course, other sequences of sweeps are also contemplated, and any such sequence may be used as desired, e.g., UP-DOWN-UP, DOWN-DOWN-UP-DOWN, and so forth. Note that the aural presentations may be made via any of a variety of means, such as, for example, via headphones attached to the computing device, speakers, and so forth.

Note that the frequency sweeps are presented (sequentially) with an inter-stimulus-interval (ISI), i.e., a specified time interval between successive frequency sweeps. In preferred embodiments, the initial anticipated threshold, the first duration, the second duration, and the (to be determined) threshold each includes a respective sweep duration, and a respective inter-stimulus-interval (ISI). In other words, the term “duration” may refer to the actual sweep duration and the ISI, and so may be a compound parameter or value.

The frequency ranges for the sweeps may be specified as desired, e.g., based on typical (aging) adult hearing frequency responses. For example, in some embodiments, if the sweep duration is above 80 ms, the frequency range for the sweep may be approximately 1000 Hz to 2428 Hz. If the sweep duration is below 80 ms, the frequency range for the sweep may be 16 octaves-per-second with minimum of 1000 Hz. Thus, for example, if the sweep duration for a frequency sweep is 70 ms, the frequency range may be 1000 Hz to 2174 Hz. It should be noted, however, that these particular values and relationships for the sweeps are meant to be exemplary only, and that other values may be used as desired. Moreover, in one embodiment, the sweep duration and inter-stimulus-interval may be co-varied in the ratio of 1:1. In other words, the sweep duration and inter-stimulus-interval may have the same value, or in some embodiments, may retain the same ratio when varied.

The adult may then be required to respond to the at least two frequency sweeps by indicating, utilizing the icons, an order in which the at least two frequency sweeps were presented. In other words, the adult may, in response to hearing the sequence of frequency sweeps, indicate the perceived order of the sweeps via the two icons. For example, in the case of the two sweep sequence UP-DOWN, the adult should indicate the order by pressing the “up” icon, and then the “down” icon. For a three sweep sequence, e.g., DOWN-DOWN-UP, the adult should press the “down” icon twice, then the “up” icon, and so forth.

In one embodiment, the requiring may include providing a period of time in which the adult is to select the icons in the order in which the at least two frequency sweeps were presented, selection of the icons made by the adult placing a cursor over a icon and clicking a mouse, wherein each mouse click is recorded as a selection, recording the selections made by the adult, and recording whether the adult correctly identified the order in which the at least two frequency sweeps were presented.

The duration of the specified track may then be modified, based on the adult's response. For example, the duration of the track may be modified in accordance with a maximum likelihood procedure, such as a ZEST (zippy estimation by sequential testing) threshold procedure, although other threshold procedures may be used as desired. In one embodiment, for each track, modifying the duration of the specified track based on the adult's response may include increasing the duration if the adult responds incorrectly, and decreasing the duration if the adult responds correctly. As noted above, modifying the duration of a track may include modifying the frequency sweep duration and/or the ISI. Thus, for each trial (in a given track), the duration of the sweep for that trial may be determined by the performance of the previous trial for that track. In other words, the adult's response to the stimulus (frequency sweep) determines that track's next sweep duration via a maximum likelihood method, such as the ZEST method.

It should be noted that while each stage is discrete, i.e., has an integer value, the stage values determined in the method may not always be integers, and may not always be modified or adjusted in integer amounts. For example, for each iteration of the assessment process described herein (or periodically per some specified number of trials), the method may determine a real (non-integral) stage value. This value may be the true updated stage value, but its rounded value may used to specify the stage to use for the next trial, e.g., a stage value of 3.4 may specify use of stage 3 for the trial, while a stage value of 3.6 may specify use of stage 4 for the trial. In one embodiment, the initial stage values may chosen such that if they are too easy (or too difficult), the next stage used will immediately be incremented (or decremented) one full stage. For example, assuming an adjustment increment/decrement of approximately 0.2, if 3.6 (which specifies stage 4) were found to be too difficult, the next value would be about 3.4 (specifying stage 3), whereas if 4 had been specified as the initial stage value and the trial were found to be too difficult, the next value (3.8) would still round to 4, and so no effective change would occur. Thus, the initial stage values may be set to real values.

The above presenting, requiring, and modifying, may be repeated one or more times in an iterative manner to determine respective final durations for the first track and the second track. For example, in one embodiment, trials in the first track and the second track may be performed in an alternating manner, or, alternatively, trials may be performed in the first track and the second track randomly with equal probability. Thus, over numerous trials, the number of trials performed in each track should be equal, or at least substantially equal. In preferred embodiments, the presenting, requiring, and modifying, may be repeated until the durations of the first track and the second track have converged to values within a specified confidence interval, and where the values are within a specified distance from each other, or, until a specified number of trials have been conducted for each track. In other words, the repetition may continue until either some maximum number of trials has been performed, or until convergence conditions for the tracks have been met, both singly, and together. For example, each track may be required converge to a respective duration value (which may include both the sweep duration and the ISI for the track), and the convergent values for the two tracks may be required to be within some distance or interval of each other.

A threshold for the adult may then be determined based on the respective final durations for the first track and the second track, where the threshold is or specifies the duration associated with the specified performance level of the adult. For example, as mentioned above, the determined threshold may specify the duration (sweep duration and/or ISI) at which the adult fails to respond correctly some specified percentage of the trials, e.g., 69%, although it should be noted that any other percentage may be used as desired. In one embodiment, the threshold for the adult may be determined by averaging the respective final durations for the first track and the second track.

In one embodiment, the method may include determining the initial anticipated threshold. For example, the initial anticipated threshold may be determined based on one or more of: the age of the adult, calibration trials performed by the adult, and/or calibration trials performed by other adults, e.g., in a “pilot” program, although it should be noted that any other type of information may also be used as desired to determine the initial anticipated threshold.

In some embodiments, the method may also include performing a plurality of practice trials, i.e., prior to performing the method elements described above. For example, in one embodiment, the initial 20 (or any other number desired) trials may be considered practice and not included in the analysis or assessment of the threshold. Thus, while the initial 20 trials may follow a ZEST (or ZEST-like) stepping procedure, the two stairs may be reset on the 21st trial to the initial track values. As indicated above, the assessment may end when either the two tracks have converged to within a given confidence interval with both tracks also within a certain distance apart or when a maximum number of trials (e.g., 100), evenly conducted between the two tracks, have been performed. The average of the two tracks' ending stage values may thus yield the adult's threshold.

Thus, various embodiments of a method for assessing an aging adult's threshold for a frequency sweep task are provided that may indicate or predict a specified performance level of the adult with regard to a frequency sweep exercise, such as the High or Low exercise described herein.

Other features and advantages of the present invention will become apparent upon study of the remaining portions of the specification and drawings.

### BRIEF DESCRIPTION OF THE DRAWINGS

FIG. 1 is a block diagram of a computer system for executing a program according to some embodiments of the present invention;

FIG. 2 is a block diagram of a computer network for executing a program according to some embodiments of the present invention;

FIG. 3 is a chart illustrating frequency/energy characteristics of two phonemes within the English language;

FIG. 4 is a chart illustrating auditory reception of a phoneme by a subject having normal receptive characteristics, and by a subject whose receptive processing is impaired;

FIG. 5 is a chart illustrating stretching of a frequency envelope in time, according to one embodiment of the present invention;

FIG. 6 is a chart illustrating emphasis of selected frequency components, according to one embodiment of the present invention;

FIG. 7 is a chart illustrating up-down frequency sweeps of varying duration, separated by a selectable inter-stimulus-interval (ISI), according to one embodiment of the present invention;

FIG. 8 is a pictorial representation of a game selection screen according to one embodiment of the present invention;

FIG. 9 is a screen shot of an initial screen in the exercise High or Low;

FIG. 10 is a screen shot of a trial within the exercise High or Low;

FIG. 11 is a screen shot during a trial within the exercise High or Low showing progress within a graphical award portion of the screen;

FIG. 12 is a screen shot showing a completed picture within a graphical award portion of the screen during training of the exercise High or Low;

FIG. 13 is a screen shot showing alternative graphical progress during training within the exercise High or Low;

FIG. 14 is a screen shot showing a reward animation within the exercise High or Low;

FIG. 15 is a flow chart illustrating advancement through the processing levels within the exercise High or Low;

FIG. 16 is a selection screen illustrating selection of the next exercise in the training of HiFi, particularly the exercise Tell us Apart;

FIG. 17 is an initial screen shot within the exercise Tell us Apart;

FIG. 18 is a screen shot within the exercise Tell us Apart particularly illustrating progress in the graphical award portion of the screen;

FIG. 19 is a screen shot within the exercise Tell us Apart illustrating an alternative progress indicator within the graphical award portion of the screen;

FIG. 20 is a screen shot of a trial within the exercise Match It;

FIG. 21 is a screen shot of a trial within the exercise Match It particularly illustrating selection of one of the available icons;

FIG. 22 is a screen shot within the exercise Match It illustrating sequential selection of two of the available icons during an initial training portion of the exercise;

FIG. 23 is a screen shot within the exercise Match It illustrating sequential selection of two of the available icons;

FIG. 24 is a screen shot within the exercise Match It illustrating an advanced training level having 16 buttons;

FIG. 25 is a screen shot within the exercise Sound Replay illustrating two icons for order association with aurally presented phonemes;

FIG. 26 is a screen shot within the exercise Sound Replay illustrating six icons for order association with two or more aurally presented phonemes;

FIG. 27 is a screen shot within the exercise Listen and Do illustrating an initial training module of the exercise;

FIG. 28 is a screen shot within the exercise Listen and Do illustrating a moderately complex scene for testing;

FIG. 29 is a screen shot within the exercise Listen and Do illustrating a complex scene for testing;

FIG. 30 is a screen shot within the exercise Story Teller illustrating an initial training module of the exercise;

FIG. 31 is a screen shot within the exercise Story Teller illustrating textual response possibilities to a question;

FIG. 32 is a screen shot within the exercise Story Teller illustrating graphical response possibilities to a question;

FIG. 33 illustrates an exemplary interface for the High or Low assessment before the start button is pressed, according to one embodiment;

FIG. 34 illustrates an exemplary interface for the High or Low assessment, after the start button is pressed, according to one embodiment;

FIG. 35 flowcharts one embodiment of a method for threshold assessment with respect to the High or Low exercise;

FIG. 36 illustrates convergence of the durations for two tracks in the High or Low assessment, according to one embodiment;

FIG. 37 flowcharts one embodiment of a method for assessing or estimating performance of an aging adult on a phoneme comparison exercise, such as the Tell Us Apart exercise;

FIG. 38 flowcharts one embodiment of a method for assessing or estimating performance of an aging adult on a spatial/auditory memory training exercise, such as the Match It exercise;

FIG. 39 illustrates one embodiment of a screenshot for the Match It assessment;

FIG. 40 is a high level flowchart of one embodiment of a method for determining an aging adult's threshold with respect to a serial memory exercise, such as the Sound Replay exercise;

FIG. 41 illustrates one embodiment of an initial screen of the Sound Replay assessment showing the start button, as an example of the interface before the start button is pressed;

FIG. 42 illustrates an example of the interface of the Sound Replay assessment after the start button is pressed, according to one embodiment;

FIG. 43 is a high level flowchart of one embodiment of a method for determining an aging adult's threshold with respect to a serial memory exercise, such as the Listen and Do exercise;

FIG. 44 illustrates an exemplary screen suitable for use in the Listen and Do assessment or exercise, specifically for instruction sequences of categories 2 and 4;

FIG. 45 illustrates another exemplary screen suitable for use in the Listen and Do assessment or exercise, specifically for instruction sequences of category 3; and

FIG. 46 is a high level flowchart of one embodiment of a method for effectively training an adult to improve cognitive and memory skills in the adult.

### DETAILED DESCRIPTION

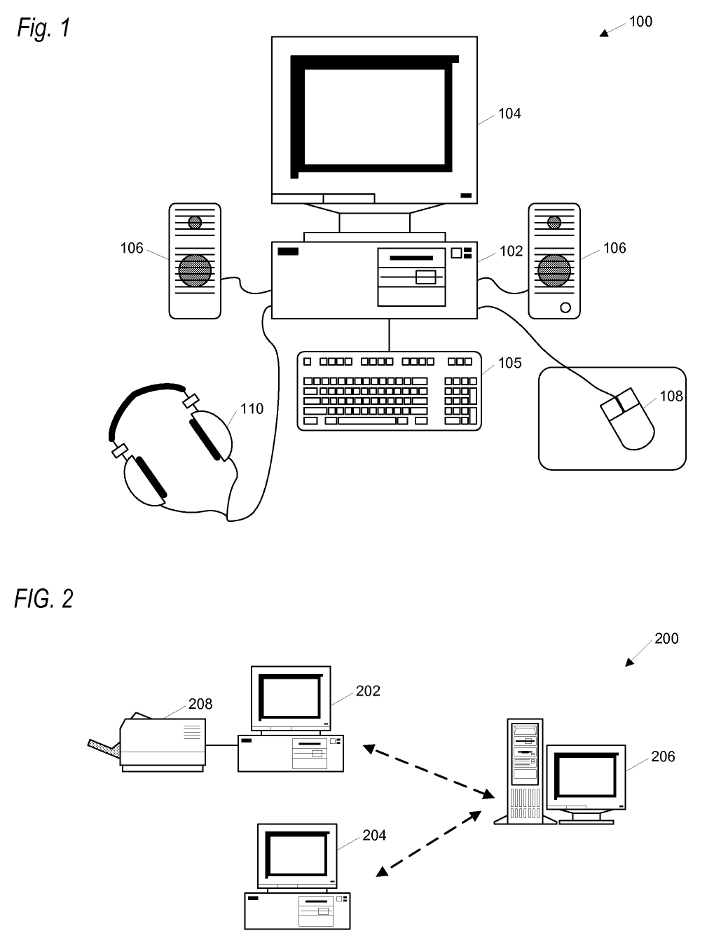

Referring to FIG. 1, a computer system 100 is shown for executing a computer program to train, or retrain an individual according to the present invention to enhance their memory and improve their cognition. The computer system 100 contains a computer 102, having a CPU, memory, hard disk and CD ROM drive (not shown), attached to a monitor 104. The monitor 104 provides visual prompting and feedback to the subject during execution of the computer program. Attached to the computer 102 are a keyboard 105, speakers 106, a mouse 108, and headphones 110. The speakers 106 and the headphones 110 provide auditory prompting and feedback to the subject during execution of the computer program. The mouse 108 allows the subject to navigate through the computer program, and to select particular responses after visual or auditory prompting by the computer program. The keyboard 105 allows an instructor to enter alpha numeric information about the subject into the computer 102. Although a number of different computer platforms are applicable to the present invention, embodiments of the present invention execute on either IBM compatible computers or Macintosh computers, or similarly configured computing devices such as set top boxes, PDA's, gaming consoles, etc.

Now referring to FIG. 2, a computer network 200 is shown. The computer network 200 contains computers 202, 204, similar to that described above with reference to FIG. 1, connected to a server 206. The connection between the computers 202, 204 and the server 206 can be made via a local area network (LAN), a wide area network (WAN), or via modem connections, directly or through the Internet. A printer 208 is shown connected to the computer 202 to illustrate that a subject can print out reports associated with the computer program of the present invention. The computer network 200 allows information such as test scores, game statistics, and other subject information to flow from a subject's computer 202, 204 to a server 206. An administrator can then review the information and can then download configuration and control information pertaining to a particular subject, back to the subject's computer 202, 204.

Before providing a detailed description of the present invention, a brief overview of certain components of speech will be provided, along with an explanation of how these components are processed by subjects. Following the overview, general information on speech processing will be provided so that the reader will better appreciate the novel aspects of the present invention.

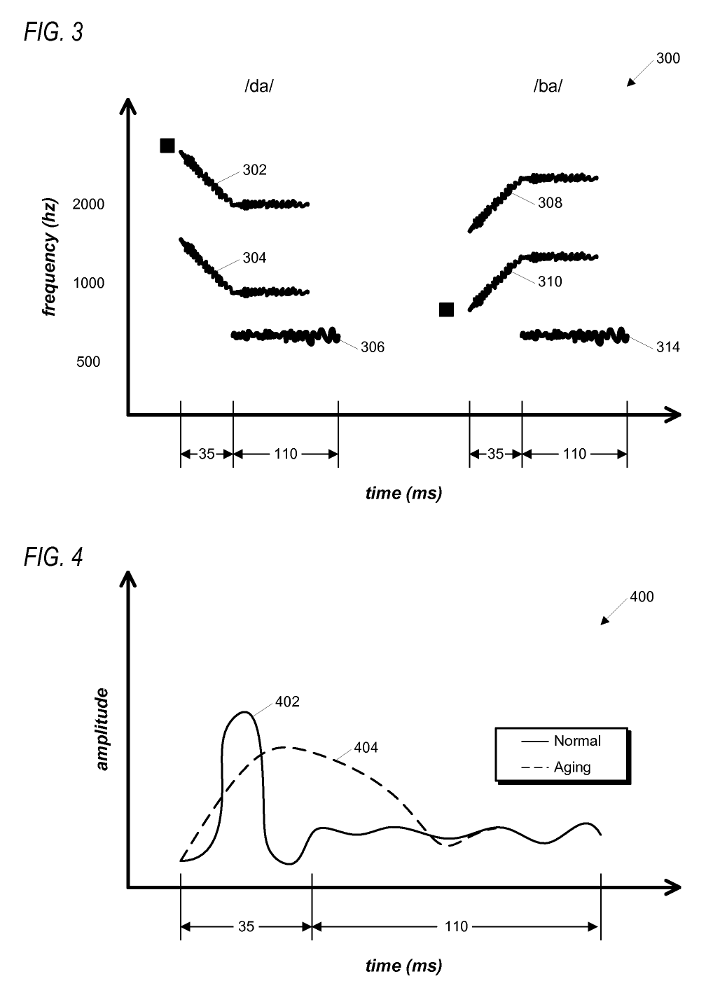

Referring to FIG. 3, a chart is shown that illustrates frequency components, over time, for two distinct phonemes within the English language. Although different phoneme combinations are applicable to illustrate features of the present invention, the phonemes /da/ and /ba/ are shown. For the phoneme /da/, a downward sweep frequency component 302 (called a formant), at approximately 2.5-2 khz is shown to occur over a 35 ms interval. In addition, a downward sweep frequency component (formant) 304, at approximately 1 khz is shown to occur during the same 35 ms interval. At the end of the 35 ms interval, a constant frequency component (formant) 306 is shown, whose duration is approximately 110 ms. Thus, in producing the phoneme /da/, the stop consonant portion of the element /d/ is generated, having high frequency sweeps of short duration, followed by a long vowel element /a/ of constant frequency.

Also shown are formants for a phoneme /ba/. This phoneme contains an upward sweep frequency component 308, at approximately 2 khz, having a duration of approximately 35 ms. The phoneme also contains an upward sweep frequency component 310, at approximately 1 khz, during the same 35 ms period. Following the stop consonant portion /b/ of the phoneme, is a constant frequency vowel portion 314 whose duration is approximately 110 ms.

Thus, both the /ba/ and /da/ phonemes begin with stop consonants having modulated frequency components of relatively short duration, followed by a constant frequency vowel component of longer duration. The distinction between the phonemes exists primarily in the 2 khz sweeps during the initial 35 ms interval. Similarity exists between other stop consonants such as /ta/, /pa/, /ka/ and /ga/.

Referring now to FIG. 4, the amplitude of a phoneme, for example /ba/, is viewed in the time domain. A short duration high amplitude peak waveform 402 is created upon release of either the lips or the tongue when speaking the consonant portion of the phoneme, that rapidly declines to a constant amplitude signal of longer duration. For an individual with normal temporal processing, the waveform 402 will be understood and processed essentially as it is. However, for an individual whose auditory processing is impaired, or who has abnormal temporal processing, the short duration, higher frequency consonant burst will be integrated over time with the lower frequency vowel, and depending on the degree of impairment, will be heard as the waveform 404. The result is that the information contained in the higher frequency sweeps associated with consonant differences, will be muddled, or indistinguishable.

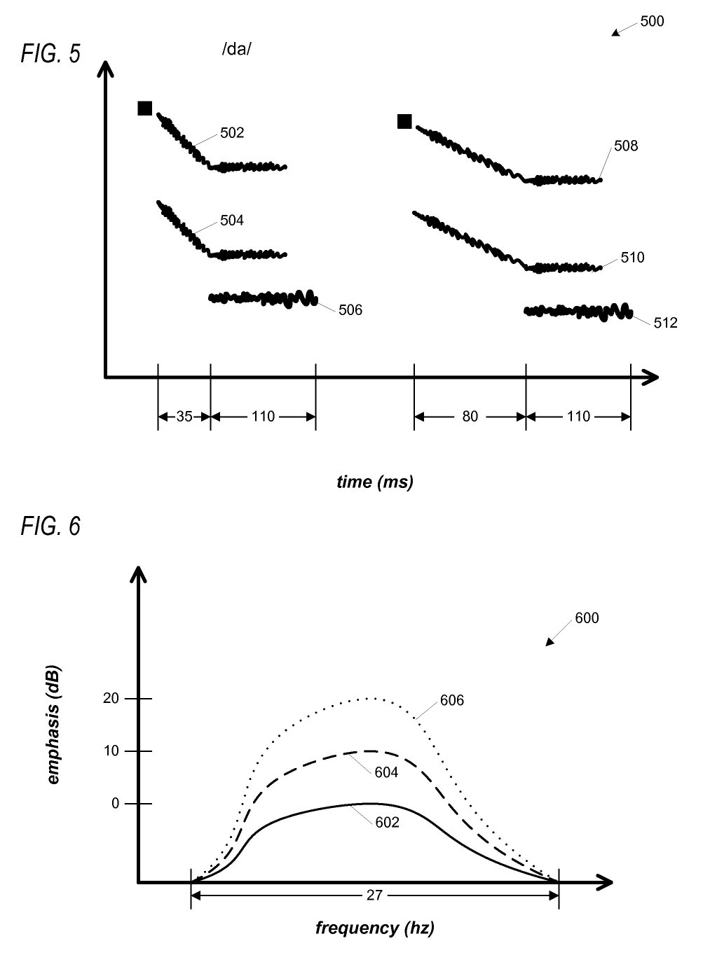

With the above general background of speech elements, and how subjects process them, a general overview of speech processing will now be provided. As mentioned above, one problem that exists in subjects is the inability to distinguish between short duration acoustic events. If the duration of these acoustic events are stretched, in the time domain, it is possible to train subjects to distinguish between these acoustic events. An example of such time domain stretching is shown in FIG. 5, to which attention is now directed.

In FIG. 5, a frequency vs. time graph 500 is shown similar to that described above with respect to FIG. 3. Using existing computer technology, the analog waveforms 502, 504 can be sampled and converted into digital values (using a Fast Fourier Transform, for example). The values can then be manipulated so as to stretch the waveforms in the time domain to a predetermined length, while preserving the amplitude and frequency components of the modified waveforms. The modified waveform can then be converted back into an analog waveform (using an inverse FFT) for reproduction by a computer, or by some other audio device. The waveforms 502, 504 are shown stretched in the time domain to durations of 80 ms (waveforms 508, 510). By stretching the consonant portion of the waveforms 502, 504 without effecting their frequency components, aging subjects with deteriorated acoustic processing can begin to hear distinctions in common phonemes.

Another method that may be used to help subjects distinguish between phonemes is to emphasize selected frequency envelopes within a phoneme. Referring to FIG. 6, a graph 600 is shown illustrating a filtering function 602 that is used to filter the amplitude spectrum of a speech sound. In one embodiment, the filtering function effects an envelope that is 27 Hz wide. By emphasizing frequency modulated envelopes over a range similar to frequency variations in the consonant portion of phonemes, they are made to more strongly engage the brain. A 10 dB emphasis of the filtering function 602 is shown in waveform 604, and a 20 dB emphasis in the waveform 606.

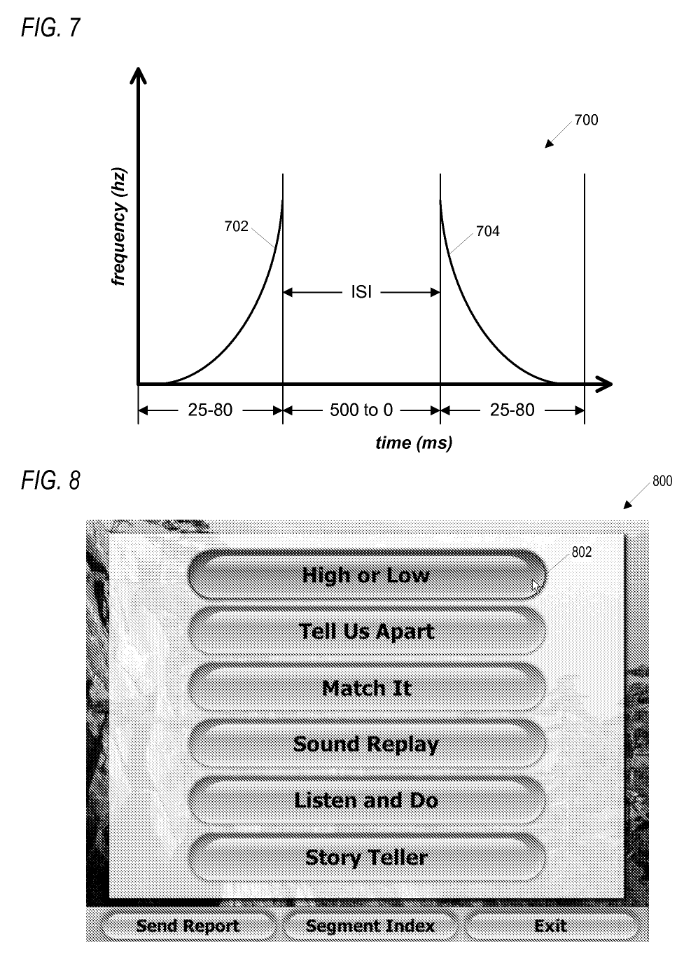

A third method that may be used to train subjects to distinguish short duration acoustic events is to provide frequency sweeps of varying duration, separated by a predetermined interval, as shown in FIG. 7. More specifically, an upward frequency sweep 702, and a downward frequency sweep 704 are shown, having duration's varying between 25 and 80 milliseconds, and separated by an inter-stimulus interval (ISI) of between 500 and 0 milliseconds. The duration and frequency of the sweeps, and the inter-stimulus interval between the sweeps are varied depending on the processing level of the subject, as will be further described below.

Although a number of methodologies may be used to produce the stretching and emphasis of phonemes, of processing speech to stretch or emphasize certain portions of the speech, and to produce sweeps and bursts, according to one embodiment of the present invention, a complete description of the methodology used within HiFi is described in Appendix G, which should be read as being incorporated into the body of this specification.

Appendices H, I and J have further been included, and are hereby incorporated by reference to further describe the code which generates the sweeps, the methodology used for incrementing points in each of the exercises, and the stories used in the exercise Story Teller.

Each of the above described methods have been combined in a unique fashion by the present invention to provide an adaptive training method and apparatus for enhancing memory and cognition in aging adults. The present invention is embodied into a computer program entitled HiFi by Neuroscience Solutions, Inc. The computer program is provided to a participant via a CD-ROM which is input into a general purpose computer such as that described above with reference to FIG. 1. Specifics of the present invention will now be described with reference to FIGS. 8-32.

Referring to FIG. 8, an initial screen shot 800 is shown which provides buttons 802 for selection of one of the six exercises provided within the HiFi computer program. It is anticipated that more exercises may be added within the HiFi program, or alternate programs used to supplement or replace the exercises identified in the screen shot 800. In one embodiment, a participant begins training by selecting the first exercise (High or Low) and progressing sequentially through the exercises. That is, the participant moves a cursor over one of the exercise buttons, which causes a button to be highlighted, and then indicates a selection by pressing a computer mouse, for example. In an alternate embodiment, the exercises available for training are pre-selected, based on the participant's training history, and are available in a prescribed order. That is, based on the participant's success or failure in previous training sessions, or the time a participant has spent in particular exercises, an optimized schedule for a particular day is determined and provided to the participant via the selection screen. For example, to allow some adaptation of a training regimen to a participant's schedule, an hour per day is prescribed for N number of weeks (e.g., 8 weeks). This would allow 3-4 exercises to be presented each day. In another model, an hour and a half per day might be prescribed for a number of weeks, which would allow either more time for training in each exercise, each day, or more than 3-4 exercises to be presented each day. In either case, it should be appreciated that a training regiment for each exercise should be adaptable according to the participant's schedule, as well as to the participant's historical performance in each of the exercises. Once the participant has made a selection, in this example, the exercise HIGH or LOW is selected, training proceeds to that exercise.

High or Low

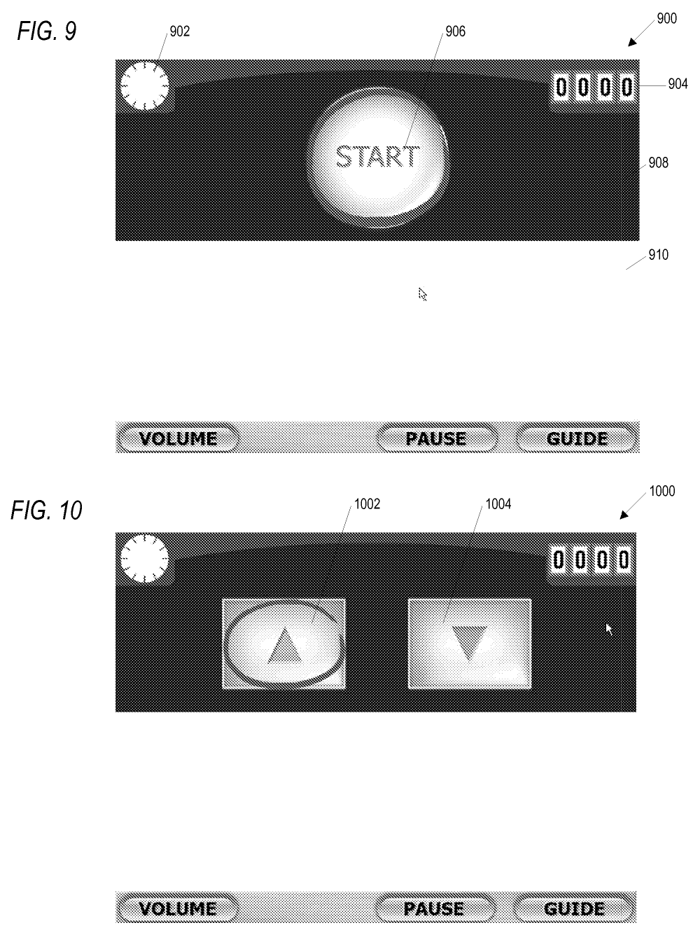

Referring now to FIG. 9, a screen shot is shown of the initial training screen for the exercise HIGH or LOW. Elements within the training screen 900 will be described in detail, as many are common for all of the exercises within the HiFi program. In the upper left of the screen 900 is a clock 902. The clock 902 does not provide an absolute reference of time. Rather, it provides a relative progress indicator according to the time prescribed for training in a particular game. For example, if the prescribed time for training was 12 minutes, each tick on the clock 902 would be 1 minute. But, if the prescribed time for training was 20 minutes, then each tick on the clock would be 20/12 minutes. In the following figures, the reader will note how time advances on the clock 902 in consecutive screens. Also shown is a score indicator 904. The score indicator 904 increments according to correct responses by the participant. In one embodiment, the score does not increment linearly. Rather, as described in co-pending application U.S. Ser. No. 10/894,388, filed Jul. 19, 2004 and entitled “REWARDS METHOD FOR IMPROVED NEUROLOGICAL TRAINING”, the score indicator 904 may increment non-linearly, with occasional surprise increments to create additional rewards for the participant. But, regardless of how the score is incremented, the score indicator provides the participant an indication of advancement in their exercise. The screen 900 further includes a start button 906 (occasionally referred to in the Appendices as the OR button). The purpose of the start button 906 is to allow the participant to select when they wish to begin a new trial. That is, when the participant places the cursor over the start button 906, the button is highlighted. Then, when the participant indicates a selection of the start button 906 (e.g., by click the mouse), a new trial is begun. The screen 900 further includes a trial screen portion 908 and a graphical reward portion 910. The trial screen portion 908 provides an area on the participant's computer where trials are graphically presented. The graphical reward portion 910 is provided, somewhat as a progress indicator, as well as a reward mechanism, to cause the participant to wish to advance in the exercise, as well as to entertain the participant. The format used within the graphical reward portion 910 is considered novel by the inventors, and will be better described as well as shown, in the descriptions of each of the exercises.

Referring now to FIG. 10, a screen shot 1000 is shown of an initial trial within the exercise HIGH or LOW. The screen shot 1000 is shown after the participant selects the start button 906. Elements of the screen 1000 described above with respect to FIG. 9 will not be referred to again, but it should be appreciated that unless otherwise indicated, their function performs as described above with respect to FIG. 9. Additionally, two blocks 1002 and 1004 are presented to the participant. The left block 1002 shows an up arrow. The right block 1004 shows a down arrow. The blocks 1002, 1004 are intended to represent auditory frequency sweeps that sweep up or down in frequency, respectively. Within the context of this application, the blocks 1002, 1004 are referred to as icons. In one embodiment, icons are pictorial representations that are selectable by the participant to indicate a selection. Icons may graphically illustrate an association with an aural presentation, such as an up arrow 1002, or may indicate a phoneme (e.g., BA), or even a word. Further, icons may be used to indicate correct selections to trials, or incorrect selections. Any use of a graphical item within the context of the present exercises, other than those described above with respect to FIG. 9 may be referred to as icons. In some instances, the term grapheme may also be used, although applicant's believe that icon is more representative of selectable graphical items.

In one embodiment, the participant is presented with two or more frequency sweeps, each separated by an inter-stimulus-interval (ISI). For example, the sequence of frequency sweeps might be (UP, DOWN, UP). The participant is required, after the frequency sweeps are auditorily presented, to indicate the order of the sweeps by selecting the blocks 1002, 1004, according to the sweeps. Thus, if the sequence presented was UP, DOWN, UP, the participant would be expected to indicate the sequence order by selecting the left block 1002, then right block 1004, then left block 1002. If the participant correctly indicates the sweep order, as just defined, then they have correctly responded to the trial, the score indicator increments, and a “ding” is played to indicate a correct response. If the participant incorrectly indicates the sweep order, then they have incorrectly responded to the trial, and a “thunk” is played to indicate an incorrect response. With the above understanding of training with respect to the exercise HIGH or LOW, specifics of the game will now be described.

A goal of this exercise is to expose the auditory system to rapidly presented successive stimuli during a behavior in which the participant must extract meaningful stimulus data from a sequence of stimulus. This can be done efficiently using time order judgment tasks and sequence reconstruction tasks, in which participants must identify each successively present auditory stimulus. Several types of simple, speech-like stimuli are used in this exercise to improve the underlying ability of the brain to process rapid speech stimuli: frequency modulated (FM) sweeps, structured noise bursts, and phoneme pairs such as /ba/ and /da/. These stimuli are used because they resemble certain classes of speech. Sweeps resemble stop consonants like /b/ or /d/. Structured noise bursts are based on fricatives like /sh/ or /f/, and vowels like /a/ or /i/. In general, the FM sweep tasks are the most important for renormalizing the auditory responses of participants. The structured noise burst tasks are provided to allow high-performing participants who complete the FM sweep tasks quickly an additional level of useful stimuli to continue to engage them in time order judgment and sequence reconstruction tasks.

This exercise is divided into two main sections, FM sweeps and structured noise bursts. Both of these sections have: a Main Task, an initiation for the Main Task, a Bonus Task, and a short initiation for the Bonus Task. The Main Task in FM sweeps is Task 1 (Sweep Time Order Judgment), and the Bonus Task is Task 2 (Sweep Sequence Reconstruction). FM Sweeps is the first section presented to the participant. Task 1 of this section is closed out before the participant begins the second section of this exercise, structured noise bursts. The Main Task in structured noise bursts is Task 3 (Structured Noise Burst Time Order Judgment), and the Bonus Task is Task 4 (Structured Noise Burst Sequence Reconstruction). When Task 3 is closed out, the entire Task is reopened beginning with easiest durations in each frequency. The entire Task is replayed.

Task 1—Main Task: Sweep Time Order Judgment

This is a time order judgment task. Participants listen to a sequential pair of FM sweeps, each of which can sweep upwards or downwards. Participants are required to identify each sweep as upwards or downwards in the correct order. The task is made more difficult by changing both the duration of the FM sweeps (shorter sweeps are more difficult) and decreasing the inter-stimulus interval (ISI) between the FM sweeps (shorter ISIs are more difficult).

Stimuli consist of upwards and downwards FM sweeps, characterized by their base frequency (the lowest frequency in the FM sweep) and their duration. The other characteristic defining an FM sweep, the sweep rate, is held constant at 16 octaves per second throughout the task. This rate was chosen to match the average FM sweep rate of formants in speech (e.g., ba/da). A pair of FM sweeps is presented during a trial. The ISI changes based on the participant's performance. There are three base frequencies:

| Base Frequency Index | Base Frequency |
|---|---|
| 1 | 500 Hz |
| 2 | 1000 Hz |
| 3 | 2000 Hz |

There are five durations:

| Duration Index | Duration |
|---|---|
| 1 | 80 ms |
| 2 | 60 ms |
| 3 | 40 ms |
| 4 | 35 ms |
| 5 | 30 ms |

Initially, a “training” session is provided to illustrate to the participant how the exercise is to be played. More specifically, an upward sweep is presented to the participant, followed by an indication, as shown in FIG. 10 of block 1002 circled in red, to indicate to the participant that they are to select the upward arrow block 1002 when they hear an upward sweep. Then, a downward sweep is presented to the participant, followed by an indication (not shown) of block 1004 circled in red, to indicate to the participant that they are to select the downward arrow block 1004 when they hear a downward sweep. The initial training continues by presenting the participant with an upward sweep, followed by a downward sweep, with red circles appearing first on block 1002, and then on block 1004. The participant is presented with several trials to insure that they understand how trials are to be responded to. Once the initial training completes, it is not repeated. That is, the participant will no longer be presented with hints (i.e. red circles) to indicate the correct selection. Rather, after selecting the start button an auditory sequence of frequency sweeps is presented, and the participant must indicate the order of the frequency sweeps by selecting the appropriate blocks, according to the sequence.

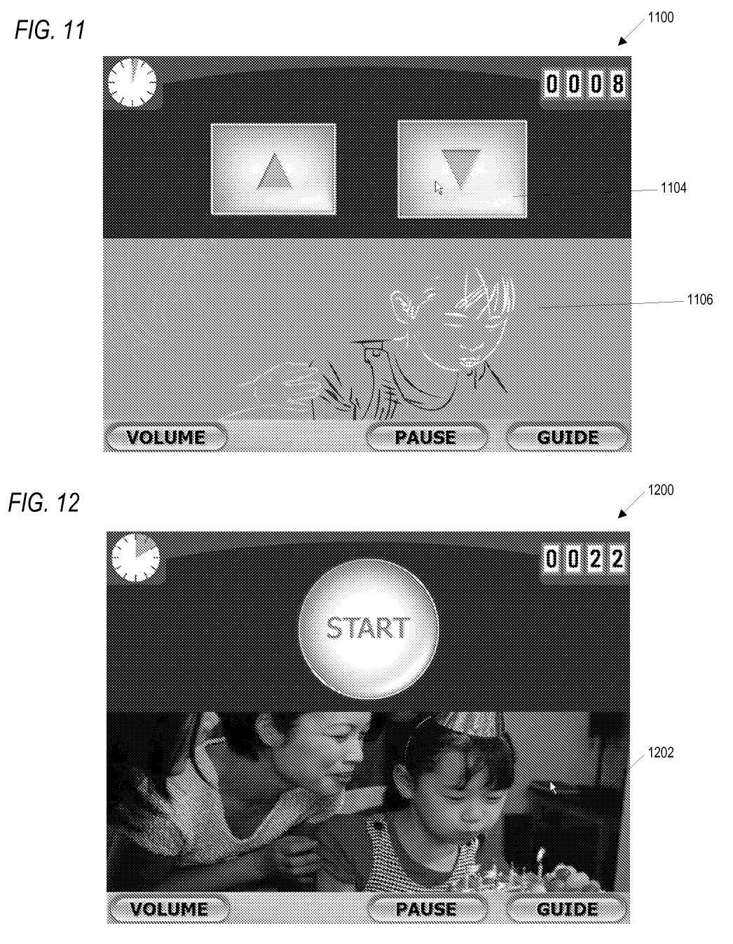

Referring now to FIG. 11, a screen shot 1100 is provided to illustrate a trial. In this instance, the right block 1104 is being selected by the participant to indicate a downward sweep. If the participant correctly indicates the sweep order, the score indicator is incremented, and a “ding” is played, as above. In addition, within the graphical reward portion 1106 of the screen 1100, part of an image is traced out for the subject. That is, upon completion of a trial, a portion of a reward image is traced. After another trial, an additional portion of a reward image is traced. Then, after several trials, the complete image is completed and shown to the participant. Thus, upon initiation of a first trial, the graphical reward portion 1106 is blank. But, as each trial is completed, a portion of a reward image is presented, and after a number of trials, the image is completed. One skilled in the art will appreciate that the number of trials required to completely trace an image may vary. What is important is that in addition to incrementing a counter to illustrate correct responses, the participant is presented with a picture that progressively advances as they complete trials, whether or not the participant correctly responds to a trial, until they are rewarded with a complete image. It is believed that this progressive revealing of reward images both entertains and holds the interest of the participant. And, it acts as an encouraging reward for completing a number of trials, even if the participant's score is not incrementing. Further, in one embodiment, the types of images presented to the participant are selected based on the demographics of the participant. For example, types of reward image libraries include children, nature, travel, etc., and can be modified according to the demographics, or other interests of the subject being trained. Applicant's are unaware of any “reward” methodology that is similar to what is shown and described with respect to the graphical reward portion.

Referring to FIG. 12, a screen shot 1200 is shown within the exercise HIGH or LOW. The screen shot 1200 includes a completed reward image 1202 in the graphical reward portion of the screen. In one embodiment, the reward image 1202 required the participant to complete six trials. But, one skilled in the art will appreciate that any number of trials might be selected before the reward image is completed. Once the reward image 1202 is completed, the next trial will begin with a blank graphical reward portion.

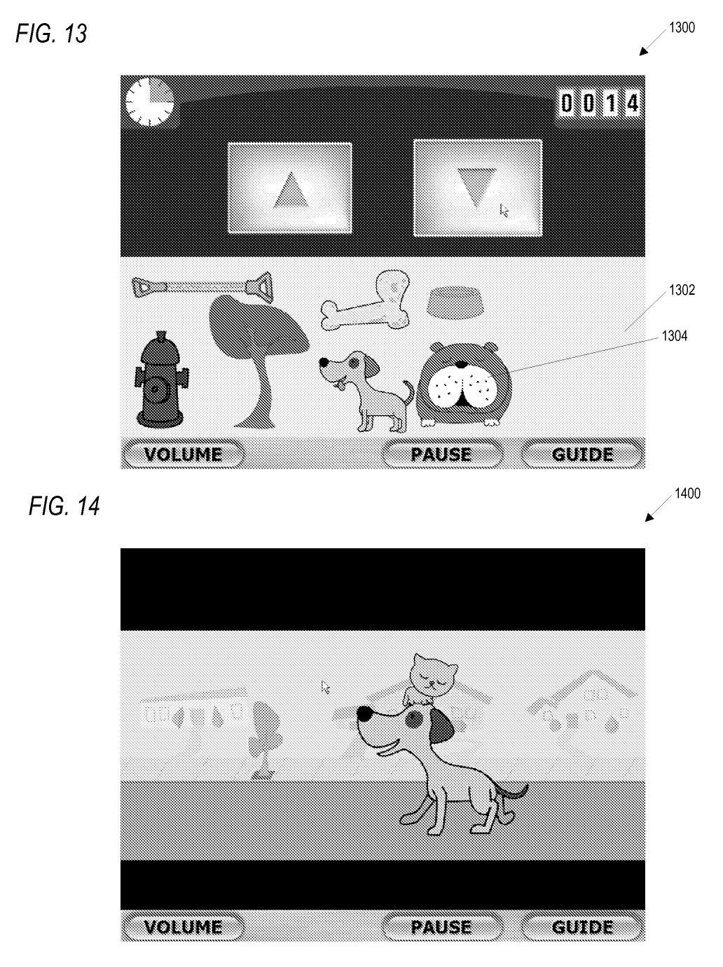

Referring to FIG. 13, a screen shot 1300 is shown within the exercise HIGH or LOW. In this screen 1300 the graphical reward portion 1302 is populated with a number of figures such as the dog 1304. In one embodiment, a different figure is added upon completion of each trial. Further, in one embodiment, each of the figures relate to a common theme, for a reward animation that will be forthcoming. More specifically at intervals during training, when the participant has completed a number of trials, a reward animation is played to entertain the participant, and provide a reward to training. The figures shown in the graphical reward portion 1302 correspond to a reward animation that has yet to be presented.

Referring now to FIG. 14, a reward animation 1400, such as that just described is shown. Typically, the reward animation is a moving cartoon, with music in the background, utilizing the figures added to the graphical reward portion at the end of each trial, as described above.

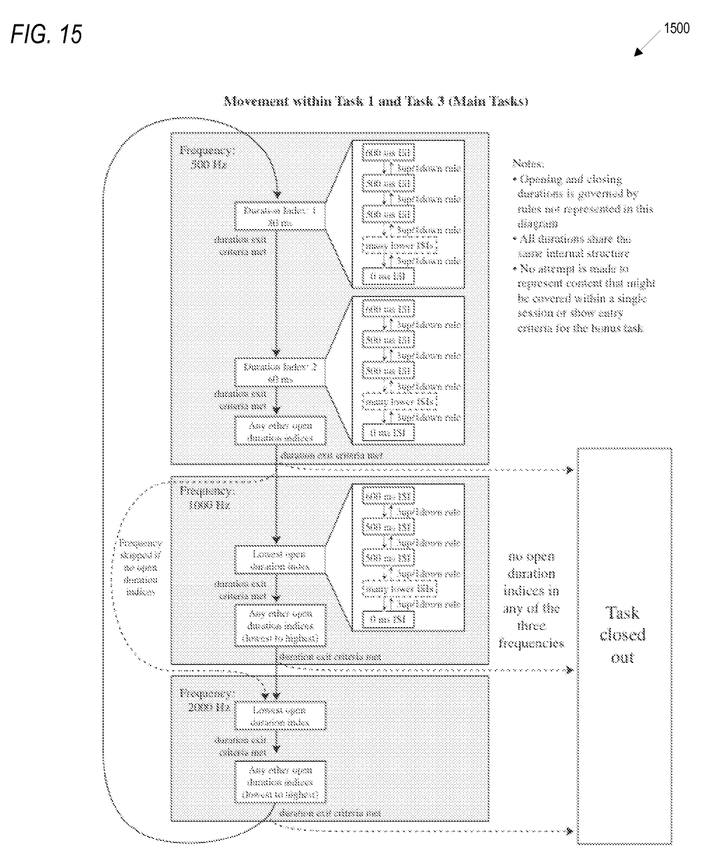

Referring now to FIG. 15, a flow chart is shown which illustrates progression thru the exercise HIGH or LOW. The first time in Task 1, a list of available durations (categories) with a current ISI is created within each frequency. At this time, there are categories in this list that have a duration index of 1 and a current ISI of 600 ms. Other categories (durations) are added (opened) as the participant progresses through the Task. Categories (durations) are removed from the list (closed) when specific criteria are met.

Choosing a frequency, duration (category) and ISI: The first time in: the participant begins by opening duration index 1 (80 ms) in frequency index 1 (500 Hz). The starting ISI is 600 ms when opening a duration and the ISI step size index when entering a duration is 1.

Beginning subsequent sessions: The participant moves to a new frequency unless the participant has completed less than 20 trials in Task 1 of the previous session's frequency.

Returning from Task 2 (bonus task): The participant will be switching durations, but generally staying in the same frequency.

Switching frequencies: The frequency index is incremented, cycling the participant through the frequencies in order by frequency index (500 Hz, 1000 Hz, 200 Hz, 500 Hz, etc.). If there are no open durations in the new frequency, the frequency index is incremented again until a frequency is found that has an open duration. If all durations in all frequencies have been closed out, Task 1 is closed. The participant begins with the longest open duration (lowest duration index) in the new frequency.

Switching durations: Generally, the duration index is incremented until an open duration is found (the participant moves from longer, easier durations to shorter, harder durations). If there are no open durations, the frequency is closed and the participant switches frequencies. A participant switches into a duration with a lower index (longer, easier duration) when 10 incorrect trials are performed at an ISI of 1000 ms at a duration index greater than 1.

Progression within a duration changes in ISI: ISIs are changed using a 3-up/1-down adaptive tracking rule: Three consecutive correct trials equals advancement—ISI is shortened. One incorrect equals retreat—ISI is lengthened. The amount that the ISI changes is adaptively tracked. This allows participants to move in larger steps when they begin the duration and then smaller steps as they approach their threshold. The following steps sizes are used:

| ISI Step Size Index | ISI Step Size |
|---|---|
| 1 | 50 ms |
| 2 | 25 ms |
| 3 | 10 ms |
| 4 | 5 ms |

When starting a duration, the ISI step index is 1 (50 ms). This means that 3 consecutive correct trials will shorten the ISI by 50 ms and 1 incorrect will lengthen the ISI by 50 ms—3 up/1 down. The step size index is increased after every second Sweeps reversal. A Sweeps reversal is a “change in direction”. For example, three correct consecutive trials shortens the ISI. A single incorrect lengthens the ISI. The drop to a longer ISI after the advancement to a shorter ISI is counted as one reversal. If the participant continues to decrease difficulty, these drops do not count as reversals. A “change in direction” due to 3 consecutive correct responses counts as a second reversal.
A total of 8 reversals are allowed within a duration; the 9^{th} reversal results in the participant exiting the duration; the duration remains open unless criteria for stable performance have been met. ISI never decreases to lower than 0 ms, and never increases to more than 1000 ms. The tracking toggle pops the participant out of the Main Task and into Task Initiation if there are 5 sequential increases in ISI. The current ISI is stored. When the participant passes initiation, they are brought back into the Main Task. Duration re-entry rules apply. A complete description of progress through the exercise High or Low is found in Appendix A.

To allow the text of this specification to be presented clearly, the details relating to progression methodology, processing, stimuli, etc., for each of the exercises within HiFi have been placed in Appendices to this specification. However, applicants consider the appendices to be part of this specification. Therefore, they should be read as part of this specification, and as being incorporated within the body of this specification for all purposes.

Stretch and Emphasis Processing of Natural Speech in HiFi

In order to improve the representational fidelity of auditory sensory representations in the brain of trained individuals, natural speech signals are initially stretched and emphasized. The degree of stretch and emphasis is reduced as progress is made through the exercise. In the final stage, faster than normal speech is presented with no emphasis.

Both stretching and emphasis operations are performed using the Praat (v. 4.2) software package (http://www.fon.hum.uva.nl/praat/) produced by Paul Boersma and David Weenink at the Institute for Phonetic Sciences at the University of Amsterdam. The stretching algorithm is a Pitch-Synchronous OverLap-and-Add method (PSOLA). The purpose of this algorithm is lengthen or shorten the speech signal over time while maintaining the characteristics of the various frequency components, thus retaining the same speech information, only in a time-altered form. The major advantage of the PSOLA algorithm over the phase vocoder technique used in previous versions of the training software is that PSOLA maintains the characteristic pitch-pulse-phase synchronous temporal structure of voiced speech sounds. An artifact of vocoder techniques is that they do not maintain this synchrony, creating relative phase distortions in the various frequency components of the speech signal. This artifact is potentially detrimental to older observers whose auditory systems suffer from a loss of phase-locking activity. A minimum frequency of 75 Hz is used for the periodicity analysis. The maximum frequency used is 600 Hz. Stretch factors of 1.5, 1.25, 1 and 0.75 are used.

The emphasis operation used is referred to as band-modulation deepening. In this emphasis operation, relatively fast-changing events in the speech profile are selectively enhanced. The operation works by filtering the intensity modulations in each critical band of the speech signal. Intensity modulations that occur within the emphasis filter band are deepened, while modulations outside that band are not changed. The maximum enhancement in each band is 20 dB. The critical bands span from 300 to 8000 Hz. Bands are 1 Bark wide. Band smoothing (overlap of adjacent bands) is utilized to minimize ringing effects. Band overlaps of 100 Hz are used. The intensity modulations within each band are calculated from the pass-band filtered sound obtained from the inverse Fourier transform of the critical band signal. The time-varying intensity of this signal is computed and intensity modulations between 3 and 30 Hz are enhanced in each band. Finally, a full-spectrum speech signal is recomposed from the enhanced critical band signals. The major advantage of the method used here over methods used in previous versions of the software is that the filter functions used in the intensity modulation enhancement are derived from relatively flat Gaussian functions. These Gaussian filter functions have significant advantages over the FIR filters designed to approximate rectangular-wave functions used previously. Such FIR functions create significant ringing in the time domain due to their steepness on the frequency axis and create several maxima and minima in the impulse response. These artifacts are avoided in the current methodology.

The following levels of stretching and emphasis are used in HiFi:
Level 1=1.5 stretch, 20 dB emphasis
Level 2=1.25 stretch, 20 dB emphasis
Level 3=1.00 stretch, 10 dB emphasis
Level 4=0.75 stretch, 10 dB emphasis
Level 5=0.75 stretch, 0 dB emphasis
   Tell Us Apart

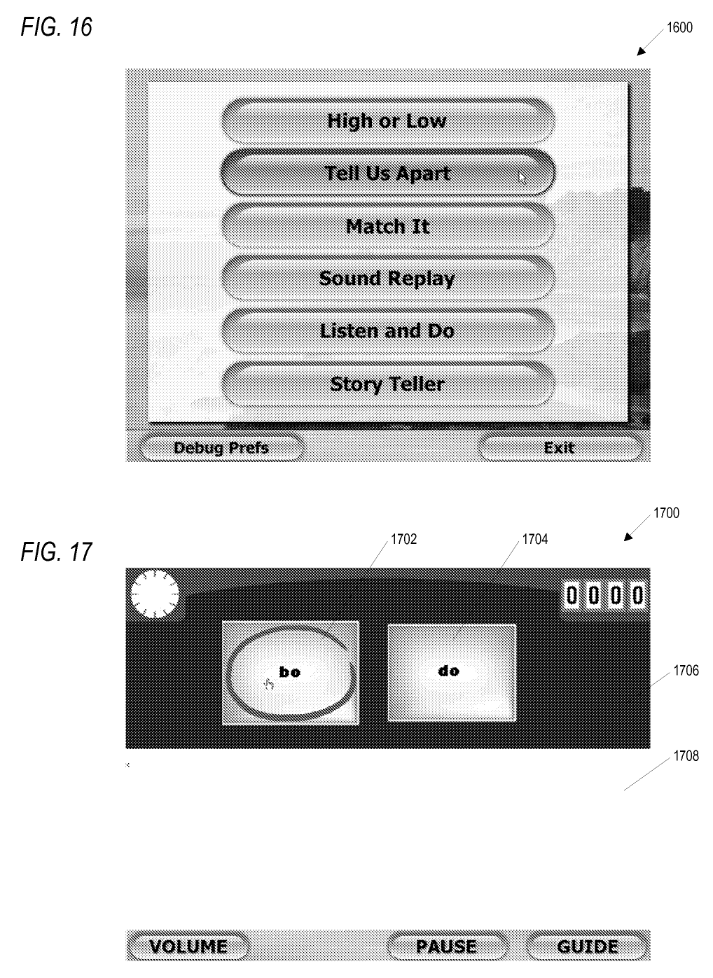

Referring now to FIG. 16, a screen shot is shown of an exercise selection screen 1600. In this instance, the exercise Tell us Apart is being selected. Upon selection, the participant is taken to the exercise. In one embodiment, the participant is returned to the exercise selection screen 1600 when time expires in a current exercise. In an alternative embodiment, the participant is taken immediately to the next prescribed exercise, without returning to the selection screen 1600.

Applicants believe that auditory systems in older adults suffer from a degraded ability to respond effectively to rapidly presented successive stimuli. This deficit manifests itself psychophysically in the participant's poor ability to perform auditory stimulus discriminations under backward and forward masking conditions. This manifests behaviorally in the participant's poor ability to discriminate both the identity of consonants followed by vowels, and vowels preceded by consonants. The goal of Tell us Apart is to force the participant to make consonant and vowel discriminations under conditions of forward and backward masking from adjacent vowels and consonants respectively. This is accomplished using sequential phoneme identification tasks and continuous performance phoneme identification tasks, in which participants identify successively presented phonemes. Applicants assume that older adults will find making these discriminations difficult, given their neurological deficits. These discriminations are made artificially easy (at first) by using synthetically generated phonemes in which both 1) the relative loudness of the consonants and vowels and/or 2) the gap between the consonants and vowels has been systematically manipulated to increase stimulus discriminability. As the participant improves, these discriminations are made progressively more difficult by making the stimuli more normal.

Referring now to FIG. 17, a screen shot 1700 is shown of an initial training screen within the exercise Tell us Apart. As in the exercise High or Low, the screen 1700 includes a timer, a score indicator, a trial portion, and a graphical reward portion. After the participant selects the Start button, two phonemes, or words, are graphically presented, (1702 and 1704 respectively). Then, one of the two words is presented in an acoustically processed form as described above. The participant is required to select one of the two graphically presented words 1702, 1704 to pair with the acoustically processed word. The selection is made when the participant places the cursor over one of the two graphical words, and indicates a selection (e.g., by clicking on a mouse button). If the participant makes a correct selection, the score indicator increments, and a “ding” is played. If the participant makes an incorrect selection, a “thunk” is played.

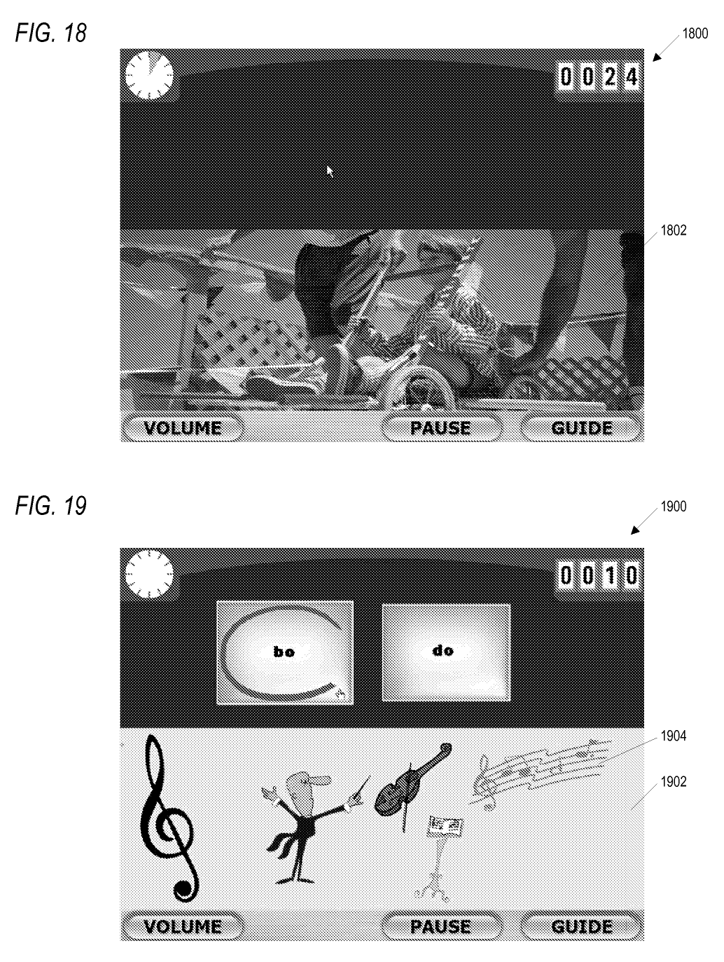

Referring to FIG. 18, a screen shot 1800 is shown, particularly illustrating a graphical reward portion 1802 that is traced, in part, upon completion of a trial. And, over a number of trials, the graphical reward portion is completed in trace form, finally resolving into a completed picture.

Referring to FIG. 19, a screen shot 1900 is shown, particularly illustrating a graphical reward portion 1902 that places a FIG. 1904 into the graphical reward portion 1902 upon completion of each trial. After a given number of trials, a reward animation is presented, as in the exercise High or Low, utilizing the FIGS. 1904 presented over the course of a number of trials. A complete description of advancement through the exercise Tell us Apart, including a description of the various processing levels used within the exercise is provided in Appendix B.

Match It

Goals of the exercise Match It! include: 1) exposing the auditory system to substantial numbers of consonant-vowel-consonant syllables that have been processed to emphasize and stretch rapid frequency transitions; and 2) driving improvements in working memory by requiring participants to store and use such syllable information in auditory working memory. This is done by using a spatial match task similar to the game “Concentration”, in which participants must remember the auditory information over short periods of time to identify matching syllables across a spatial grid of syllables.

Match It! has only one Task, but utilizes 5 speech processing levels. Processing level 1 is the most processed and processing level 5 is normal speech. Participants move through stages within a processing level before moving to a less processed speech level. Stages are characterized by the size of the spatial grid. At each stage, participants complete all the categories. The task is a spatial paired match task. Participants see an array of response buttons. Each response button is associated with a specific syllable (e.g., “big”, “tag”), and each syllable is associated with a pair of response buttons. Upon pressing a button, the participant hears the syllable associated with that response button. If the participant presses two response buttons associated with identical syllables consecutively, those response buttons are removed from the game. The participant completes a trial when they have removed all response buttons from the game. Generally, a participant completes the task by clicking on various response buttons to build a spatial map of which buttons are associated with which syllables, and concurrently begins to click consecutive pairs of responses that they believe, based on their evolving spatial map, are associated with identical syllables. The task is made more difficult by increasing the number of response buttons and manipulating the level of speech processing the syllables receive.

Stages: There are 4 task stages, each associated with a specific number of response buttons in the trial and a maximum number of response clicks allowed:

| | | Maximum Number |
|---|---|---|
| | Number of | of Clicks (max |
| Stage | Response Buttons | clicks) |
| 1 | 8 (4 pairs) | 20 |
| 2 | 16 (8 pairs) | 60 |
| 3 | 24 (12 pairs) | 120 |
| 4 | 30 (15 pairs) | 150 |

Categories: The stimuli consist of consonant-vowel-consonant syllables or single phonemes:

| Category 1 | Category 2 | Category 3 | Category 4 | Category 5 |
|---|---|---|---|---|
| baa | fig | big | buck | back |
| do | rib | bit | bud | bag |
| gi | sit | dig | but | bat |
| pu | kiss | dip | cup | cab |
| te | bill | kick | cut | cap |
| ka | dish | kid | duck | cat |
| laa | nut | kit | dug | gap |
| ro | chuck | pick | pug | pack |
| sa | rug | pig | pup | pat |
| stu | dust | pit | tub | tack |
| ze | pun | tick | tuck | tag |
| sho | gum | tip | tug | tap |
| chi | bash | bid | bug | gab |
| vaa | can | did | cud | gag |
| fo | gash | pip | puck | bad |
| ma | mat | gib | dud | tab |
| nu | lab | tig | gut | tad |
| the | nag | gig | guck | pad |

Category 1 consists of easily discriminable CV pairs. Leading consonants are chosen from those used in the exercise Tell us Apart and trailing vowels are chosen to make confusable leading consonants as easy to discriminate as possible. Category 2 consists of easily discriminable CVC syllables. Stop, fricative, and nasal consonants are used, and consonants and vowels are placed to minimize the number of confusable CVC pairs. Categories 3, 4, and 5 consist of difficult to discriminate CVC syllables. All consonants are stop consonants, and consonants and vowels are placed to maximize the number of confusable CVC syllables (e.g., cab/cap).

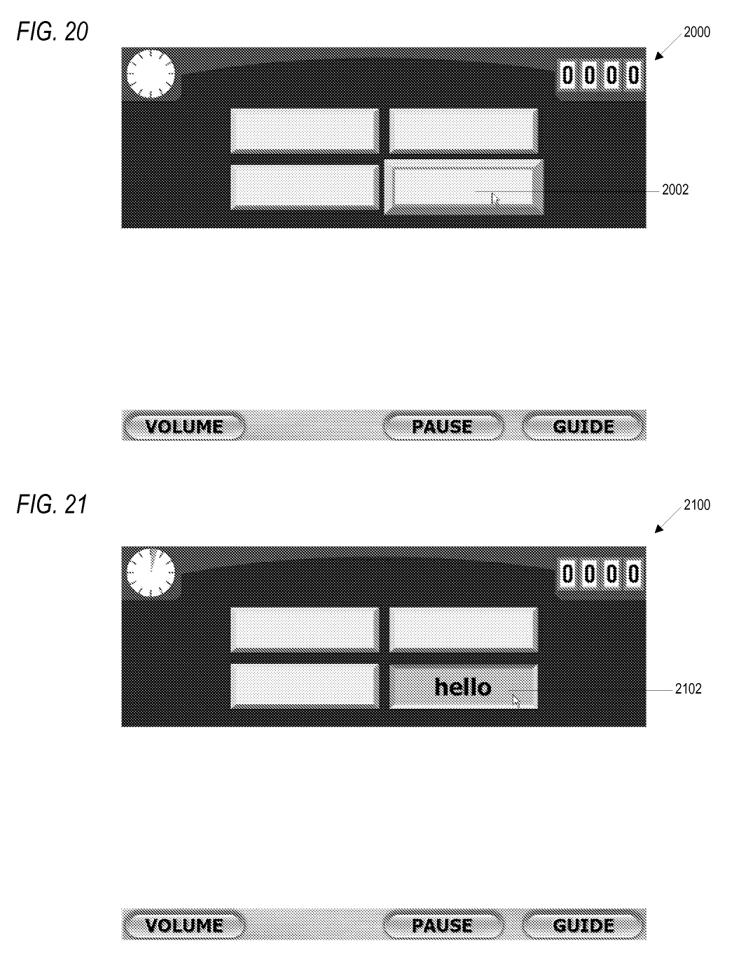

Referring now to FIG. 20, a screen shot 2000 is shown of a trial within the exercise Match It! That is, after the participant selects the start button to begin a trial, they are presented initially with four buttons 2002 for selection. As they move the cursor over a button 2002, it is highlighted. When they select a button 2002, a stimuli is presented. Consecutive selection of two buttons 2002 that have the same stimuli results in the two buttons being removed from the grid.

Referring now to FIG. 21, a screen shot 2100 is shown. This screen occurs during an initial training session after the participant has selected a button. During training, the word (or stimuli) associated with the selected button 2102 is presented both aurally and graphically to the participant. However, after training has ended, the stimuli is presented aurally only.

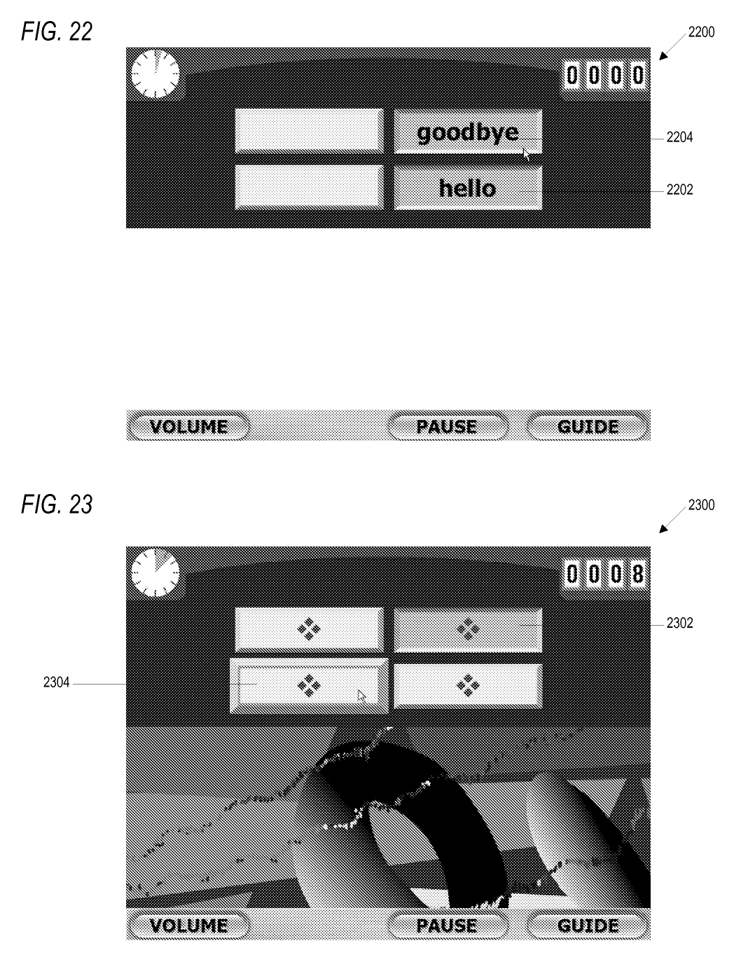

Referring now to FIG. 22, a screen shot 2200 is shown. This shot particularly illustrates that button selections are made in pairs. That is, a first selection is made to button 2202, associated with the stimuli “hello”. This selection is held until a selection is made to the second button 2204, associated with the stimuli “goodbye”. Since the consecutively selected buttons 2202 and 2204 were not associated with the same stimuli, the buttons will remain on the grid, and will be covered to hide the stimuli.

Referring now to FIG. 23, a screen shot 2300 is shown. This screen 2300 shows two consecutively selected buttons 2302 and 2304, as in FIG. 2200. However, this screen 2300 particularly illustrates that the stimuli associated with these buttons 2302 and 2304 are presented aurally only, but not graphically.

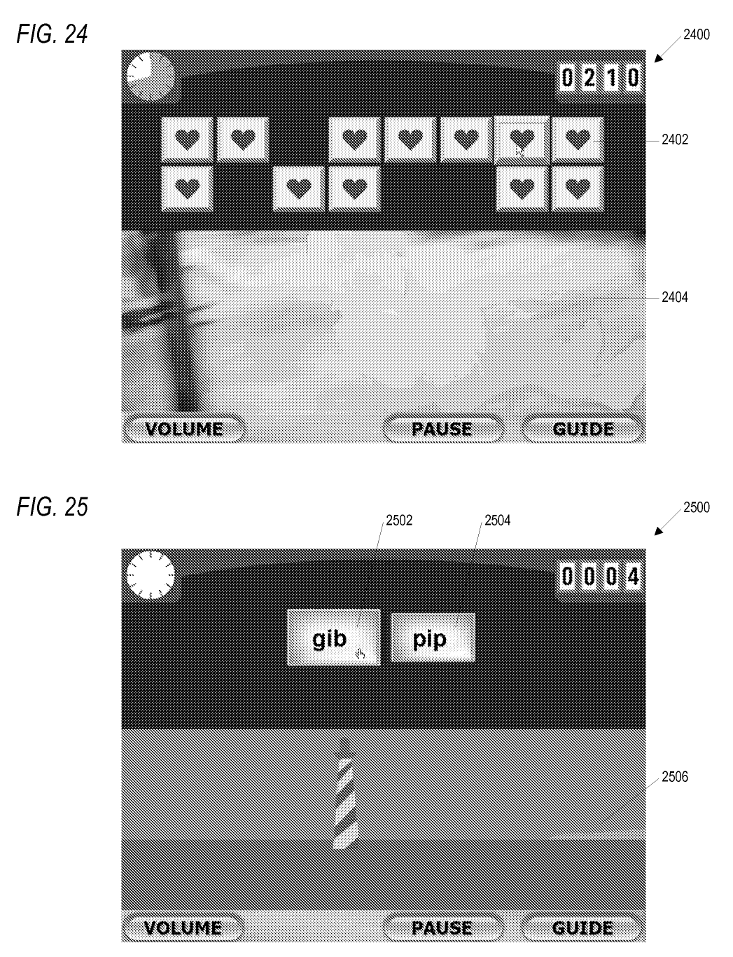

Referring now to FIG. 24, a screen shot 2400 is shown. This screen 2400 particularly illustrates a 16 button 2402 grid, presented to the participant during a more advanced stage of training than shown above with respect to FIGS. 20-23. Furthermore, what is shown is the beginning traces of a picture in the graphical reward portion 2404, as described above. One skilled in the art will appreciate that as the participant advances through the various levels in the exercise, the number of buttons provided to the participant also increases. For a complete description of flow through the processing levels, please see Appendix C.

Sound Replay

Applicants believe that the degraded representational fidelity of the auditory system in older adults causes an additional difficulty in the ability of older adults to store and use information in auditory working memory. This deficit manifests itself psychophysically in the participant's poor ability to perform working memory tasks using stimuli presented in the auditory modality. The goals of this exercise therefore include: 1) To expose the participant's auditory system to substantial numbers of consonant-vowel-consonant syllables that have been processed to emphasize and stretch the rapid frequency transitions; and 2) To drive improvements in working memory by requiring participants to store and use such syllable information in auditory working memory. These goals are met using a temporal match task similar to the neuropsychological tasks digit span and digit span backwards, in which participants must remember the auditory information over short periods of time to identify matching syllables in a temporal stream of syllables.

Sound Replay has a Main Task and Bonus Task. The stimuli are identical across the two Tasks in Sound Replay. In one embodiment, the stimuli used in Sound Replay is identical to that used in Match It. There are 5 speech processing levels. Processing level 1 is the most processed and processing level 5 is normal speech. Participants move through stages within a processing level before moving to a less processed speech level. At each stage, participants complete all categories.

A task is a temporal paired match trial. Participants hear a sequence of processed syllables (e.g., “big”, “tag”, “pat”). Following the presentation of the sequence, the participant sees a number of response buttons, each labeled with a syllable. All syllables in the sequence are shown, and there may be buttons labeled with syllables not present in the sequence (distracters). The participant is required to press the response buttons to reconstruct the sequence. The Task is made more difficult by increasing the length of the sequence, decreasing the ISI, and manipulating the level of speech processing the syllables receive. A complete description of the flow through the various stimuli and processing levels is found in Appendix D.

Referring now to FIG. 25, a screen shot 2500 is shown which illustrates a trial within the exercise Sound Replay. More specifically, after the participant selects the start button, two or more processed stimuli are aurally presented, in a particular order. Subsequent to the aural presentation, two or more graphical representations 2502, 2504 of the stimuli are presented. In one embodiment, distracter icons may also be presented to make the task more difficult for the participant. The participant is required to select the icons 2502, 2504 in the order in which they were aurally presented. Thus, if the aural presentation were “gib”, “pip”, the participant should select icon 2502 followed by selection of icon 2504. If the participant correctly responds to the trial, a “ding” is played, and the score indicator increments. Then, the graphical award portion 2506 traces a portion of a picture, as above. If the participant does not indicate the correct sequence, a “thunk” is played, and the correct response is illustrated to the participant by highlighting the icons 2502, 2504 according to their order of aural presentation.

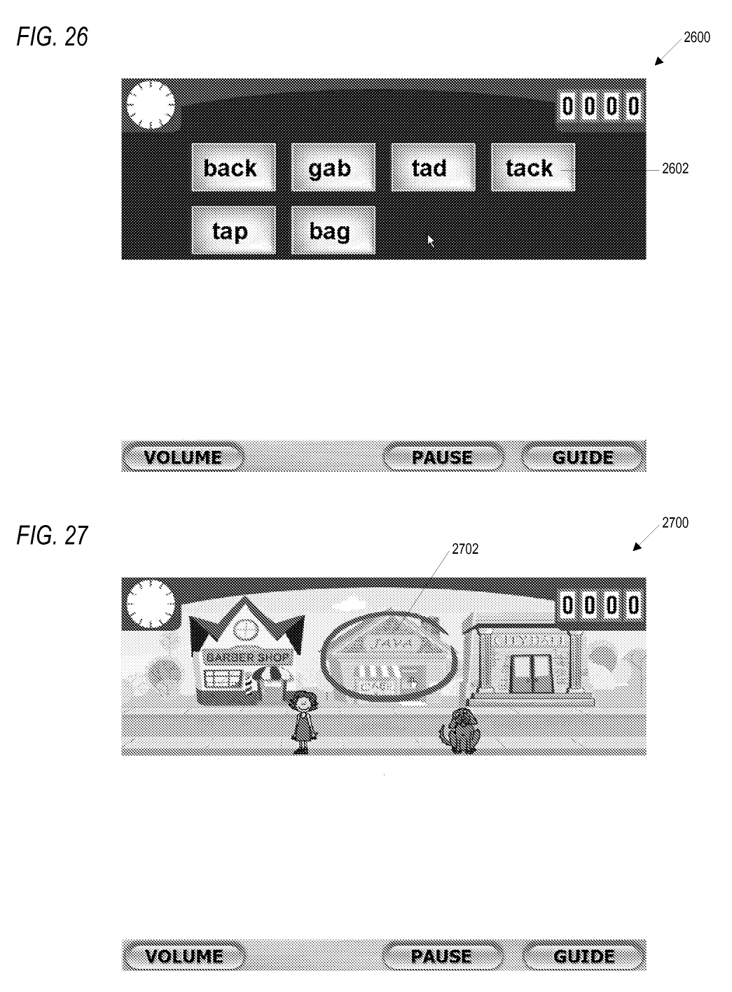

Referring now to FIG. 26, a screen shot is shown of a more advanced level of training within the exercise Sound Replay. In this instance, six buttons 2602 are presented to the participant after aural presentation of a sequence. The participant is required to select the buttons 2602 according to the order presented in the aural sequence. As mentioned above, if they are incorrect in their selection of the buttons 2602, Sound Replay provides an onscreen illustration to show the correct order of selection of the buttons by highlighting the buttons 2602 according to the order of aural presentation.

Listen and Do

Applicants believe that a degraded representational fidelity of the auditory system in older adults causes an additional difficulty in the ability of older adults to store and use information in auditory working memory. This deficit manifests itself behaviorally in the subject's poor ability to understand and follow a sequence of verbal instructions to perform a complex behavioral task. Therefore, goals of the exercise Listen and Do include: 1) exposing the auditory system to a substantial amount of speech that has been processed to emphasize and stretch the rapid frequency transitions; and 2) driving improvements in speech comprehension and working memory by requiring participants to store and use such speech information. In this task, the participant is given auditory instructions of increasing length and complexity.

The task requires the subject to listen to, understand, and then follow an auditory instruction or sequence of instructions by manipulating various objects on the screen. Participants hear a sequence of instructions (e.g., “click on the bank” or “move the girl in the red dress to the toy store and then move the small dog to the tree”). Following the presentation of the instruction sequence, the participant performs the requested actions. The task is made more difficult by making the instruction sequence contain more steps (e.g., “click on the bus and then click on the bus stop”), by increasing the complexity of the object descriptors (i.e., specifying adjectives and prepositions), and manipulating the level of speech processing the instruction sequence receives. A complete description of the flow through the processing levels in the exercise Listen and Do is found in Appendix E.

Referring now to FIG. 27, a screen shot 2700 is shown during an initial training portion of the exercise Listen and Do. This screen occurs after the participant selects the start button. An auditory message prompts the participant to click on the cafe 2702. Then, the café 2702 is highlighted in red to show the participant what item on the screen they are to select. Correct selection causes a “ding” to be played, and increments the score indicator. Incorrect selection causes “thunk” to be played. The participant is provided several examples during the training portion so that they can understand the items that they are select. Once the training portion is successfully completed, they are taken to a normal training exercise, where trials of processed speech are presented.

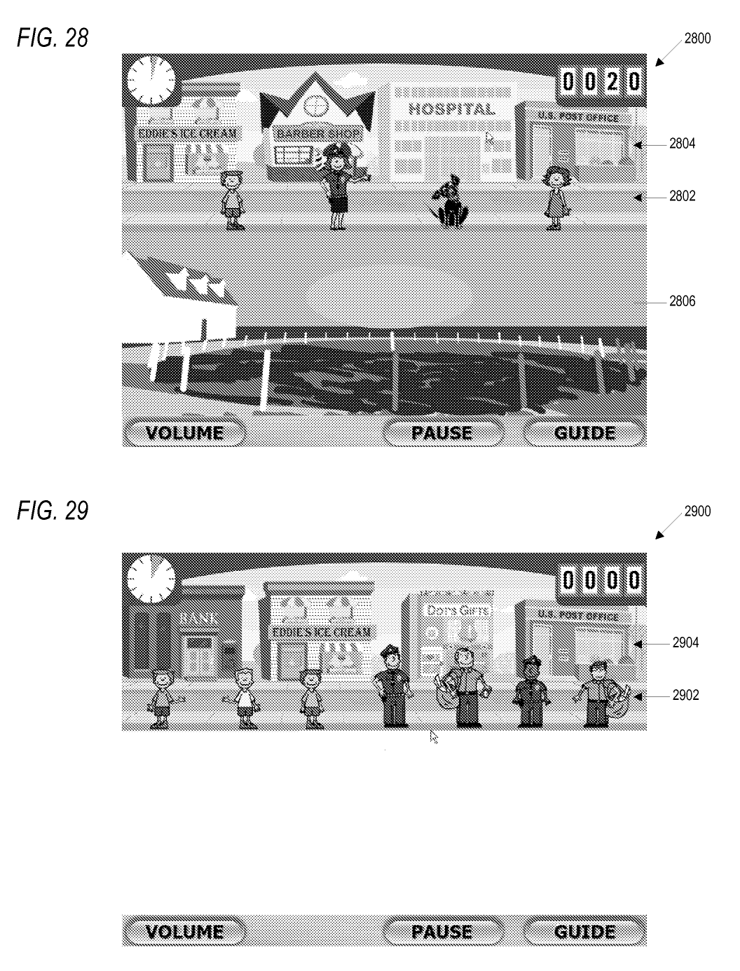

Referring now to FIG. 28, a screen shot 2800 is shown during a trial within the Listen and Do exercise. In this trial, there are 4 characters 2802 and 4 locations 2804 that may be used to test the participant. Further, as in the other exercises, a graphical reward portion 2806 is provided to show progress within the exercise.

Referring now to FIG. 29, a screen shot 2900 is shown during a more advanced training level within the exercise Listen and Do. In this screen 2900 there are 7 characters 2902 and 4 locations 2904 to allow for more complex constructs of commands. A complete list of the syntax for building commands, and the list of available characters and locations for the commands are found in Appendix E.

Story Teller

Applicants believe that the degraded representational fidelity of the auditory system in older adults causes an additional difficulty in the ability of older adults to store and use information in auditory working memory. This deficit manifests itself behaviorally in the participant's poor ability to remember verbally presented information. Therefore applicants have at least the following goals for the exercise Story Teller: 1) to expose the participant's auditory system to a substantial amount of speech that has been processed to emphasize and stretch the rapid frequency transitions; and 2) to drive improvements in speech comprehension and working memory by requiring participants to store and recall verbally presented information. This is done using a story recall task, in which the participant must store relevant facts from a verbally presented story and then recall them later. In this task, the participant is presented with auditory stories of increasing length and complexity. Following the presentation, the participant must answer specific questions about the content of the story.

The task requires the participant to listen to an auditory story segment, and then recall specific details of the story. Following the presentation of a story segment, the participant is asked several questions about the factual content of the story. The participant responds by clicking on response buttons featuring either pictures or words. For example, if the story segment refers to a boy in a blue hat, a question might be: “What color is the boy's hat?” and each response button might feature a boy in a different color hat or words for different colors. The task is made more difficult by 1) increasing the number of story segments heard before responding to questions 2) making the stories more complex (e.g., longer, more key items, more complex descriptive elements, and increased grammatical complexity) and 3) manipulating the level of speech processing of the stories and questions. A description of the process for Story Teller, along with a copy of the stories and the stimuli is found in Appendix F.

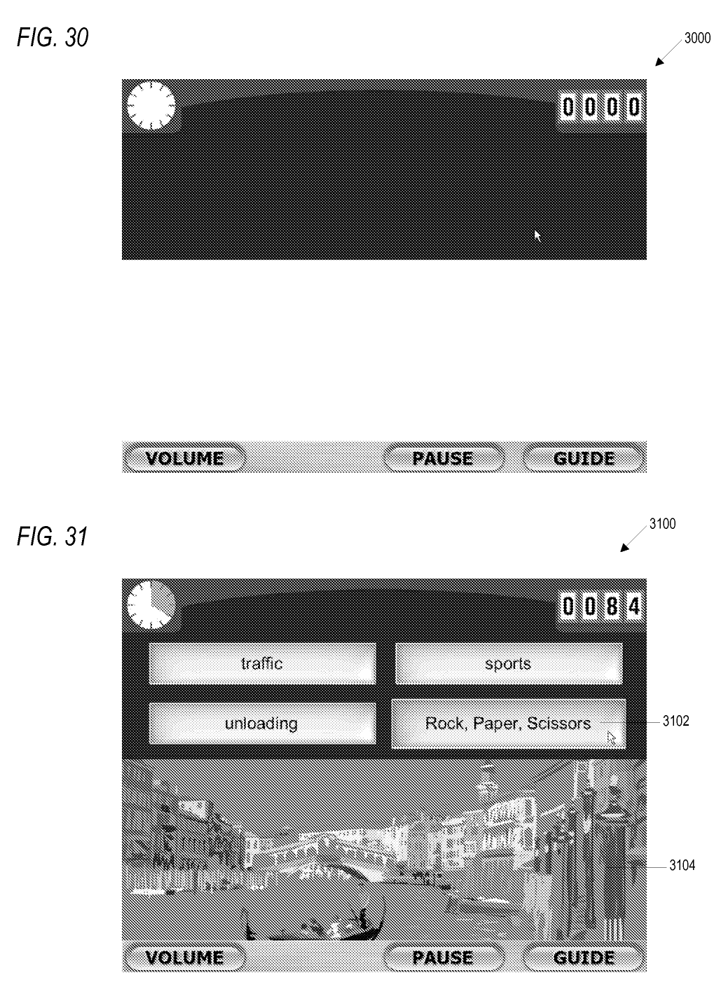

Referring now to FIG. 30, a screen shot 3000 is shown of an initial training screen within the exercise Story Teller. After the participant selects a start button, a segment of a story is aurally presented to the participant using processed speech. Once the segment is presented, the start button appears again. The participant then selects the start button to be presented with questions relating to the story.

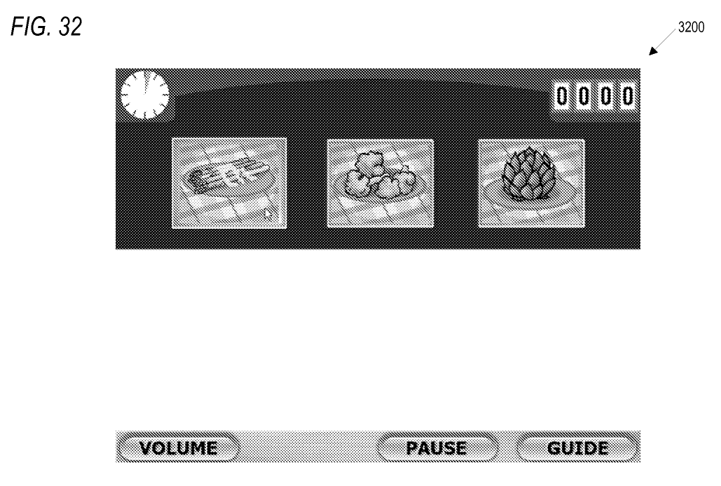

Referring now to FIG. 31, a screen shot 3100 is shown of icons 3102 that are possible answers to an aurally presented question. In one embodiment, the aurally presented questions are processed speech, using the same processing parameters used when the story was presented. In some instances, the icons are in text format, as in FIG. 31. In other instances, the icons are in picture format, as in FIG. 32. In either instance, the participant is required to select the icon that best answers the aurally presented question. If they indicate a correct response, a “ding” is played, the score indicator is incremented, and the graphical reward portion 3104 is updated, as above. If they indicate an incorrect response, a “thunk” is played.

Progressions in HiFi Assessments

Exercise based assessments are designed to assess a participant's threshold with respect to stimuli on a given exercise. The assessment can be used to assess or determine a pre-training threshold that can then be used to calibrate the program to an individual's capabilities on various exercises as well as serve as a baseline measure to which post-training thresholds can be compared. Comparison of pre-training to post-training thresholds may be used to determine the gains made as a function of training with the cognition enhancement exercises described herein.

In some embodiments, exercise based assessments may be similar or even identical to the actual exercises in appearance with the exception of the rewards and points systems. Since assessments are not designed to be training tools, but rather assessment tools, the rewards screen, progress bar, and points are not needed. However, the bells and thunks associated with correct and incorrect responses may remain, i.e., may still be used.

There are various approaches whereby such thresholds may be assessed, such as, for example, the well known QUEST (Quick Estimation by Sequential Testing) threshold method, which is an adaptive psychometric procedure for use in psychophysical experiments, or a related method, referred to as the ZEST (Zippy Estimation by Sequential Testing) procedure or method, among others, although it should be noted that such methods have not heretofore been utilized in cognition enhancement exercise assessments as described herein.

The ZEST procedure is a maximum-likelihood strategy to estimate a subject's threshold in a psychophysical experiment based on a psychometric function that describes the probability a stimulus is detected as a function of the stimulus intensity. For example, consider a cumulative Gaussian psychometric function, F(x−T), for a 4-alternative-forced-choice (afc) task with a 5% lapsing rate, with proportion correct (ranging from 0-1) plotted against intensity of the stimulus (ranging from 0-5). As used herein, the term intensity (with respect to stimuli) refers to the value of the adaptive dimension variable being presented to the user at any particular trial in a particular exercise. For example, as will be discussed below, in the High or Low exercise, the intensity value is the sweep duration (in log millisecond); for the Sound Replay exercise, it is the word list length (e.g., as a fraction); for the Listen and Do exercise, it is the instruction list length (e.g., as a fraction), and so forth. In other words, the intensity value is that parameter regarding the exercise stimuli that may be adjusted or adapted, e.g., to make a trial more or less difficult. The threshold is defined to be the mean of the Gaussian distribution—a value yielding 60% success rate, which corresponds to an intensity of 2.

The method may make some assumptions about the psychophysics:
1. The psychometric function has the same shape, except a shift along the stimulus intensity axis to indicate different threshold value.
2. The threshold value does not change from trial to trial.
3. Individual trials are statistically independent.

The primary idea of the ZEST procedure is as follows: given a prior probability density function (P.D.F.) centered around the best threshold guess, x, this P.D.F. is adjusted after each trial by one of two likelihood functions, which are the probability functions that the subject will respond “yes” or “no” to the stimulus at intensity as a function of threshold. Since the psychometric function has a constant shape and is of the form F(x−T), fixing the intensity x and treating threshold T as the independent variable, the “yes” likelihood, p=F(−(T−x)), is thus the mirror image of the psychometric function about the threshold, and the “no” likelihood function is then simply 1−p.

The P.D.F. is updated using Bayes' rule, where the posterior P.D.F. is obtained by multiplying the prior P.D.F. by the likelihood function corresponding to the subject's response to the trial's stimulus intensity. The mean of the updated (or posterior) P.D.F. is then used as the new threshold estimate and the test is repeated with the new estimate until the posterior P.D.F. satisfies a confidence interval criteria (e.g. standard deviation of posterior P.D.F. <predetermined value) or a maximum number of trials is reached.

In one example of the ZEST procedure, a single trial of a 4-afc experiment is performed, with x=2.5 (intensity) as the initial threshold guess. If the subject responds correctly, the next trial is placed at the mean of the corresponding posterior P.D.F., ˜x=2.3; if the response is incorrect, the next trial is placed at the mean of the corresponding P.D.F., ˜x=2.65.

In some embodiments of the exercised based assessments described herein, a 2-stair ZEST procedure may be employed, where two independent tracks with starting values, preferably, encompassing the true threshold, each running its own ZEST procedure, are randomly interleaved in the threshold seeking procedure. In addition to their individual termination criterion, the difference between the two stairs may also be required to be within a specified range, e.g., the two stairs may be constrained to be a predetermined distance apart. An exemplary implementation of this method is described below with respect to the High or Low threshold assessment.

As used herein, the parameters required for ZEST may include the mean of the prior P.D.F. (threshold estimate), the standard deviation of the prior P.D.F. (spread of threshold distribution), the standard deviation of the cumulative Gaussian distribution (slope of psychometric function), the maximum number of trials to run, and a confidence level and interval. Additionally, in one embodiment, the trial-by-trial data saved for analysis may include: the track used, the stimulus intensity presented, the subject's response, the mean of posterior P.D.F., and the standard deviation of the posterior P.D.F., as well as any other data deemed necessary or useful in assessing the participant's threshold.

In various embodiments, an assessment performed with respect to a given exercise may be performed independently of the training exercise, or, alternatively, may be performed in conjunction with the training exercise (although it should be noted that in either case, the primary aspects and mechanisms of the exercise are performed). For example, in some embodiments, a first assessment may be performed, e.g., using a representative set or subset of data for the exercise, then the exercise may be performed as a training exercise, e.g., using the full or regular data set for the exercise, after which another, second, assessment may be performed, e.g., again using the representative set or subset of data for the exercise. A comparison of the adult's performance on the pre (exercise) and post (exercise) assessments may be used to gauge the effectiveness of the training (middle) exercise. An exemplary embodiment using this approach is described in detail below with respect to the Match It assessment, although it should be noted that this approach may be used regarding any of the exercises described herein, or others. The following describes exemplary embodiments of exercises implementing threshold assessments specific to the respective exercises. It should be noted that the particular implementations described may be used with respect to other, e.g., similar, exercises, as well.

High or Low Threshold Assessment

The following threshold assessment method is based on the High or Low exercise described above with reference to FIGS. 9-15.

A primary purpose of the High or Low threshold assessment is to determine the smallest duration of tone sweeps in a timer order judgment task that a person can respond correctly to above a statistical threshold. The High or Low assessment may be similar to the High or Low exercise with respect to visual presentation, where the differences between the assessment and the exercise lie (at least primarily) in the movement or progression through the task and the data that are obtained from this movement for the assessment. The task is designed to obtain a threshold, which is a statistical rather than an exact quantity. For the purposes of this task, the threshold is defined as the smallest duration of tone sweep (in milliseconds) at which a participant will fail to respond correctly a specified percentage, e.g., 69%, of all trials for a serial order judgment task. In a preferred embodiment, being a computer based task, the High or Low assessment may use the ZEST procedure to progress or move through the task, adjust the duration of the tone sweeps to be presented, and determine the statistical threshold.

As noted above, many aspects of the High or Low assessment may generally be similar, or possible even identical, to the High or Low exercise with respect to visual presentation. However, some aspects of the exercise version of High or Low are not necessary in the High or Low assessment. For example, the progress bar normally displayed on the upper left hand comer, the points bar, and the reward area are not necessary, and so may be omitted. The features or assets that remain the same include the buttons and the “ding” and “thump” sounds that play after a participant responds correctly or incorrectly. Also identical to the exercise version, may be the stimulus presentation.

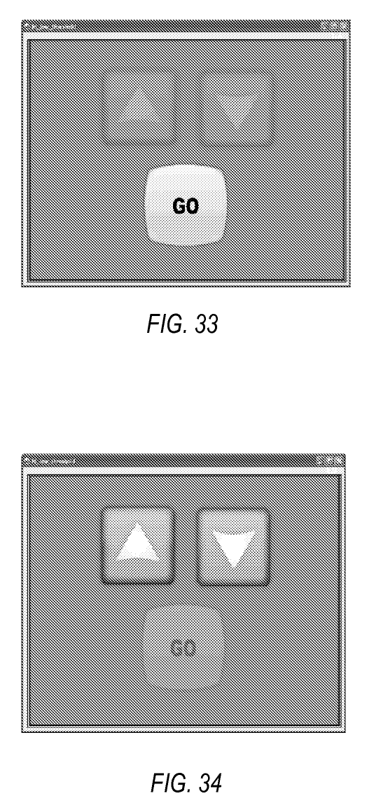

FIGS. 33 and 34 illustrate one embodiment of a graphical interface for the High or Low assessment, where a go or start button and arrow buttons for designating upward or downward sweeps are shown, either activated or inactivated. As shown in FIG. 33, initially the only active button on the screen is the go or start button. Once the go or start button is clicked on, it is deactivated, and the arrow buttons are activated. Note that in other embodiments, the inactive or deactivated buttons may not be shown, or may be presented in different dialogs (see FIGS. 9 and 10, described above), instead of being “grayed out”, as shown in FIGS. 33 and 34.

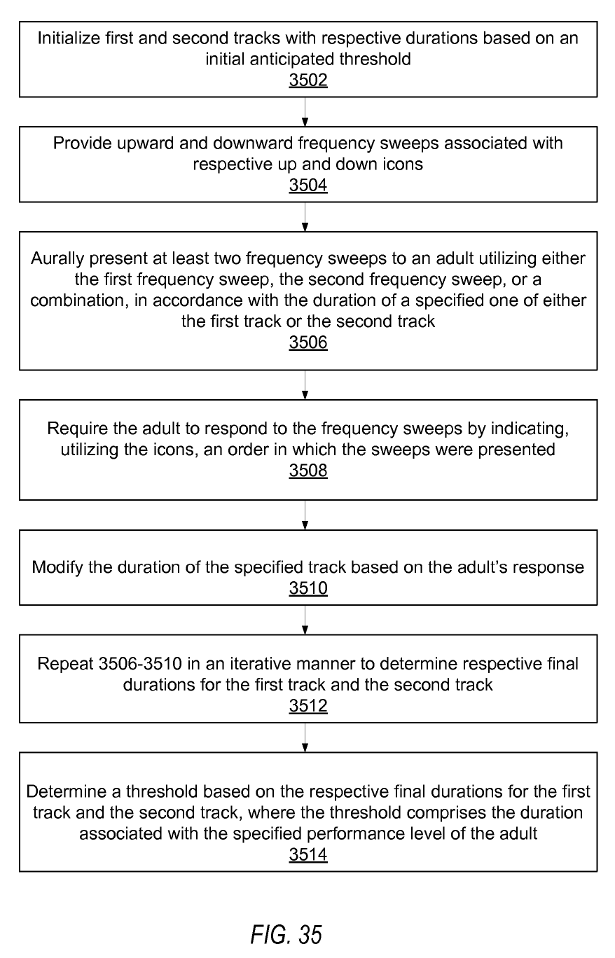

FIG. 35 is a high level flowchart of one embodiment of a method for determining a psychophysical threshold for an aging adult, utilizing a computing device to present aural presentations to the adult, and to record responses from the adult. Note that in various embodiments, some of the method elements may be performed concurrently, in a different order than shown, or may be omitted. Additional method elements may also be performed. As shown, the method may operate as follows:

In 3502, first and second tracks may be initialized with respective durations based on an initial anticipated threshold, where the initial anticipated threshold is an initial estimate or guess of a duration for frequency sweeps corresponding to a specified performance level of the adult, e.g., a stimulus duration at which the adult fails to respond correctly some specified percentage of the time, e.g., 69%. For example, in one embodiment, the first track may be initialized to a first duration that is below the initial anticipated threshold, e.g., preferably just slightly below the initial anticipated threshold, and the second track may be initialized to a second duration that is (e.g., slightly) above the initial anticipated threshold. Thus, the initial durations of the two tracks may straddle the initial anticipated threshold.

In 3504, upward and downward frequency sweeps associated with respective “up” and “down” icons may be provided. For example, a first frequency sweep that increases in frequency over time may be provided, and associated with a first icon, e.g., a button that displays an up arrow (see, e.g., FIGS. 33 and 34, described above), and a second frequency sweep that decreases in frequency over time may be provided, and associated with a second icon, e.g., a button that displays a down arrow. For example, associating the first frequency sweep with the first icon may include aurally presenting the first frequency sweep, and then highlighting the first icon to indicate to the adult the association. Similarly, associating the second frequency sweep with the second icon may include aurally presenting the second frequency sweep, and then highlighting the second icon to indicate to the adult the association. Both the first and second frequency sweeps are then available for aural presentation to the adult.

In 3506, at least two frequency sweeps may be aurally presented to the adult utilizing the first frequency sweep, the second frequency sweep, or a combination of the first and second frequency sweeps, in accordance with the duration of a specified one of either the first track or the second track. In other words, one of the tracks may be selected or otherwise determined, and the frequency sweeps may be presented with durations of the selected track. In one embodiment, the aurally presenting may include randomly selecting at least two frequency sweeps to be presented, utilizing combinations of the first frequency sweep and the second frequency sweep. In one embodiment, the first frequency sweep may be referred to as UP, and the second frequency sweep may be referred to as DOWN, and the aurally presenting at least two frequency sweeps may include any of the following possible combinations: UP-UP, UP-DOWN, DOWN-UP, and DOWN-DOWN. Of course, other sequences of sweeps are also contemplated, and any such sequence may be used as desired, e.g., UP-DOWN-UP, DOWN-DOWN-UP-DOWN, and so forth. Note that the aural presentations may be made via any of a variety of means, such as, for example, via headphones attached to the computing device, speakers, and so forth.

Note that the frequency sweeps are presented (sequentially) with an inter-stimulus-interval (ISI), i.e., a specified time interval between successive frequency sweeps. In preferred embodiments, the initial anticipated threshold, the first duration, the second duration, and the (to be determined) threshold each includes a respective sweep duration, and a respective inter-stimulus-interval (ISI). In other words, the term “duration” may refer to the actual sweep duration and the ISI, and so may be a compound parameter or value.

The frequency ranges for the sweeps may be specified as desired, e.g., based on typical (aging) adult hearing frequency responses. For example, in some embodiments, if the sweep duration is above 80 ms, the frequency range for the sweep may be approximately 1000 Hz to 2428 Hz. If the sweep duration is below 80 ms, the frequency range for the sweep may be 16 octaves-per-second with minimum of 1000 Hz. Thus, for example, if the sweep duration for a frequency sweep is 70 ms, the frequency range may be 1000 Hz to 2174 Hz. It should be noted, however, that these particular values and relationships for the sweeps are meant to be exemplary only, and that other values may be used as desired.

Moreover, in one embodiment, the sweep duration and inter-stimulus-interval may be co-varied in the ratio of 1:1. In other words, the sweep duration and inter-stimulus-interval may have the same value, or in some embodiments, may retain the same ratio when varied.

In 3508, the adult may be required to respond to the at least two frequency sweeps by indicating, utilizing the icons, an order in which the at least two frequency sweeps were presented. In other words, the adult may, in response to hearing the sequence of frequency sweeps, indicate the perceived order of the sweeps via the two icons. For example, in the case of the two sweep sequence UP-DOWN, the adult should indicate the order by pressing the “up” icon, and then the “down” icon. For a three sweep sequence, e.g., DOWN-DOWN-UP, the adult should press the “down” icon twice, then the “up” icon, and so forth.

In one embodiment, the requiring may include providing a period of time in which the adult is to select the icons in the order in which the at least two frequency sweeps were presented, selection of the icons made by the adult placing a cursor over a icon and clicking a mouse, wherein each mouse click is recorded as a selection, recording the selections made by the adult, and recording whether the adult correctly identified the order in which the at least two frequency sweeps were presented.

The duration of the specified track may then be modified, based on the adult's response, as indicated in 3510. For example, the duration of the track may be modified in accordance with a maximum likelihood procedure, such as a QUEST (quick estimation by sequential testing) threshold procedure, and/or a ZEST (Zippy Estimation by Sequential Testing) threshold procedure, although other threshold procedures may be used as desired. In one embodiment, for each track, modifying the duration of the specified track based on the adult's response may include increasing the duration if the adult responds incorrectly, and decreasing the duration if the adult responds correctly. As noted above, modifying the duration of a track may include modifying the frequency sweep duration and/or the ISI. Thus, for each trial (in a given track), the duration of the sweep for that trial may be determined by the performance of the previous trial for that track. In other words, the adult's response to the stimulus (frequency sweep) determines that track's next sweep duration via a maximum likelihood method.

In 3512, the above presenting (3506), requiring (3508), and modifying (3510), may be repeated one or more times in an iterative manner to determine respective final durations for the first track and the second track. For example, in one embodiment, trials in the first track and the second track may be performed in an alternating manner, or, alternatively, trials may be performed in the first track and the second track randomly with equal probability. Thus, over numerous trials, the number of trials performed in each track should be equal, or at least substantially equal. In preferred embodiments, the presenting, requiring, and modifying, may be repeated until the durations of the first track and the second track have converged to values within a specified confidence interval, and where the values are within a specified distance from each other, or, until a specified number of trials have been conducted for each track. In other words, the repetition may continue until either some maximum number of trials has been performed, or until convergence conditions for the tracks have been met, both singly, and together. For example, each track may be required converge to a respective duration value (which may include both the sweep duration and the ISI for the track), and the convergent values for the two tracks may be required to be within some distance or interval of each other.

In 3514, a threshold for the adult may be determined based on the respective final durations for the first track and the second track, where the threshold is or specifies the duration associated with the specified performance level of the adult. For example, as mentioned above, the determined threshold may specify the duration (sweep duration and/or ISI) at which the adult fails to respond correctly some specified percentage of the trials, e.g., 69%, although it should be noted that any other percentage may be used as desired. In one embodiment, the threshold for the adult may be determined by averaging the respective final durations for the first track and the second track.

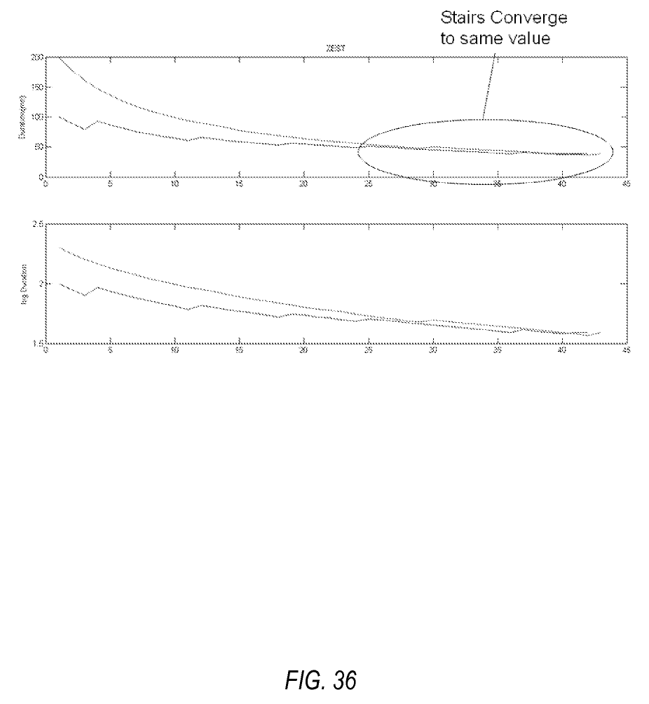

FIG. 36 illustrates an exemplary case where two tracks or “stairs” used in a ZEST threshold procedure are shown converging to a threshold value over a series of trials. Note that in the top graph, sweep duration vs. trials is plotted in a linear manner, whereas the bottom graph provides the same information but is logarithmic on the duration (vertical) axis. As may be seen, after about 25 trials, the two tracks or stairs converge to a value at or near 50 ms. Thus, the two tracks, initialized respectively to values above and below an initial estimate of the threshold, converge to an approximation of the adult's actual stimulus threshold for the exercise.

In some embodiments, the presenting, requiring, and modifying may compose performing a trial, and certain information may be save on a per trial basis. For example, In one embodiment, for each trial, the method may include saving one or more of: which track was used in the trial, the duration used in the trial, the direction and order of sweeps presented to the adult in the trial, the series of icons used in the adult's response (e.g., UP-button, DOWN-button, UP-button, and so forth), the correctness or incorrectness of the adult's response, the mean of a posterior probability distribution function for the maximum likelihood procedure, and the standard deviation of the posterior probability distribution function for the maximum likelihood procedure.

Additionally, in some embodiments, various parameters for the maximum likelihood procedure besides the respective (initial) durations of the two tracks may be initialized, such as, for example, the standard deviation of a cumulative Gaussian psychometric function for the maximum likelihood procedure, and/or the standard deviation of a prior threshold distribution for the maximum likelihood procedure. For example, in one embodiment, the following values may be used: initial duration values or estimates for the two tracks: 100 ms and 200 ms; standard deviation of cumulative Gaussian psychometric function: 0.14; Standard deviation of prior threshold distribution: 0.15. Exemplary values for the confidence interval and width are: confidence interval: 0.95; confidence interval width: 0.2, although it should be noted that other values may be used as desired.

In one embodiment, the method may include determining the initial anticipated threshold. For example, the initial anticipated threshold may be determined based on one or more of: the age of the adult, calibration trials performed by the adult, and/or calibration trials performed by other adults, e.g., in a “pilot” program, although it should be noted that any other type of information may also be used as desired to determine the initial anticipated threshold.

In some embodiments, the method may also include performing a plurality of practice trials, i.e., prior to performing the method elements described above. For example, in one embodiment, the initial 20 (or any other number desired) trials may be considered practice and not included in the analysis or assessment of the threshold. Thus, while the initial 20 trials may follow a ZEST (or ZEST-like) stepping procedure, the two stairs may be reset on the 21 st trial to the initial track values. As indicated above, the assessment may end when either the two tracks have converged to within a given confidence interval with both tracks also within a certain distance apart or when a maximum number of trials (e.g., 100), evenly conducted between the two tracks, have been performed. The average of the two tracks' ending stage values may thus yield the adult's threshold.

Tell Us Apart Assessment

The following assessment method is based on the Tell Us Apart exercise described above with reference to FIGS. 16-19.

A primary purpose of the purpose of the Tell Us Apart assessment is to determine a participant's (i.e., an aging adult's) ability to classify formant transition and segment duration information in making phonetic categorizations. However, since (1) the range of implementations of these contrasts in speech is not readily described with respect to a single dimension along which a detection threshold can be measured, and (2) their realization in the Tell Us Apart exercise emphasis levels does not relate to detection difficulty in a monotonic manner that is sufficiently uniform across participants and contrasts, a participant's success in the Tell Us Apart exercise can currently best be estimated by measuring overall performance across a range of stimuli that is representative of the contrasts and difficulty included in the Tell Us Apart exercise. In other words, an assessment of the aging adult's success in the Tell Us Apart exercise may be estimated by performing a modified version of the exercise (e.g., without visual or auditory feedback) with a restricted but representative data set. More specifically, a single percent correct identification score for a pre-selected (restricted but representative) stimulus set may be determined.

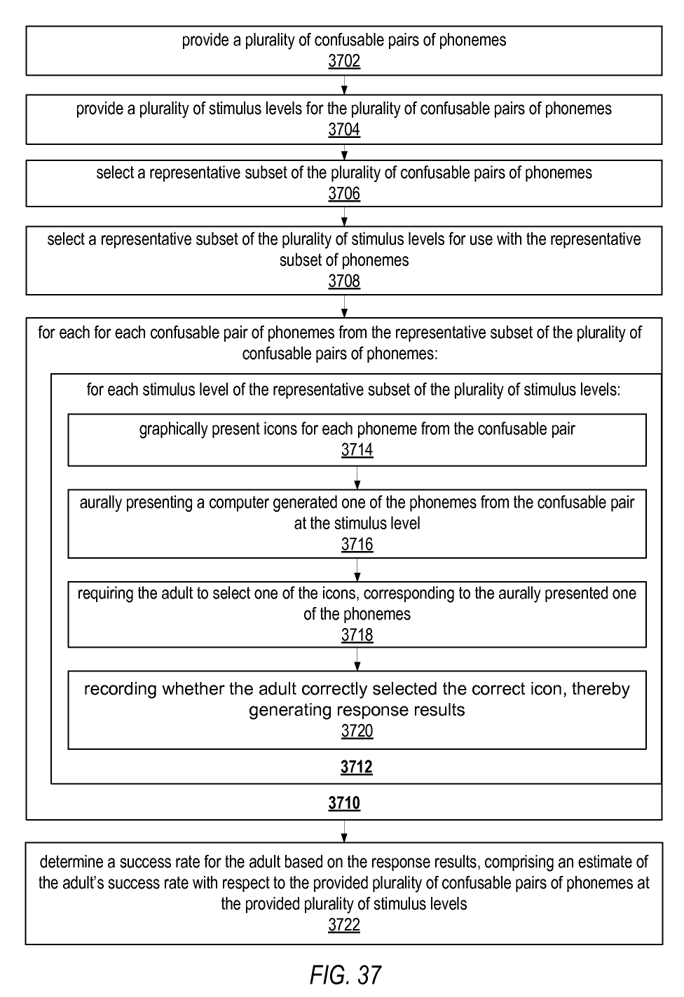

FIG. 37 is a high level flowchart of one embodiment of a method for estimating or predicting an aging adult's success with respect to a cognitive enhancement exercise, such as the Tell Us Apart exercise described herein, utilizing a computing device to present aural presentations to the adult, and to record responses from the adult. Note that in various embodiments, some of the method elements may be performed concurrently, in a different order than shown, or may be omitted. Additional method elements may also be performed. As shown, the method may operate as follows:

In 3702, a plurality of confusable pairs of phonemes may be provided, each of the phonemes having a consonant portion and a vowel portion.

In 3704, a plurality of stimulus levels, which may comprise emphasis levels, for computer processing of the plurality of confusable pairs of phonemes may be provided. A stimulus level may specify various timing and/or tonal aspects of a synthesized or computer processed phoneme (or word containing a phoneme) to make discriminating between the phonemes more or less difficult. For example, the plurality of stimulus levels may include stimulus levels that stretch the consonant portion of the phonemes, that vary the relative loudness of the consonant and vowel portions of the phonemes, and/or that vary the gap between the consonant and vowel portions of the phonemes, among others.

In 3706, a representative subset of the plurality of confusable pairs of phonemes may be selected for presentation to the aging adult. In other words, a portion of the plurality of confusable pairs of phonemes may be selected that broadly or substantially covers or represents the range of phonetic attributes of the plurality of confusable pairs of phonemes. For example, the confusable pairs of phonemes may be selected to represent a spectrum of articulation points, including, for example, back of throat, tongue and pallet, and lip generated consonants. As another example, some of the confusable pairs of phonemes may be selected to represent a frequency spectrum of vowels. In one embodiment, at least one of the representative subset of the plurality of stimulus levels may assist the aging adult in discriminating between the consonant and vowel portion of the one of the phonemes being aurally presented. For example, at least one of the plurality of stimulus levels may emphasize and stretch both the consonant and vowel portions of the one of the phonemes.

In 3708, a representative subset of the plurality of stimulus levels may be selected for use with the selected representative subset of confusable pairs of phonemes. Said another way, a portion of the plurality of stimulus levels may be selected that substantially covers or represents the range of attributes of the plurality of stimulus levels. For example, stimulus levels that cover a range of the stimulus attributes described above in 3704 may be selected as a representative subset, e.g., that stretch the consonant portion of the phonemes, that vary the relative loudness of the consonant and vowel portions of the phonemes, and/or that vary the gap between the consonant and vowel portions of the phonemes, among others.

As indicated in 3710 and 3712, each confusable pair of phonemes from the representative subset of the plurality of confusable pairs of phonemes may be processed or considered at each stimulus level of the representative subset of the plurality of stimulus levels. Specifically, for each confusable pair of phonemes from the representative subset of the plurality of confusable pairs of phonemes, and for each stimulus level of the representative subset of the plurality of stimulus levels, the following described method elements of 3714-3720 may be performed.

As indicated in 3714, icons for each phoneme from the confusable pair may be graphically presented on the computing device. In other words, icons for each phoneme from the confusable pair may be graphically presented on the computing device, where, for example, each icon may textually and phonetically represent the respective phoneme. For example, buttons may be displayed that are respectively labeled with the phonemes of the confusable pair, as illustrated in FIGS. 17 and 19, described above. Thus, the icons may be or include visual representations of the phonemes on the computing device. Note that in preferred embodiments, the visual representations are independently selectable by the aging adult.

In 3716, a computer generated one of the phonemes from the confusable pair may be aurally presented on the computing device, the computer generation corresponding to the stimulus level. In other words, one of the phonemes from the confusable pair may be synthesized and aurally or audibly presented in accordance with the stimulus level (of the representative subset of the plurality of stimulus levels). Note that in some embodiments, the term “computer generated” may indicate that the phonemes are generated algorithmically by the computing device rather than simply processing recorded speech. Moreover, in some embodiments, the aurally presenting may be performed by a selected one of a plurality of synthesized speakers, where in this use, “speaker” refers to a source of speech, such as a human speaker, not a device for presenting general sounds, such as a stereo speaker. In one embodiment, the aurally presented computer generated one of the phonemes may be randomly selected from the confusable pair. In one embodiment, the aurally presenting the phoneme may be performed via headphones coupled to the computing device, although any other means, e.g., computer speakers, may be used as desired.

In 3718, the adult may be required to select one of the icons, specifically, the icon corresponding to the aurally presented phoneme. In other words, the adult may be required to select the aurally presented phoneme by selecting the corresponding icon. For example, the adult may have to move a selection tool, e.g., a computer mouse, over one of the icons, and indicate the selection, e.g., by clicking a button on the mouse while the cursor is over the icon. Note that any other means of selection are also contemplated.

In 3720, the correctness or incorrectness of the adult's icon selection may be recorded, i.e., whether the adult correctly selected an icon corresponding to the aurally presented one of the phonemes may be recorded, thereby generating response results. In other words, the method may include recording whether the adult correctly selected an icon corresponding to the aurally presented one of the phonemes, e.g., for later analysis. Thus, method elements 3714-3720 may be performed for each confusable pair of phonemes in the representative subset of the plurality of confusable pairs of phonemes, at each stimulus level in the representative subset of the plurality of stimulus levels.

In 3722, a success rate for the adult may be determined based on the response results, where the success rate includes or is an estimate of the adult's success rate with respect to the provided plurality of confusable pairs of phonemes at the provided plurality of stimulus levels. In other words, a single score or metric may be determined based on the recorded responses of the adult, where, because the confusable pairs of phonemes and the stimulus levels were respective representative subsets of the pluralities of confusable pairs of phonemes and stimulus levels, the determined success rate may be indicative (i.e., predictive) of how well the adult would perform with the provided pluralities of confusable pairs of phonemes and stimulus levels.

In one embodiment, the method may further include repeating the method elements of 3714-3720, specifically, the graphically presenting, aurally presenting, requiring, and recording, in an iterative manner for each confusable pair of phonemes of the representative subset of the plurality of confusable pairs of phonemes, at each stimulus level of the representative subset of the plurality of stimulus levels, where determining the success rate for the adult may be further based on response results from this repeating. In other words, the graphically presenting, aurally presenting, requiring, and recording, may be performed for each phoneme pair at each stimulus level more than once, and the total results used to determine the success rate.

For example, in one embodiment, for each phoneme contrast (confusable pair of phonemes)/level of the respective subsets, the adult may be asked or required to identify a specified number of items, e.g., 30, (randomly) selected from the same confusable pair. In some embodiments, illustrative practice examples may be presented first. For example, in one embodiment, the adult may first hear a specified number of randomly ordered practice items (e.g., 10), for which answers may be provided, after which the above representative trials may be performed for assessment.

Note that in preferred embodiments, no visual or auditory feedback may be provided to the adult, for example, to minimize learning effects during the test procedure. This is an important difference between the above described assessment method and the regular (Tell Us Apart) exercise.

Stimuli Specifications

Note that, as described above, the representative subset of confusable pairs of phonemes and the representative subset of stimulus levels, collectively referred to as a test set, preferably contains stimuli that are representative of the contrasts and difficulty levels that HiFi participants (performers of the exercise(s) disclosed herein) are exposed to, and sufficiently novel that improvements cannot be attributed solely to learning specific to the set of sounds in HiFi. The following describes one exemplary test set.

In one embodiment, three contrasts (confusable phoneme pairs) may be included in the assessment. For example, two, e.g., bo/do and gi/ki, may be included in the (regular) Tell Us Apart exercise, where one, e.g., gi/ki, may be produced by a novel (female) synthesized speaker. In this particular embodiment test set, an additional (third) contrast, e.g., ba/ga may be included, using the same synthesized speaker as the (regular) Tell Us Apart exercise. Exemplary stimulus or emphasis levels used in the assessment may include (for each of the phoneme pairs): bo/do: 10, 5, 1; gi/ki: 10, 6, 2; and ba/ga/ 10, 5, 0, although it should be noted that these test set stimulus levels (and confusable phoneme pairs) are meant to be exemplary only, and are not intended to limit the assessment method to any particular set (or subset) of phonemes or stimulus levels.

Match It Assessment

A primary purpose of the Match It assessment described herein is to assess an aging adult's integration of visual-spatial and auditory memory. The Match It assessment is very similar to the Match It exercise described above, but with several key distinctions, as will be described below.

A general goal of the Match It assessment described herein is to provide a tool to compare pre and post training performance of the aging adult with respect to a visual-spatial and auditory memory exercise, such as the Match It exercise described above. In one exemplary embodiment, the method may use and present data in accordance with a representative subset of the many variables (speech processing level, stimulus category and grid size) used in the regular training exercise a specified number of times, e.g., 5 times, pre and post to allow for a consistent comparison of the adult's performance before and after training. A secondary goal of the Match It assessment method described herein is to develop more advanced analysis than is currently possible given the level of detail in a trial-by-trial database. Additionally, an attempt may be made to quantify memory-span and analyze strategies employed in this task.

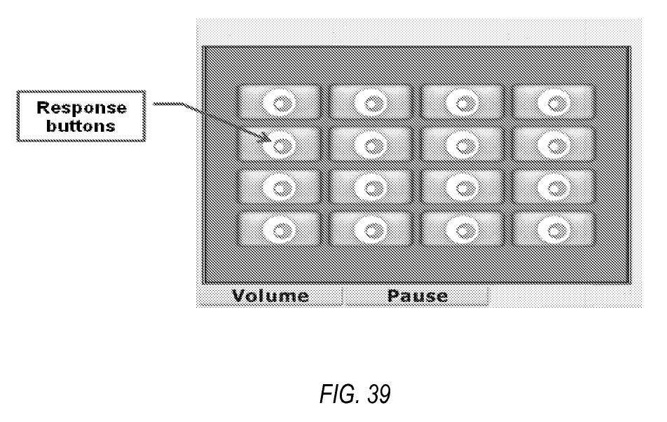

Note that for assessment purposes, in some embodiments, certain visual aspects of the interface of the exercise version of Match It are not necessary, thus, since the method is not concerned with conveying progress to participants who are taking the assessment, all assets, e.g., GUI/auditory indicators, relating to progress are unnecessary (see, e.g., FIG. 39, described below) and thus may be omitted.

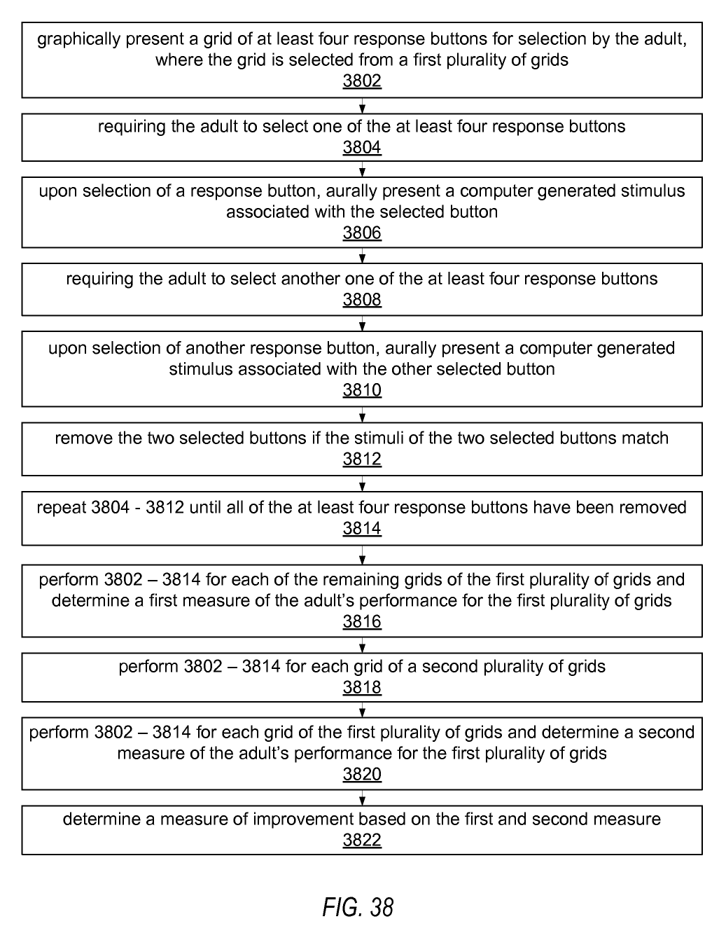

FIG. 38 is a high level flowchart of one embodiment of a method for assessing an aging adult's ability to integrate visual-spatial and auditory memory, such as the Match It exercise described herein, utilizing a computing device to provide aural and graphical presentations, and to record responses from the adult. Note that in various embodiments, some of the method elements may be performed concurrently, in a different order than shown, or may be omitted. Additional method elements may also be performed. As shown, the method may operate as follows:

In 3802, at least two pairs of response buttons for selection by the adult may be graphically presented on a computing device, where the at least two pairs of response buttons compose a grid, and where the grid is selected from a first plurality of grids. In other words, a grid of buttons may be graphical presented to the adult, where the grid is from a first plurality of grids, e.g., selected for use in the assessment.

As noted above, in the assessment portion of the method (directed to the first plurality of grids), i.e., for trials performed with respect to the first plurality of grids, no visual or auditory indication of the adult's progress may be provided. FIG. 39 illustrates an exemplary embodiment of the assessment screen with a presented grid. In this embodiment, the grid is a 4×4 grid and is void of assets, e.g., indicators, indicating progress. As also shown, in this embodiment, controls are provided for pausing and for adjusting the volume of aural presentations.

In 3804, the adult may be required to select one response button of the at least two pairs of response buttons from the presented grid, e.g., by clicking on a button with a pointing device, such as a mouse, although any other means of selecting the button may be used as desired.

In 3806, upon selection of one response button of the at least two pairs of response buttons by the adult, one of a plurality of computer generated stimuli that has been associated with the selected one response button of the at least two pairs of response buttons may be aurally presented, e.g., via speakers or headphones coupled to the computing device. For example, in one embodiment, the computer generated stimuli may include syllables that may be audibly presented to the adult, e.g., kiss, dish, etc. In another embodiment, the computer generated stimuli may include consonant-vowel phonemes, e.g., ki, na, etc. In yet other embodiments, the computer generated stimuli may include a plurality of consonant-vowel-consonant syllables, e.g., fig, lab, etc.

In 3808, the adult may be required to select another response button of the at least two pairs of response buttons, i.e., where the other response button is different from the button selected in 3804.

In 3810, upon selection of another response button of the at least two pairs of response buttons by the adult, another one of the plurality of computer generated stimuli that has been associated with the selected another response button of the at least two pairs of response buttons may be aurally presented. Thus, each time the adult selects a response button, the stimulus associated with the button may be aurally presented to the adult.

In 3812, the two selected response buttons may be removed if the adult has consecutively selected two response buttons of the at least two pairs of response buttons that have had associated with them a desired pairing, removing those two selected buttons from those presented, e.g., removing the two buttons from the grid. In one embodiment, the desired pairing includes associating the same computer generated aural stimuli with the two consecutively selected response buttons. Thus, for example, in one embodiment, if the stimuli for the two selected buttons match, the buttons may be removed from the grid.

There are numerous ways in which the response buttons may be associated with the computer generated stimuli. For example, in one embodiment, desired pairs of stimuli may be associated with pairs of response buttons prior to graphically presenting the buttons. Alternatively, a stimulus may not be associated with a response button until after the response button is selected. Not associating a stimuli with a response button until after the response button is selected may prevent the adult from accidentally consecutively selecting two response buttons of the at least two pairs of response buttons with the desired pairing, prior to previously hearing the stimuli for each of the selected response buttons. Thus, in some embodiments, a stimulus may be associated with a response button only after the response button has been selected. In one embodiment, the method may include detecting if a chance pairing of response buttons occurs, and if so, changing an association of a stimulus with a selected response button to prevent the chance pairing.

In 3814, the method elements 3804-3812 may be repeated until all of the at least two pairs of response buttons have been removed from the grid. In one embodiment, the adult may complete a trial when they have removed all of the at least two pairs of response buttons that have pairs of stimuli associated with them. In another embodiment, a trial may be ended if the adult fails to remove all of the at least two pairs of response buttons within a predetermined number of selections. In one embodiment, a trial may include the presentation of such a plurality of response buttons (in a grid), and may continue as described above until either all of the presented response buttons have been removed, or the adult exceeds a predetermined number of selections for the trial. In other words, a trial may include the above-described method elements repeated until either all the buttons have been matched and removed, or until some maximum number of selections by the adult have been made.

As indicated in 3816, in some embodiments, the method elements 3802-3814 may be performed for each of the remaining grids of the first plurality of grids, and a first measure of the adult's performance with respect to the first plurality of grids determined. For example, in one embodiment, the first measure may include the average number of selections made by the adult to clear a grid, e.g., to match all the stimulus pairs of the grid, over all the grids of the first plurality of grids. Thus, the first measure may characterize the adult's performance with regard to the first plurality of grids.

In 3818, the method elements 3802-3814 may be performed for each grid of a second plurality of grids. In other words, the steps of graphically presenting (3802) through repeating (3814) may be performed for each grid of a second plurality of grids.

In one embodiment, the second plurality of grids may be directed to training the adult, i.e., via the Match It exercise described above, whereas the first plurality of grids may be directed to assessment or estimation of the adult's capabilities. For example, in one embodiment, the first plurality of grids may include grids that are representative of the grids in the second plurality of grids, e.g., may include grids in accordance with a representative sample of parameter values for the exercise used in training the adult. For example, in one embodiment, the first plurality of grids may have a first processing level, e.g., level 5 (which may be the level closest to human speech), whereas the grids used in training (the second plurality of grids) may include grids at all processing levels, ranging from heavily processed synthetic speech (e.g., level 1) through natural or near-natural processed speech (e.g., level 5).

For example, in one embodiment, performing the steps of graphically presenting through repeating for each grid of a second plurality of grids may include providing a plurality of processing levels for processing the computer generated stimuli, and beginning with a first processing level for aurally presenting the computer generated stimuli which makes the stimuli easy to distinguish. As the adult successfully pairs the stimuli, the amount of processing may be altered towards a last processing level, where, for example, the last processing level is that of normal speech. Additionally, in some embodiments, as the adult successfully pairs the stimuli, the number of response buttons presented in a trial may be increased. Thus, during training (with the second plurality of grids), the trials may be made more difficult as the adult progresses.

In some embodiments, to prevent the adult's memory of grid layout from trial to trial from influencing the adult's performance, the first plurality of grids may include various subsets of grids with different parameters, e.g., size, processing level, stimulus category, etc., where consecutive trials may use grids from different subsets. For example, in one embodiment, the first plurality of grids may include a first subset of grids, referred to as primary stimuli, where each grid has a first size and a first category of stimuli, and a second subset of grids, referred to as secondary stimuli, where each grid has a second size and a second category of stimuli. Thus, trials with respect to the first plurality of grids may alternate between the first subset of grids (primary stimuli) and the second subset of grids (secondary stimuli) to avoid effects of spatial memory of an immediately previous trial.

In 3820, the above-described method elements 3802-3814 may be performed (again) for each grid of the first plurality of grids. In other words, the steps of graphically presenting (3802) through repeating (3814) may be performed for each grid of the first plurality of grids. A second measure of the adult's performance with respect to the first plurality of grids may then be determined based on the performing the steps of graphically presenting through repeating for each grid of the first plurality of grids. In other words, trials directed to the assessment grids (the first plurality of grids) may be performed a second time (after the training trials directed to the second plurality of grids), and the adult's performance characterized, e.g., by an average number of selections made by the user to clear each grid.

Finally, in 3822, a measure of the adult's improvement may be determined based on the first measure and the second measure. For example, a ratio of the first measure to the second measure may be computed, where a value greater than 1 indicates improvement, presumably due to the intervening training session. In another embodiment, a difference between the two measures may be computed, indicating a difference in average performance from the first assessment to the second assessment. Of course, these particular measures are meant to be exemplary only, and are not intended to limit the types of measures nor the means for determining such measures to any particular type or technique.

Stimuli Specifications

The following describes exemplary stimulus data sets suitable for use in the above-described method. It should be noted, however, that the data described is meant to be exemplary only, and is not intended to limit the data used in the invention to any particular data sets or attributes.

In one embodiment, the primary stimuli or first subset of the first plurality of grids may be characterized by a grid size of 4×4, with 16 total sounds (8 pairs of distinct sounds). Moreover, the computer generated stimuli may have a sound processing level that is closest to human speech, e.g., a sound processing level of 5, from a range of 1 to 5, where a processing level of 1 is heavily processed to emphasize distinguishing attributes of the aurally presented stimuli. The stimulus category may be set at category level 2, which may include the syllables: ‘fig’, ‘rib’, ‘sit’, ‘kiss’, ‘bill’, ‘dish’, ‘nut’, ‘chuck’, ‘rug’, ‘dust’, ‘pun’, ‘gum’, ‘bash’, ‘can’, ‘gash’, ‘mat’, ‘lab’, and ‘nag’, although in other embodiments, other syllables may be used as desired.

In one embodiment, the secondary stimulus or second subset of the first plurality of grids may be characterized by a grid size of 3×2, with 6 total sounds (3 pairs of distinct sounds). The computer generated stimuli may have a sound processing level that is closest to human speech, e.g., a sound processing level of 5, from a range of 1 to 5, where, as described above, a processing level of 1 is heavily processed to emphasize distinguishing attributes of the aurally presented stimuli. The stimulus category may be set at category level 4 from among a plurality of stimulus categories, where category 4 may include the words (syllables): ‘buck’, ‘bud’, ‘but’, ‘cup’, ‘cut’, ‘duck’, ‘dug’, ‘pug’, ‘pup’, ‘tub’, ‘tuck’, ‘tug’, ‘bug’, ‘cud’, ‘puck’, ‘dud’, ‘gut’, ‘guck’, although in other embodiments, other words may be used as desired.

In one exemplary embodiment, during the assessment portion of the method, the adult may be presented with 9 grids, 5 primary grids and 4 secondary grids, where, as described above, beginning with a primary grid, the grids may alternate between primary and secondary, the purpose of alternating being to remove or ameliorate any spatial memory of the previous trial. Of course, other numbers of grids may be used as desired.

In moving through the task or method, the adult may click a ‘start’ button on the screen to begin. Once presented with the first grid, the adult may click or select each button in any order or sequence. As the adult clicks on matching buttons in succession, the buttons may be removed from the screen. Once all the buttons are gone, the adult may be presented with a ‘start’ button to begin the next grid. In other embodiments, once each grid is completed, the next grid may be presented automatically, i.e., without the need for the adult to click or select a start button.

Sound Replay Threshold Assessment

A primary purpose of the Sound Replay threshold assessment described herein is to determine the number of items a participant can remember in a serial order, specifically, the number of syllables, which corresponds to stage, that a person can respond correctly to above a statistical threshold. The Sound Replay threshold assessment is very similar to the Sound Replay exercise described above, but with several key distinctions, as will be described below. For example, the Sound Replay assessment may be similar to the Sound Replay exercise with respect to visual presentation. At least some of the differences between the assessment and the exercise may be with regard to movement through the task and the data that are obtained from this movement for the assessment. In a preferred embodiment, the task (of the assessment) is designed to obtain a threshold, which is a statistical rather than an exact quantity. For the purposes of this task, “threshold” is defined as the number of sounds (e.g., stage) at which a participant will fail to respond correctly some specified percentage, e.g., 47.5%, of trials. Sound Replay assessment is similar to neuropsychological tasks “digit span” and “digit span backwards”, in which subjects must remember the auditory information over short periods of time to identify matching syllables in a temporal domain. Being a computer based task, Sound Replay assessment may use the ZEST algorithm to move through the task, adjust the number of sounds to be presented, and determine the statistical threshold, as described below in more detail.

In the exemplary embodiments described below, a primary goal is to statistically determine the stage value where a participant will fail to respond correctly 47.5% of trials, as mentioned above.

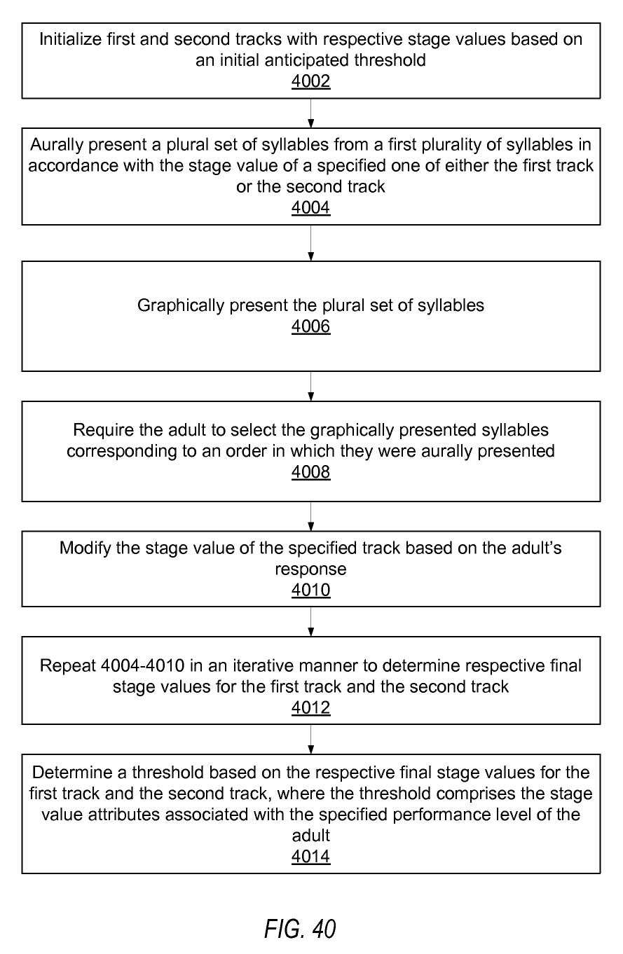

FIG. 40 is a high level flowchart of one embodiment of a method for determining an aging adult's threshold with respect to a serial memory exercise, such as the Sound Replay exercise described herein, utilizing a computing device to provide aural and/or graphical presentations, and to record responses from the adult. More specifically, a psychophysical threshold may be determined regarding the aging adult's ability to temporarily store and retrieve an order of syllables. Note that in various embodiments, some of the method elements may be performed concurrently, in a different order than shown, or may be omitted. Additional method elements may also be performed. As shown, the method may operate as follows:

In 4002, first and second tracks may be initialized with respective stage values based on an initial anticipated threshold, where a stage specifies a set of stimulus attributes, and where the initial anticipated threshold specifies an initial estimate of stimulus attributes corresponding to a specified performance level of the adult, e.g., stimulus attributes at which the adult fails to respond correctly some specified percentage of the time, e.g., 47.5%. For example, in one embodiment, the first track may be initialized to a stage value that is below the initial anticipated threshold, e.g., preferably just slightly below the initial anticipated threshold, and the second track may be initialized to a second stage value that is (e.g., slightly) above the initial anticipated threshold. Thus, the initial stage values of the two tracks may straddle the initial anticipated threshold. In one embodiment, the method may include determining the initial anticipated threshold, e.g., based on one or more of: the age of the adult, calibration trials performed by the adult, and/or calibration trials performed by other adults, among others.

In some embodiments, an initialization process may operate to initialize other items as well. For example, the initialization process may include initializing one or more of: the first and second tracks' initial stage values (as indicated above), a standard deviation of a cumulative Gaussian psychometric function for the maximum likelihood procedure, or a standard deviation of a prior threshold distribution for the maximum likelihood procedure.

Note that there may be a specified number of stages used in the method, e.g., stages 1-8, where each stage specifies or is associated with stimulus attributes, as indicated above. For example, in one embodiment, the attributes may include one or more of: a respective number of distinct syllables in the plural set of syllables, a respective number of repeat syllables in the plural set of syllables, a respective number of distractor buttons presented in a trial, and/or a respective inter-stimulus-interval (ISI), denoting a time interval between successive syllables, among others.

In 4004, a plural set of syllables from a first plurality of syllables may be aurally presented on the computing device in accordance with the stage value of a specified one of either the first track or the second track, where the plural set of syllables are presented serially, e.g., where serially indicates that the plural set of syllables are aurally presented, one at a time, e.g., one after another, until all of the syllables in the plural set of syllables have been presented. In preferred embodiments, the aural presentations may be made via headphones attached to the computing device, although speakers may be used as desired. In some embodiments, the syllables may include consonant-vowel-consonant syllables, and/or may include phonemes. In one embodiment, the syllables may be processed to emphasize and stretch rapid frequency transitions, although in some embodiments, the processing used may be minimal, or even none, e.g., to approximate natural human speech.

In 4006, after the aurally presenting of 4004, the plural set of syllables may be graphically presented on the computing device, e.g., via a GUI. For example, in one embodiment, the graphically presenting may include providing a graphical icon (e.g., a graphical response button) for each one of the plural set of syllables, and displaying graphical icons on the computing device that correspond to the aurally presented syllables. The displayed graphical icons may be selectable by the adults using a pointer on the computing device. Moreover, in some embodiments, the graphically presenting may also include graphically presenting distracter syllables along with the first plurality of syllables. The distracter syllables may be provided to the adult to allow the adult to make incorrect selections, i.e., may present incorrect choices for selection by the adult.

In 4008, the adult may be required to select on the computing device the graphically presented syllables corresponding to an order in which they were aurally presented. In other words, the adult may be required to select the graphical icons or buttons representing each aurally presented syllable in the order in which they were presented. Note that the distracter syllables mentioned above may thus be provided to the adult to make the requiring more difficult, since the graphically presented icons or buttons include these incorrect responses among those corresponding to the aurally presented syllables.

In 4010, the stage value of the specified track may be modified based on the adult's response. Modifying the stage value of the specified track based on the adult's response may include modifying the stage value in accordance with a maximum likelihood procedure, such as, for example, a QUEST (quick estimation by sequential testing) threshold procedure, or a ZEST (zippy estimation by sequential testing) threshold procedure, described above. In one embodiment, for each track, modifying the stage value of the specified track based on the adult's response may include increasing the stage value if the adult responds correctly in a specified percentage of trials, and decreasing the stage value if the adult responds incorrectly in the specified percentage of trials. For example, in one exemplary embodiment, if the player obtains a 90% or over correct rate on the first 10 trials, the track's initial values may be increased, and if the player obtains a 90% or over incorrect rate on the first 10 trials, the track's initial values may be decreased, and the assessment may resume, or start over, with the new initial values.

Note that while each stage is discrete, i.e., has an integer value, the stage values determined in the method may not always be integers, and may not always be modified or adjusted in integer amounts. For example, for each iteration of the assessment process described herein (or periodically per some specified number of trials), the method may determine a real (non-integral) stage value. This value may be the true updated stage value, but its rounded value may used to specify the stage to use for the next trial, e.g., a stage value of 3.4 may specify use of stage 3 for the trial, while a stage value of 3.6 may specify use of stage 4 for the trial. In one embodiment, the initial stage values may chosen such that if they are too easy (or too difficult), the next stage used will immediately be incremented (or decremented) one full stage. For example, assuming an adjustment increment/decrement of approximately 0.2, if 3.6 (which specifies stage 4) were found to be too difficult, the next value would be about 3.4 (specifying stage 3), whereas if 4 had been specified as the initial stage value and the trial were found to be too difficult, the next value (3.8) would still round to 4, and so no effective change would occur. Thus, the initial stage values may be set to real values.

As noted above, the initial anticipated threshold, the first stage value, the second stage value, and the threshold (determined below) may each specify or be associated with one or more of: a respective number of distinct syllables in the plural set of syllables, a respective number of repeat syllables in the plural set of syllables, a respective number of distractor buttons presented in a trial, and/or a respective inter-stimulus-interval (ISI), denoting a time interval between successive syllables. Thus, for each track, increasing the stage value may include one or more of: increasing the respective number of distinct syllables in the plural set of syllables, increasing the respective number of repeat syllables in the plural set of syllables, increasing the respective number of distractor buttons presented in a trial, or decreasing the respective ISI (the time interval between successive syllables). Similarly, for each track, decreasing the stage value may include one or more of: decreasing the respective number of distinct syllables in the plural set of syllables, decreasing the respective number of repeat syllables in the plural set of syllables, decreasing the respective number of distractor buttons presented in a trial, or increasing the respective inter-stimulus-interval. Thus, increasing the stage value for a track may operate to make subsequent trials performed in that track more difficult, while decreasing the stage value for a track may operate to make subsequent trials performed in that track less difficult. Note that the adult's response to the trial conducted at a track's value may thus determine that track's next stage value via the maximum likelihood method.

In 4012, the aurally presenting, graphically presenting, requiring, and modifying (i.e., method elements 4004-4010) may be repeated (i.e., performed) one or more times in an iterative manner with respect to other plural sets of syllables from the first plurality of syllables to determine respective final stage values for the first track and the second track.

Finally, in 4014, a threshold for the adult may be determined based on the respective final stage values for the first track and the second track, where the threshold is or includes the stage value associated with the specified performance level of the adult.

In various embodiments, repeating the presenting, requiring, and modifying, one or more times in an iterative manner may include performing trials in the first track and the second track in an alternating manner, or performing trials in the first track and the second track randomly, e.g., with equal probability. Note that in either approach, over many trials the number of trials performed in each track are equal or at least approximately equal. Moreover, in accordance with QUEST or ZEST threshold determination techniques, repeating the presenting, requiring, and modifying, one or more times in an iterative manner may include repeating the presenting, requiring, and modifying, until the stage values of the first track and the second track have converged to values within a specified confidence interval, and where the values are within a specified distance from each other, or, until a specified number of trials have been conducted for each track (e.g., 20 per track).

In preferred embodiments, determining a threshold for the adult based on the respective final stage values for the first track and the second track may include averaging the respective final stage values for the first track and the second track to determine the threshold for the adult. For example, averaging the respective final stage values for the first track and the second track to determine the threshold for the adult may include rounding the average of the respective final stage values for the first track and the second track to determine the threshold for the adult. Thus, a stage value of 4.6 corresponds to stage 5, a stage value of 4.2 corresponds to stage 4, and so forth.

In one embodiment, the presenting, requiring, and modifying described above may compose performing a trial. Certain information may be saved with respect to each trial performed, e.g., for operation of the method, and/or for subsequent analysis of the assessment. For example, for each trial, one or more of the following may be saved: which track was used in the trial, the stage value used in the trial, the series of syllables presented to the adult, the button to syllable assignments, the series of button selections by the adult, the correctness or incorrectness of the adult's response, the mean of a posterior probability distribution function for the maximum likelihood procedure, and the standard deviation of the posterior probability distribution function for the maximum likelihood procedure. Of course, any other type of information may also be saved as desired.

As indicated above, the adult may interact with the assessment process via a GUI presented on the computing device, similar to the GUI used in the training exercise (Sound Replay). However, some aspects of the exercise version of Sound Replay may not be necessary in the Sound Replay assessment. For example, a progress bar, points bar, and reward area included in the training exercise GUI (of Sound Replay) are not necessary, since progress/reward indicators are not used in the assessment. However, in some embodiments, some of the GUI elements or assets may remain the same, such as the response buttons and the “ding” and “thump” sounds that play after an adult responds correctly or incorrectly. The stimulus presentation may also be identical to the exercise version. In one embodiment, initially the only button in the screen is the start button. However, because the adult will not already know the number of sounds to be presented for each trial, the number of sounds to be played may be displayed in the space of the response buttons.

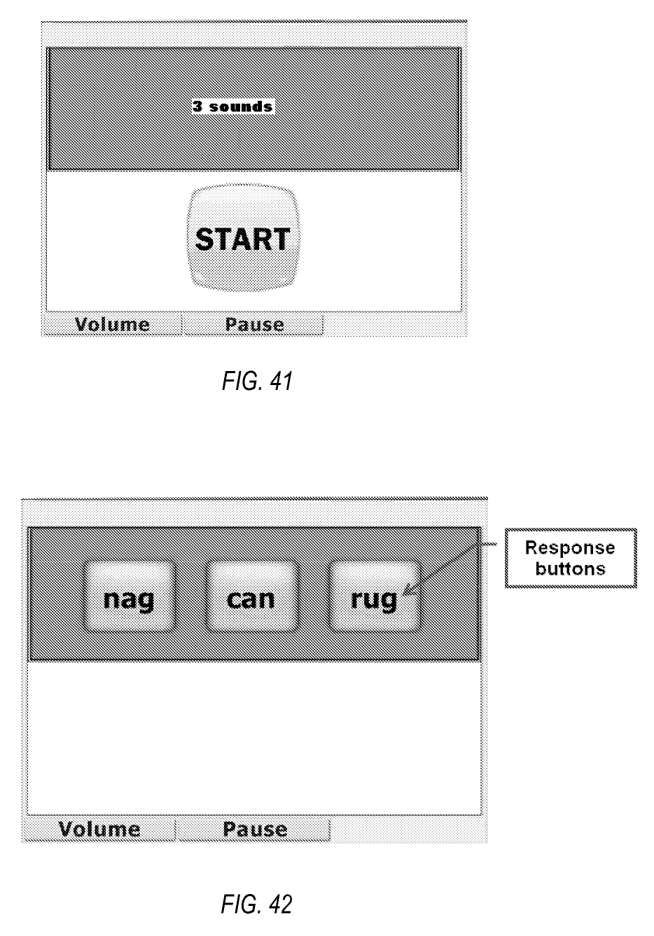

FIG. 41 illustrates one embodiment of an initial screen showing the start button, e.g., as an example of the interface before the start button is pressed. As may be seen, the number of sounds (syllables) to be presented (in the trial) is also shown, in this case, 3. As also shown, in this embodiment, controls are provided for pausing and for adjusting the volume of aural presentations.

After the participant clicks on the start button, the sounds (syllables) may be played and the buttons displayed in random order, as described above. FIG. 42 illustrates an example of the interface after the start button is pressed, according to one embodiment. As shown, three response button or graphical icons are displayed, each corresponding to a syllable or sound, in this case, “nag”, “can”, and “rug”. As described above, the adult may select from among these buttons to indicate an order of aurally presented syllables. Note, for example, that if the series of aurally presented syllables were “nag”, “rug”, “nag”, then the correct button sequence would be “nag”, “rug”, “nag”, where the “can” button would be a distractor button.

Stimuli Specifications

The following describes exemplary stimulus data sets suitable for use in the above-described method. It should be noted, however, that the data described is meant to be exemplary only, and is not intended to limit the data used in the invention to any particular data sets or attributes.

In one embodiment, for assessment purposes, the sound processing level for presentation of the syllables may be set at level 5, where level 5 is the level closest to human speech. This is in contrast to the processing levels used in the normal training exercise (Sound Replay), ranging from heavily processed synthetic speech (e.g., level 1), e.g., to emphasize distinguishing attributes of the aurally presented stimuli, through natural or near-natural processed speech (e.g., level 5).

In some embodiments, the stimulus category may be set at category level 2, from among a plurality of available categories, where category 2 may include the syllables: ‘fig’, ‘rib’, ‘sit’, ‘kiss’, ‘bill’, ‘dish’, ‘nut’, ‘chuck’, ‘rug’, ‘dust’, ‘pun’, ‘gum’, ‘bash’, ‘can’, ‘gash’, ‘mat’, ‘lab’, and ‘nag’, although in other embodiments, other syllables may be used as desired.

As noted above, in preferred embodiments, the stage parameters may be the same as the stage parameters for the Sound Replay exercise. Exemplary stage parameters and their ranges are provided below:

| | | | Number of | |
|---|---|---|---|---|
| | Number of | Number of Repeat | Distractor | Interstimulus |
| Stage | Distinct Sounds | Sounds | Buttons | Interval (ms) |
| 1 | 2 | 0 | 0 | 1200 |
| 2 | 3 | 0 | 0 | 1100 |
| 3 | 4 | 0 | 0 | 1000 |
| 4 | 4 | 1 | 1 | 950 |
| 5 | 5 | 1 | 1 | 900 |
| 6 | 5 | 2 | 1 | 850 |
| 7 | 5 | 3 | 2 | 800 |
| 8 | 6 | 3 | 2 | 750 |

Initialization Values

In one embodiment, initial values for the assessment process may be set at:
Initial stage values: 2.4 and 3.6
Confidence Interval: 0.95
Confidence Interval Width: 0.5
Standard deviation of cumulative Gaussian psychometric function: 1
Standard deviation of prior threshold distribution: 1
   However, it should be noted that in other embodiments, other values may be used as desired.
   Listen and Do Threshold Assessment

A primary purpose of the Listen and Do threshold assessment described herein is to determine the number of instructions (associated with a stage value) an aging adult can remember and perform in a serial order correctly above a statistical threshold. The Listen and Do assessment is similar to the Listen and Do exercise described above with respect to visual presentation. In preferred embodiments, the differences between the assessment and the training exercise are primarily in the movement or progression through the task and the data obtained for the assessment. The task is designed to determine a threshold, which is a statistical rather than an exact quantity. For the purposes of this task, “threshold” is defined, as the number of instructions (e.g., stage) at which a participant fails to respond correctly some specified percentage of trials, e.g., 47.5%, with processing level and stimulus category fixed. Note that the Listen and Do assessment described herein may be similar to neuropsychological tasks “digit span” and “digit span backwards”, in which subjects must remember auditory information over short periods of time. Being a computer-based task, Listen and Do assessment preferably uses the ZEST algorithm (described above) to move through the task, adjust the number of instructions to be presented, and determine the statistical threshold, as will be described below in detail.

In the exemplary embodiments described below, a primary goal of the Listen and Do assessment is to statistically determine the stage value where a participant will fail to respond correctly 47.5% of trials, as mentioned above.

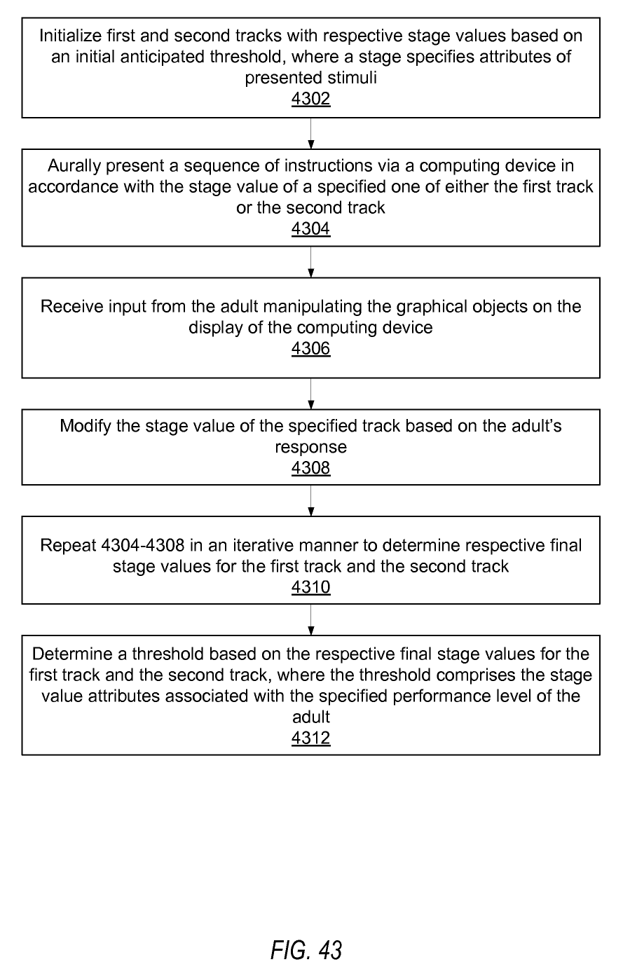

FIG. 43 is a high level flowchart of one embodiment of a method for determining an aging adult's threshold with respect to a serial memory exercise. More specifically, a psychophysical threshold may be determined regarding the aging adult's ability to temporarily remember and perform a series of actions, similar to the Listen and Do exercise described herein, utilizing a computing device to provide aural sequences of instructions, and to record responses from the adult. Note that in various embodiments, some of the method elements may be performed concurrently, in a different order than shown, or may be omitted. Additional method elements may also be performed. As shown, the method may operate as follows:

In 4302, first and second tracks may be initialized with respective stage values based on an initial anticipated threshold, where a stage specifies a set of stimulus attributes, and where the initial anticipated threshold specifies an initial estimate of stimulus attributes corresponding to a specified performance level of the adult, e.g., stimulus attributes at which the adult fails to respond correctly some specified percentage of the time, e.g., 47.5%. For example, in one embodiment, the first track may be initialized to a stage value that is below the initial anticipated threshold, e.g., preferably just slightly below the initial anticipated threshold, and the second track may be initialized to a second stage value that is (e.g., slightly) above the initial anticipated threshold. Thus, the initial stage values of the two tracks may straddle the initial anticipated threshold. In one embodiment, the method may include determining the initial anticipated threshold, e.g., based on one or more of: the age of the adult, calibration trials performed by the adult, and/or calibration trials performed by other adults, among others.

In some embodiments, an initialization process may operate to initialize other items as well. For example, the initialization process may include initializing one or more of: the first and second tracks' initial stage values (as indicated above), a standard deviation of a cumulative Gaussian psychometric function for the maximum likelihood procedure, or a standard deviation of a prior threshold distribution for the maximum likelihood procedure.

In 4304, a sequence of one or more auditory instructions that have been processed by the computer may be presented, e.g., via headphones and/or speakers connected to the computing device, where the auditory instructions indicate a corresponding sequence of actions to be performed by the adult. The actions may include or specify manipulations of graphical objects displayed on a display of a computing device. Note that in preferred embodiments, the graphical objects displayed with respect to a sequence of instructions may include a confusable superset of objects referred to in the instructions, i.e., various of the objects may be easily confused by the adult.

The presenting of the sequence of instructions may be made in accordance with the stage value of a specified one of either the first track or the second track. Note that there may be a specified number of stages used in the method, where each stage specifies or is associated with stimulus attributes, as indicated above. For example, in one embodiment, the attributes may include or specify a respective number of distinct instructions in the sequence of instructions, i.e., the length of the sequence. Thus, the initial stage values for the two tracks, the initial anticipated threshold, and the threshold (determined below) may each specify or be associated with a respective number of distinct instructions in the sequence of instructions.

In one embodiment, the sequence of instructions may be selected from a plurality of sequences of instructions, where the plurality of sequences of instructions has a specified stimulus category, i.e., where the plurality of sequences of auditory instructions is from a specified category from a plurality of categories, each category specifying a type of sequences of instructions. For example, in the Listen and Do training exercise described above, sequences of instructions from a variety of categories are used, such as: category 1, where each of the instructions is of lower complexity and is directed to stimulus discrimination where the adult is to select a respective graphical object with a pointing device; category 2, where each of the instructions is of higher complexity and is directed to stimulus discrimination where the adult is to select a respective graphical object with a pointing device, wherein the respective graphical object is qualified by one or more adjectives and/or one or more prepositional phrases; category 3, where each of the instructions is of lower complexity and is directed to memory, and includes an instruction to move a respective first graphical object with respect to a respective second graphical object; and category 4, where each of the instructions is of higher complexity and is directed to memory, and includes an instruction to move a respective first graphical object with respect to a respective second graphical object, where one or both of the respective first graphical object and the respective second graphical object are qualified by one or more adjectives and/or one or more prepositional phrases.

In a preferred embodiment, the sequences used in the Listen and Do assessment described herein may be sequences from category 2. In other words, each of the instructions (in the sequence) may include an instruction to select a respective graphical object with a pointing device, where the respective graphical object may be qualified by one or more adjectives and/or one or more prepositional phrases. Of course, in other embodiments, other sequences of instructions, possibly in other categories, may be used as desired.

As noted above, in some embodiments, the aurally presented instruction sequences may be processed to some degree, e.g., to facilitate understanding by the adult. For example, in the Listen and Do training exercise, there are a number of different processing levels, ranging from heavily processed synthetic speech (e.g., level 1), e.g., to emphasize distinguishing attributes of the aurally presented stimuli, through natural or near-natural processed speech (e.g., level 5), where, for example, the level of processing of the auditory instructions may be based one or more of: 1) modifying a rate at which at least a portion of the auditory instructions are played, while maintaining characteristic pitch-pulse-phase synchronous temporal structure of voiced speech sounds, and 2) emphasizing portions of the auditory instructions, using band-modulation deepening to selectively enhance relatively fast-changing events in the voiced speech sounds.

In preferred embodiments, for assessment purposes, the sound processing level for presentation of the instructions may be set at level 5, where level 5 is the level closest to human speech. In other words, each of the plurality of sequences of auditory instructions may be aurally presented with a specified processing level substantially corresponding to natural speech. This is in contrast to the multiple processing levels used in the normal training exercise (Listen and Do). Of course, in other embodiments, any processing levels may be used as desired. Thus, in some embodiments, each of the plurality of sequences of auditory instructions may have a respective difficulty based a stage, corresponding to the number of instructions in the sequence, and a level of processing of the auditory instructions, where the level of processing corresponds to the degree to which the auditory instructions have been processed to enhance clarity of the auditory instructions.

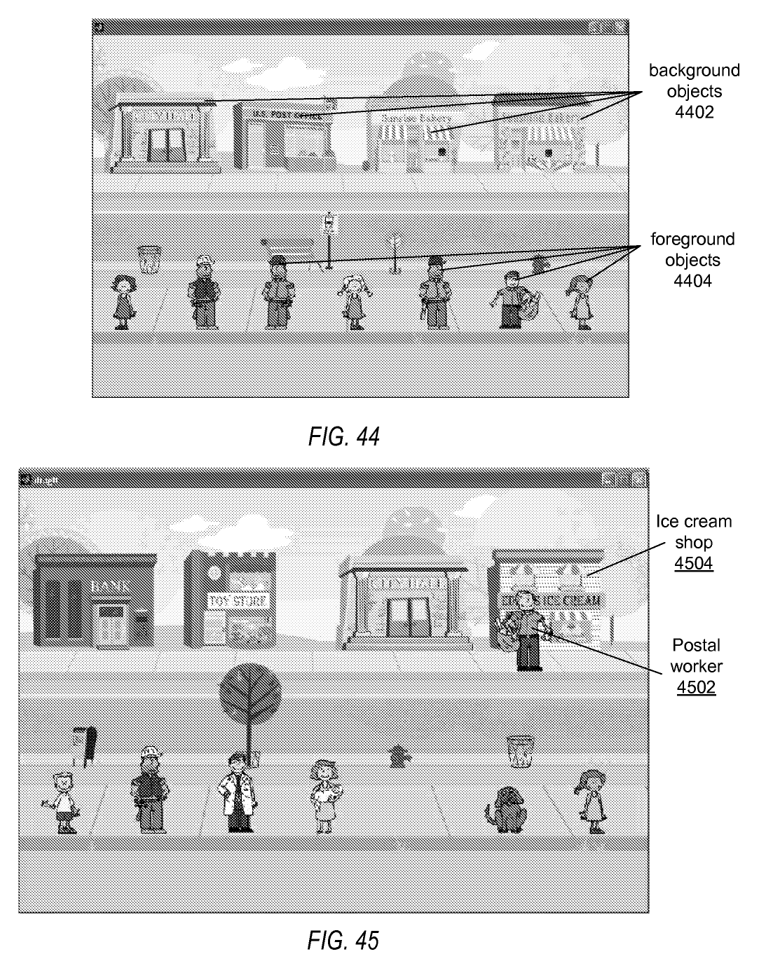

In 4306, input may be received from the adult, where the input manipulates the graphical objects on the display. For example, the adult may click on various items displayed in a GUI presented on a display of the computing device. FIG. 44 illustrates an exemplary screen suitable for use in the Listen and Do assessment described herein (and the training exercise (Listen and Do), as well). More specifically, the screen may be suitable for instruction sequences of categories 2 and 4. As FIG. 44 shows, in this embodiment, the screen may include one or more (immovable) background objects 4402, such as various buildings, including two bakeries, a city hall, and a post office. As also shown, the screen includes a plurality of (moveable) foreground objects 4404, e.g., various people standing on a sidewalk. Where both the background and foreground objects may be selectable, e.g., “clickable” by a mouse or other pointing device, by the adult. For example, in one embodiment, the adult may be instructed to click on “the girl with the blue dress”, and where the input received from the adult may simply be the adult's mouse click on the girl with the blue dress displayed on the screen.

FIG. 45 illustrates another exemplary screen that may be suitable for use in the Listen and Do assessment described herein (and the Listen and Do training exercise, as well). More specifically, the screen may be suitable for instruction sequences of category 3. As with FIG. 44, the screen of FIG. 45 includes background objects (e.g., buildings such as a bank, toy store, city hall, and ice cream shop) and foreground objects (e.g., people and/or animals). In this particular example, a postal worker 4502 has been moved (by the adult) to the ice cream shop 4504, presumably in response to a corresponding sequence of instructions, which is an exemplary category 3 instruction. As noted above, however, in preferred embodiments, the sequences of instructions used in the Listen and Do assessment are from category 2.

In one embodiment, the method may include indicating whether the adult correctly performed the sequence of actions. For example, a respective sound indicating correctness or incorrectness may be presented to the user, e.g., a “ding” indicating correctness, and a “thunk”indicating incorrectness of the response. Additionally, or alternatively, a respective graphical indication of correctness or incorrectness of the response may be presented, e.g., a “success” image, icon, or animation.

In 4308, the stage value of the specified track may be modified based on the adult's response. For example, modifying the stage value of the specified track based on the adult's response may include modifying the stage value in accordance with a maximum likelihood procedure, e.g., in accordance with a QUEST (quick estimation by sequential testing) threshold procedure, or a ZEST (zippy estimation by sequential testing) threshold procedure, as described above in some detail.

In one embodiment, for each track, modifying the stage value of the specified track based on the adult's response may include increasing the stage value if the adult responds correctly in a specified percentage of trials, and decreasing the stage value if the adult responds incorrectly in the specified percentage of trials. For example, similar to the Sound Replay assessment described above, in one exemplary embodiment, if the player obtains a 90% or over correct rate on the first 10 trials, the track's initial values may be increased, and if the player obtains a 90% or over incorrect rate on the first 10 trials, the track's initial values may be decreased, and the assessment may resume, or start over, with the new initial values.

As also described above, it should be noted that while each stage is discrete, i.e., has an integer value, the stage values determined in the method may not always be integers, and may not always be modified or adjusted in integer amounts. For example, for each iteration of the assessment process described herein (or periodically per some specified number of trials), the method may determine a real (non-integral) stage value. This value may be the true updated stage value, but its rounded value may used to specify the stage to use for the next trial, e.g., a stage value of 3.4 may specify use of stage 3 for the trial, while a stage value of 3.6 may specify use of stage 4 for the trial. In one embodiment, the initial stage values may chosen such that if they are too easy (or too difficult), the next stage used will immediately be incremented (or decremented) one full stage. For example, assuming an adjustment increment/decrement of approximately 0.2, if 3.6 (which specifies stage 4) were found to be too difficult, the next value would be about 3.4 (specifying stage 3), whereas if 4 had been specified as the initial stage value and the trial were found to be too difficult, the next value (3.8) would still round to 4, and so no effective change would occur. Thus, the initial stage values may be set to real values.

As noted above, the initial anticipated threshold, the first stage value, the second stage value, and the threshold (determined below) may each specify or be associated with a respective number of distinct instructions in the sequence of instructions. Thus, for each track, increasing the stage value may include increasing the number of instructions in the sequence. Similarly, for each track, decreasing the stage value may include decreasing the number of instructions in the sequence. Increasing the stage value for a track may operate to make subsequent trials performed in that track more difficult, while decreasing the stage value for a track may operate to make subsequent trials performed in that track less difficult. Note that the adult's response to the trial conducted at a track's value may thus determine that track's next stage value via the maximum likelihood method.

In 4310, the presenting, receiving, and modifying described above may be performed with respect to each of a plurality of sequences of auditory instructions in an iterative manner to determine respective final stage values for the first track and the second track. In other words, method elements 4304-4308 may be performed for each of a plurality of instruction sequences to determine final stage values of the two tracks.

For example, in one embodiment, performing the presenting, receiving, and modifying, one or more times in an iterative manner may include performing trials in the first track and the second track in an alternating manner, or performing trials in the first track and the second track randomly with equal probability. As noted above, in either approach, over many trials the number of trials performed in each track are equal or at least approximately equal. Moreover, in accordance with QUEST or ZEST threshold determination techniques, repeating the presenting, receiving, and modifying, one or more times in an iterative manner may include repeating the presenting, receiving, and modifying, until the stage values of the first track and the second track have converged to values within a specified confidence interval, and where the values are within a specified distance from each other, or, until a specified number of trials have been conducted for each track (e.g., 20 per track).

In 4312, a threshold for the adult may be determined based on the respective final stage values for the first track and the second track, where the threshold is or includes the stage value associated with the specified performance level of the adult. In other words, a threshold stage value may be determined that specifies stimulus attributes at which the adult will generally fail some specified percentage of the time, e.g., 47.5%.

In preferred embodiments, determining a threshold for the adult based on the respective final stage values for the first track and the second track may include averaging the respective final stage values for the first track and the second track to determine the threshold for the adult. For example, averaging the respective final stage values for the first track and the second track to determine the threshold for the adult may include rounding the average of the respective final stage values for the first track and the second track to determine the threshold for the adult. Thus, a stage value of 4.6 corresponds to stage 5, and a stage value of 4.2 corresponds to stage 4.

In one embodiment, the presenting, receiving, and modifying described above may compose performing a trial. Certain information may be saved with respect to each trial performed, e.g., for operation of the method, and/or for subsequent analysis of the assessment. For example, for each trial, one or more of the following may be saved: which track was used in the trial, the stage value used in the trial, the series of auditory instructions presented to the adult, button-to-sound assignments, the series of selections by the adult, the correctness or incorrectness of the adult's response, the mean of a posterior probability distribution function for the maximum likelihood procedure, and the standard deviation of the posterior probability distribution function for the maximum likelihood procedure. Of course, any other type of information may also be saved as desired.

As indicated above, the adult may interact with the assessment process via a GUI presented on the computing device, similar to the GUI used in the training exercise (Listen and Do). However, some aspects of the exercise version of Listen and Do may not be necessary in the Listen and Do assessment. For example, a progress bar, points bar, and reward area included in the training exercise GUI (of Listen and Do) are not necessary, since progress/reward indicators may not be used in the assessment. However, in some embodiments, some of the GUI elements or assets may remain the same, such as the response buttons and the “ding” and “thump” sounds that play after an adult responds correctly or incorrectly. In some embodiments, the stimulus presentation may also be identical to the exercise version. In one embodiment, initially the only button in the screen is the start button. However, because the adult will not already know the number of instructions to be presented for each trial, in some embodiments, the number of instructions to be presented (and followed) may be displayed at the beginning of each trial so the adult knows how many instructions to expect to receive. After the adult clicks on the start button, the instructions may be played and the interface may be activated after the entire set of instructions is given, i.e., the various graphic objects may be selectable by the adult to carry out the instructions.

Stimuli Specifications

The following describes exemplary stimulus data sets suitable for use in the above-described assessment method. It should be noted, however, that the data described is meant to be exemplary only, and is not intended to limit the data used in the invention to any particular data sets or attributes.

In one embodiment, for assessment purposes, the sound processing level for presentation of the instructions may be set at level 5, where level 5 is the level closest to human speech. This is in contrast to the processing levels used in the normal training exercise (Listen and Do), ranging from heavily processed synthetic speech (e.g., level 1), e.g., to emphasize distinguishing attributes of the aurally presented stimuli, through natural or near-natural processed speech (e.g., level 5).

In preferred embodiments, for assessment purposes, the sound processing level for presentation of instructions may be set at level 5, which is the level in which sounds are not emphasized but simply sped up. To avoid problems the adult might have with dragging and dropping items, in preferred embodiments, the stimulus category may be set at category 2, where the adult is only asked to select (i.e., click on) various objects on the interface. Thus, drag and drop commands may not be used for assessment purposes. Note that category 2 includes characters that are descriptive, e.g. the girl in the purple (green, red) dress, the tall (short) police officer, Washington (Lincoln) library, etc.). Said another way, in some embodiments, the stimulus category may be set at category 2, from among a plurality of available categories (see above), where, as described above, category 2 may include instructions to identify or select (e.g., click on) graphical objects or items presented on the display of the computing device, where the graphical objects in the instructions are modified by one or more adjectives and/or one or more prepositional phrases, although in other embodiments, other types of instructions may be used as desired.

As noted above, in preferred embodiments, the stage parameters may be the same as the stage parameters for the Listen and Do exercise, and may represent or correspond to the number of instructions given. For example, an exemplary stage 3 sequence of instructions may include three qualified selection instructions, e.g., click on the brown dog and then click on man in the red hard hat and then click on the sunshine bakery.

Initialization Values

In one embodiment, initial values for the assessment process may be set at:
Initial stage values: 3.4 and 4.6
Confidence Interval: 0.95
Confidence Interval Width: 0.5
Standard deviation of cumulative Gaussian psychometric function: 0.8
Standard deviation of prior threshold distribution: 0.7.

However, it should be noted that in other embodiments, other values may be used as desired.

Assessment and Exercise Performance

Maximum likelihood procedure based psychophysical threshold determination, such as described above with respect to various exemplary cognitive training exercises, may facilitate more effective use of such exercises by establishing a stimulus intensity for each exercise that is substantially optimal for improving the cognitive skills of the adult subject.

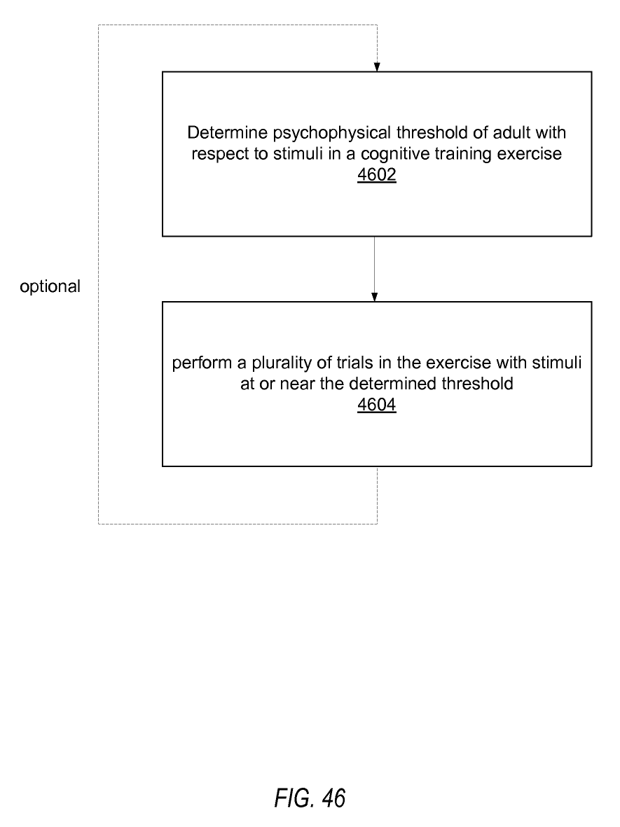

FIG. 46 is a high level flowchart of one embodiment of a method for improving cognition and memory in an aging adult, utilizing a computing device to present stimuli to the adult, and to record responses from the adult. The method described below may utilize any of the various cognitive training exercises described herein, although it should be noted that any other cognitive training exercise may be used as desired. Note that in various embodiments, some of the method elements may be performed concurrently, in a different order than shown, or may be omitted. Additional method elements may also be performed. As shown, the method may operate as follows:

In 4602, a psychophysical threshold for an aging adult with respect to stimuli in a cognitive training exercise may be determined. As noted above, the threshold may comprise a stimulus intensity value associated with a specified performance level of the adult, and may be determined using a maximum likelihood procedure, such as, for example, a QUEST (quick estimation by sequential testing) threshold procedure, or a ZEST (zippy estimation by sequential testing) threshold procedure, as described above.

For example, similar to the assessments described above, in one embodiment, determining the psychophysical threshold may include initializing a first track to a first intensity value that is below an initial anticipated threshold, where the initial anticipated threshold comprises or includes an initial estimate of a stimulus intensity value for stimuli corresponding to a specified performance level of the adult. A second track may be initialized to a second stimulus intensity value that is above the initial anticipated threshold. A stimulus may then be presented to the adult via the computing device in accordance with the stimulus intensity value of a specified one of either the first track or the second track. For example, the stimuli may be presented via one or more of: headphones attached to the computing device, speakers attached to the computing device, and/or a display device attached to the computing device. A response to the stimulus may then be received from the adult via the computing device, and the stimulus intensity value of the specified track modified based on the adult's response in accordance with the maximum likelihood procedure. For example, in one embodiment, for each track, modifying the stimulus intensity value of the specified track based on the adult's response may include increasing the stimulus intensity value if the adult responds correctly in a specified percentage of trials, and decreasing the stimulus intensity value if the adult responds incorrectly in the specified percentage of trials.

In one embodiment, an indication of whether the adult responded correctly to the stimulus may be provided. For example, a respective sound and/or graphical indication indicating correctness or incorrectness may be presented. Additionally, or alternatively, points may be awarded (or possibly subtracted) based on the correctness of the adult's response.

This presenting, receiving, and modifying may be performed with respect to each of a plurality of stimuli in an iterative manner to determine respective final stimulus intensity values for the first track and the second track, after which a threshold for the adult may be determined based on the respective final stimulus intensity values for the first track and the second track, where the threshold is or includes the stimulus intensity value associated with the specified performance level of the adult. In other words, an assessment version of the cognitive training exercise may be performed to determine the psychophysical threshold for the adult with respect to that exercise. For example, determining a threshold for the adult based on the respective final stimulus intensity values for the first track and the second track may include averaging the respective final stimulus intensity values for the first track and the second track to determine the threshold for the adult. In one embodiment, averaging the respective final stimulus intensity values for the first track and the second track to determine the threshold for the adult may include rounding the average of the respective final stimulus intensity values for the first track and the second track to determine the threshold for the adult. Please see the above-described assessments for particular examples of such threshold determination with respect to specific exercises.

In one embodiment, performing the presenting, requiring, and modifying, one or more times in an iterative manner may include performing trials in the first track and the second track in an alternating manner, or, alternatively, performing trials in the first track and the second track randomly with equal probability, the idea being to perform substantially the same number of trials in each track over the duration of the determination process. In some embodiments, the presenting, requiring, and modifying, may be performed (iteratively) until either the stimulus intensity values of the first track and the second track have converged to stimulus intensity values within a specified confidence interval, where the stimulus intensity values are within a specified distance from each other, or a specified number of trials have been conducted for each track. In other words, in some embodiments, trials may be performed until one of these conditions obtains.

In one embodiment, the presenting, requiring, and modifying described above may compose performing a trial (in the determination process or assessment exercise of 4602). Moreover, the method may include saving various parameters or values for each trial performed, including, for example, one or more of: which track was used in the trial; the stimulus intensity value used in the trial; the stimulus presented to the adult; button to response assignments; the series of button selections by the adult; the correctness or incorrectness of the adult's response; the mean of a posterior probability distribution function for the maximum likelihood procedure; and the standard deviation of the posterior probability distribution function for the maximum likelihood procedure, among others.

Additionally, in some embodiments, the method may further include initializing various parameters, such as, for example, one or more of: initial stimulus intensity values of the first and second tracks; the standard deviation of a cumulative Gaussian psychometric function for the maximum likelihood procedure; and the standard deviation of a prior threshold distribution for the maximum likelihood procedure, among others.

In one embodiment, the method may include determining the initial anticipated threshold based on one or more of: the age of the adult, calibration trials performed by the adult, and/or calibration trials performed by other adults.

In 4604, a plurality of trials in the exercise may be performed with stimuli at or near the determined threshold to improve the adult's cognition and memory skills. In other words, the exercise may be performed based on the determined threshold. For example, the adult may be trained through repetitive trials at or near the determined threshold to increase the benefit of performing trials in the cognitive training exercise.

In some embodiments, performing a plurality of trials in the exercise with stimuli at or near the determined threshold may include: providing a set of stimuli for the cognitive training exercise. For each stimulus in the set of stimuli, the stimulus may be presented to the adult at or near the determined threshold via the computing device. A response to the presented stimulus may be received from the adult via the computing device, and a determination made as to whether the response is correct. An indication may then be provided as to whether the response is correct. The presenting, receiving, determining, and indicating may be repeated for each stimulus in the set of stimuli in an iterative manner to improve the adult's cognitive and memory skills. In one embodiment, this presenting, receiving, determining, and indicating for each stimulus in the set of stimuli may include increasing a difficulty level of the stimulus as the adult progresses through the exercise. Note that in preferred embodiments, the stimuli used in determining the psychophysical threshold may be or include a representative subset of the set of stimuli used in performing the plurality of trials in the exercise.

In one embodiment, presenting the stimulus to the adult at or near the determined threshold via the computing device may include presenting aural stimuli, e.g., spoken words phonemes, instructions, etc., and/or visual stimuli, e.g., images, text, etc., to the adult. Various examples of each are provided above with respect to the different exercise assessments described herein.

In preferred embodiments, the method may further include repeating the determining the psychophysical threshold and performing the plurality of trials in the exercise one or more times in an iterative manner to improve the adult's cognitive and memory skills. For example, the repetitions may be performed over a plurality of sessions, e.g., over days, weeks, or even months, as noted above.

It should be noted that any of the techniques, parameters, and aspects disclosed above with respect to any of the various exercises and assessment methods described herein may be used with respect to any others of the exercises and assessment methods, as desired. In other words, any of the particular details described above with respect to any specific method may be used with respect to any of the other methods disclosed herein as desired, the above descriptions being meant to be exemplary only, and not to restrict embodiments of the invention to any particular form, appearance, or function.

Moreover, although the present invention and its objects, features, and advantages have been described in detail, other embodiments are encompassed by the invention. For example, particular advancement/promotion methodology has been thoroughly illustrated and described for each exercise. The methodology for advancement of each exercise is based on studies indicating the need for frequency, intensity, motivation and cross-training. However, the number of skill/complexity levels provided for in each exercise, the number of trials for each level, and the percentage of correct responses required within the methodology are not static. Rather, they may change, based on heuristic information, as more participants utilize the HiFi training and assessment programs. Therefore, modifications to advancement/progression methodology are anticipated. In addition, one skilled in the art will appreciate that the stimuli used for training, as detailed in the Appendices, are merely a subset of stimuli that can be used within a training or assessment environment similar to HiFi. Furthermore, although the characters, and settings of the exercises are entertaining, and therefore motivational to a participant, other storylines can be developed which would utilize the unique training and assessment methodologies described herein.

Finally, those skilled in the art should appreciate that they can readily use the disclosed conception and specific embodiments as a basis for designing or modifying other structures for carrying out the same purposes of the present invention without departing from the spirit and scope of the invention as defined by the appended claims. For example, various embodiments of the methods disclosed herein may be implemented by program instructions stored on a memory medium, or a plurality of memory media.

### Appendix A: Exercise 1: High or Low?

Description of Target Neurological Deficit:

We believe that that auditory systems in older adults suffer from a degraded ability to respond effectively to rapidly presented successive stimuli. This deficit manifests itself psychophysically in the participant's poor ability to perform temporal order judgments on rapidly presented successive stimuli, and behaviorally in the subject's poor ability to receive speech at normal and high rates.

Goal of the Exercise:

The goal of this exercise is to expose the auditory system to rapidly presented successive stimuli during a behavior in which the participant must extract meaningful stimulus data from both the first and second stimulus.

This can be done efficiently using time order judgment tasks and sequence reconstruction tasks, in which participants must identify each successively present auditory stimulus. Two types of simple, speech-like stimuli will be used in this exercise in order to improve the underlying ability of the brain to process rapid speech stimuli: frequency modulated (FM) sweeps, and structured noise bursts. These stimuli are used because they resemble certain classes of speech. Sweeps resemble stop consonants like /b/ or /d/. Structured noise bursts are based on fricatives like /sh/ or /f/, and vowels like /a/ or /i/.

In general, the FM sweep tasks are the most important for renormalizing the auditory responses of participants. The structured noise burst tasks are provided to allow high-performing participants who complete the FM sweep tasks quickly an additional level of useful stimuli to continue to engage them in time order judgment and sequence reconstruction tasks.

Overview of exercise flow and structure:

High or Low? (Exercise 1) can be divided into two main sections, FM sweeps and structured noise bursts. Both of these sections have a Main Task and an initiation for the Main Task. The Main Task in FM sweeps is Task 1 (Sweep Time Order Judgment). FM Sweeps is the first section presented to the participant. Task 1 of this section must be closed out before the participant can begin the second section of this exercise, structured noise bursts. The Main Task in structured noise bursts is Task 3 (Structured Noise Burst Time Order Judgment). NOTE: Task 2 & 4, the bonus tasks, were removed in HiFi v0.4 s3a.

[image]

The Tasks:

Task 1—Main Task: Sweep Time Order Judgment

General Description of Task:

This is a time order judgment task. Participants listen to a sequential pair of FM sweeps, each of which could sweep upwards or downwards. Participants are required to identify each sweep as upwards or downwards in the correct order. The task is made more difficult by changing both the duration of the FM sweeps (shorter sweeps are more difficult) and decreasing the inter-stimulus interval (ISI) between the FM sweeps (shorter ISIs are more difficult).

Trial Description:

1. OR button click: A trial begins with the participant providing an observing response to indicate they are attentive and ready to perform the task.
2. Pre-Stimulus delay
3. Stimulus presentation: a pair of stimuli are presented. Four combinations of stimuli are possible: up/up, up/down, down/up, and down/ down. The four combinations are presented with equal frequency.
4. Response: The participant responds by identifying the first stimulus as up or down, and then identifying the second stimulus as up or down. Stimuli are identified by clicking response buttons (or using a keyboard shortcut). If the first response is incorrect, the trial is ended.
5. Pre-reward delay
6. Correctness feedback: A “ding” or “thunk” indicates whether the trial was correct or incorrect
7. Points awarded (correct trials only): TBD
8. Other rewards (correct trials only): TBD
9. Pre-OR delay
   Stimuli:

Stimuli consist of upwards and downwards FM sweeps, characterized by their base frequency (the lowest frequency in the FM sweep) and their duration. The other characteristic defining an FM sweep, the sweep rate, is held constant at 16 octaves per second throughout the task. This rate was chosen to match the average FM sweep rate of formants in speech (e.g., ba/da).

A pair of FM sweeps is presented during a trial. The ISI changes based on the participant's performance.

There are three base frequencies:

| Base Frequency Index | Base Frequency |
|---|---|
| 1 | 500 Hz |
| 2 | 1000 Hz |
| 3 | 2000 Hz |

There are five durations:

| Duration Index | Duration |
|---|---|
| 1 | 80 ms |
| 2 | 60 ms |
| 3 | 40 ms |
| 4 | 35 ms |
| 5 | 30 ms |

Moving Through the Task:
An Orientation to Main Task Flow:

A participant will cycle through frequencies, but move in a linear fashion, generally from longer to shorter durations (categories) within each frequency. Adaptive tracking is used to change the ISI based on the participant's performance.

[image]

Task 1 Entry Criteria:

Task 1 Initiation passed
   Movement within Task 1:

A List of Available Durations (Categories):

The first time in Task 1, a list of available durations (categories) with a current ISI is created within each frequency. At this time, there are only categories in this list that have a duration index of 1 and a current ISI of 600 ms. Other categories (durations) will be added (opened) as the participant progresses through the Task. Categories (durations) are removed from the list (closed) when specific criteria are met.

Choosing a Frequency, Duration (Category), and ISI:

The first time in:
the participant begins by opening duration index 1 (80 ms) in frequency index 1 (500 Hz)
the starting ISI is always 600 ms when opening a duration and the ISI step size index when entering a duration is always 1

Beginning subsequent sessions:
the participant moves to a new frequency (see “Switching frequencies”) UNLESS the participant has completed less than 20 trials in Task 1 of the previous session's frequency (see “Entering a duration”)

Switching frequencies:
the frequency index is incremented, cycling the participant through the frequencies in order by frequency index (500 Hz, 1000 Hz, 200 Hz, 500 Hz, etc.)
   if there are no open durations in the new frequency, the frequency index is incremented again until a frequency is found that has an open duration
   if all durations in all frequencies have been closed out, Task 1 is closed
the participant begins with the longest open duration (lowest duration index) in the new frequency
see “Entering a duration” below

Switching durations:
generally, the duration index is incremented until an open duration is found (the participant moves from longer, easier durations to shorter, harder durations)
   if there are no open durations, the frequency is closed and they participant switches frequencies
the only time a participant switches into a duration with a lower index (longer, easier duration) is if 10 incorrect trials are performed at an ISI of 1000 ms at a duration index greater than 1
   Entering a Newly Opened Duration:
the starting ISI is 600 ms
the ISI step size is 10% of the current ISI or 60 ms
the above rules apply if a duration was closed and then subsequently re-opened
   Re-entering an Already Open Duration:
the starting ISI=(3× the current ISI step size) higher than the stored ISI of the new duration (making the trials easier; NOTE: this only applies to entering durations that are “open”
   Progression within a Duration (Category)—Changes in ISI:
ISIs are changed using the 3-up/1-down adaptive tracking rule: Three consecutive correct trials equals advancement—ISI is shortened. One incorrect equals retreat—ISI is lengthened
For the first 5 trials of a session the above adaptive tracking rule is turned off

The amount by which the ISI changes is also varied. This allows participants to move in larger steps when the ISI is longer and then smaller steps when the ISI is shorter. The ISI step size is 10% of the current ISI, but never drops below 5 ms.

| ISI | ISI Step Size |
|---|---|
| >=50 | 10% of ISI |
| <50 | 5 ms |

When starting a duration with an ISI of 600 ms, the ISI step size is 60 ms. This means that 3 consecutive correct trials will shorten the ISI by 60 ms and 1 incorrect will lengthen the ISI by 60 ms—3 up/1 down.
A total of 8 reversals are allowed within a duration; the 9^{th} reversal results in the participant exiting the duration; the duration remains open. See “Example of reversals below”
   A Sweeps reversal is a “change in direction”. For example, three correct consecutive trials shortens the ISI (increase difficulty). A single incorrect lengthens the ISI (decreases difficulty). The drop to a longer ISI after the advancement to a shorter ISI is counted as one reversal. If the participant continues to decrease difficulty (does not respond correctly to 3 consecutive trials), these drops do not count as reversals. A “change in direction” due to 3 consecutive correct responses (which shortens the ISI) counts as a second reversal. (The tally is NOT reset by movement in the same direction.)
ISI can never decrease to lower than 20 ms, and can never increase to more than 1000 ms
   An Example of Maximum Reversals within a Durations:
   NOTE: The following example uses sequential reversals, however reversals need not occur one after another. There may be several sequential promotions or several demotions before a reversal occurs. A reversal is a “change in direction”.

Action: 3 correct trials at 150 ISI
Result: increase in difficulty (“up”); 0 reversals, ISI decreased by 15

Action: 1 incorrect trials at 135 ISI
Result: decrease in difficulty (“down”); 1 reversal, ISI increased by 14

Action: 3 correct trials at 149 ISI
Result: increase in difficulty (“up”); 2 reversals, ISI decreased by 15

Action: 1 incorrect trials at 134 ISI
Result: decrease in difficulty (“down”); 3 reversals, ISI increased by 13

Action: 3 correct trials at 147 ISI
Result: increase in difficulty (“up”); 4 reversals, ISI decreased by 15

Action: 1 incorrect trials at 132 ISI
Result: decrease in difficulty (“down”); 5 reversals, ISI increased by 13

Action: 3 correct trials at 145 ISI
Result: increase in difficulty (“up”); 6 reversals, ISI decreased by 15

Action: 1 incorrect trials at 130 ISI
Result: decrease in difficulty (“down”); 7 reversals, ISI increased by 13

Action: 3 correct trials at 143 ISI
Result: increase in difficulty (“up”); 8 reversals, ISI decreased by 14

Action: 1 incorrect trials at 129 ISI
Result: 9^{th} reversal and the participant exits the duration threshold value of (130+143+129)/3 is stored
   Opening a Duration (Category)—Adding to the List of Available Durations:

A duration index can be added to the list of available durations by:
completing a single trial at an ISI of 150 ms or less adds a shorter (harder) duration to the list of available durations (current duration index+1); the participant starts at 600 ms ISI
10 incorrect trials at an ISI of 1000 ms reopens the next longer (easier) duration, if one is available; since this duration was closed, the participant starts at 600 ms ISI
   Exiting a Duration (Category)—Leaving a Duration:

The participant exits the current duration:
10 incorrect trials are performed at an ISI of 1000 ms and the current duration index is greater than 1 (closes the duration and the participant moves into the duration with the next lower index—a longer duration that is easier)
a 9th reversal has occurred. The duration remains open, threshold, not current ISI, is stored

The participant exits and closes the current duration when:
See section below.

The participant exits the current duration and drops into initiation step 4 when:
10 incorrect trials are performed at an ISI of 1000 ms and the current duration index is 1 (80 ms duration—longest duration); the duration remains open
   A Summary of when a Duration (Category) is Closed—Removing the Duration from the List of Available Durations:

A duration index is removed from the list of available durations when:
3 consecutive correct trials are performed at an ISI of 20 ms
10 incorrect trials are performed at an ISI of 1000 ms; if the duration index is greater than 1, the next longer duration is re-opened
When a duration is closed any longer open durations in the same frequency are also closed.
   Closing Task 1:

Task 1 is closed when there are no durations (categories) open in any of the frequencies.

Task 1 Initiation—FM Sweep Time Order Judgment

Goal of Initiation:

Many participants find this time order judgment very difficult to perform at first. Yet it is very important that they learn how to perform it, and then perform it intensively. To do so, these participants learn to perform the task through a carefully defined sequence of preliminary steps designed to introduce them to the full task in a step-by-step manner.

By the end of initiation, it should be clear to the participant that

1. the participant must initiate the trial

2. exactly two stimuli are presented in each trial

3. each stimulus is associated with a single response button that appears following the trial

4. the participant can not respond until both stimuli have completed

5. the participant press the response buttons in the order that the associated stimuli were presented

General Description of Flow, Trials, and Stimuli:

This portion of the exercise has a linear flow from top to bottom with an “eddy” for remedial instruction. The “eddy” is entered only if the main step is failed. Exiting the “eddy” will bring the participant back to the main step.

Step 3 and its “eddy” (step 3a and step 2) use only one stimulus. An FM sweep is used in step 3. If the participant fails this step, they will be presented with a pure tone (step 3a) and then re-introduced to an FM sweep with no possibility of an incorrect response (step 2) before going back to step 3.

Step 4 and its “eddy” (step 4a) use two stimuli. FM sweeps are used in step 4 and pure tones in step 4a.

The trials in Task 1 initiation and Task 1 are presented in a similar manner (see “Trial Description” under Task 1). Differences are noted in the detailed description, where they occur.

[image]

Detailed Description of Task 1 Initiation Steps:

Step 3:

The trial:
Trial stimulus: I sweep (up or down randomly chosen); Frequency: 500 Hz, duration: 80 ms
Trial presentation:
   2 response buttons present, both active
   visual cues for the first 3 trials,
   after first 3 trials, if there is an incorrect response, visual cues are given again until there is a correct response

Exit criteria:
Pass: 10 correct trials; Go to: Step 4
Fail: 20 trials (without doing 10 correct trials); Go to: Step 3a
Skip/Continue: step not completed in three tries
   Step 3a:

The trial:
Trial stimulus: 1 pure tone (high or low randomly chosen); Frequency: 500 Hz, duration: 80 ms
High tone: highest frequency in FM sweep
Low tone: lowest frequency in FM sweep
Trial presentation:
   2 response buttons present, both active
   visual cues for the first 3 trials,
   after first 3 trials, if there is an incorrect response, visual cues are given again until there is a correct response

Exit criteria:
Pass: 10 correct trials; Go to: Step 2
Fail: 20 trials (without doing 10 correct trials); Go to: Skip/Continue
   Step 2:

The trial:
Trial stimulus: 1 sweep (up or down); Frequency: 500 Hz, duration: 80 ms
10 trials with up sweep
10 trials with down sweep
Trial presentation:
   2 response buttons present, only the correct response is active
   visual cues for all trials,

Exit criteria:
Pass: 20 correct trials; Go to: Step 3
Fail: not possible unless response window elapses; Go to: Skip/Continue
   Step 4 with 700 ms ISI:

The trial:
Trial stimuli: 2 sweeps (pair randomly generated); Frequency: 500 Hz, duration: 80 ms, ISI: 700 ms
NOTE: If this step is re-entered from the Main Task, the frequency and duration used will be the same as the Main Task
Trial presentation:
   2 response buttons present, both active
   visual cues for the first 3 trials,
   after first 3 trials, if there is an incorrect response, visual cues are given again until there is a correct response

Exit criteria:
Pass: 10 correct trials; Go to: Task 1
Fail: 20 trials (without doing 10 correct trials); Go to: Step 4 with 1000 ms ISI
   Step 4 with 1000 ms ISI:

The trial (equivalent to block):
Trial stimuli: 2 sweeps (pair randomly generated); Frequency: 500 Hz, duration: 80 ms, ISI: 1000 ms
Trial presentation:
   2 response buttons present, both active
   visual cues for the first 3 trials,
   after first 3 trials, if there is an incorrect response, visual cues are given again until there is a correct response

Exit criteria:
Pass: 10 correct trials; Go to: Task 1
Fail: 20 trials (without doing 10 correct trials); Go to: Step 4a
Skip/Continue: step not completed in three tries
   Step 4a:

The trial:
Trial stimuli: 2 tones (pair randomly generated); Frequency: 500 Hz, duration: 80 ms, ISI:
High tone: highest frequency in FM sweep
Low tone: lowest frequency in FM sweep
Trial presentation:
   2 response buttons present, both active
   2 visual cues for the first 3 trials,
   after first 3 trials, if there is an incorrect response, visual cues are given again until there is a correct response

Exit criteria:
Pass: 10 correct trials; Go to: Step 4 with 1000 ms ISI
Fail: 20 trials (without doing 10 correct trials); Go to: Skip/Continue
   Data Recording:

Data recording for task 1 initiation will be the same as for Task 1, expect that it should be noted the participant was in initiation for these trials.

Task 3—Main Task: Structured Noise Burst Time Order Judgment

General Description of Task:

This task is identical to task 1 (FM sweep time order judgment) except that it uses structured noise burst stimuli rather than FM sweep stimuli. Participants listen to a sequential pair of structured noise bursts, each of which could be perceived as having a higher frequency or a lower pitch. Participants are required to identify each burst as “high” or “low” in the correct order. The task is made more difficult by changing both the duration of the structured noise bursts (shorter bursts are more difficult), decreasing the relative frequency separation between the structured noise bursts (closer in frequency are more difficult), and decreasing the inter-stimulus interval (ISI) between the structured noise bursts (shorter ISIs are more difficult).

Trial description (equivalent to a Block):

Trial logic is identical to Task I (Sweep Time Order Judgment).

Stimuli:

Stimuli consist of pairs of structured noise bursts, characterized by their base frequency (the center frequency between the pair), their frequency offset (the frequency distance from the base frequency to the peak envelope frequency of each burst), their duration, and their ISI. Other variables defining the structured noise burst (i.e., envelope shape, harmonic structure) are held constant throughout the task.

There are three base frequencies (500 Hz, 1000 Hz, 2000 Hz), identical to those in task 1 (FM sweep time order judgment).

Frequency offset and duration are co-varied with 5 variations:

| Frequency Offset/ | | |
|---|---|---|
| Duration Index | Frequency Offset | Duration |
| 1 | 50% of Base Frequency | 300 ms |
| 2 | 40% of Base Frequency | 250 ms |
| 3 | 30% of Base Frequency | 200 ms |
| 4 | 20% of Base Frequency | 150 ms |
| 5 | 10% of Base Frequency | 100 ms |

Moving Through the Task:

Moving through the task is identical to task 1 (FM sweep task time order judgment), with the exception that instead of a duration index, there is a frequency offset/duration index.

Closing Task 3:

Task 3 (and the whole exercise) is closed when there are no available frequency offset/durations available.

Replay:

After Task 3 is closed, the entire Task is re-opened beginning with the easiest durations in each frequency.

Data Recording:

Data recorded will be identical to Task 1 with the exception that the frequency/duration index will be used instead of the duration, and there needs to be an indication that the participant is in Task 3.

If the participant is on a reduced schedule, that should be indicated in the trail data.

Task 3 Initiation—Structured Noise Burst Time Order Judgement

In general, initiation occurs in the same way as for Task 1. However, there are no pure tone stimulus fallback trials. Having no pure tone trials caused 2 differences in flow:
1. failing Step 3 will take the participant directly to Step 2
2. after 20 trials in Step 4 using a 1000 ms ISI, the participant falls back into Step 3

All rules for passing and failing found in Task 1 initiation apply to Task 3 Initiation.

[image]

Data Recording:

Data recorded will be identical to Task 1 with the exception that the frequency/duration index will be used instead of the duration, and there needs to be an indication that the participant is in Task 3.

Terms and Definitions Unique to High or Low?: (also see HiFi.doc)

3 Up_{—}1 Down:

Three consecutive correct trials equals advancement. One incorrect equals retreat.

Tracking_toggle:

The tracking toggle prevents the participant from drifting too far from threshold through inattention. If a participant's responses cause 5 consecutive increases in ISI, the participant pops into Task Initiation. The current ISI is recorded. When the participant passes initiation, they re-enter the duration (or duration/frequency offset) and all re-entry rules apply (an increase in ISI, step size index of 1).

Sweeps_reversal:

Different from serial reversals, a Sweeps reversal is defined as a “change in direction”. For example, three correct consecutive correct trials move the participant shorten the ISI (increase difficulty). A single incorrect lengthens the ISI (decreases difficulty). The drop to a longer ISI is counted as one reversal. If the participant continues to decrease difficulty (does not respond correctly to 3 consecutive trials), these drops do not count as reversals. A “change in direction” due to 3 consecutive correct responses (difficulty increases) counts as a second reversal. The tally is NOT reset by movement in the same direction.

Threshold:

The threshold is the average ISI of the final 3 Sweeps reversals when the maximum number of reversals has been attained. When exiting a duration (or duration/frequency offset) due to maximum reversals, this average ISI is retained for game initialization instead of the current ISI.

Stable performance:

Stable performance is based on a comparison of threshold ISIs from 3 different training days. If the difference in ISI between the lowest ISI and the highest ISI is 25 ms or less AND the threshold values do not show a clear trend either upward or downward, stable performance has been reached. For example, sequential threshold values of 15, 23, and 17 would meet the criteria for stable performance. Sequential threshold values of 15, 17, and 23 would not meet the criteria for stable performance since there is a trend toward increasing ISI, nor would sequential threshold values of 23, 17, and 15 (decreasing thresholds).

### Appendix B: Exercise 2: Tell Us Apart

Description of Target Neurological Deficit:

We believe that auditory systems in older adults suffer from a degraded ability to respond effectively to rapidly presented successive stimuli. This deficit manifests itself psychophysically in the participant's poor ability to perform auditory stimulus discriminations under backward and forward masking conditions. This manifests behaviorally in the participant's poor ability to discriminate both the identity of consonants followed by vowels, and vowels preceded by consonants.

Goal of the Exercise:

The goal of exercise 2 is to force the participant to make consonant and vowel discriminations under conditions of forward and backward masking from adjacent vowels and consonants respectively.

This can be done efficiently using sequential phoneme identification tasks and continuous performance phoneme identification tasks, in which participants must identify successively presented phonemes. We assume that older adults will often find making these discriminations difficult, given their neurological deficits as discussed above. These discriminations are made artificially easy (at first) by using synthetically generated phonemes in which both 1) the relative loudness of the consonants and vowels and/or 2) the gap between the consonants and vowels has been systematically manipulated to increase stimulus discriminability. As the participant improves, these discriminations are made progressively more difficult by making the stimuli more normal.

[image]

[image]

The Tasks:

Task 1—Main Task: Two Alternative Phoneme Discrimination

General Description of Task:

The task is a sequential phoneme discrimination task. Participants hear a sequence of phonemes from a confusable pair (e.g., da/ga). Participants are required to classify each stimulus as one of the two members of the confusable pair (e.g., as a /da/ or as a /ga/). The difficulty of the task is systematically manipulated by changing the level of emphasis that each stimulus receives, ranging from a high level of emphasis making the discrimination less difficult, to no emphasis making the discrimination more difficult.

Block Description (a Block Consists of 10 Trials):

Stimuli in a block:

Each block consists of 10 phonemes (10 trials) in a sequence. For example, a given block might be presented as da, ga, da, da, ga, da, ga, ga, ga, da.
There is no minimum or maximum number of times a phoneme must occur within a block, however . . .
the same phoneme should not be presented more than 3 times in a row.
Each block of 10 trials is evaluated for progression.
   Response buttons:
Response buttons display the phoneme orthographically.
The position of response buttons is fixed according to the table in the stimulus description. For example, in the bo/do contrast, the button labeled “bo” is always on the left and the one labeled “do” is always on the right.
   Elapsed response window:
If the exercise enters the pause state (either “pause” button clicked or response window has elapsed), the block is aborted, and is re-started from the beginning when the pause state ends
   Flow:
   1. OR button click: A block begins with the participant providing an observing response to indicate they are attentive and ready to perform the task.
   2. Repeat steps below for every trial (single stimulus and response) that occurs until a 10-Pack bonus animation plays or criteria is met for a category change.
   3. Pre-Stimulus delay
      1. Stimulus presentation: a single stimulus is presented
      2. Response: participant responds by identifying the phoneme
      3. Pre-reward delay (correct response only)
      4. Correctness feedback: A “ding” or “thunk” indicates whether the trial was correct or incorrect
      5. Points awarded (correct response only)
      6. Pop-up reward (first 9 trials only—on correct response) until a maximum of 9 pop-ups are present on screen
   4. After every 10 trials: evaluate for progression
   5. After 10 correct responses: play 10-pack bonus and then display OR button
   6. After criteria met for a category change: display OR button
      Stimuli:

Phoneme Contrasts (Categories):

Two types of phoneme contrasts are used:
The first type covers the b/d/g continuum semi-exhaustively across vowel contexts because perceptual training of this crucial discrimination is known not to generalize well across vowel contexts.

The second type convers various contrasts in which the key element is a timing (e.g., silent gap) element. In this type, vowel context is not exhaustively trained because perceptual training is known to generalize adequately accross vowel context.

| | Contrast | | |
|---|---|---|---|
| | (Category) | Phoneme 1 | Phoneme 2 |
| Phoneme Class | Index | (wave file name) | (wave file name) |
| stop consonant | 1 | baa (bbae) | daa (ddae) |
| | 2 | bo (bbow) | do (ddow) |
| | 3 | bi (bbiy) | di (ddiy) |
| | 4 | da (ddaa) | ga (ggaa) |
| | 5 | de (ddeh) | ge (ggeh) |
| | 6 | du (dduw) | gu (gguw) |
| timing | 7 | baa (bbae) | paa (ppae) |
| | 8 | do (ddow) | to (to) |
| | 9 | gi (gi) | ki (ki) |
| | 10 | sa (sa) | sta (sta) |
| | 11 | she (she) | che (che) |

Emphasis Levels (14 Stages):

Both stimuli of each stop contrast pair are synthesized at 14 emphasis levels. The first of the timing contrast pair is only synthesized at the least level of emphasis (14) while the second in the pair is sytnthesized at 14 emphasis levels. These emphasis levels correspond to stages. At the lowest stage (easiest), the stimuli receive the greatest emphasis. At the highest stage (most difficult), the stimuli receive no emphasis (e.g., the task is to discriminate unemphasized stimuli).

Moving Through the Task:

An Orientation to Main Task Flow:

Participants perform blocks of 10 stimuli (trials) with a specific phoneme contrast (category) at a specific emphasis level (stage). Participants make one response per stimulus (trial). The emphasis level (stage) is adaptively tracked within a contrast (category).

Category presentation alternates between stop consonant and timing contrasts. This alternating presentation is maintained over sessions.

Task 1 Entry Criteria:
Task 1 Initiation passed

Movement within Task 1:

A List of Categories and their States:

A list of all 11 current status, and current stage is maintained. Categories may be either “open” or “closed”. If a category is open, it may either be “active” or “inactive”. Only categories which are both open and active are performed.

The first time in Task 1, all categories are open and only one stop contrast is active. This stop contrast category is chosen randomly. Other categories will be made active as needed.

Choosing a Category and Stage:

The first time in:
The participant begins with category 2 (bo/do) which is used for initiation. When initiation is complete, Task 1 continues with category 2.
The first stage entered is stage 1.

Beginning subsequent sessions:
The participant begins the session with an open, active category of a different type from the last one performed in the previous session. For example, if the last category performed in a session is a timing category, the first one performed will be a stop category. The stop category will be chosen from the list of categories that were open and active in the previous session.
see “Entering a category” below

Switching categories:
stop and timing categories alternate; a stop category is followed by a timing category which is followed by a stop category . . . etc. (unless this is impossible due to category closure)
categories of the required type are chosen randomly from:
   1. open, active categories that have not been performed during the current session;
   2. if no open, active categories of the required type are available, an open, inactive category of the correct type becomes active;
   3. if no categories of the required type are open and inactive, a previously performed category within the current session will be repeated
if there are no categories open, Task 1 is closed
see “Entering a category” below

Entering a Category:
Association (coach) and “warm-up” trials are completed before the participant begins the first block in the category
Re-entering a category, the starting stage is 2 less than the stored current stage for the category—an easier stage; stage 1 is the lowest stage possible

Association:
the coach guides the association of each phoneme with its response button. There is no user interaction during the association

“Warm-up” trials:
next, a block of two “warm-up” trials is presented with each phoneme in the contrast presented (using the emphasis level of the starting stage)
a second block of two “warm-up” trials is presented
regardless of the user's performance, the category begins after the second block of “warm-up” trials

Progression within a Category (Contrast)—Changes in Emphasis Level (Stage):
If >=90% of the trials in a block are correct, the stage is increased by one (increasing difficulty); highest possible stage is 14
If >=70% and <90% of the trials in a block are correct, the stage remains the same
If <70% of the trials in a block are correct, the stage is decreased by one (decreasing the difficulty); lowest possible stage is 1

Exiting a Category (Contrast):
3 consecutive blocks are performed at the same stage (>=70% and <90% correct)
3 consecutive blocks with <70% correct
3 blocks at the highest stage (most difficult) with >=90% correct (NOTE: this also closes the category)
exercise time-out

Reclassifying a Category from Active to Inactive (But Still Open):
“stable performance” is reached exiting a category at the same stage 3 consecutive times, either within or across sessions (provided the stage is not the highest stage)

Reclassifying a Category from Inactive to Active (and Open):
a new category is required and all other active, open categories of the same type have been performed during the current session

Closing a Category:
3 blocks at the highest stage 14 (the most difficult, least processed stage) with >=90% correct
exiting a category at stage 1 (easiest stage) with <70% correct 5 consecutive times, either within or across sessions. NOTE: If all categories are closed in this way the participant will fall back to step 2a of initiation. After returning from initiation all categories are re-opened.
   Closing Task 1:

Task 1 (and Task 2) is closed when there are no categories (contrasts) open. The exercise terminates at this point.

Task 1 Initiation—Two Alternative Phoneme Discrimination

Goal of Initiation:

Participants learn to perform the task through a sequence of preliminary tasks designed to introduce them to the full task in a step-by-step manner.

By the end of initiation, it should be clear to the subject that
1. the subject must initiate the trial
2. each block contains 10 stimuli
3. within a trial, each stimulus is one of a pair
4. each stimulus is associated with exactly one of the two response buttons
5. the subject must identify each stimulus by clicking on the corresponding response button
6. the next stimulus is not presented until a response to the previous stimulus is made
   General Description of Flow, Blocks, and Stimuli:

Initiation begins with a fairly easy to discriminate phoneme contrast with different vowels sounds (step 2: baa/do). This contrast is presented in unprocessed natural speech. If the participant is unable to perform the sequential classification task with these stimuli, they are presented with stimuli that are even easier to distinguish (step 1: hello/goodbye), presented in unprocessed natural speech. Other wise they are presented again with the (baa/do) contrast, but this time using generated phonemes at the highest emphasis. Once they master this stimuli the participant moves on to the (bo/do) contrast at the highest emphasis.

Stimuli:

Step 1: “Hello/Goodbye” (natural speech)

Step 2: “baa/do” (natural speech—can be taken from Match It! stimuli set)

Step 3: “baa/do” (highest emphasis)

Step 4: “bo/do” (highest emphasis—same as main task stimuli)

Flow:

Each step of initiation has three parts:
Part a: Two blocks. Each block has 2 trials, one for each stimulus.
Visual cues (red circles) provided.
100% correct or 2 blocks completed to move forward, no failure possible
Part b: A block of 10 trials, with stimuli presented randomly.
Visual cues (red circles) provided.
>=90% correct to move forward, <90% correct to move back.
Part c: A block of 10 trials, with stimuli presented randomly.
No visual cues (red circles) provided.
>=70% correct to move forward, <70% correct to move back.

The participant enters at Step 2, “baa/do” (natural speech), and advances to step 3, “baa/do” (highest emphasis), or fails down to Step 1, “hello/goodbye.” See diagram below:

[image]

Resuming Initiation:

If a participant exits the exercise with out completing the initiation, they should resume at part “a” of whichever step they were on when they exited.

If a participant continues the initiation from the Skip/Continue screen, they should resume at part “a” of whichever step they were on when they dropped to the Skip/Continue screen.

Skip/Continue:

If the participant fails at any step four times, they should be taken to the Skip/Continue screen. This screen notifies the participant that they have reached a point in the training where it is necessary to contact their study coordinator and a number is provided.

Two buttons are active on this screen:
Skip to Next Exercise: Advances the participant to the next exercise in the current session or to the “End of Session” screen, if the current exercise is the last one in the session.
Continue: Returns the player to the step of initiation from which they arrived at this screen.
   Reward Animations—a Special Case for Tell Us Apart Initiation:

In Tell Us Apart initiation, the participant responds to a block of 2 to 10 trials. In each of the blocks of trials, the next stimulus is presented immediately after the response button is clicked, with the OR only re-appearing after the block is complete. The 10-Pack bonus (and benchmark & mini-series animations) should only play after the block is complete and when the final response in the block is correct. At the end of the block if 6 or more pop-ups are on screen then the bonus will play. If all 9 are on screen and trials remain in the block, there are no additional pop-ups until the final trial of the block. If the final trial is correct, the bonus plays, if it is incorrect the pop-ups are cleared. If multiple benchmark animations are cued, only one will play. The benchmarks only play if the final response of the block is correct. If a benchmark is cued and the final response is not correct, that benchmark will NOT be removed the cue and will have an opportunity to play at the end of each block. Once it is played it is removed from the cue.

### Appendix C: Exercise 3: Match It!

Description of Target Neurological Deficit:

We believe that degraded representational fidelity of the auditory system in older adults causes an additional difficulty in the ability of older adults to store and use information in auditory working memory. This deficit manifests itself psychophysically in the participant's poor ability to perform working memory tasks using stimuli presented in the auditory modality.

Goal of the Exercise:

Exercise 3 has two goals:
1. To expose the auditory system to substantial numbers of consonant-vowel-consonant syllables that have been processed to emphasize and stretch the rapid frequency transitions
2. To drive improvements in working memory by requiring participants to store and use such syllable information in auditory working memory

This can be done efficiently using a spatial match task similar to the game “concentration”, in which participants must remember the auditory information over short periods of time to identify matching syllables across a spatial grid of syllables.

Overview of exercise flow and structure:

Match It! (Exercise 3) has only one Task. The stimuli are identical to those used in Phonic Streams (Exercise 4).

There are 5 speech processing levels. Processing level 1 is the most processed and processing level 5 is normal speech. Participants move through stages within a processing level before moving to a less processed speech level. Stages are characterized by the size of the spatial grid. At each stage, participants complete all the categories.

[image]

Task 1—Main Task: Spatial Match

General Description of Task:

The task is a spatial paired match task, based on the children's game “Concentration.” Participants see an array of response buttons. Each response button is associated with a specific syllable (e.g., “big”, “tag”), and each syllable is associated with a pair of response buttons. Upon pressing a button, the participant hears the syllable associated with that response button. If the participant presses two response buttons associated with identical syllables consecutively, those response buttons are removed from the game. The participant completes a trial when they have removed all response buttons from the game. Generally, a participant completes the task by clicking on various response buttons to build a spatial map of which buttons are associated with which syllables, and concurrently begins to click consecutive pairs of responses that they believe, based on their evolving spatial map, are associated with identical syllables. The task is made more difficult by increasing the number of response buttons and manipulating the level of speech processing the syllables receive.

Blocks and Trials:

Block in Match It!: OR button, the grid of response buttons, and all the clicks (trials) the participant makes to find matching response buttons (and clear the grid)

Trial in Match It!: each click on a response button (representing a syllable)

Assigning syllables to a button: Syllables are not assigned to a specific button until the participant clicks on the button for the first time. On the first click, a syllable is chosen randomly from the pool of syllables selected for the grid. The only criterion for choosing a syllable is that it should not match the previously heard syllable (syllable associated with previously clicked button). This approach prevents a participant from receiving credit for clicking a pair of buttons before hearing the syllable associated with each button, which would represent a coincidental match.

A match: Three clicks are generally required to make a match. Two non-sequential clicks on two different buttons assigns the syllable to the buttons. A minimum of one more click (second button to first button) will make the match.

Max clicks: maximum number of clicks the participant can use to successfully clear the grid; this number increases with the size of the grid

Block Description:

1. OR button click: block begins with the participant providing an observing response to indicate they are attentive and ready to perform the task.
2. Grid presentation: a spatial grid of response buttons is presented; the number of syllable pairs and the number of response buttons is determined by the current stage
3. Each response until grid is cleared: participant clicks on a response button:
   Each time a button is clicked it is activated (highlighted). Any previously activated button is deactivated (highlight removed) after the match evaluation.
   IF this is the first time the response button was clicked:
      the button is assigned a syllable
      pre-stimulus delay
      syllable plays
   OR
   IF the button was previously clicked:
      pre-stimulus delay
      syllable associated with button plays
      determine if a match has been made: the syllable associated with the current response is compared to last response syllable to see if they are identical—a match;
      pre-reward delay
      correctness feedback: “ding” for match (no “thunk” is used for a failed match).
      points are awarded for a match
      response buttons are cleared, if there was a match
      other reward given (if there was match)
4. Bonus Points awarded (grid cleared successfully): TBD
5. Other rewards (grid cleared successfully): TBD
6. Pre-OR delay
   Stimuli:

Processing Levels:

Each stimulus is available at 5 levels of speech processing, ranging from level 1 (highly processed) to level 5 (unprocessed natural speech).

Stages:

There are 4 task stages, each associated with a specific number of response buttons in the trial and a maximum number of response clicks allowed:

| | Number of Response | Maximum Number of |
|---|---|---|
| Stage | Buttons | Clicks (max clicks) |
| 1 | 8 (4 pairs) | 20 |
| 2 | 16 (8 pairs) | 60 |
| 3 | 24 (12 pairs) | 120 |
| 4 | 30 (15 pairs) | 150 |

Categories:

The stimuli are identical to those used in Exercise 4 (Phonic Streams) and consist of consonant-vowel-consonant syllables or single phonemes:

| Category 1 | Category 2 | Category 3 | Category 4 | Category 5 |
|---|---|---|---|---|
| baa | fig | big | buck | back |
| do | rib | bit | bud | bag |
| gi | sit | dig | but | bat |
| pu | kiss | dip | cup | cab |
| te | bill | kick | cut | cap |
| ka | dish | kid | duck | cat |
| laa | nut | kit | dug | gap |
| ro | chuck | pick | pug | pack |
| sa | rug | pig | pup | pat |
| stu | dust | pit | tub | tack |
| ze | pun | tick | tuck | tag |
| sho | gum | tip | tug | tap |
| chi | bash | bid | bug | gab |
| vaa | can | did | cud | gag |
| fo | gash | pip | puck | bad |
| ma | mat | gib | dud | tab |
| nu | lab | tig | gut | tad |
| the | nag | gig | guck | pad |

Category 1 consists of easily discriminable CV pairs. Leading consonants are chosen from those used in exercise 2 and trailing vowels are chosen to make confusable leading consonants as easy to discriminate as possible.

Category 2 consists of easily discriminable CVC syllables. Stop, fricative, and nasal consonants are used, and consonants and vowels are placed to minimize the number of confusable CVC pairs.

Categories 3, 4, and 5 consist of difficult to discriminate CVC syllables. All consonants are stop consonants, and consonants and vowels are placed to maximize the number of confusable CVC syllables (e.g., cab/cap).

Moving through the Task:

An Orientation to Main Task Flow:

Participants may find either the stimulus discrimination aspects or the memory aspects of the task difficult (or both). Task progression is designed to allow participants with poor stimulus discrimination to advance through the memory challenges of the task without getting stuck because of their poor stimulus discrimination capabilities, and to allow participants with poor memory to advance through the stimulus discrimination aspects of the task without getting stuck because of their poor memory abilities. Participants move through stages (i.e., increasing numbers of response buttons) before increasing processing level (decreasing the level of processing). However, not all stages must be completed before moving on to a new processing level. At each stage, participants complete all stimulus categories.

Task 1 Entry Criteria:
Task 1 Initiation passed

Movement within Task 1:

A List of Categories and Their States:

A list of available syllable categories and their current status is maintained.

The first time in Task 1, the list contains all syllable categories. Each syllable category is marked as “open.”

Choosing a Processing Level and Stage:

The first time in:
the participant begins with processing level 1 (most highly processed speech)
the first stage entered is stage 1

Beginning subsequent sessions:
the participant resumes with the same processing level as the previous session
if the participant was in the middle of clearing a grid when the exercise timed out, the grid is saved and the participant resumes from where they left off with the same number of matches remaining.

Choosing a Category:
the first category chosen is always category 1, if that is not open,
the second category is always category 2, following that,
the category is chosen randomly from the “open” categories on the list

Establishing the Grid:

Syllables and response buttons:
The number of different syllables and the number of response buttons (2 times the number of syllables) is determined by the current stage
The required syllables are chosen randomly from the current category.

Max clicks:
The number of clicks a participant can use and still successfully clear the grid is determined by the current stage

Opening, Closing, and Failing Categories:
When a stage is first entered, all categories are marked “open.”
A category is marked “failed” when a participant fails to clear the grid in maximum clicks allowed (max clicks)
A category is marked “closed” when a participant clears the grid in max clicks or less
Second chance rule: After all five categories are performed, if any of the more difficult categories (3, 4, or 5) are marked “closed”, all “failed” categories are re-opened. The re-opened categories are repeated once more before determining if the participant will advance or retreat a stage. The second chance rule applies over sessions. Therefore, the participant data must differentiate between categories performed only once and those that have been re-opened.

Moving Between Stages:
advance 1 stage (larger grid) when all categories are marked “closed”; (advancing from stage 4 moves participant into a new processing level and the stage is reset to 1)
   the category list is reset to include all syllable categories and all are marked “open”
repeat a stage (same size grid) when no categories are “open” and at least one category is marked “failed” following the second chance rule, that stage is repeated.
   the category list is reset to include all syllable categories and all are marked “open”
   if a stage is repeated a designated number of time, the processing level is advanced (see below).

Advancing to the Next Processing Level:
all categories in stage 4 are “closed”
the participant has repeated a stage the number of times in the table below consecutively without meeting criteria to advance a stage.

NOTE: retreat to earlier processing levels is not possible. When entering a new processing level the stage is set to 1.

| Stages | Number of repetitions before advancing |
|---|---|
| stage 1 (8 buttons) | 3 |
| stage 2 (16 buttons) | 2 |
| stage 3 (24 buttons) | 2 |
| stage 4 (30 buttons) | 2 |

Closing Task 1:
criteria have been met for advancing from processing level 5

After closing Task 1:
At this point the exercise terminates (v0.5)
   Task 1 Initiation—Spatial Match
   Goal of Initiation:

Most participants should be generally familiar with the concept of a spatial match memory game. To ensure that they can perform the task, participants begin the task in a training game with a small number of response buttons and be assisted by visual cues.

By the end of initiation, it should be clear to the participant that
1. each button in a grid is consistently associated with one and only one stimulus
2. the participant must activate response buttons before receiving credit for matching them
3. clicking on two response buttons associated with identical syllables consecutively removes those response buttons from the grid
4. the goal of the task is to remove all the response buttons using as few clicks as possible
   General Description of Flow, Trials, and Stimuli:

Initiation for Task 1 will begin with the use of stimuli that are trivial to distinguish in a small spatial grid (Step 1) and then advance to the use of relevant stimuli (Step 2).

[image]

Detailed Description of Task 1 Initiation Steps:

Step 1:
The grid (Equivalent to block):
Grid stimuli: “hello” and “goodbye”—no processing (normal speech)
Grid presentation:
   4 response buttons, 2 for each stimulus
   visual cues: each time a response button is clicked, the syllable will appear on the button;
   NOTE: the grid can be cleared using only visual information in at this point
   max clicks is 8
Exit criteria:
Pass: 1 grid cleared in max clicks or less; Go to: Step 1a
Fail: 10 grids; Go to: Skip/Continue

Step 1a:
The grid (equivalent to block):
Grid stimuli: same as step 1
Grid presentation:
   4 response buttons, 2 for each stimulus
   no visual cues
   max clicks is 8
Exit criteria:
Pass: 3 grids cleared in max clicks or less; Go to: Step 2
Fail: 10 grids; Go to: Step 1
If step not completed in three tries; Go to: Skip/Continue

Step 2:
The grid (equivalent to block):
Grid stimuli: 2 stimuli chosen randomly from category 1 at processing level 1
Grid presentation:
   4 response buttons, 2 for each stimulus
   visual cues: each time a response button is clicked, the syllable will appear on the button;
   NOTE: the grid can be cleared using only visual information in at this point
   max clicks is 8
Exit criteria:
Pass: 1 grid cleared in max clicks or less; Go to: Step 2a
Fail: 10 grids; Go to: step 1

Step 2a:
The grid (equivalent to block):
Grid stimuli: same as step 2
Grid presentation:
   4 response buttons, 2 for each stimulus
   no visual cues
   max clicks is 8
Exit criteria:
Pass: 3 grids cleared in max clicks or less; Go to: Task 1
Fail: 10 grids; Go to: Step 2
If step not completed in three tries; Go to: Skip/Continue
Skip/Continue:
This screen notifies the participant that they have reached a point in the training where it is necessary to contact their study coordinator and a number is provided.
Two buttons are active on this screen:
   Skip to Next Exercise: Advances the participant to the next exercise in the current session or to the “End of Session” screen, if the current exercise is the last one in the session
   Continue: Returns the player to the step of initiation from which they arrived at this screen

### Appendix D: HiFi Sound Replay (Exercise 4)

This document includes the following sections:

| | |
|---|---|
| Goals | 2 |
| Description of Target Neurological Deficit | 2 |
| Goals of the Exercise | 2 |
| Summary | 2 |
| Task Description | 2 |
| Task Progression | 2 |
| Mechanics | 3 |
| Core Flow: Progression Overview | 3 |
| Processing Levels | 3 |
| Stages | 3 |
| Categories | 3 |
| Main Task Flow | 4 |
| Entry Criteria | 4 |
| Choosing a processing level and stage | 4 |
| Warm-up Trials | 5 |
| Categories | 5 |
| Trial sequence | 5 |
| Response buttons | 6 |
| Opening, closing, and failing categories | 6 |
| Moving between stages | 6 |
| Advancing to the next processing level | 6 |
| Maximum serial reversals | 7 |
| Closing Task 1 | 7 |
| Initiation | 7 |
| Goal | 7 |
| Initiation Flow | 7 |
| Coach Voice-over | 8 |
| Step-by-step Progression | 8 |
| Elements | 10 |
| Trial description (equivalent to a Block) | 10 |
| User Interface | 10 |
| Flowchart | 10 |
| Art Assets | 10 |
| Sound and Music | 10 |
| Level Requirements | 11 |
| Stimuli | 11 |
| Points | 11 |
| Rewards | 11 |

Goals
Description of Target Neurological Deficit

We believe that degraded representational fidelity of the auditory system in older adults causes an additional difficulty in the ability of older adults to store and use information in auditory working memory. This deficit manifests itself psychophysically in the participant's poor ability to perform working memory tasks using stimuli presented in the auditory modality.

Goals of the Exercise

Sound Replay has two goals:
To expose the auditory system to substantial numbers of consonant-vowel-consonant syllables that have been processed to emphasize and stretch the rapid frequency transitions
To drive improvements in working memory by requiring participants to store and use such syllable information in auditory working memory

These goals can be met using a temporal match task similar to the neuropsychological tasks digit span and digit span backwards, in which participants must remember the auditory information over short periods of time to identify matching syllables in a temporal stream of syllables.

Summary

Task Description

The task is a temporal paired match task, based on the digit span neuropsychological task. Participants hear a sequence of syllables (e.g., “big”, “tag”, “pat”). Following the presentation of the sequence, the participant sees a number of response buttons, each labeled with a syllable. All syllables in the sequence are shown. In addition there may be buttons labeled with syllables not present in the sequence (distracters). The participant is required to press the response buttons to reconstruct the sequence. The Task is made more difficult by increasing the length of the sequence, decreasing the ISI, and manipulating the level of speech processing the syllables receive.

Task Progression

The task progression is designed to allow participants with poor stimulus discrimination to advance through the memory challenges of the task without getting stuck because of their poor stimulus discrimination capabilities, and to allow participants with poor memory to advance through the stimulus discrimination aspects of the task without getting stuck because of their poor memory abilities. Participants move through stages (that is, increasing sequence length and complexity) before advancing in processing level (decreasing the level of speech processing).

Mechanics

Core Flow: Progression Overview

Sound Replay has an initiation interval (see below) followed by the main task.

NOTE Version 0.5 included a bonus task which was removed in version 0.6.

The main task is a nested progression consisting of processing levels, stages, categories, and trials. The following is a brief description of the progression:

Processing Levels

Processing levels correspond to five speech processing levels. Participants move through stages within a processing level before moving to the next processing level.

Stages

There eight stages in the main task, each associated with the following specifications:
the number of syllables in the sequence
the sequence length
ISI (inter-stimulus interval)

the number of response buttons in the trial (including the number of “distracters,” buttons not associated with any stimulus, but included as a distraction)

| | Total | | | |
|---|---|---|---|---|
| | Number of | Number of | Number of | |
| | Stimuli in | Different Syllables | Distracter | |
| Stage | Sequence | in Sequence | Response Buttons | ISI |
| 1 | 2 | 2 | 0 | 1200 ms |
| 2 | 3 | 3 | 0 | 1100 ms |
| 3 | 4 | 4 | 0 | 1000 ms |
| 4 | 5 | 4 | 1 | 950 ms |
| 5 | 6 | 5 | 1 | 900 ms |
| 6 | 7 | 5 | 1 | 850 ms |
| 7 | 8 | 5 | 2 | 800 ms |
| 8 | 9 | 6 | 2 | 750 ms |

Within each stage there are five categories. The stage advances or retreats depending on progress through the five categories (this is described in detail below).

Categories

The categories correspond to the five stimulus categories. The stimuli for Sound Replay are identical to those used in Match It! (Exercise 3) and consist of consonant-vowel-constant syllables or single phonemes. The first two categories are easily discriminable pairs, while the last three categories are difficult to discriminate. See the Stimulus Generation Document, HiFi_{—}Stimulus Generation, for details on the stimuli used in Sound Replay.

[image]

Main Task Flow

Entry Criteria

Task 1 Initiation passed

Choosing a Processing Level and Stage

The first time in:
processing level 1
stage 1
category 1

Beginning subsequent sessions:
the same processing level as the previous session
the same stage as the previous session
category selection:
   categories previously closed in the current stage remain closed
   categories previously failed in the current stage remain failed
   use the rules in “choosing a category” below
   if possible, start with a different category from the last one performed at the end of the previous session
begin the session with a series of warm-up trials using the stimuli from the chosen category
   NOTE: Reversals are tracked over sessions (see “advancing to the next processing level”) and the “second chance” rule also applies over sessions (see “opening, closing, and failing categories”).
   Warm-up Trials

Two blocks of two trials using 2 randomly chosen syllables from the starting category are performed. There are no distracters. After the two blocks are performed, the participant begins the session at the same stage as the previous session regardless of their performance on the two trials. There are no warm up trials following initiation.

Categories

Choosing a category
the first category chosen is always category 1,
the second category is always category 2,
following that (or if category 1 and 2 are both closed), the category is chosen randomly from the “open” categories on the list

Category status
A list of available syllable categories and their current status is maintained.
The first time in Task 1, the list contains all syllable categories. Each syllable category is marked as “open.”
   Trial Sequence
The number of different syllables, the length of the trial sequence, and the ISI are determined by the current stage.
The required syllables are chosen randomly from the current category. (There is no requirement to employ all of the syllables within a category.)
When a syllable has been selected, it should be removed from the list of available syllables in that category until all have been used.
   Response Buttons
A response button will be displayed for each different syllable in the trial sequence.
The number of distracters (response buttons not in the sequence) is determined by the stage.
Distracters (if there are any) will be chosen randomly from the unused syllables in the current category.
   Opening, Closing, and Failing Categories
When a stage is first entered, all categories are marked “open.”
A category is marked “failed” when a participant does 3 incorrect trials in the category (not necessarily sequential)
A category is marked “closed” when a participant does 3 correct trials in the category (not necessarily sequential)
   Second chance rule: After all five categories are performed, if any of the more difficult categories (3, 4, or 5) are marked “closed”, all “failed” categories are re-opened. The re-opened categories are repeated once more before determining if the participant will advance or retreat a stage. The second chance rule applies over sessions. Therefore, the participant data must differentiate between categories performed only once and those that have been re-opened.
      NOTE: A maximum of 5 trials is required to meet either the criterion for failing or the criterion for closing the category.
      Moving Between Stages
advance 1 stage when all categories are marked “closed”, (advancing from stage 8 moves participant into a new processing level)
   the category list is reset to include all syllable categories and all are marked “open”
retreat 1 stage when no categories are “open” and at least one category is marked “failed”, unless the criteria for advancing to the next processing level have been met; the participant will stay in Task 1; retreating from stage 1 moves the participant back into initiation
   the syllable categories marked “closed” in the previous (higher) stage are marked as “closed” in the new stage, and the syllable categories marked “failed” in the previous (higher) stage are marked “open.” (This prevents participants from having to repeat previously closed syllable categories.)
      Advancing to the Next Processing Level
All categories in stage 8 are “closed.”
The participant has advanced and retreated between the same two stages consecutively the number of times noted in the table below. For example, stages 2->3->2->3->2->3->2 is 3 serial reversals; if this is the maximum number of reversals, the participant does not enter stage 2 again, but goes directly to the next processing level.
Reversals are tracked over sessions, so the participant data must maintain the list of serial reversals.
   NOTE: Retreat to earlier processing levels is not possible.
   Maximum Serial Reversals

NOTE: The number of reversals between stages is subject to change, so an external file should be created for this information.

| Stages | Maximum Reversals |
|---|---|
| Initiation & stage 1 | 3 |
| stage 1 & stage 2 | 2 |
| stage 2 & stage 3 | 2 |
| stage 3 & stage 4 | 2 |
| stage 4 & stage 5 | 2 |
| stage 5 & stage 6 | 2 |
| stage 6 & stage 7 | 2 |
| stage 7 & stage 8 | 2 |

Closing Task 1
criteria have been met for advancing from processing level 5
After Task 1 is closed, the exercise terminates.
   Initiation

Most participants will be generally familiar with the concept of a temporal match memory game. To ensure that they can perform the task, participants will begin the task in a training game with a small number of response buttons and be assisted by visual cues.

Goal

By the end of initiation, it should be clear to the participant that
1. the participant must initiate the trial
2. a sequence of at least two stimuli are presented in each trial
3. the participant can not respond until the sequence has been presented in its entirety
4. each response button is associated with a single syllable
5. some response buttons are associated with syllables presented in the sequence and others are not
6. the participant clicks the response buttons in the order that the associated stimuli were presented
   Initiation Flow

Initiation for Task 1 will begin with the use of relevant stimuli (Step 2a) and retreat to the use of stimuli that are trivial to distinguish if the participant fails to pass Step 2a. In general, promotion occurs with 3 consecutive correct trials and demotion occurs with 3 incorrect trials.

[image]

Coach Voice-over

Coach is used throughout the initiation. Please see the coach document for Sound Replay, HiFi Sound Replay Coach, HiFi_{—}v.6_{—}SoundReplay_{—}coach.

Step-by-step Progression

Step 2a

The trial
Trial stimulus: 2 stimuli chosen randomly from category 1 at processing level 1
   NOTE: If dropping into initiation from Task 1, use the current processing level for all initiation trials.
Trial presentation
   2 response buttons present, both active
   visual cues for the first trial,
   after first trial, if there is an incorrect response, visual cues are given again until there is a correct response
Exit criteria
   Pass: 3 sequential correct trials; Go to: Step 2b
   Fail: 3 incorrect trials; Go to: Step 1
   If step not completed in four tries; Go to: Skip/Continue
      Step 2b

The trial
Trial stimulus: 2 stimuli chosen randomly from category 1 at processing level 1
   NOTE: If dropping into initiation from Task 1, use the current processing level for all initiation trials.
Trial presentation
   3 response buttons present, all active; distracter is chosen from same category as above
   visual cues for the first trial,
   after first trial, if there is an incorrect response, visual cues are given again until there is a correct response
Exit criteria
   Pass: 3 sequential correct trials; Go to: Task 1
   Fail: 3 incorrect trials; Go to: Step 2a
   If step not completed in four tries; Go to: Skip/Continue
      Step 1a

The trial
Trial stimulus: 2 stimuli chosen from “cat”, “bird”, “dog”; stimuli are not processed (normal speech)
Trial presentation
   2 response buttons present, both active
   visual cues for the first trial,
   after first trial, if there is an incorrect response, visual cues are given again until there is a correct response
Exit criteria
   Pass: 3 sequential correct trials; Go to: Step 1b
   Fail: 3 incorrect trials; Go to: Skip/Continue
      Step 1b

The trial
Trial stimulus: 3 stimuli—“cat”, “bird”, “dog”; stimuli are not processed (normal speech)
Trial presentation
   3 response buttons present, all active
   visual cues for the first trial,
   after first trial, if there is an incorrect response, visual cues are given again until there is a correct response
Exit criteria
   Pass: 3 sequential correct trials; Go to: Step 2a
   Fail: 3 incorrect trials; Go to: Step 1a
   If step not completed in four tries; Go to: Skip/Continue
      Skip/Continue

This screen notifies the participant that they have reached a point in the training where it is necessary to contact their study coordinator and a number is provided.

Two buttons are active on this screen:
Skip to Next Exercise: Advances the participant to the next exercise in the current session or to the “End of Session” screen, if the current exercise is the last one in the session
Continue: Returns the player to the step of initiation from which they arrived at this screen
   Elements

Trial description (equivalent to a Block)
1. OR button click: A trial begins with the participant providing an observing response to indicate they are attentive and ready to perform the task.
2. Pre-Stimulus delay
3. Stimulus presentation (with no response buttons present): a sequence of syllables is presented; the number of different syllables, the length of the sequence, the ISI, and the degree of processing the syllables receive is determined by the participant's progression through the Task
4. Response buttons appear: response buttons are labeled with the syllables in the sequence (e.g., “big”), and there may be 1 or more buttons for syllables not in the sequence (distracters); the position of response buttons is randomized for each trial
5. Response: The participant responds by identifying each syllable in the sequence
6. Pre-reward delay (correct response only)
7. Correctness feedback: A “ding” or “thunk” indicates whether the trial was correct or incorrect; the first incorrect response ends the trial and it is evaluated as incorrect
8. Model the correct trial: If the trial was incorrect (NOT because participant timed out), the correct trial is modeled.
9. Animation: response buttons highlighted in the correct sequence and stimulus is repeated.
10. Points awarded (correct response only): TBD
11. Other rewards (correct response only): HiFi Reward Functional Spec, HiFi_{—}v.6_{—}RewardAnimations_{—}spec
12. Pre-OR delay
   User Interface
   Flowchart
   Art Assets

HiFi Exercise UI Functional Spec, HiFi_{—}Exercise_{—}UI_{—}Func_{—}Spec

HiFi Exercise UI Assets, hifi_{—}exercise_{—}ui_{—}assets_{—}100104

Sound and Music

HiFi Coach Functional Spec, HiFi_{—}v.6_{—}SoundReplay_{—}coach

Level Requirements

Stimuli

HiFi Stimuli Functional Spec, HiFi_{—}Stimulus Generation

Points

HiFi Points Functional Spec,

Rewards

HiFi Reward Functional Spec, HiFi_{—}v.6_{—}RewardAnimations_{—}spec

### Appendix E: Exercise 5: Listen and Do

Description of Target Neurological Deficit:

We believe that the degraded representational fidelity of the auditory system in older adults causes an additional difficulty in the ability of older adults to store and use information in auditory working memory. This deficit manifests itself behaviorally in the subject's poor ability to understand and follow a sequence of verbal instructions to perform a complex behavioral task.

Goal of the Exercise:

Exercise 5 has two goals:
1) To expose the auditory system to a substantial amount of speech that has been processed to emphasize and stretch the rapid frequency transitions
2) To drive improvements in speech comprehension and working memory by requiring participants to store and use such speech information
   This can be done efficiently using an analog of the token task, a neuropsychological assessment of a participant's ability to follow auditory instructions. In this task, the participant is given auditory instructions of increasing length (e.g., number of steps in the instruction sequence) and complexity (e.g., stimulus discriminations required to perform the task correctly).
   Overview of Exercise Flow and Structure:

There are 5 speech processing levels. Processing level 1 is the most processed and processing level 5 is normal speech. Participants move through stages within a processing level before moving to a less processed speech level. Stages are characterized by the number of sequential instructions followed. Participants move through stages independently in four categories. Each category is characterized by instruction type.

General Description of Task:

The task requires the subject to listen to, understand, and then follow an auditory instruction or sequence of instructions by manipulating various objects on the screen. Participants hear a sequence of instructions (e.g., “click on the bank” or “move the girl in the red dress to the toy store and then move the small dog to the tree”). Following the presentation of the instruction sequence, the participant performs the requested actions. The task is made more difficult by making the instruction sequence contain more steps (e.g., “click on the bus and then click on the bus stop”), by increasing the complexity of the object descriptors (i.e., specifying adjectives and prepositions), and manipulating the level of speech processing the instruction sequence receives.

This task may be implemented in any one of a number of different game play styles (e.g., making a machine, following a recipe, manipulating people and objects in a street scene). Much of the exact content of the task (e.g., the exact instruction sequences, the initiation steps) will be dependent on the choice of game play style made.

Blocks and Trials:

Trial in Listen and Do: A trial consists of a click of the OR button, followed by the presentation of one or more instructions in sequence and the participants response(s) to the instructions which are evaluated for correct or incorrect.

Block in Listen and Do: A block is 5 trials in a specific category that is evaluated for progression (movement up or down stages)

Trial Description:

1. OR button click: A trial begins with the participant providing an observing response to indicate they are attentive and ready to perform the task.
2. Pre-Stimulus delay
3. Stimulus presentation: a single instruction or sequence of instructions are presented; the number and type of instructions are determined by the participant's progression through the Task
4. Response: The participant responds by manipulating objects on the screen as described in the instructions.
5. Pre-reward delay (correct response only)
6. Correctness feedback: A “ding” or “thunk” indicates whether the trial was correct or incorrect; the first incorrect response (if there are more than one instruction) ends the trial and it is evaluated as incorrect
7. Points awarded (correct response only)
8. Other rewards (correct response only)
9. Pre-OR delay
   Stimuli:

Processing Levels:

Each stimulus is available at 5 levels of speech processing, ranging from level 1 (highly processed) to level 5 (unprocessed natural speech).

Stages:

There are 6 stages, each associated with a specific number of instructions in the trial.

| Stage | Number of Instructions |
|---|---|
| 1 | 1 |
| 2 | 2 |
| 3 | 3 |
| 4 | 4 |
| 5 | 5 |
| 6 | 6 |

Categories:

There are four categories of instructions. Each category contains a distinct type of instruction. Categories 1 & 2 are “Click” instructions and categories 3 & 4 are “Drag” instructions.

| Category 1 | Category 2 | Category 3 | Category 4 |
|---|---|---|---|
| Click | | Drag | |
| Lower Complexity | Higher Complexity | Lower Complexity | Higher Complexity |
| Click-Object | Click-Adjective-Object | Drag-Object-to-Indirect | Drag-Adjective-Object- |
| | | Object | Preposition-Adjective |
| | | | (optional)-indirect object |

Examples

| | | | |
|---|---|---|---|
| Click on the bank | Click on the yellow car | Move the policeman to the | Move the tall policeman |
| | | bank | between the jail and the |
| | | | bank |
| Click on the policeman | Click on the tall policeman | Move the girl to the nurse | Move the girl in the red |
| | | | dress to the left of the |
| | | | nurse |
| Click on the school | Click on the girl in the red | Move the boy to the | Move the redheaded boy |
| | dress | school | next to the dog |
| Click on the dog | Click on the black dog | Move the dog to the | Move the man in the red |
| | | hydrant | shirt to the ice cream shop |
| Click on the tree | Click on the tall tree | Move the dog to the tree | Move the black dog next |
| | | | to the tall tree |
| Click on the doctor | Click on the blue trash can | Move the doctor to the | Move the briefcase to the |
| | | hospital | woman in the brown dress |

In Category 4, the prepositional relationship could be: to, next to, to the left of, to the right of, between, above, below, etc.

Category 2 & 4 require that the movable foreground objects on screen appear in confusable sets. If the instruction is to “click on the girl in the red dress,” the character set containing a girl in a red dress, a girl in a green dress, and a girl in a blue dress must appear on screen. Refer to “Screen Requirements” later in this document.

Please reference “Listen and Do Instruction List.doc” for list of recorded instructions.

Moving Through the Exercise:

An Orientation to Main Task Flow:

Participants may find either the stimulus discrimination aspects or the memory aspects of the task difficult (or both). Task progression is designed to allow participants with poor stimulus discrimination to advance through the memory challenges of the task without getting stuck because of their poor stimulus discrimination capabilities, and to allow participants with poor memory to advance through the stimulus discrimination aspects of the task without getting stuck because of their poor memory abilities.

Participants move through stages (i.e., increasing numbers of instructions) before increasing processing level (decreasing the level of processing). However, not all stages must be completed before moving on to a new processing level.

Entry Criteria:
Initiation passed

Movement within Exercise:

A List of Categories and their States:

A list of available instruction categories and their current status (“open” or “closed” & current Stage) is maintained.

The first time in, the list contains all instruction categories. Each category is marked as “open.”

Choosing a Processing Level and Stage:
The first time in:
   the participant begins with processing level 1 (most highly processed speech)
   the first stage entered is stage 1
Beginning subsequent sessions:
   the participant resumes with the same processing level as the previous session
   the participant resumes with the same stage as the previous session
   participants resume with the same category as the previous session
   the participant begins the session with a series of warm-up trials using the stimuli from the current category

Warm Up Trials:

Two single instruction warm-up trials are performed using a single instruction randomly chosen stimuli from the new session's category. After the two trials are performed, the participant begins the session at the same stage as the previous session regardless of their performance on the two trials.

Choosing a Category:
the first time in the exercise, the participant will start with category 1
After exiting a category, the participant will enter the next category as follows: 1-2,2-3,3-4,4-1.
The sequence above is maintained across sessions.

Choosing Instructions:
the instructions are chosen randomly from the appropriate category. There is no requirement to employ all instructions in a category within a stage.
the same instruction should not repeat twice in a row

Progression within a Category (Instruction Type)—Changes in Stage (Number of Instructions Presented in Sequence):
If >=90% of the trials in a block of 5 are correct (5 of 5), the stage is increased by one (increasing difficulty); highest possible stage is 6
If >=70% and <90% of the trials in a block are correct (4 or more), the stage remains the same
If <70% of the trials in a block are correct (3 or less), the stage is decreased by one (decreasing the difficulty); lowest possible stage is 1
Categories move through stages independently from one another.

Exiting and Closing a Category:

Categories are exited and closed when any of the criteria below are met. Once categories are closed, they remain closed and no trials are performed in that category until either the speech processing level changes or the participant returns from initiation (both of which re-open all categories at stage 1).
Good Performance: 1 block at the highest stage (most difficult) with >=90% correct
Moderate Performance: 2 consecutive blocks performed at the same stage (>=70% and <90% correct)
Poor Performance: 3 consecutive blocks with <70% correct. If a participant closes category 1, stage 1 in this way, they will return to Step 1 of initiation.
Stable Performance: 2 serial reversals: the participant has advanced and retreated between the same two stages in a category two times consecutively (e.g., stages 2->3->2->3->2). In this example no trail will be taken in the final stage shown, stage 2, but rather the category will be exited. Reversals are tracked over sessions, so the participant data must maintain a list of serial reversals. Once a participant exits a category for any reason, the reversal count is reset to 0. The serial reversal count is returned to 0 if the participant moves up or down two stages without a change in direction. It is not reset if the participant remains in the same stage for more than one block.
Trial Count Stable Performance: 500 trials taken in a category before any other exit/close criteria is met. The number is artificially high and will be adjusted down later. It should be set in an external XML file and saved and tracked across sessions.

ALTERNATE 1 Closing Criteria (Not Used for v0.6):

Categories are closed after they have been exited three times, either within or across sessions, for any of the reasons or combination of reasons described above in the “Exiting a category” section. Once categories are closed, they remain closed and no trials are performed in that category until either the speech processing level changes or the participant returns from initiation (both of which re-open all categories at stage 1).
If the participant's third exit from Category 1 is due to Poor Performance (described above) and they are at Stage 1, they will return to Step 1 of initiation.

ALTERNATE 2 Closing Criteria (Not Used for v0.6):

Categories are closed when any of the criteria below are met. Once categories are closed, they remain closed and no trials are performed in that category until either the speech processing level changes or the participant returns from initiation (both of which re-open all categories at stage 1).
exiting a category with Good Performance (described above), 3 times, either within or across sessions
exiting a category with Moderate Performance (described above), 3 times, either within or across sessions
exiting a category with Stable Performance (described above), 3 times between the same two stages, either within or across sessions
exiting a category with Poor Performance (described above), 3 times, either within or across sessions. If a participant closes category 1 in this way, they will return to Step 1 of initiation.
NOTE: the criteria above must be met 3 times, but not 3 times sequentially.

Advancing to the Next Processing Level:
all categories are “closed” in any method described above (except if all closed for poor performance, which returns the participant to initiation).
NOTE: retreat to earlier processing levels is not possible

Closing the Exercise:
criteria have been met for advancing from processing level 5

Schedule After Closing:
After Task 1 is closed, the exercise will terminate (v0.5)
   Screen Requirements:

Settings:

The current setting for Listen and Do is a street scene with building and characters in the foreground that can be clicked and dragged. Other setting may be developed.

Layers: There are Four Layers in which Objects Appear on Screen
Background: there are no objects in this layer. This is the setting for the objects (e.g. street in city)
Background Objects: These objects are mostly buildings in the street scene. They can be clicked on and have other objects dragged to them, but cannot be moved by the participant
Mid-ground Objects: These objects (e.g. bus stop) can be clicked on and have other objects dragged to them, but cannot be moved by the participant
Foreground Objects: These objects are mostly characters in the street scene. They can be clicked on, dragged to other objects, and have other objects dragged to them

Changing Objects on Screen
After each block (5 trials) the screen objects can be changed
There will always be four background objects or buildings

The number of foreground elements will vary with the stage as follows:

| Stage | Number of Foreground Objects |
|---|---|
| 1 | 4 |
| 2 | 5 |
| 3 | 6 |
| 4 | 7 |
| 5 | 8 |
| 6 | 8 |

Object Sets
Some foreground objects will appear on screen in confusable sets. If a category 2 instruction like, “click on the girl in the red dress,” is presented, the character set containing a girl in a red dress, a girl in a green dress, and a girl in a blue dress must appear on screen. Foreground sets generally have 3 objects.
Some background elements may appear in object sets (e.g. “Joe's Cafe” and “Joe's Ice Cream”). Background sets generally have 2 objects.
Please reference “Listen and Do Art List.doc” for list of art elements.
   Initiation
   Goal of Initiation:

By the end of initiation, it should be clear to the participant that
1. the participant must click the OR button to begin a trial
2. the participant must manipulate objects on the screen as described in the instructions
3. more than one instruction can be presented
4. the participant must use the mouse to drag objects for some instructions
   General Description of Flow, Trials, and Stimuli:

Initiation will begin with the use of single instructions from category 1. There will be fewer objects on screen to manipulate.

[image]

Detailed Description of Initiation Steps:

Step 1:
One block (5 trials):
Stimuli: single instruction randomly chosen from category 1—processing level 1
Screen presentation:
   2 moveable objects on screen.
   visual cues for first trial
   visual cues removed after first correct, resumed after incorrect
Exit criteria:
Pass: 70% correct responses; Go to: Step 2
Fail: two blocks with <70% correct; Go to: Skip/Continue

Step 2:
One block (5 trials):
Stimuli: single instruction randomly chosen from category 2—processing level 1
Screen presentation:
   3 moveable objects on screen.
   visual cues for first trial
   visual cues removed after first correct, resumed after incorrect
Exit criteria:
Pass: 70% correct responses; Go to: Step 3
Fail: <70% correct; Go to: Step 1

Step 3:
One block (5 trials):
Stimuli: single instruction randomly chosen from category 3—processing level 1
Screen presentation:
   2 moveable objects on screen.
   visual cues for first trial
   visual cues removed after first correct, resumed after incorrect
Exit criteria:
Pass: 5 Trials Go to: Exercise
Fail: No failure possible (this may be changed post v0.5)
Skip/Continue:
This screen notifies the participant that they have reached a point in the training where it is necessary to contact their study coordinator and a number is provided.
Two buttons are active on this screen:
   Skip to Next Exercise: Advances the participant to the next exercise in the current session or to the “End of Session” screen, if the current exercise is the last one in the session
   Continue: Returns the player to the step of initiation from which they arrived at this screen

Data Recording:

Data recording for task 1 initiation will be the same as for Task 1, expect that it should be noted the participant was in initiation.

Listen and Do Instruction List

Instruction Types:

Category 1: CLICK (lower complexity):
<“Click on” ><Character> OR <Mid-ground Object> OR <Background Object>
(Characters, mid-ground, and background objects from lower complexity side of table)

Category 2: CLICK (higher complexity):
<“Click on”><Character> OR <Mid-ground Object> OR <Background Object>
(Characters, mid-ground, and background objects from higher complexity side of table)

Category 3: DRAG (lower complexity):
<Move“><Character><“to”><Character> OR <Mid-ground Object> OR <Background Object>
(Characters, mid-ground, and background objects from lower complexity side of table, preposition always “to”)

Category 4: DRAG (higher complexity):
A: <Move“><Character><Preposition><Character> OR <Mid-ground Object> OR <Background Object>
B: <“Move”><Character><“between”><Character> OR <Mid-ground Object> OR <Background Object>“and”<Character> OR <Mid-ground Object> OR <Background Object>
(Characters from higher complexity side of table; prepositions, mid-ground, and background objects from either side of table)
   Stages:

When more than one instruction required, use conjunction between instructions:

<instruction><Conjunction><Instruction><Conjunction><Instruction>

Actions

Click on
Move

Characters

| Lower Complexity | Higher Complexity |
|---|---|
| the mother | the mother in the red dress |
| | the mother in the blue dress |
| | the mother in the yellow dress |
| the boy | the tall boy |
| | the short boy |
| | the boy in the blue shorts |
| | the boy in the green shorts |
| | the boy in the red shorts |
| the Doctor | the tall Doctor |
| | the short Doctor |
| the Police Officer | the tall Police Officer |
| | the short Police Officer |
| the dog | the black dog |
| | the brown dog |
| | the yellow dog |
| the girl | the redheaded girl |
| | the blond girl |
| | the brunette girl |
| | the girl in the pink dress |
| | the girl in the orange dress |
| | the girl in the purple dress |
| | the tall girl |
| | the short girl |
| the construction worker | the man in the white hard hat |
| | the man in the red hard hat |
| | the man in the blue hard hat |
| the postal worker | the tall postal worker |
| | the short postal worker |

Mid-ground Objects

| | |
|---|---|
| the Bus Stop | |
| the hydrant | |
| the trash can | |
| the mail box | |
| the tree | the large tree |
| | the small tree |

Background Objects

| | |
|---|---|
| City Hall | |
| the Library | the Lincoin Library |
| | the Washington Library |
| the School | |
| the Bank | |
| the Hospital | |
| the Barbershop | |
| the Post Office | |
| the store | the Toy Store |
| | the Gift Store |
| the café | Joe's Café |
| | Java Café |
| the bakery | the Sunrise Bakery |
| | the Sunshine Bakery |
| the market | the Farmer's Market |
| | the Fruit Market |
| Eddie's Ice Cream | |

Prepositions

| | |
|---|---|
| to | next to |
| | to the left of |
| | to the right of |
| | between |

Conjunctions

and
then
and then

### Listen and Do Art List

Background: City or town street scene. This background should accommodate four buildings in the background and up to 8 characters in the foreground (see below). Eddie's prototype can be used as a reference. The screen size for the background is 800×275 pixels, but it's constrained at the top by the timer, points display, and dashboard.

Background Objects: These are the buildings in the street scene. All buildings need text labels which can be part of the building design, e.g., on sign of a store or engraved “Bank” in Roman lettering. There will be a maximum of 4 buildings in the background. The exact size of the buildings is flexible. Those in Eddie's prototype range from 120×120 pixels to 150×140 pixels. There should be space between the buildings (40-50 pixels) to accommodate instructions like “move the policeman between the library and the café.”
City Hall
Bank
Library [Lincoln Library, Washington Library]
School
Hospital
Barbershop
Post Office
Store [Toy Store, Gift Store]
Café [Joe's Café, Java Café]
Bakery [Sunrise Bakery, Sunshine Bakery]
Market [Farmer's Market, Fruit Market]
Eddie's Ice Cream

Midground Objects: (These are similar to the buildings in that they can be clicked and foreground objects can be dragged to them, but they cannot be moved. They will appear in front of the buildings, but behind the foreground characters).
Bus Stop
Hydrant
Trash Can
Mail Box
Tree [Large Tree, Small Tree]

Foreground Objects (Characters):

There will be from four to eight foreground objects in a scene depending on the Stage (number of instructions delivered in sequence). The size of the characters is also flexible. It is OK for them to bit a bit oversized compared to the buildings. The should “read” well be easy to identify. The characters in Eddie's prototype range form 40×80 pixels to 100×145 pixels.
Mother (with baby stroller) [Mother in red dress, Mother in blue dress, Mother in yellow dress]
Boy [Boy in blue shorts, Boy in green shorts, Boy in red shorts]
Boy [Tall Boy, Short Boy]
Doctor (male) [Tall Doctor, Short Doctor]
Doctor (female) [Tall Doctor, Short Doctor]
Police Officer (male) [Tall Police Officer, Short Police Officer]
Police Officer (female) [Tall Police Officer, Short Police Officer]
Dog [Black Dog, Brown Dog, Yellow Dog]
Girl [Redheaded Girl, Blond Girl, Brunette Girl]
Girl [Girl in pink dress, Girl in orange dress, girl in purple dress]
Girl [Short Girl, Tall Girl]
Construction Worker [Man in white hard hat, Man in red hard hat, Man in blue hard hat]
Postal Worker (with U.S. Mail Bag) [Tall Postal Worker, Short Postal Worker]

### Appendix F: Exercise 6: Story Teller

Description of Target Neurological Deficit:

We believe that the degraded representational fidelity of the auditory system in older adults causes an additional difficulty in the ability of older adults to store and use information in auditory working memory. This deficit manifests itself behaviorally in the participant's poor ability to remember verbally presented information.

Goal of the Exercise:

Exercise 6 has two goals:
1) To expose the auditory system to a substantial amount of speech that has been processed to emphasize and stretch the rapid frequency transitions
2) To drive improvements in speech comprehension and working memory by requiring participants to store and recall verbally presented information

This can be done efficiently using a story recall task, in which the participant must store relevant facts from a verbally presented story and then recall them later. In this task, the participant is presented with auditory stories of increasing length (e.g., number of details in the story) and complexity (e.g., types of details in the story). Following the presentation, the participant must answer specific questions about the content of the story.

General Description of Task:

The task requires the participant to listen to an auditory story segment, and then recall specific details of the story. Following the presentation of a story segment, the participant is asked five questions about the factual content of the story. The participant responds by clicking on response buttons featuring either pictures or words. For example, if the story segment refers to a boy in a blue hat, a question might be: “What color is the boy's hat?” and each response button might feature a boy in a different color hat or words for different colors. The task is made more difficult by 1) increasing the number of story segments heard before responding to questions 2) making the stories more complex (e.g., longer, more key items, more complex descriptive elements, and increased grammatical complexity) and 3) manipulating the level of speech processing of the stories and questions.

Blocks and Trials:

Trial in Story Teller: A trial is equivalent to a click on a response button, which is evaluated for correct or incorrect.

Block in Phonic Story Teller: A block is everything that occurs between each click of the OR button: The presentation of one or more story segments, the presentation of five questions for each segment, and the participant's responses to these questions. There are a minimum of five trials in a block. Each block is evaluated for progression.

Block description:

1. OR button click: block begins with the participant providing an observing response to indicate they are attentive and ready to perform the task.
2. Pre-Stimulus delay: (800-1200 ms)
3. Story segment presentation: one or more story segments are presented aurally.
4. The following is repeated 5 times for each segment presented:
   Pre-OR delay (300-700 ms)
   OR button click
   Pre-Stimulus Delay: (800-1200 ms)
   A question is presented and response buttons appear
   Participant clicks on a response button
   Pre-reward delay (100-500 ms)
   Correctness feedback: A “ding” or “thunk” indicates whether the trial was correct or incorrect
   Points awarded (correct response only): TBD
   Pre-animation delay: (0-200 ms)
   Pop-up reward (first 9 trials only—on correct response) until a maximum of 9 pop-ups are present on screen
5. Pre-OR delay
   Stimuli:

Stories:

There are five stories, each in 20 story segments from 20-30 seconds long. The five stories are progressively more complex (story 2 is more complex than story 1, story 3 is more complex than story 2, etc.). Complexity is governed by:
Length of sentences.
Number of key elements.
Complexity of key elements (e.g., “red hat” vs. “a black top-hat with and ermine rim worn at a jaunty angle”).
Narrative relevance of key elements (e.g., key element is main element of plot vs. key element is background item).
Grammatical complexity (e.g., simple noun verb sentence structure vs. nested clauses, number of clauses, etc.).

Questions:

There are five questions for each story segment. The questions will be presented in a random order

Response Buttons:

For each set of 5 questions, 3 questions will have text response buttons and 2 will have picture response buttons. The responses are presented in a random order. There are four response buttons for each text response question and three (v0.5) response buttons for each picture response question.

Processing Levels:

Each story and associated questions are at a different levels of speech processing, ranging from level 1 (highly processed) to level 5 (unprocessed natural speech). In other words, each story will only have one level of speech processing and all five will be at different levels. The order of the stories is as follows:
The Obstacle Course (Level 1)
5-Ton Cake (Level 2)
Urban Jungle (Level 3)
Dahlias (Level 4)
The Spot (Level 5)
   Title & End Screens

A title screen is displayed in the reward space at the start of each story. It is displayed during the first segment and remains until it is replaced by the first 10-Pack pop-up after a correct response. An end screen is displayed after the final block of a story is evaluated. If a benchmark animation is triggered, the end screen is displayed after the animation.

Moving through the Task:

An Orientation to Main Task Flow:

Participants listen to a story segment and then respond to five questions about that segment. If they do poorly, they will hear the same segment and associated questions again. If they do fairly well, they will hear the next segment and its questions. If they do very well, they will hear the next two segments together and answer all 10 associated questions. If they continue to do very well, a third segment is added. A maximum of four segments can be heard at once.

Progression through Blocks:
After completing a block with <=40% correct (poor performance):
   IF that block contained only one story segment, the participant will hear that story segment repeated and will answer the same set of questions again. Any incorrect response buttons chosen in the previous block will be de-activated and cannot be chosen again. This will ensure a correct response after a limited number of repetitions. A deactivated button will remain deactivated across sessions.
   IF that block contained more than one story segments, the last story segment would be removed and the remaining segments would be repeated. As above, any incorrect response buttons would be deactivated.
After completing a block with >40% and <80% correct, the participant would advance to the next story segment or segments (in the same number as the previous block) and answer the associated questions.
After completing a block with >=80% correct, provided none of the questions in that block have been previously presented, the participant would advance to the next story segment or segments (in the same number as the previous block) and an additional segment would be added. The participant would then answer all of the questions associated with each segment. The maximum number of story segments in a block is four.
NOTE: If one or more of the questions have been previously presented and the block is completed with >=80%, the participant would advance to the next story segment or segments (in the same number as the previous block).
The above progress tracking is maintained across sessions.

Entry Criteria:
Initiation passed.

Movement within Story Teller:

Choosing a Processing Level and Stage:

The first time in:
The participant begins with the first story at processing level 1 (most highly processed speech)

Beginning subsequent sessions:
The participant resumes at the story segment and processing level where they left off. If a story segment(s) was presented in the previous session, but not all questions were answered before the exercise timed out, the segment(s) are repeated and the unanswered questions are presented. Questions related to these segments answered in the previous session will not be repeated.

Advancing to the next processing level:
All story segments in a given processing level have been heard and all questions in the final segment have been answered with >40% correct.
The number of sequential segments is reset to 1
NOTE: retreat to earlier processing levels (stories) is not possible

Closing out Story Teller:
Criteria have been met for advancing from processing level 5

After Closing out Story Teller:
After closing out Story Teller, the exercise will terminate

Data Recording:

Data Recording—Trial by Trial Data

In general, all relevant data describing the stimulus and the response should be recorded to allow subsequent analysis to completely reconstruct the trial

The following data should be recorded for each trial:
1. the stimulus: the processing level, the story segment, the question
2. the response: the identity of participant response, and the evaluation of the trial (“correct”, “incorrect”or “timeout”)
   Story Teller Initiation

Stimuli:

The stimuli includes the first segment of the first story along with the associated five questions and responses.

Trail Presentation:

Following the participant's OR click, the story segment is presented and then the OR button appears again. After the participant clicks the OR, the first question is presented and four response buttons appear. There is a visual cue indicating which button is the correct response. After the first trial, if there is an incorrect response, visual cues are given again until there is a correct response.

Evaluating the Initiation Block:

After the five questions have been answered:
IF >40% of the responses are correct, the participant leaves initiation and the second story segment is presented.
IF <=40% of the responses are correct, the segment and questions are repeated. Any incorrect response buttons chosen in the previous block will be de-activated and cannot be chosen again. This will ensure a correct response after a limited number of repetitions.

Falling Back to Initiation:

There is no way to fall back into initiation in Story Teller.

### Appendix G Hi Fi Cross-exercise Spec

Standard Exercise Features:

Interface Elements:

Main Screen Buttons:
OR button:
   Responds to mouseDown
   Displayed after pre-OR delay
   Removed following the participants observation response
Response buttons:
   Respond to mouseDown
   Displayed after pre-stimulus delay. (In High or Low? and Sound Replay response buttons are displayed AFTER the stimulus sequence is given. In Tell Us Apart and Story Teller response buttons are displayed and active at the beginning of the stimulus presentation)
   Remain on screen until the end of the “thunk” or points “ding” and removed during rewards (except for in Story Teller where they remain on screen during the reward).
   Replaced by the OR button
User Interface Bar:
   On screen and active at all times with the following buttons:
      1. Volume: opens Volume Screen
      2. Pause: opens Pause Screen
      3. Guide: opens Guide Screen
   These buttons respond to mouseUp
   Exercise time is paused while any of the above screens are open
   If the OR is present when any of these buttons are clicked, returning from the associated screen brings the player back to the OR with the same trial cued.
   If the response buttons are present when any of these buttons are clicked, returning from the associated screen brings the player back to the OR with current trial (or block for Tell Us Apart) evaluated as “time_out” which counts as an incorrect response.
   If an animation is playing when any of these buttons are clicked, the animation is paused and returning from the associated screen brings the player back to the animation in progress.
   EXCEPTIONS to the above include clicking on one of these buttons during the presentation of a story segment in Story Teller. In this case the story is paused and then resumed when returning to the exercise. In Match It! any “activated” or “visited” buttons return to their normal state.
Timer and points display:
   Timer: elapsed time from total exercise time
   Points: points for current session (four digits)
Button States:

Below are the required button states for each exercise:

| | | | | |
|---|---|---|---|---|
| Exercise | Idle | Rollover | Down* | Inactive** |

OR Button

| | | | | |
|---|---|---|---|---|
| All Exercises | Yes | Yes | Yes | No |

Response Buttons:

| High or Low? | Yes | Yes | Yes | No |
|---|---|---|---|---|
| Tell Us Apart | Yes | Yes | Yes | No |
| Match It! | Yes | Yes | Replaced with | NA |
| | | | Activated | |
| | | | State | |
| Sound Replay | Yes | Yes | Yes | No |
| Listen and Do | NA | NA | NA | NA |
| Story Teller | Yes | Yes | Yes | No |
| *Down State: The down state is behaving with slight variations in each exercise. We will standardize the down state (post v0.5?) to be displayed with a short delay (most likely handled as a button animation) that does not interfere with the participants next response (e.g., in High or Low? if the stimulus is two sequential up sweeps the down state of the first click on the up button will not interfere with the second click on the same button to complete the response). The OR | | | | |
| # will also use this type of down state. | | | | |

**Inactive State: Instead of using an inactive state the buttons will be only be present when active. The buttons are active only after the stimulus presentation is complete in High or Low? and Sound Replay, they are active at the start of the stimuli presentation in Tell Us Apart and Story Teller. They are never present during the pre-stimulus delay. They are removed following the ding and points, but before the animated rewards.

Keyboard shortcuts:
OR button: space bar or up arrow
Response buttons: varies with the number of response buttons on screen; can only be used in exercises with 3 or less response buttons
   1 response button: down arrow
   2 response buttons: left arrow for left button; right arrow for right button
   3 response buttons: left arrow for left button; down arrow for middle button; right arrow for right button
   Pause button: return or enter (both number pad and keyboard)
      Flow:

This diagram shows the events occurring between one observation response (OR button click) and the next. It is meant to show a generic flow of events and each exercise will have it's own variation.

[image]

Trial-related Features:

Limit to Number of Identical Stimuli:

In exercises that use a series of randomized stimuli, the same stimuli in the same order cannot be presented more than 3 times.

Trial is Evaluated as Incorrect After First Incorrect Response:

Trials that require multiple responses will be evaluated as incorrect after the first incorrect response and ended. For example, in High or Low?, if the first response to a 2-sweep sequence does not correspond to the first stimulus, the trial is evaluated as incorrect and no second response can be given.

Saving Trial Data and User Data:

Trial data write out not implemented in v0.5

XML data and preferences should be written out after every 10 trials in an exercise to minimize the amount of data lost due to computer crashes. Both trial data and user data files should be written out at the same time so there is no discrepancy between them.

Rewards:

No Rewards will be given on an incorrect response. A “thunk” sound will play.

Points-related Rewards (please refer to “Points.doc”):
Points: number of points awarded for each correct trial will increase as the stimuli become more difficult. A “ding” sound plays as points are awarded.
Bonus points: extra points awarded after specified number of correct trials.
Bonus point animation: animation occurring while bonus points are given (deferred from v0.5)

Animated Rewards (please refer to “RewardAnimations.doc”):
10-PACK ANIMATIONS:
10-Pack Pop-up: a short animation given after a correct response; generally 9 pop-ups are given before the larger 10-Pack bonus animation
10-Pack Bonus Animation: a larger animation than the pop-ups that ends the ten-pack series of animations
Variable schedule: (REMOVED FROM v0.5 s3b) at random intervals, the 10-Pack Bonus animation will be given and the 9^{th} pop-up eliminated or the 10-Pack Bonus animation will be delayed until the 11^{th} correct trial
BENCHMARK ANIMATIONS:

Advancement-based: an animation that occurs with a major advancement (specifics vary for each exercise)
Accuracy-based: an animation given after a streak of sequential correct responses Removed in v0.5 s3b
Random: variable ration animation (4% chance of playing after correct response) Removed in v0.5 s2b
MINI-SERIES ANIMATIONS:
   longer animations that play in order (but not sequentially) to tell a story
   each theme has a unique mini-series animation set
   each mini-series animation has three alternate endings
   fill in for a benchmark animation if a benchmark trigger coincides with the time schedule for a mini-series animation

Reward Sequence:

Rewards will play in the following sequence:

Pre-reward delay (100-500 ms)—“Ding” Sound AND Points—Bonus Points—Pre-animation delay (0-200 ms)—10-pack pop-up OR 10-pack bonus—Benchmark Animation (with concurrent text).

Time-related Features:

OR Window: (60 Seconds)

A window of time during which the participant must click the OR button. If this window of time has elapsed, the program enters the paused state.

COACH:

| Trigger | Script | N or I | Audio # |
|---|---|---|---|
| 40 seconds into the | Click the START button. | N | TimeOut_01 |
| OR window (when 20 | Otherwise, the program | | |
| seconds remain) | will pause in 20 seconds. | | |

Response Window: (60 Seconds)

A window of time given for the participant to respond. This window is reset after each response in a series of responses. If the response window has elapsed, the trial (or block in Tell Us Apart) is terminated and evaluated as “timed_out” and treated as an incorrect trial for progression. No incorrect feedback is given and the program enters the paused state. Clicking the Pause button will have the same effect as an elapsed response window. When the participant returns to the exercise from the pause screen the OR is present and the next trial (or block for Tell Us Apart) is cued.

COACH:

| Trigger | Script | N or I | Audio # |
|---|---|---|---|
| 40 seconds into the | Keep going. Otherwise, | N | TimeOut_02 |
| OR window (when 20 | the program will pause | | |
| seconds remain) | in 20 seconds. | | |

Paused State:

The exercise is suspended and exercise time is not decremented. The Pause Screen is displayed. The paused state is entered by clicking the pause button in the UI bar (or equivalent keyboard shortcut) or through participant inactivity (elapsed OR window or response window).

Audio Prompt:

If ⅔ (40 seconds) of the OR window or response window has elapsed, an audio prompt will be given by the Coach.

Delays that Introduce “Jitter”:

These delays will vary the timing of events and make the exercises slightly less predictable. Delays will be chosen at random from a range of milliseconds.
Pre-OR delay (100-300 ms):
This does not occur on the first trial. It is the time delay after all rewards have been given, but before the OR button reappears. The time delay is chosen randomly from the range of times above.
Pre-stimulus delay (400-600 ms):
Time delay after OR button is clicked, but before stimulus is given. For a specific stimulus, the time delay is chosen randomly from the range of times above.
Pre-reward delay (0-200 ms):
Time delay after trial has been evaluated and before auditory feedback for correctness (“ding”), points, and bonus points are given. The time delay is chosen randomly from the range of times above.
Pre-animation delay (0-200 ms):
Time delay after the auditory feedback for correctness, points, and bonus point are given and before and any reward animations that follow. The time delay is chosen randomly from the range of times above.

Exercise Time-out:

Each exercise will be assigned a specific number of minutes, the exercise time. When this time has expired the exercise is terminated and the participant is brought to the end of exercise screen as described below:

If the OR is present or the exercise is Match It!, the exercise ends immediately when the exercise time expires.

If the response buttons are present, the exercise terminates after the players response to the trial is complete (and any associated rewards have been presented) or after the response window ends, whichever comes first.

Post v05 we may adjust this on an exercise by exercise basis to prevent things like a Story Teller question being presented when there is no time to respond or terminating Match It! when there is only one match left in a large grid.

Terms and Definitions:

Exercise Structure:

Session:

A session begins when the first exercise is entered and ends when exiting the last exercise. It may be possible to have multiple sessions in a single calendar day.

Task:

A fundamental subdivision of the exercise with it's own stimulus presentation and progression rules.
Main Task: The portion of the exercise where the participant spend most of their time. Progression through the exercise is determined by performance in the Main Task.
Bonus Task: REMOVED FROM v0.5 s3a. A more challenging portion of the exercise entered at the end of the session, after the Main Task, and when a participant shows proficiency at the Main Task. The stimuli in this task are based on the participant's performance in the Main Task. Performance in the Bonus Task has no influence on the participant's progression through the exercise.

Initiation:

A sequence of preliminary trials designed to introduce the participant to a Task within an Exercise. It may be possible to drop down into initiation for remedial instruction after the main task has been entered.

Entry Criteria:

Conditions that must be met before starting a Task within an Exercise.

Warm-up:

The warm-up is a series of simpler trials given at the very beginning of a session in some of the exercises. The warm-ups re-orient the participant to the Main Task.

Trial:

The smallest stimulus and response grouping that can be evaluated for progression. For example, in High or Low? Task 1, two stimuli are given and 1 to 2 responses are evaluated to determine if the trial was correct or incorrect. In Tell Us Apart, on the other hand, each stimulus/response pair is individually evaluated and therefore considered a trial.

Trial Evaluation:

A trial may be:
correct—the correct response was chosen
incorrect—a response was chosen, but not the correct one
time_out—no response was chosen before the response window was exhausted or the pause button was clicked

Response:

A single selection representing a single stimulus.

Block:

A group of trials evaluated for progression in some exercises. Tell Us Apart has 10-trial blocks, Listen and Do has 5-trial blocks, and Story Teller blocks range from 5 to 20 trials.

Category:

A group of stimuli sharing predetermined characteristics. This group has significance for progression to other categories or tasks within the exercise. Generally categories can be closed (and never seen again).

Category States:
open (replaces “untested”)
   active: a subgroup of open categories used in the current session)—used in Tell Us Apart
   inactive: a subgroup of open categories held in reserve, but not used in the current session)—used in Tell Us Apart
closed (replaces “completed”; can be reopened only under special circumstances)
failed (may be subsequently opened depending on participant performance)—used in Sound Replay

Processing Level:

A measure of the processing stimuli receive; there are 5 speech processing levels with level 5 being the most processed, and level 1 being normal speech

Stage:

Meaningful for progression between trials of lesser or greater difficulty (typically within a category). Difficulty increases with higher numbered stages.

ISI:

Inter-stimulus interval. The shorter the ISI, the more difficult the trial. The ISI shrinks and expands based on the participant's performance (generally associated with the stage).

Adaptive Tracking:

The means used by each exercise to adapt to the participant's performance. Generally changes are made to the stimulus in order to increase or decrease the difficulty of trials.

Progression:

The following are used to track correct and incorrect trials to determine progression through the exercise. A combination of several may be working at the same time to determine when a participant advances to greater difficulty or retreats to simpler trials.

Steady_state_tally:

Typically this is used to track sequential correct or incorrect trials (High or Low? Task 1 initiation, for example).

Trial_tally:

At it's most basic, the trial tally counts the number of trials taken. However, it may be used to count the number of incorrect or correct trials (not necessarily sequential).

Percent_correct:

Stores the number of correct trials and the number of trials taken so a percent correct can be calculated.

Serial_reversal (Sound Replay, Match It!, Listen and Do):

Serial_reversal tallys the number of times there is a series of advancements and retreats with no repetition of movement in the same direction. Distinct from a High or Low? reversal (see below), a reversal in this case is an advancement and retreat between the same two stages (Stage 2-Stage 3-Stage 2). Moving up a stage, down a stage, up a stage, and then back down a stage counts as two 2 serial reversals. As soon as a movement is repeated in the same direction (moving up a stage again), the tally is reset. (3->2->3->2->3->2 is 3 serial reversals; 3->2->3->4 is 0 serial reversals—tally was reset).

3 Up_{—}1 Down (High or Low?):

Three consecutive correct trials equals advancement. One incorrect equals retreat.

Tracking_toggle (High or Low?):

The tracking toggle prevents the participant from drifting too far from threshold through inattention. The tracking toggle is coupled with 3 up_{—}1 down (used in High or Low?). If a participant's responses cause 5 consecutive drops in stage (ISI in High or Low?), the participant pops into Task Initiation. The current stage (ISI in High or Low?) is recorded. When the participant passes initiation, they re-enter the task at the same category (duration or duration/frequency offset in High or Low?) and all re-entry rules apply (a drop in difficulty from recorded stage).

High or Low?_reversal (High or Low?):

Different from serial reversals, a High or Low? reversal is defined as a “change in direction”. For example, three correct consecutive correct trials moves the participant shorten the ISI (increase difficulty). A single incorrect lengthens the ISI (decreases difficulty). The drop to a longer ISI is counted as one reversal. If the participant continues to decrease difficulty (does not respond correctly to 3 consecutive trials), these drops do not count as reversals. A “change in direction” due to 3 consecutive correct responses (difficulty increases) counts as a second reversal. The tally is NOT reset by movement in the same direction.

### Appendix G HiFi Stimulus Generation

This document includes the following sections:

| | |
|---|---|
| Links | 1 |
| General Specifications | 2 |
| High or Low (Exercise 1) | 2 |
| Sweep Stimuli | 2 |
| Generating Sweeps | 2 |
| Burst Stimuli | 3 |
| Generating Bursts | 3 |
| Tell Us Apart (Exercise 2) | 4 |
| Phoneme contrasts (categories) | 4 |
| Sound Generation | 4 |
| Phoneme Spec Files | 5 |
| Emphasis levels (14 stages) | 6 |
| Match It! (Exercise 3) | 6 |
| Processing Levels | 6 |
| Stages | 6 |
| Categories | 7 |
| Sound Replay (Exercise 4) | 8 |
| Processing Levels | 8 |
| Stages | 8 |
| Categories | 8 |
| Listen & Do (Exercise 5) | 9 |
| Processing Levels | 9 |
| Stages | 9 |
| Categories | 10 |
| Story Teller (Exercise 6) | 10 |
| Stories | 10 |
| Story Complexity | 11 |
| Questions | 11 |
| Response Buttons | 11 |
| Processing Levels | 11 |
| Title & End Screens | 11 |

Links
Description of the Story Teller Stories° Creation HiFi Stimulus Story Teller Stories Story Teller Scripts:
The Obstacle Course HiFi Stimulus Story Teller Obstacle Course
5-Ton Cake HiFi Stimulus Story Teller 5 Ton Cake
Urban Jungle HiFi Stimulus Story Teller Urban Jungle
Dahlias HiFi Stimulus Story Teller Dahlias
The Spot HiFi Stimulus Story Teller The Spot
   General Specifications

All sound stimuli in the HiFi exercises have the following parameters:
sampling rate of 22,050 samples per second (up to the Nyquist limit)
recorded in mono
16 bit dynamic range
normalized at 0.95 of the dynamic range
   High or Low (Exercise 1)

Stimuli consist of upward and downward frequency modulated (FM) sweeps characterized by their base frequency (the lowest frequency in the FM sweep) and their duration. In the exercise, a pair of FM sweeps is presented separated by an inter-stimulus interval (ISI).

Sweep Stimuli

The other characteristic defining an FM sweep:
The sweep rate is held constant at 16 octaves per second throughout the task. This rate was chosen to match the average FM sweep rate of formants in speech (for example, ba/da).
The upward sweep begins at the base frequency; the downward sweep ends at the base frequency.
Upward and downward sweeps for each base frequency and at each duration are generated using a speech synthesizer as described below.
Sweep pairs are selected programmatically according to the progression schedule.
The ISI are generated programmatically also according to the progression schedule.
   Generating Sweeps

The sweeps are created according to the following formula:
f(t)=f0*2(16*t)
f0=base frequency
t=seconds
t≠0

Example:
fᵢ=f₀
f_{f}=f₀*2⁽16*duration)

Upward sweep:
fi->ff

Downward sweep:
ff->fi

There are three base frequencies:

| Base Frequency Index | Base Frequency |
|---|---|
| 1 | 500 Hz |
| 2 | 1000 Hz |
| 3 | 2000 Hz |

There are five durations:

| Duration Index | Duration |
|---|---|
| 1 | 80 ms |
| 2 | 60 ms |
| 3 | 40 ms |
| 4 | 35 ms |
| 5 | 30 ms |

Burst Stimuli

Stimuli consist of pairs of structured noise bursts, characterized by their base frequency (the center frequency between the pair), their frequency offset (the frequency distance from the base frequency to the peak envelope frequency of each burst), their duration, and their ISI. Other variables defining the structured noise burst (i.e., envelope shape, harmonic structure) are held constant throughout the task.

There are three base frequencies (500 Hz, 1000 Hz, 2000 Hz), identical to those in task 1 (FM sweep time order judgment).

Frequency offset and duration are co-varied with 5 variations:

| Frequency Offset/ | | |
|---|---|---|
| Duration Index | Frequency Offset | Duration |
| 1 | 250 Hz | 300 ms |
| 2 | 200 Hz | 250 ms |
| 3 | 150 Hz | 200 ms |
| 4 | 100 Hz | 150 ms |
| 5 | 50 Hz | 100 ms |

Generating Bursts

Bursts are single formant structured noise stimuli. They are created by filtering noise stimuli with bandpass filters. The two bursts that must be distinguished differ in their center frequency according to the following formula. The formula used to create the bursts is as follows:
f_highFrequency=f_baseFrequency+f_baseFrequency*multiplier

High burst:
f_highFrequency

Low burst:
f_baseFrequency

| Index | Multiplier |
|---|---|
| 1 | 0.5 |
| 2 | 0.4 |
| 3 | 0.3 |
| 4 | 0.2 |
| 5 | 0.1 |

Tell Us Apart (Exercise 2)
Phoneme Contrasts (Categories)

Users are trained on two types of phoneme contrasts:

The Class A phonemes (the b/d/g continuum) are covered semi-exhaustively across vowel contexts because perceptual training of this discrimination does not generalize well across vowel contexts.

The Class B phonemes, the phoneme class in which the key emphasis is timing, are not exhaustively trained across vowel contexts because perceptual training is known to generalize adequately.

| | Contrast | | |
|---|---|---|---|
| | (Category) | | |
| Phoneme Class | Index | Syllable 1 | Syllable 2 |
| Class A | 1 | Ba(e) | Da(e) |
| | 2 | Bo | Do |
| | 3 | Bi | Di |
| | 4 | Da | Ga |
| | 5 | Diy | Giy |
| | 6 | Du | Gu |
| Class B | 7 | Ba(e) | Pa(e) |
| | 8 | Do | To |
| | 9 | Gi | Ki |
| | 10 | Sa | Sta |
| | 11 | She | Che |

Sound Generation

Syllable generation: The syllables in Tell Us Apart are synthetically generated using CV Gen Stim, a speech synthesizer developed by Athanassios Protopapas. Emphasis is added to the phonemes differently depending on whether they are differentiated by formant transitions or timing transitions.

Note: The generated sounds recreate the formant characteristics of the phonemes for which we are training the ear, but do not have all the characteristics of natural speech. For this reason the sounds may not be recognizable speech.

Phoneme Spec Files

Protopapas' program generates synthesized speech by reading in files specifying the parameters of the various syllables. (These speech generation files are called Klatt's formant files after Dennis Klatt who developed MiTalk, a research system that converted ordinary printed text into intelligible synthesized speech.) The examples below are Klatt's formant files for the syllable /bi/. The first example is the syllable /bi/ with no lengthening (stretching) added; the second with the highest level of lengthening.

Klatt's files specify the frequency of each formant at the beginning and end of a segment, for example, the first formant in the first segment (200 msec-209.6 msec) begins at 200 Hz and ends at 300 Hz, the second begins at 300 Hz and ends at 310 Hz, and so on. The pitch determines the pitch period (1/pitch) within which stretching may be added. Finally, the amplitude is 85 dB.

NOTE: Because of a glitch in the program, emphasis (change in amplitude) is added later, including ascending and descending ramps (on and off) to make the transition sound more natural.

In the files below, notice that as the consonant is stretched, the vowel shortens, for example, the consonant to vowel ratio in the first example is 36:161 while the ratio in the second example is 92:107. Note that the total time doesn't change. Syllable recognition improves when the ratio between the consonant and vowel is changed in favor of the consonant.

### EXAMPLES

| Bi - no lengthening added | | | | | | Bi - highest lengthening | | | | | |
|---|---|---|---|---|---|---|---|---|---|---|---|
| 3 | 5 | | | | | 3 | 5 | | | | |
| 200.0 | 105 | 85 | 200 | 1100 | 2150 | 200.0 | 105 | 85 | 200 | 1100 | 2150 |
| 209.6 | 110 | 85 | 300 | 1600 | 2450 | 238.5 | 110 | 85 | 300 | 1600 | 2450 |
| 218.8 | 120 | 85 | 310 | 1880 | 2800 | 275.3 | 120 | 85 | 310 | 1880 | 2800 |
| 235.6 | 120 | 85 | 310 | 2020 | 2990 | 292.2 | 120 | 85 | 310 | 2020 | 2990 |
| 286.2 | 120 | 85 | 310 | 2020 | 2990 | 325.9 | 120 | 85 | 310 | 2020 | 2990 |
| 396.9 | 100 | 85 | 290 | 2070 | 3000 | 399.7 | 100 | 85 | 290 | 2070 | 3000 |

NOTE:
These Klatt's formant files are found in: Neuroscience/Assets/auditory/application/phonic_id/task_1/bi/BBIYO and BBIY13

Format:

number of formants; number of segments

time (msec); pitch (Hz); amplitude (dB); first formant freq (Hz); 2^{nd} formant freq (Hz); 3^{rd} formant freq (Hz)

Class A phonemes: The b/d/g continuum of phonemes is reliably differentiated (that is across accents and vocal ranges) by the sweep of their formants. Emphasis is added by lengthening and amplifying the sweep aspect of both consonants equally. Because the formant is a reliable cue for differentiating these phonemes, the ear is trained to distinguish them by exaggerating this difference only.

Class B phonemes: For the phonemes distinguished by a timing element, the first syllable is not emphasized and the second is emphasized based on the timing element.

For example, the voice onset time (VOT) is emphasized or the aspiration is lengthened depending on the pair.

In the first three voiced pairs, the second syllables /pa(e)/, /to/ and /ki/, are emphasized by lengthening the voice onset time (VOT), the time between when the voiced vowel appears and the consonant.

In the fourth pair, /sta/ is distinguishable from /sa/ by the stop gap between the /s/ and the /a/. Emphasis is added to /sta/ by increasing the gap between the /s/ and the /a/.

In the fifth pair, /che/ is distinguished from /she/ by the abrupt onset produced by erasing part of the /sh/ sound. Emphasis is added by erasing more from the /sh/ to create and more abrupt (and easily distinguishable) /ch/ sound.

Emphasis Levels (14 Stages)

Both stimuli of each contrast pair are synthesized at 14 emphasis levels. These emphasis levels correspond to stages. At the lowest stage (easiest), the stimuli receive the greatest emphasis. At the highest stage (most difficult), the stimuli receive no emphasis (for example, the task is to discriminate un-emphasized stimuli).

NOTE: The difficulty of different levels is currently being tested. It's not necessarily true most processed are easiest to understand.

It! (Exercise 3)

Processing Levels

Each stimulus is available at 5 levels of speech processing, ranging from level 1 (highly processed) to level 5 (faster than natural speech) according to the table below. The sounds are all pre-recorded in studio and pre-rendered.

| | Length Compared | |
|---|---|---|
| Processing Level | to Natural Speech | Emphasis Added |
| 1 | 1.5 (slower) | 20 |
| 2 | 1.5 (slower) | 20 |
| 3 | 1.0 (same) | 10 |
| 4 | 0.75 (faster) | 10 |
| 5 | 0.75 (faster) | None |

Stages

There 4 task stages, each associated with a specific number of response buttons in the trial and a maximum number of response clicks allowed:

| | Number of | |
|---|---|---|
| | Response | Maximum Number of |
| Stage | Buttons | Clicks (max clicks) |
| 1 | 8 (4 pairs) | 20 |
| 2 | 16 (8 pairs) | 60 |
| 3 | 24 (12 pairs) | 120 |
| 4 | 30 (15 pairs) | 150 |

NOTE: Athanassios Protopapas suggested higher maximum clicks for stages three and four, but they were never modified.
Categories

The stimuli are identical to those used in Exercise 4 (Phonic Streams) and consist of consonant-vowel-consonant syllables or single phonemes:

| Category 1 | Category 2 | Category 3 | Category 4 | Category 5 |
|---|---|---|---|---|
| baa | fig | big | buck | back |
| do | rib | bit | bud | bag |
| gi | sit | dig | but | bat |
| pu | kiss | dip | cub | cab |
| te | bill | kick | cut | cab |
| ka | dish | kid | duck | cat |
| laa | nut | kit | dug | gap |
| ro | chuck | pick | pug | pack |
| sa | rug | pig | pup | pat |
| stu | dust | pit | tub | tack |
| ze | pun | tick | tuck | tag |
| sho | gum | tip | tug | tap |
| chi | bash | bid | bug | gab |
| vaa | can | did | cud | gag |
| fo | gash | pip | puck | bad |
| ma | mat | gib | dud | tab |
| nu | lab | tig | gut | tad |
| the | nag | gig | guck | pad |

Category 1 consists of easily discriminable consonant-vowel (CV) pairs. Leading consonants are chosen from those used in exercise 2 and trailing vowels are chosen to make confusable leading consonants as easy to discriminate as possible.

Category 2 consists of easily discriminable CVC syllables. Stop, fricative, and nasal consonants are used, and consonants and vowels are placed to minimize the number of confusable CVC pairs.

Categories 3, 4, and 5 consist of difficult to discriminate CVC syllables. All consonants are stop consonants, and consonants and vowels are placed to maximize the number of confusable CVC syllables (for example, cab/cap).

Sound Replay (Exercise 4)

Processing Levels

Each stimulus is available at 5 levels of speech processing, ranging from level 1 (highly processed) to level 5 (faster than natural speech) according to the table below. The sounds are all pre-recorded in studio and pre-rendered.

| | Length Compared | Emphasis |
|---|---|---|
| Processing Level | to Natural Speech | Added |
| 1 | 1.5 (slower) | 20 |
| 2 | 1.5 (slower) | 20 |
| 3 | 1.0 (same) | 10 |
| 4 | 0.75 (faster) | 10 |
| 5 | 0.75 (faster) | None |

Stages

There are 8 task stages, each associated with a specific number of syllables in the sequence, a specific sequence length, an ISI, and a specific number of response buttons in the trial (including the number of distracters). See HiFi Sound Replay Functional Specification, HiFi v0.6 SoundReplay spec, for details.

Categories

The stimuli are identical to those used in Exercise 3 (Phonic Match) and consist of consonant-vowel-consonant syllables or single phonemes:

| Category 1 | Category 2 | Category 3 | Category 4 | Category 5 |
|---|---|---|---|---|
| baa | fig | big | buck | back |
| do | rib | bit | bud | bag |
| gi | sit | dig | but | bat |
| pu | kiss | dip | cup | cab |
| te | bill | kick | cut | cap |
| ka | dish | kid | duck | cat |
| laa | nut | kit | dug | gap |
| ro | chuck | pick | pug | pack |
| sa | rug | pig | pup | pat |
| stu | dust | pit | tub | tack |
| ze | pun | tick | tuck | tag |
| sho | gum | Tip | tug | tap |
| chi | bash | bid | bug | gab |
| vaa | can | did | cud | gag |
| fo | gash | pip | puck | bad |
| ma | mat | gib | dud | tab |
| nu | lab | Tig | gut | tad |
| the | nag | gig | guck | pad |

Category 1 consists of easily discriminable CV pairs. Leading consonants are chosen from those used in exercise 2 and trailing vowels are chosen to make confusable leading consonants as easy to discriminate as possible.

Category 2 consists of easily discriminable CVC syllables. Stop, fricative, and nasal consonants are used, and consonants and vowels are placed to minimize the number of confusable CVC pairs.

Categories 3, 4, and 5 consist of difficult to discriminate CVC syllables. All consonants are stop consonants, and consonants and vowels are placed to maximize the number of confusable CVC syllables (for example, cab/cap).

Listen & Do (Exercise 5)

Processing Levels

Each stimulus is available at 5 levels of speech processing, ranging from level 1 (highly processed) to level 5 (faster than natural speech) according to the table below. The sounds are all pre-recorded in studio and pre-rendered.

| | Length Compared | Emphasis |
|---|---|---|
| Processing Level | to Natural Speech | Added |
| 1 | 1.5 (slower) | 20 |
| 2 | 1.5 (slower) | 20 |
| 3 | 1.0 (same) | 10 |
| 4 | 0.75 (faster) | 10 |
| 5 | 0.75 (faster) | None |

Stages

There are 6 stages, each associated with a specific number of instructions in the trial.

| Stage | Number of Instructions |
|---|---|
| 1 | 1 |
| 2 | 2 |
| 3 | 3 |
| 4 | 4 |
| 5 | 5 |
| 6 | 6 |

Categories

There are four categories of instructions. Each category contains a distinct type of instruction. Categories 1 & 2 are “Click” instructions and categories 3 & 4 are “Drag” instructions.

| Category 1 | Category 2 | Category 3 | Category 4 |
|---|---|---|---|
| Click | | Drag | |
| Lower Complexity | Higher Complexity | Lower Complexity | Higher Complexity |
| Click-Object | Click-Adjective-Object | Drag-Object-to-Indirect | Drag-Adjective-Object- |
| | | Object | Preposition-Adjective |
| | | | (optional)-indirect object |

Examples

| | | | |
|---|---|---|---|
| Click on the bank | Click on the yellow car | Move the policeman to | Move the tall policeman |
| | | the bank | between the jail and the |
| | | | bank |
| Click on the policeman | Click on the tall | Move the girl to the | Move the girl in the red |
| | policeman | nurse | dress to the left of the |
| | | | nurse |
| Click on the school | Click on the girl in the | Move the boy to the | Move the redheaded |
| | red dress | school | boy next to the dog |
| Click on the dog | Click on the black dog | Move the dog to the | Move the man in the red |
| | | hydrant | shirt to the ice cream |
| | | | shop |
| Click on the tree | Click on the tall tree | Move the dog to the tree | Move the black dog next |
| | | | to the tall tree |
| Click on the doctor | Click on the blue trash | Move the doctor to the | Move the briefcase to |
| | can | hospital | the woman in the brown |
| | | | dress |

In Category 4, the prepositional relationship could be: to, next to, to the left of, to the right of, between, above, below, etc.

Category 2 & 4 require that the movable foreground objects on screen appear in confusable sets. If the instruction is to “click on the girl in the red dress,” the character set containing a girl in a red dress, a girl in a green dress, and a girl in a blue dress must appear on screen. Refer to “Screen Requirements” later in this document.

Please reference “Listen and Do Instruction List.doc” for list of recorded instructions.

Story Teller (Exercise 6)

Stories

There are five stories, each in 20 story segments from 20-30 seconds long.

Story Complexity

Story complexity has not been implemented: The five stories are progressively more complex (story 2 is more complex than story 1, story 3 is more complex than story 2, etc.). Complexity is governed by:
Length of sentences.
Number of key elements.
Complexity of key elements (for example, “red hat” vs. “a black top-hat with and ermine rim worn at a jaunty angle”).
Narrative relevance of key elements (for example, key element is main element of plot vs. key element is background item).
Grammatical complexity (for example, simple noun verb sentence structure vs. nested clauses, number of clauses, etc.).
   Questions

There are five questions for each story segment. The questions will be presented in a random order

Response Buttons

For each set of 5 questions, 3 questions will have text response buttons and 2 will have picture response buttons. The responses are presented in a random order. There are four response buttons for each text response question and three (v0.5) response buttons for each picture response question.

Processing Levels

Each story and associated questions are at a different levels of speech processing, ranging from level 1 (highly processed) to level 5 (unprocessed natural speech). In other words, each story will only have one level of speech processing and all five will be at different levels. The order of the stories is as follows:
The Obstacle Course (Level 1) HiFi Stimulus Story Teller Obstacle Course
5-Ton Cake (Level 2) HiFi Stimulus Story Teller 5 Ton Cake
Urban Jungle (Level 3) HiFi Stimulus Story Teller Urban Jungle
Dahlias (Level 4) HiFi Stimulus Story Teller Dahlias
The Spot (Level 5) HiFi Stimulus Story Teller The Spot

The following document details the creation of the Story Teller stories:
HiFi Stimulus Story Teller Stories
   Title & End Screens

A title screen is displayed in the reward space at the start of each story. It is displayed during the first segment and remains until it is replaced by the first 10-Pack pop-up after a correct response. An end screen is displayed after the final block of a story is evaluated. If a benchmark animation is triggered, the end screen is displayed after the animation.

APPENDIX H
Code for Generating Sweeps for High or Low

```
short int *gentlogsweep ( int *Nsamples,
        double freq1, double freq2, double duration,
double power,
        double ramp_on, double ramp_off, double S_Rate )
{
/* Identical to gentonesweep but with logarithmic frequency sweep */
  double s, rd, S_Period, SWave_Period, SWave_SP ;
  double curfreq, nf, amp, fli, flr, x, p ;
  int i, rampondur, fullampdur, rampoffdur, fullampend ;
  short int *samples ;
  double two_PI, S2 ;
  S2 = sqrt(2.0) ;
  two_PI = 2.0 * M_PI ;
  power = power + HPCAL ;
  amp = pow(10.0,power/20.0); /* +90 to bring 0..SHRT_MAX to 0..1 */
  S_Period = 1000.0 / S_Rate ;  /* sampling period in
milliseconds */
  *Nsamples = ms2is ( duration, S_Rate ) ;
  samples = (short int *)malloc(*Nsamples*sizeof(short int)) ;
  rampondur = ms2is ( ramp_on, S_Rate ) ;
  rampoffdur = ms2is ( ramp_off, S_Rate ) ;
  fullampend = *Nsamples − rampoffdur ;
  fullampdur = fullampend − rampondur ;
  rd = (double)rampondur ;
  if ( power < 1.0−MINDOUBLE ) {
    for ( i=0 ; i<*Nsamples ; i++ )
      samples[i] = 0 ;
    return ( samples ) ;
  }
  p = sin(phase) ; /* initial phase */
  x = phase ;
  for ( i=0; i<rampondur; i++ ) {
    fli = (double)i ;
    curfreq = intplog(0,*Nsamples−1,i,freq1,freq2) ;
```

| | |
|---|---|
| SWave_Period = 1000.0 / curfreq ; | /* sinewave period in |
| milliseconds */ | |
| SWave_SP = SWave_Period / S_Period ; | /* sinewave period in samples |
| */ | |

```
    nf = two_PI / SWave_SP ;
    s = SQR(sin(M_PI*(fli / rd)/2.0)) * amp * p ;
    p += cos( (x+nf/2.0) ) * nf ; /* dx = portion of period per sample
*/
    x += nf ; while ( x > two_PI ) { x −= two_PI ; }
    samples[i] = (int)floor(0.5 + s) ;
    }
    for ( i=rampondur; i<fullampend; i++ ) {
      fli = (double)i ;
      curfreq = intplog(0,*Nsamples−1,i,freq1,freq2) ;
      SWave_Period = 1000.0 / curfreq ;  /* sinewave period in
milliseconds */
      SWave_SP = SWave_Period / S_Period ; /* sinewave period in samples
*/
      nf = two_PI / SWave_SP ;
      s = amp * p ;
      p += cos( (x+nf/2.0) ) * nf ; /* dx = portion of period per sample
*/
      x += nf ; while ( x > two_PI ) { x −= two_PI ; }
      samples[i] = (int)floor(0.5 + s) ;
    }
    rd = (double)rampoffdur ;
    for ( i=fullampend; i< *Nsamples; i++ ) {
      fli = (double)i ;
      flr = rd − (double) (i-fullampend) ;
      curfreq = intplog(0,*Nsamples−1,i,freq1,freq2) ;
      SWave_Period = 1000.0 / curfreq ; /* sinewave period in
milliseconds */
      SWave_SP = SWave_Period / S_Period ; /* sinewave period in samples
*/
      nf = two_PI / SWave_SP ;
      s = SQR(sin(M_PI*(flr / rd)/2.0)) * amp * p ;
      p += cos( (x+nf/2.0) ) * nf ; /* dx = portion of period per sample
*/
      x += nf ; while ( x > two_PI ) { x −= two_PI ; }
      samples[i] = (int)floor(0.5 + s) ;
    }
    if ( p > 1.0 ) p = 1.0 ;
    if ( p < −1.0 ) p = −1.0 ;
    if ( cos(x) < 0.0 )
      phase = M_PI − asin ( p ) ;
    else
      phase = asin ( p ) ;
#ifdef DEBUG
    fprintf ( stderr, “p = %f, slope= %f, phase saved: %f\n”, p, cos(x),
phase ) ;
#endif
    return ( samples ) ;
}
short int *gentlogsweep ( int *Nsamples,
        double freq1, double freq2, double duration,
double power,
        double ramp_on, double ramp_off, double S_Rate )
{
/* Identical to gentonesweep but with logarithmic frequency sweep */
  double s, rd, S_Period, SWave_Period, SWave_SP ;
  double curfreq, nf, amp, fli, flr, x, p ;
  int i, rampondur, fullampdur, rampoffdur, fullampend ;
  short int *samples ;
  double two_PI, S2 ;
  S2 = sqrt(2.0) ;
  two_PI = 2.0 * M_PI ;
  power = power + HPCAL ;
  amp = pow(10.0,power/20.0); /* +90 to bring 0..SHRT_MAX to 0..1 */
  S_Period = 1000.0 / S_Rate ;  /* sampling period in
milliseconds */
  *Nsamples = ms2is ( duration, S_Rate ) ;
  samples = (short int *)malloc(*Nsamples*sizeof(short int)) ;
  rampondur = ms2is ( ramp_on, S_Rate ) ;
  rampoffdur = ms2is ( ramp_off, S_Rate ) ;
  fullampend = *Nsamples − rampoffdur ;
  fullampdur = fullampend − rampondur ;
  rd = (double)rampondur ;
  if ( power < 1.0−MINDOUBLE ) {
    for ( i=0 ; i<*Nsamples ; i++ )
      samples[i] = 0 ;
    return ( samples ) ;
  }
  p = sin(phase) ; /* initial phase */
  x = phase ;
  for ( i=0; i<rampondur; i++ ) {
    fli = (double)i ;
    curfreq = intplog(0,*Nsamples−1,i,freq1,freq2) ;
```

| | |
|---|---|
| SWave_Period = 1000.0 / curfreq ; | /* sinewave period in |
| milliseconds */ | |
| SWave_SP = SWave_Period / S_Period ; | /* sinewave period in samples |
| */ | |

```
    nf = two_PI / SWave_SP ;
    s = SQR(sin(M_PI*(fli / rd)/2.0)) * amp * p ;
    p += cos( (x+nf/2.0) ) * nf ; /* dx = portion of period per sample
*/
    x += nf ; while ( x > two_PI ) { x −= two_PI ; }
    samples[i] = (int)floor(0.5 + s) ;
  }
  for ( i=rampondur; i<fullampend; i++ ) {
    fli = (double)i ;
    curfreq = intplog(0,*Nsamples−1,i,freq1,freq2) ;
    SWave_Period = 1000.0 / curfreq ;  /* sinewave period in
milliseconds */
    SWave_SP = SWave_Period / S_Period ; /* sinewave period in samples
*/
    nf = two_PI / SWave_SP ;
    s = amp * p ;
    p += cos( (x+nf/2.0) ) * nf ; /* dx = portion of period per sample
*/
    x += nf ; while ( x > two_PI ) { x −= two_PI ; }
    samples[i] = (int)floor(0.5 + s) ;
  }
  rd = (double)rampoffdur ;
  for ( i=fullampend; i< *Nsamples; i++ ) {
    fli = (double)i ;
    flr = rd − (double) (i−fullampend) ;
    curfreq = intplog(0,*Nsamples−1,i,freq1,freq2) ;
    SWave_Period = 1000.0 / curfreq ; /* sinewave period in
milliseconds */
    SWave_SP = SWave_Period / S_Period ; /* sinewave period in samples
*/
    nf = two_PI / SWave_SP ;
    s = SQR(sin(M_PI*(flr / rd)/2.0)) * amp * p ;
    p += cos( (x+nf/2.0) ) * nf ; /* dx = portion of period per sample
*/
    x += nf ; while ( x > two_PI ) { x −= two_PI ; }
    samples[i] = (int)floor(0.5 + s) ;
  }
  if ( p > 1.0 ) p = 1.0 ;
  if ( p < −1.0 ) p = −1.0 ;
  if ( cos(x) < 0.0 )
    phase = M_PI − asin ( p ) ;
  else
    phase = asin ( p ) ;
#ifdef DEBUG
  fprintf ( stderr, “p = %f, slope= %f, phase saved: %f\n”, p, cos(x),
phase ) ;
#endif
  return ( samples ) ;
}
```

### Appendix 1: HiFi Points: Level Requirements

| | |
|---|---|
| Triggers and Values | 1 |
| Points | 1 |
| Bonus Points | 1 |
| High or Low? | 1 |
| Task 1: Time Order Judgment (Sweeps) | 1 |
| Task 3: Time Order Judgment (Bursts) | 2 |
| Tell Us Apart | 2 |
| Task 1: Two Alternative Phoneme Discrimination | 2 |
| Match It! | 3 |
| Sound Replay | 3 |
| Task 1: Forward Temporal Match | 3 |
| Listen & Do | 4 |
| Story Teller | 4 |

Triggers and Values

The points awarded for a correct response in the HiFi exercises increase as the stimuli become more challenging. This helps to insure the participant continues to earn the same or more points in each session even if their correct response rate drops as expected when the stimuli become more challenging.

Points
Points are awarded after every correct response.
The points display is incremented by the value of the points awarded (variable, see below)

Bonus Points
Bonus points are awarded after a variable number of correct responses (see below).
The points display is incremented in steps of 5 points up to the total number of bonus points awarded
A “short ding” sound accompanies each step 5 points.
Correct responses are not tracked across sessions for bonus points
   High or Low?

Task 1: Time Order Judgment (Sweeps)
Points Trigger: Correct Response

Points Calculation: Points Awarded=(Duration Index +4)

| | Points Awarded | Bonus Points Awarded |
|---|---|---|
| Duration Index 1 | 2 | 10 |
| Duration Index 2 | 3 | 15 |
| Duration Index 3 | 4 | 20 |
| Duration Index 4 | 5 | 25 |
| Duration Index 5 | 6 | 30 |

Bonus Points Trigger: 10 Correct Responses
Bonus Points Calculation: Bonus Points Awarded=(15× Point Increment)

Task 2: Sequence Reconstruction (Sweeps): REMOVED v0.5 s3 a

Task 3: Time Order Judgment (Bursts)
Points Trigger: Correct Response

Points Calculation: Points Awarded=(Frequency Offset/Duration Index +1)

| | | Bonus |
|---|---|---|
| | Points | Points |
| | Awarded | Awarded |
| Frequency Offset/Duration Index 1 | 2 | 10 |
| Frequency Offset/Duration Index 2 | 3 | 15 |
| Frequency Offset/Duration Index 3 | 4 | 20 |
| Frequency Offset/Duration Index 4 | 5 | 25 |
| Frequency Offset/Duration Index 5 | 6 | 30 |

Bonus Points Trigger: 10 Correct Responses
Bonus Points Calculation: Bonus Points Awarded=(5× Point Increment)

Task 4: Sequence Reconstruction (Bursts): REMOVED v0.5 s3 a

Tell Us Apart

Task 1: Two Alternative Phoneme Discrimination
Points Trigger: Correct Response

Points Calculation: Based on Stage (emphasis level) as shown below

| | Points Awarded | Bonus Points Awarded |
|---|---|---|
| Initiation-Stage 2 | 2 | 10 |
| Stages 3-4 | 3 | 15 |
| Stages 5-6 | 4 | 20 |
| Stages 7-8 | 5 | 25 |
| Stages 9-10 | 6 | 30 |
| Stages 11-12 | 7 | 35 |
| Stages 13-14 | 8 | 40 |

Bonus Points Trigger: 10 Correct Responses
Bonus Points Calculation: Bonus Points Awarded=(15× Point Increment)

Task 2: Two Alternative Categorical Perception: REMOVED v0.5 s3 a

Task 3: Three Alternative Phoneme Discrimination: NOT IMPLEMENTED v0.5

Task 4: Three Alternative Categorical Perception: NOT IMPLEMENTED v0.5

Match It!

Points Trigger: Correct Response

Points Calculation: Points Awarded=(Stage #Level #1)

| | Level 1 | Level 2 | Level 3 | Level 4 | Level 5 |
|---|---|---|---|---|---|
| Initiation (4 button grid) | 2 | 3 | 4 | 5 | 6 |
| Stage 1 (8 button grid) | 3 | 4 | 5 | 6 | 7 |
| Stage 2 (16 button grid) | 4 | 5 | 6 | 7 | 8 |
| Stage 3 (24 button grid) | 5 | 6 | 7 | 8 | 9 |
| Stage 4 (30 button grid) | 6 | 7 | 8 | 9 | 10 |
| Stage 5 (36 button grid) | 7 | 8 | 9 | 10 | 11 |

Bonus Points Trigger: Grid Cleared
Bonus Points Calculation: Bonus Points Awarded=(2× (Max Clicks−Clicks))
   Sound Replay

Task 1: Forward Temporal Match
Points Trigger: Correct Response

Points Calculation: Points Awarded=(Stage #Level #)

| | Level | Level | | | |
|---|---|---|---|---|---|
| | 1 | 2 | Level 3 | Level 4 | Level 5 |
| Initiation | 2 | 3 | 4 | 5 | 6 |
| Stage 1 (2 stimuli sequence) | 2 | 3 | 4 | 5 | 6 |
| Stage 2 (3 stimuli sequence) | 3 | 4 | 5 | 6 | 7 |
| Stage 3 (4 stimuli sequence) | 4 | 5 | 6 | 7 | 8 |
| Stage 4 (5 stimuli sequence) | 5 | 6 | 7 | 8 | 9 |
| Stage 5 (6 stimuli sequence) | 6 | 7 | 8 | 9 | 10 |
| Stage 6 (7 stimuli sequence) | 7 | 8 | 9 | 10 | 11 |
| Stage 7 (8 stimuli sequence) | 8 | 9 | 10 | 11 | 12 |
| Stage 8 (9 stimuli sequence) | 9 | 10 | 11 | 12 | 13 |

Bonus Points Trigger: 10 Correct Responses
Bonus Points Calculation: Bonus Points Awarded=(5×Point Increment)

Task 2: Backwards Temporal Match: REMOVED v0.5 s3a

Listen & Do

Points Trigger: Correct Response

Points Calculation: Points Awarded=2× (Stage #Level#)

| | Level 1 | Level 2 | Level 3 | Level 4 | Level 5 |
|---|---|---|---|---|---|
| Initiation | 4 | 6 | 8 | 10 | 12 |
| Stage 1 (1 instruction) | 4 | 6 | 8 | 10 | 12 |
| Stage 2 (2 instructions) | 6 | 8 | 10 | 12 | 14 |
| Stage 3 (3 instructions) | 8 | 10 | 12 | 14 | 16 |
| Stage 4 (4 instructions) | 10 | 12 | 14 | 16 | 18 |
| Stage 5 (5 instructions) | 12 | 14 | 16 | 18 | 20 |

Bonus Points Trigger: 10 Correct Responses
Bonus Points Calculation: Bonus Points Awarded=(5×Point Increment)
   Story Teller
Points Trigger: Correct Response

Points Calculation: Points Awarded=2×(#of segments−Level#)

| | Level 1 | Level 2 | Level 3 | Level 4 | Level 5 |
|---|---|---|---|---|---|
| 1 Segment | 4 | 6 | 8 | 10 | 12 |
| 2 Segments | 6 | 8 | 10 | 12 | 14 |
| 3 Segments | 8 | 10 | 12 | 14 | 16 |
| 4 Segments | 10 | 12 | 14 | 16 | 18 |

Bonus Points Trigger: On same schedule as 10-Pack bonus animations (see Reward Animation spec)
Bonus Points Calculation: Bonus Points Awarded 15× Point Increment)
   The first response listed is always the correct response.
   Questions with picture response buttons are always numbers 4 and 5.
   5-TON CAKE
   Segment 1

It was half past eight in the morning when Molly Lentil stepped out onto the porch of her tidy two-story Tudor home. Birds were chirping, lawnmowers burping, and a beautiful spring day was just getting into full swing. Molly sniffed the air—there was a faint aroma of fertilizer, which always reminded her of her first husband, Oswald. The corners of her eyes crinkled enthusiastically as she smiled. Molly picked up the phone. “Rush delivery,” she said.
1. How many stories did Molly's house have?
   a) two
   b) one
   c) three
   d) four
2. What was Molly's first husband's name?
   a) Oswald
   b) Waldo
   c) Wally
   d) Harold
3. What scent reminded Molly of her first husband?
   a) fertilizer
   b) almonds
   c) butter
   d) cut grass
4. What season was it? (pictures)
   a) spring
   b) fall
   c) winter
   d) summer
5. What did Molly hear?
   a) pictures of a bird and a lawnmower
   b) pictures of a cow and a lawnmower
   c) pictures of a bird and a telephone
   d) pictures of a cow and a telephone
      Segment 2

A little while later, Professor Bertram Bramble happened by Molly's house accidentally-on-purpose while walking his Scotch terrier, Max. He found Molly hard at work, lining the inside of her empty, kidney-shaped swimming pool with aluminum foil. “What's this?” he asked, twisting his white handlebar moustache in a characteristic gesture. “Radio telescope?” The professor worked at the Mount Molehill Observatory and did, in fact, have a modest radio telescope in his own backyard.
1. What kind of dog is Max?
   a) Scotch Terrier
   b) Fox Terrier
   c) Bull Terrier
   d) Jack Russell Terrier
2. Where does Professor Bramble work?
   a) An observatory
   b) A laboratory
   c) A cemetery
   d) A university
3. What was Molly putting in the pool when Professor Bramble happened by?
   a) aluminum foil
   b) water
   c) butter
   d) chlorine
4. What shape is Molly's swimming pool? (pictures of pools)
   a) kidney-shaped pool (repeated later)
   b) circular pool
   c) rectangular pool
   d) L-shaped pool
5. What does Professor Bramble's moustache look like? (pictures of moustaches)
   a) white handlebar
   b) black Groucho Marx
   c) brown pencil-thin
   d) red walrus
      Segment 3

Just then a large, green refrigerated truck with “Dana's Dairy Delivery” printed on the side pulled into Molly's driveway. A round, sweaty man with a nametag reading “Steve” and a ball cap that matched the truck got out and waddled uncertainly across the lawn. He scratched his head, his elbow, then his head again, and looked between Molly and the clipboard in his hand. “Did you order two thousand pounds of butter?” he asked. Molly nodded. “Sign here, please.”
1. What was the butter delivery driver's name?
   a) Steve
   b) Dana
   c) Oswald
   d) Bertram
2. How much butter did Molly order?
   a) two thousand pounds
   b) two hundred pounds
   c) a thousand pounds
   d) ten thousand pounds
3. What color was the dairy truck?
   a) green
   b) yellow
   c) white
   d) red
4. What did the delivery driver scratch besides his head? (pictures, with hand scratching)
   a) elbow
   b) armpit
   c) knee
   d) side
5. What was the driver holding? (pictures)
   a) clipboard (with a bill of delivery on it)
   b) baseball cap (green)
   c) stick of butter
   d) nametag (“Joe”)
      Segment 4

As the butter was being unloaded directly into Molly's swimming pool, three more trucks arrived in rapid succession, carrying two thousand pounds each of sugar, eggs, and flour. The trucks managed to wedge themselves in such a way that each one was blocked by both of the others, and traffic on Juniper Lane came to a standstill. The driver of the sugar truck suggested that they play Rock, Paper, Scissors to decide who would try to move first, and they spent the next thirty minutes arguing over how it could be played with three people.
1. What is the name of the street Molly lives on?
   a) Juniper Lane
   b) Bramble Lane
   c) Rocklin Lane
   d) Wisteria Lane
2. How long did the drivers argue?
   a) thirty minutes
   b) fifteen minutes
   c) an hour
   d) three hours
3. What were the drivers arguing about?
   a) Rock, Paper, Scissors
   b) traffic
   c) unloading
   d) sports
4. What was in the three trucks that arrived at the same time? (pictures of commodities)
   a) sugar, eggs, flour
   b) butter, sugar, flour
   c) eggs, flour, butter
   d) eggs, butter, sugar
5. To where was the butter being unloaded? (pictures)
   a) swimming pool with heap of butter in it (may be able to reuse art from s02_q4_a)
   b) garage with butter stacked in it
   c) sidewalk with butter stacked on it
   d) truck with butter in it
      Segment 5

Professor Bramble coughed politely as he surveyed the contents of the trucks. “Is this your version of a mud bath,” he asked, “or are we making a few thousand cakes?” Molly chuckled. “Cake,” she answered, ”but just one. Help me get this sugar into the pool.” They retrieved two snowshovels from Molly's garage and set to work. As they shoveled, a tanker truck slowly and expertly made its way around the traffic and up the sidewalk, demolishing a mailbox and a privet bush but otherwise causing no harm. A sign on the side said simply: “frosting.”
1. What did Professor Bramble do before asking Molly what she was making?
   a) coughed
   b) cleared his throat
   c) chuckled
   d) chuckled and coughed
2. Who chuckled?
   a) Molly
   b) Professor Bramble
   c) Steve
   d) the flour truck driver
3. How many cakes are they going to make?
   a) one
   b) two
   c) two thousand
   d) a few thousand
4. What was being shoveled with the snowshovels? (pictures of commodities—may be able to reuse art from s04_q4)
   a) sugar
   b) flour
   c) butter
   d) eggs
5. What was demolished by the tanker truck? (pictures)
   a) mailbox
   b) snowshovel
   c) house
   d) flour truck
      Segment 6

Hovering over Juniper Lane at six hundred feet, Rick Trellis was perplexed. In his four years as helicopter traffic reporter for WOGD radio, he had never seen such a large tie-up on a residential street. He counted five large trucks stopped at various angles in the middle of the block, as well as a construction crane, a limousine and what appeared to be a troop of boy scouts. Cars were backed up for a quarter mile in all directions. Rick felt it was his duty as a reporter to land and find out what was going on.
1. How long had Rick been a traffic reporter?
   a) four years
   b) three years
   c) five years
   d) six years
2. What was Rick's last name?
   a) Trellis
   b) Juniper
   c) Angle
   d) Rodgers
3. What kind of station is WOGD?
   a) radio
   b) cable TV
   c) network TV
   d) satellite TV
4. What kind of vehicle does Rick drive? (pictures)
   a) helicopter (art repeated later)
   b) taxi (art repeated later)
   c) limousine (art repeated later)
   d) airplane
5. What did Rick see on the street besides trucks? (pictures)
   a) construction crane (art repeated later)
   b) elephant
   c) helicopter (repeats S06_q4_a)
   d) steamroller
      Segment 7

The mound of butter and sugar was shaped vaguely like Mount Vesuvius, and Molly was considering the problem of how to beat it all together when the tall, red-headed man tapped her on the shoulder. Molly sneezed in surprise. The man introduced himself as Rick Trellis, helicopter traffic reporter. His voice reminded Molly of Mike Wallace. He fairly squirmed with excitement when he found out what was going on. “I'm sorry,” Molly said, “Did you say you have a helicopter?”
1. What was the mound of butter and sugar shaped like?
   a) Mount Vesuvius
   b) Mount Baldy
   c) Mount St. Helen's
   d) Mount Jefferson
2. How does Rick respond when he finds out they are baking a cake?
   a) excited
   b) amused
   c) doubtful
   d) curious
3. Who does Rick's voice remind Molly of?
   a) Mike Wallace
   b) Peter Jennings
   c) Morley Safer
   d) Tom Brokaw
4. What did Molly do when Rick tapped her on the shoulder? (pictures of Molly's head)
   a) sneezed (with handkerchief)
   b) fainted (arm over forehead, toppling)
   c) screamed (mouth open, hair standing on end)
   d) coughed (fist over mouth)
5. What does Rick look like? (pictures)
   a) tall skinny redhead
   b) short fat redhead
   c) tall skinny blond
   d) short fat blond
      Segment 8

A sizeable crowd of curious onlookers had assembled by this time, which was good because it took ten people to tilt the helicopter onto its side, blades in the swimming pool. “Stand back!” shouted an enthusiastic Rick Trellis as he belted himself into the cockpit and started the engine. The crowd murmured appreciatively as the butter and sugar were slowly transformed into a smooth, creamy mass. The lone dissenting voice came from a neighbor wearing a blue bathrobe, who was yelling something about a privet bush.
1. How many people did it take to move the helicopter?
   a) ten
   b) twelve
   c) eight
   d) twenty
2. What did Rick Trellis say?
   a) “Stand back!”
   b) “Stay back!”
   c) “Watch out!”
   d) “Look out!”
3. What did the crowd do when Rick started the helicopter engine?
   a) murmur
   b) roar
   c) chatter
   d) laugh
4. What was the neighbor wearing? (pictures)
   a) blue bathrobe
   b) blue slippers
   c) green bathrobe
   d) green slippers
5. What was the orientation of the helicopter? (pictures of helicopter in/next to swimming pool with mound of butter and sugar)
   a) helicopter on side next to pool, blades in pool
   b) helicopter right side up in pool, atop mound
   c) helicopter on nose next to pool, blades in pool
   d) helicopter upside down in pool
      Segment 9

There are roughly sixteen thousand eggs in a ton. Carton upon carton of them were piled on the lawn in rough towers reminiscent of Stonehenge. Molly looked troubled. Just then, a jowly man wearing a khaki shirt with a red tie introduced himself and said that he had 27 boy scouts who'd like to lend a hand. Molly asked if the boy scouts had a merit badge for cooking. “Since 1911, ” said the scoutmaster proudly.
1. About how many eggs are there in a ton?
   a) 16,000
   b) 27,000
   c) 19,000
   d) 11,000
2. What did the scoutmaster's face look like?
   a) jowly
   b) troubled
   c) scruffy
   d) rough
3. How many boy scouts were there?
   a) 27
   b) 11
   c) 19
   d) 16
4. What did the scoutmaster's uniform look like? (pictures of shirt & tie, shirt has a few boy scouty badges and the like on it)
   a) khaki shirt, red tie
   b) white shirt, red tie
   c) white shirt, khaki tie
   d) blue shirt, black tie
5. What did the piles of egg cartons look like? (pictures of egg cartons piled up to resemble various monuments:)
   a) Stonehenge
   b) pyramid
   c) Taj Mahal
   d) Statue of Liberty
      Segment 10

Janet Wilmot had grown up in urban Pittsburg but had been obsessed with horses since the age of six, when her family had visited the canola farm of a relative in Manitoba. Joining the mounted police had been the fulfillment of a lifelong dream. She rode Twyla, a sturdy brown mare, down Juniper Lane into a scene of pandemonium. A group of boy scouts and a little league team seemed to be throwing eggs at a helicopter which had crashed into a swimming pool. A bird-faced man in a bathrobe ran up, shouting about a privet bush.
1. Where did Janet Wilmot grow up?
   a) Pittsburg
   b) Philadelphia
   c) New York City
   d) Detroit
2. Where was the farm?
   a) Manitoba
   b) Alberta
   c) Saskatchewan
   d) Ontario
3. What was grown on the farm?
   a) canola
   b) alfalfa
   c) corn
   d) semolina
4. What did Twyla look like? (pictures of horses' heads)
   a) brown horse head
   b) black horse head
   c) white horse head
   d) spotted horse head
5. What did the man in the bathrobe look like? (pictures of people's heads—these images should be exaggerated toward looking more animal than human)
   a) bird-faced man (with narrow head, sharp nose and beady eyes—art repeated later)
   b) pig-faced man (with big round head, big round nose)
   c) mouse-faced man (with small round head and whiskers)
   d) gorilla-faced man
      Segment 11

Janet flashed her badge efficiently at the small, curly-haired woman who appeared to be in charge. “Cake batter,” she noted sternly. “I assume you have a cake permit?” Molly produced an official-looking piece of paper so swiftly that Janet felt as though she were watching a magic show. She studied the angular blue scrawl at the bottom. “That really the mayor's signature?” “Ask him yourself,” said Molly, “he's over there by the limousine.”
1. What did Janet show to Molly?
   a) badge
   b) gun
   c) warrant
   d) permit
2. What did Janet feel like she was watching when Molly produced the permit?
   a) a magic show
   b) a cooking show
   c) a children's show
   d) a ballet
3. To whom did Molly show the permit?
   a) Janet Wilmot
   b) the mayor
   c) Professor Bramble
   d) Rick Trellis
4. What did the permit look like? (pictures of official-looking documents) (the mayor's name is Cyrus Bluebottle)
   a) angular blue signature
   b) roundish blue signature (red)
   c) angular black signature
   d) roundish black signature
5. What was the mayor standing next to? (pictures)
   a) limousine (repeats S06_q4_c)
   b) helicopter (repeats S06_q4_a)
   c) construction crane (repeats S06_q5_a)
   d) taxi (repeats S06_q4_b)
      Segment 12

Mayor Cyrus Bluebottle watched as the little league bucket brigade dumped sack after sack of flour into the pool. Flour filled the air like snow flurries, momentarily blotting out the sun and coating everything and everyone within forty yards. The mayor idly wrote his own initials in the dust on his limousine and thought how lucky he was that his PR advisor, Louise, happened to live on Juniper Lane. Four news stations were already setting up cameras.
1. What did the flour in the air look like?
   a) snow flurries
   b) fog
   c) dust
   d) clouds
2. Who is putting the flour into the pool?
   a) the little league
   b) the boy scouts
   c) Molly
   d) the mayor
3. What does Louise do for the mayor?
   a) PR advisor
   b) secretary
   c) legal counsel
   d) chauffeur
4. In what was the flour before it was put into the pool? (pictures—may be able to reuse art from s04_q4_or s05_q4_b)
   a) sacks of flour
   b) boxes of flour
   c) heap of flour
   d) cans of flour
5. What did the Mayor write in the dust on the limousine? (close-up pictures of limousines lightly dusted with flour, with different things written in the dust)
   a) initials “CB”
   b) “Louise”
   c) a heart
   d) “Mayor”
      Segment 13

Molly had been so busy dealing with the police, the mayor, the little league, the boy scouts and the television crews that she did not notice that Professor Bramble had disappeared until he reappeared with his son, Ernest, just as the batter was finally ready. They had brought with them an enormous lens, several yards across, balanced precariously in a little red wagon. Ernest extracted a tape measure from one of the many pockets of the overalls he always wore and began sizing up a nearby elm tree.
1. Which of these was Molly NOT busy dealing with?
   a) Professor Bramble
   b) the police
   c) the mayor
   d) the boy scouts
2. How big was the lens?
   a) several yards across
   b) several feet across
   c) several inches across
   d) largest in the world
3. What did Ernest have in his pocket?
   a) a tape measure
   b) a lens
   c) a screwdriver
   d) a balance
4. What was Ernest wearing? (pictures of a young, robust man with a handlebar moustache, wearing different kinds of clothing)
   a) wearing overalls
   b) wearing a scoutmaster's uniform (khaki shirt and red tie)
   c) wearing a lab coat
   d) wearing a suit and tie
5. What did the professor and his son use to bring the lens? (pictures)
   a) little red wagon
   b) flatbed truck
   c) construction crane (repeats S06_q5_a)
   d) taxi (repeats S06_q4_b)
      Segment 14

Ernest and the professor enlisted the aid of several burly construction workers with orange hard hats, who helped them hoist the lens into the elm tree. The lens, the professor explained, was an observatory leftover—it had been replaced by a bigger one twelve years ago and he had kept it in his tool shed ever since. They turned the lens so as to focus the sunlight onto the swimming pool, and the batter slowly began to cook. The air was filled with the pleasing if inexplicable scent of almonds.
1. What kind of tree was the lens hoisted into?
   1) elm
   2) almond
   3) maple
   4) juniper
2. Where had the professor been keeping the lens?
   1) tool shed
   2) garage
   3) attic
   4) garden
3. As the batter began to cook, what scent filled the air?
   1) almonds
   2) butter
   3) charcoal
   4) vanilla
4. The sunlight was focused onto what?
   1) picture of swimming pool with sunbeam (may be able to reuse art from s02_q4_a)
   2) picture of house with sunbeam (may be able to reuse art from s05_q5_c)
   3) picture of truck with sunbeam
   4) picture of tree with sunbeam
5. What were the construction workers wearing?(pictures of burly construction workers wearing different hats)
   1) wearing orange hard hats
   2) wearing yellow hard hats
   3) wearing orange ball caps
   4) wearing yellow ball caps
      Segment 15

Some of Molly's neighbors, led by Frank Murphy, a civil engineer who lived on the corner, temporarily dismantled their picket fences in order to construct an enormous cooling rack atop some cars stuck in the middle of the street. The construction crew brought in a crane that they had been using to move a fifteen thousand pound marble staircase. Fortunately, the aluminum foil lining the swimming pool was of the heavy duty variety. It held, and the cake was lifted free with minimal superficial crumbling. It lay steaming and vulnerable in the afternoon sun, a mouth-watering island in a hungry human sea.
1. What did Molly's neighbor Frank Murphy do for a living?
   a) civil engineer
   b) mechanical engineer
   c) electrical engineer
   d) railroad engineer
2. How did the cake come out?
   a) minimal crumbling
   b) mild structural damage
   c) in two pieces
   d) perfectly
3. Where did Molly's neighbor Frank Murphy live?
   a) on the corner
   b) across the street
   c) next door
   d) top of the hill
4. What was used to make the cooling rack? (pictures)
   a) picket fence
   b) chain link fence
   c) hedge row
   d) trellis
5. What was the crane being used on, prior to the cake? (pictures)
   a) marble staircase
   b) wrought iron spiral staircase
   c) top of a windmill
   d) wooden staircase
      Segment 16

The pumps on the frosting tanker were started and swiftly built to a jet-engine whine. Three men took hold of what appeared to be a fire hose attached to the left side of the truck and began spraying the cake with long, even strokes of sugary pink. With consummate skill they camouflaged an angular irregularity on the north end of the cake, where the pool steps had been, until it was a pleasing, gentle ripple. The crowd fell silent in admiration. A single voice called out: “Who's going to pay for my privet bush?”
1. What did the frosting tanker pumps sound like?
   a) jet engine
   b) fire engine
   c) gurgling sink
   d) silent
2. What caused the irregularity in the cake?
   a) pool steps
   b) crane
   c) aluminum foil
   d) helicopter
3. What did the crowd do while watching the frosting team?
   a) fell silent
   b) cheered
   c) offered advice
   d) dispersed
4. How many men held the frosting hose? (pictures of jumpsuited frosting professionals grappling with the hose)
   a) three
   b) two
   c) four
   d) five
5. What did the frosted cake look like? (pictures)
   a) big pink kidney bean cake
   b) big yellow kidney bean cake
   c) big white kidney bean cake
   d) big green kidney bean cake
      Segment 17

Mayor Bluebottle was incredulous. “You mean you brought the silver scissors but no ribbon? Louise, how could you forget the ribbon? I've got to cut something for the TV cameras! What about that garden hose? I could cut that! Whose hose is this?” A bird-faced man who had been saying something about a privet bush spoke up. “It's mine.” The mayor thought about the television crews. “I'll give you a thousand dollars for that hose,” he said.
1. Who forgot the ribbon?
   a) Louise
   b) Lois
   c) Louis
   d) Lulu
2. What is the mayor's last name?
   a) Bluebottle
   b) Bottlebrush
   c) Brushfire
   d) Threepwood
3. How did the mayor first react to the forgetting of the ribbon?
   a) incredulously
   b) joyously
   c) sadly
   d) indifferently
4. What made the mayor want to cut the garden hose? (pictures)
   a) television camera
   b) bird-faced man (repeats s10_q5_a)
   c) money (bills and coins)
   d) privet bush
5. How much did the mayor offer to pay for the hose? (pictures of money)
   a) thousand dollar bill
   b) hundred dollar bill
   c) five hundred dollar bill
   d) fifty dollar bill
      Segment 18

Although Mayor Bluebottle was the most notorious windbag in five counties, the cake dedication speech he gave before cutting the garden hose was his shortest on record. He had barely started talking about his father's uncle Wilbur, who had allegedly been a baker, when the hungry crowd began waving plastic forks in his direction. Unnerved, he jumped directly to his closer, quoting Marie Antoinette, and turned things over to Molly. She waved a paisley handkerchief in the air and simply said, “Dig in!”
1. The mayor is the most notorious windbag across what area?
   a) five counties
   b) two states
   c) seven counties
   d) six states
2. The mayor quoted whom?
   a) Marie Antoinette
   b) Marc Antony
   c) Molly
   d) Wilbur
3. Who said “Dig in!”
   a) Molly
   b) the mayor
   c) Wilbur
   d) Marie Antoinette
4. What did Molly wave in the air? (pictures of hand waving various handkerchiefs)
   a) paisley handkerchief
   b) polka dot handkerchief
   c) striped handkerchief
   d) solid purple handkerchief
5. What did the crowd wave in the air? (pictures of hand waving these items)
   a) plastic fork
   b) plastic knife
   c) plastic spoon
   d) paper napkin
      Segment 19

It was the biggest thing that had happened in town since the Wallabies won their minor league division. The owner of the local supermarket passed out paper plates and napkins. Milk was poured into a dozen rented canoes. The drivers of the supply trucks discovered a common interest in music, formed a barbershop quartet on the spot, and sang a modified version of Sweet Adeline they dubbed “Sweet Cake-O-Mine.” Molly got a congratulatory phone call from the governor, and the cake was universally declared to be delicious.
1. What kind of team are the Wallabies?
   a) minor league
   b) major league
   c) little league
   d) junior league
2. Who sang Sweet Cake-O-Mine?
   a) truck drivers
   b) barbers
   c) the Wallabies
   d) Molly
3. Who made a phone call?
   a) the governor
   b) the mayor
   c) Molly
   d) Adeline
4. What was passed out to everyone? (pictures)
   a) paper plates and napkins
   b) paper plates and cups
   c) napkins and cups
   d) napkins and spoons
5. In what was milk served? (pictures)
   a) canoe filled with milk
   b) swimming pool filled with milk (may be able to reuse art from s02_q4_a)
   c) cauldron filled with milk
   d) horse trough filled with milk
      Segment 20

When it was all over, and the people had gone home, and the fences had been put back, and the construction crane had lifted the supply trucks out of their mutual tangle, Molly, hands on her hips, surveyed her lawn. Crumbs covered it like a carpet of cherry blossoms. For a moment she felt as though she were standing in an Andrew Wyeth painting. Professor Bramble nudged her gently. “Why?” he asked. “Nice day for it,” replied Molly with a subtle smile. The professor twisted his moustache. “What are you doing tomorrow?”
1. What did the crumbs on the lawn look like?
   a) cherry blossoms
   b) mushrooms
   c) snow
   d) cotton
2. Why did Molly say she baked the cake?
   a) nice day for it
   b) nice weather for it
   c) to make people happy
   d) to please the professor
3. Molly felt like she was standing in what?
   a) an Andrew Wyeth painting
   b) a Pablo Picasso painting
   c) an Ansel Adams photo
   d) a carpet
4. How was Molly standing as she looked at her lawn? (pictures, full body)
   a) hands on hips
   b) arms folded across chest
   c) one hand shading eyes
   d) sitting cross legged
5. What two things did the professor touch? (pictures)
   a) Molly, moustache (white handlebar)
   b) Molly, crumbs
   c) crumbs, moustache
   d) moustache, cap
      The first response listed is always the correct response.
      Questions with picture response buttons are always numbers 4 and 5.
      Dahilas
      Segment 01—WC 95

In every aspect but one it was a usual day: Wyndham would awake at 5:30 with no alarm clock, do her horizontal stretches in bed with the morning light filtering across the north wall, and pick up her breakfast tray and reading material outside the bedroom door at 5:45. In either a navy or a taupe satin robe, with pockets, she would sit at a small table made of walnut and ash, its comers carved expertly into trailing vines with inlaid rose buds of cherry wood, and take her tea and egg and fresh fruit.
1. What time does Wyndham wake up in the morning?
   a) 5:30
   b) 5:45
   c) 7:00
   d) 7:45
2. What does Wyndham do before getting out of bed?
   a) stretch
   b) plan
   c) gaze at the light
   d) read
3. What do Wyndham's satin robes have in common?
   a) they have pockets
   b) they all have taupe collars
   c) they are all navy blue
   d) they hang on the north wall
4. What things are included in Wyndham's usual breakfast?
   a) teacup and egg in an egg cup
   b) cherries on a stem (art repeated later)
   c) eggs and bacon (art repeated later)
   d) teacup and muffin
5. What detail is inlaid in Wyndham table?
   a) rose bud
   b) cherries on a stem (repeats s01_q4_b)
   c) stylized deer or hare
   d) section of rose vine
      Segment 02—WC 87

She would pour a second cup, this time with sugar, two lumps, and peruse, from back to front, a gardening journal or newsletter, looking out now and then at the southeast garden below her window to check the bird bath or the light on the roses.

Then she would dress and go about her day, which, if it were Wednesday, would include a bridge game, and if it were Monday or Thursday, pastries and coffee at the Green Door Café with her old friends Anne and Charles.
1. When does Wyndham take sugar with her tea?
   a) on the second cup
   b) while it's hot
   c) after she reads the paper
   d) Monday and Thursday
2. How does Wyndham read the gardening publications?
   a) back to front
   b) front to back
   c) she skims
   d) without interruption
3. What are Wyndham friends' names?
   a) Charles and Anne
   b) Lizbeth and Charles
   c) Mary and Charles
   d) Anne and Robert
4. What does Wyndham do on Wednesdays?
   a) hand of playing cards to indicate card game (art repeated)
   b) gardening tools: hand spade, trowel, bucket
   c) coffee and croissant (art repeated)
   d) binoculars with arrow pointing to a bird, to indicate birdwatching
5. What does Wyndham enjoy with her friends?
   a) coffee and croissant (repeats s02_q4_c)
   b) bush with red roses (art repeated later)
   c) golf club(s)
   d) bird bath in garden
      Segment 03—WC 86

What was different about this day, which happened to be a sunny Monday, was a small thing. It didn't take up any room, or much time, and it didn't interfere with her daily activities. But it changed everything. From this day on, her eyes had a reaching quality about them. This felt youthful, and pleasurable, and a bit annoying in its constancy. For now, she had a mystery. She had her own private who-done-it, the culprit yet to be discovered, the victim her own treasured tedium.
1. On what day does something unusual happen?
   a) Monday
   b) Friday
   c) her anniversary
   d) garden show day
2. How do the changes feel to Wyndham?
   a) all of these
   b) youthful
   c) annoying
   d) pleasurable
3. What is annoying about what Wyndham is experiencing?
   a) it is so constant
   b) it takes up too much time
   c) it's too mysterious
   d) it's cumbersome
4. What seems different to Wyndham on this day
   a) eyes on female face (art repeats later)
   b) bush with red roses (repeats s02_q5_b)
   c) blue sky with clouds (art repeats later)
   d) heart (art repeats later)
5. What is the weather like on this day?
   a) sun (art repeats later)
   b) blue sky with clouds (repeats s03_q4_b)
   c) raindrops (art repeats later)
   d) classical “father wind” face (puffy cheeks, blowing smoke) to indicate windy (art repeats later)
      Segment 04—WC 95

It all began when she stepped out for her morning stroll. There, about six steps from the door, on the stone patio leading to the shady west path, sat a vase. A plain vase—nearly and intentionally invisible in its plainness, for in it was a stunning Nellie Broomhead, a rare dahlia, and not from her own garden—though it would certainly have been a worthy competitor, so perfect were its tubular petals, so strong its stem, so even the transition of shading from the pure white base to the neon mauve edge.
1. How far from the door does Wyndham see something unusual?
   a) six steps
   b) twenty feet
   c) three feet
   d) at the gate to the west path
2. How is the west path described?
   a) shady
   b) sunny
   c) fragrant
   d) winding
3. What is special about the dahlia Wyndham finds?
   a) it is rare
   b) its broom-shaped flower
   c) it's from her garden
   d) its golden color
4. What is described as being strong?
   a) stem with bit of leaf showing (but make sure the stem not the leaf is the emphasis) [see http://www.oldhousegardens.com/bigFlwr.asp?Cat=nellieB for example of leaf]
   b) vase (art repeats later)
   c) garden gate (art repeats later)
   d) “father wind” face (puffy cheeks, blowing smoke) to indicate windy (repeats s03_q5_d)
5. What is described as being very plain?
   a) vase (repeats s04_q4_b)
   b) white rose (art repeats later)
   c) ladies' shoes (art repeats later)
   d) door (art repeats later)
      Segment 05—WC 123

Behind the exuberant heirloom flower, a small paper, rolled up like a miniature scroll, was balanced among broad leaves. Wyndham unrolled it at once.

It was at this instant her eyes changed, reaching for an answer before the question had formed—the way a nerve ending reaches for something electric before it arrives.

It was a poem, typewritten, in italics, unsigned. And she could not imagine its author.

She read it three times, possibly four:
For lovely Wyndham:
Against the painted garden wall
Where shadow kisses white
The light reveals the reaching bloom
As the bloom reveals the light

Wyndham carefully re-rolled the poem and tucked it where a woman tucks small treasures, a hiding place she had not made use of in a very long time.
1. What does Wyndam find among the leaves of the dahlia?
   a) a poem
   b) an heirloom
   c) an envelope
   d) a ladybug
2. What characterizes the note Wyndham finds?
   a) there is no signature
   b) it's hand written
   c) it's in parentheses
   d) all of these
3. What does Wyndham do with the paper?
   a) tucks it away
   b) puts it back
   c) writes a poem on it
   d) crumples it
4. In what form does Wyndham find the message?
   a) rolled-up scroll
   b) small gift box with bow (art repeats later)
   c) envelope (art repeats later)
   d) miniature gift card
5. What color is mentioned in the poem?
   a) white-colored rectangle
   b) green-colored rectangle
   c) pink-colored rectangle
   d) gold-colored rectangle
      Segment 06—WC 93

An hour later over pastries—today it was croissant with almond and apricot filling—she did not mention the mysterious note to Anne and Charles. Nonetheless, Charles, being his usual observant self, commented as he stirred his coffee, “You're looking bright, today, Wyn. Such good color.” Anne agreed.

Wyndham knew they were referring to her cheeks, but she deflected, smoothing the cuff of her lavendar cardigan, “Thank you. This sweater often draws compliments—I must wear it more often.” She would save the story for the next time, when she had more information.
1. What nut is featured in the sweet filling?
   a) almond
   b) walnut
   c) chestnut
   d) hazelnut
2. What does Charles comment on?
   a) Wyndham's color
   b) Anne's blouse
   c) the coffee
   d) the weather
3. How does Anne respond to Charles' comment?
   a) all of these
   b) she understands it
   c) she deflects it
   d) she thanks him
4. What are they eating?
   a) croissant (art repeats later)
   b) doughnut
   c) strawberries (art repeats later)
   d) thumb cookies (small buffer cookies with jam-filled “thumbprint” in the middle)
5. What is Wyndham wearing?
   a) lavendar-colored cardigan
   b) apricot-colored cardigan
   c) soft yellow-colored cardigan
   d) soft sage green-colored cardigan
      Segment 07—WC 136

But more information, as it turned out, was not forthcoming. She received no phone calls or visitors revealing the poet's identity. Her housekeeper Ivy claimed to know nothing about it, and before Wyndham had had time to gather any clues, she found another dahlia on Tuesday, the very next morning, on the stone bench along the herb garden.

This beauty, the elegant white Alpine Snowbird, was less rare but more playful, with eight simple petals curled like small tongues from a lemon-colored center. It was accompanied by the poem, with a second verse added:
Against the painted garden wall
Where shadow kisses white
The light reveals the reaching bloom
As the bloom reveals the light
And once revealed, this lustrous pair
a destiny doth hold
compelled by such a simple task:
to let the thing unfold
   1. What is the housekeeper's name?
      a) Ivy
      b) Rose
      c) Sarah
      d) Irene
   2. When did Wyndham find the second dahlia?
      a) all of these
      b) the next day
      c) Tuesday
      d) in the morning
   3. What did the housekeeper tell Wyndham?
      a) she knew nothing about it
      b) look on the stone bench
      c) she was in the herb garden
      d) who the poet is
   4. Where does Wyndham find the second dahlia?
      a) stone garden bench
      b) garden gate (repeats s04_q4_c)
      c) arched arbor (art repeats later)
      d) black wrought iron chair
   5. What does an Alpen Snowbird look like?
      a) White flower with eight petals, yellow center (see picture at http://www.alpengardens.com/)
      b) small white bird (art repeats later)
      c) white rose (repeats s04_q5_b)
      d) white mum
         Segment 08—WC 104

On Wednesday, Wyndham awoke, did her horizontal stretches, and picked up her tray, as always. She poured her second cup of tea, plunked in two lumps, and looked up from her reading to watch a family of finches in their comical bathing routine, fluffing and preening, until the gardener scared them away with a wheelbarrow of compost on his way to the delphinium.

Mid-swallow, she suddenly gave a surprised cough, almost dropping her cup. Robert? she thought, then immediately said aloud, “Oh, that's absurd.” But she watched him, his broad graceful shoulders leaning into the tall blue stems, until he had emptied the wheelbarrow.
1. How does Wednesday begin for Wyndham?
   a) the same as always
   b) with a cup of coffee
   c) with a bath
   d) with the gardener
2. What is the gardener's name?
   a) Robert
   b) David
   c) Andrew
   d) Charles
3. Who does Wyndham notice about Robert?
   a) his shoulders
   b) his voice
   c) his hat
   d) his clothes
4. Wyndham almost drops what?
   a) teacup
   b) magazine
   c) handbag blue
   d) delphinium (long stem, blue flower clusters all the way up)
5. What tool is Robert using?
   a) wheelbarrow (art repeats later)
   b) rake
   c) garden trowel (art repeats later)
   d) hammer
      Segment 09—WC 109

Robert, she realized, was the only other one who would know her walking routine: the herb garden and rosebeds on Mondays and Wednesdays, the west path on Tuesdays and Thursdays, and on Fridays, saving the best for last, her prize-winning dahlia beds. No one but he and Ivy would have known where to place the vases where she would see them, and Ivy had already sworn innocence.

But Robert? He had been with her for years, and although they both knew flowers intimately, and had shared everything two people could share about loams and fertilizers, hybrids and tubers, he was private in other respects. She knew little about him.
1. What would Robert know about Wyndham?
   a) her walking routine
   b) what she did last week
   c) that she had talked to Ivy
   d) that she was innocent
2. What does Wyndham visit in her garden on Fridays, saving the best for last?
   a) her dahlia beds
   b) her prize-winning roses
   c) the walking paths
   d) the herb garden
3. What has Ivy done?
   a) sworn innocence
   b) tattled on Robert
   c) taken a walk
   d) whispered something
4. What item was placed along Wyndham's garden walk?
   a) vase (repeats s04_q4_b)
   b) white rose (repeats s04_q4_b)
   c) egg
   d) ladies' shoes (repeats s04_q5_c)
5. What do Robert and Wyndham know intimately?
   a) flowers (dahlias) (art repeats later)
   b) lips (mouth)
   c) books (art repeats later)
   d) hand of playing cards (repeats s02 q4_a)
      Segment 10—WC 91

He does have deep, intelligent eyes, she thought, and uses his horticultural Latin quite well. She could picture him a poet, ensconced in a small private library, tending words the way he tends new shoots.

But her gardener? What a scandal that would be among certain of her acquaintances. And socially, how would that work? Would she have to stop employing him? Perhaps she would just marry him, and his livelihood would simply become his hobby.

“Stop that,” she chided herself aloud, and pushed her chair back and rose to dress.
1. What does Wyndham remember about Robert?
   a) his eyes
   b) he speaks Latin fluently
   c) his favorite book
   d) his favorite hobby
2. What is Wyndham worried about?
   a) all of these
   b) a possible scandal
   c) her social status
   d) her status as an employer
3. What does Wyndham do after she chides herself?
   a) gets dressed
   b) makes a phone call
   c) finds a Latin dictionary
   d) reads a book
4. Where is Wyndham while she ponders Robert?
   a) chair (art repeats later)
   b) arched arbor (repeats s07_q4_c)
   c) bed
   d) cafe
5. What does Wyndham imagine Robert surrounded by?
   a) books (repeats s09_q5_c)
   b) cats
   c) insects
   d) trees
      Segment 11—WC 123

At The Green Door Cafe later that morning, enjoying an assortment of tiny strawberry tartlets—creamed, brandied, adorned with chocolate—Wyndham described the situation as casually as possible to Anne and Charles.

“It appears I have a suitor,” Wyndham announced. Anne's fork, Charles' cup, and Wyndham's words all hung in mid-air.

“A suitor!” Anne exclaimed, setting her fork back down with a wedge of pink still balanced on it. “Wyn, tell us!”

“There's not much to tell,” Wyndham said, “he's anonymous. I've been receiving notes.”

“Notes?” Charles said.

“Yes,” she replied, not mentioning the flowers or poems, “I suspect I know who it is, but I'm not quite sure how to respond, and I thought you might be able to offer some advice.”
1. What is Wyndham's tone when she tells Charles and Anne her news?
   a) casual
   b) nervous
   c) excited
   d) suspicious
2. How does Wyndham describe her suitor?
   a) anonymous
   b) handsome
   c) persistant
   d) as her gardener
3. What does Wyndham say the suitor has been giving her?
   a) notes
   b) poems
   c) flowers
   d) butterflies
4. What is featured in the morning pastries?
   a) strawberries (repeats s06_q4_c)
   b) cherries on a stem (repeats s01_q4_b)
   c) wedge of swiss cheese
   d) nuts (almonds or walnut)
5. What does Wyndham decide not to mention?
   a) flowers (dahlias) (repeats s09_q5_a)
   b) dollar signs (to indicate money) (art repeats later)
   c) books (repeats s09_q5_c)
   d) raindrops (repeats s03_q5_c)
      Segment 12—WC 109

They eagerly agreed to advise her as best they could, and she went on. “Imagine being alone as long as I have. I have everything I need. I'm satisfied, and with my dahlias winning more prizes every year I always have something to strive for, which is important. Besides, . . . ”

Anne interrupted her, “Are you trying to convince yourself that you're not interested in a possible romance?”

“Not a complicated one.” Wyndham said. She waited for the waiter to refill their coffee cups, and then continued. “And this one—he is handsome and intelligent, a poet, but . . . well, perhaps a bit below my station, if that doesn't sound too crude.”
1. What does Wyndham say gives her something to strive for?
   a) her dahlia competitions
   b) a new romance
   c) her self-discipline
   d) her interest in poetry
2. Who interrupts Wyndham to ask her a question?
   a) Anne
   b) Charles
   c) the waiter
   d) Robert
3. What reason does Wyndham give for resisting a romance?
   a) it could be complicated
   b) it could be stressful
   c) she can't afford the time
   d) her children need her
4. What does Anne suggest Wyndham is trying to convince herself that she's not interested in?
   a) romance—two people holding hands
   b) flowers(dahlias) (repeats s09_q5_a)
   c) white rose (repeats s04_q4_b)
   d) wheelbarrow (repeats s08_q5_a)
5. What does Wyndham wait for while talking with Anne and Charles?
   a) coffee cup with liquid pouring into it
   b) the check (the bill for their food and beverage)
   c) taxi
   d) train
      Segment 13—WC 152

Charles wiped his mouth with his napkin. “Below your station? How do you mean?”

Wyndham skirted the question and went on to explain that her life was going smoothly, and she wasn't sure she wanted to stir the waters.

“For Pete's sake, Wyn, stir the waters! You're bored, face it,” Charles laughed, and Wyndham gave him a playful glare to show she knew he was right.

The three of them talked for two hours, with too many refills, and finally they ordered lunch just to counteract the caffeine. Anne played the devil's advocate, while Charles, being Anne's older brother, took the opposite role, and goaded Wyndham to take a chance, get bold, let her hair down. Finally he looked sincerely into her eyes, and said, “If you think there is any chance you could love this mystery poet, then give it your all.” By the time they parted, Wyndham was convinced.
1. How does Wyndham respond to Charles' question about her suitor being below her station?
   a) she skirts it
   b) she thinks about it
   c) she answers it
   d) she reframes it
2. Charles accuses Wyndham of what?
   a) being bored
   b) insincerity
   c) stirring the waters
   d) ignorance
3. How does Wyndham respond to Charles' accusation?
   a) playfully
   b) angrily
   c) she is confused by it
   d) analytically
4. What did Wyndham, Anne, and Charles order after talking for two hours?
   a) lunch—a plate with a sandwich
   b) breakfast—eggs and bacon (repeats s01_q4_c)
   c) coffee cup with steam coming from it (art repeats later)
   d) croissant (repeats s06_q4_a)
5. What do Wyndham, Anne, and Charles have too much of?
   a) coffee cup with steam coming from it (repeats s13_q4_c)
   b) heart (repeats s03_q4_d)
   c) strawberries (repeats s06_q4_c)
   d) clock (to indicate time)
      Segment 14—WC 147

Friday Wyndham awoke earlier than usual and went straight to her desk. “Dear Robert,” she wrote on plain stationery, “Please meet me in the dahlia bed . . . ” She stopped, thinking better of her wording and began again on a fresh piece of paper. “Please meet me in the dahlia garden at 10:00. We have flowers to discuss.” Then, feeling bold, she added, “And if you would, please check the rose garden below my window first thing this morning for . . . ” for what, she wondered, “for flaws,” she decided ridiculously, adding, “I'm sure I will enjoy the view . . . knowing it is perfect.”

She sealed her note in an envelope and wrote another to Ivy. “Please post this memo for Robert on the garden shed so he'll see it when he arrives. Thank you.” She leaned the note and the envelope outside her door and awaited the arrival of her breakfast tray.
1. What time does Wyndham awake?
   a) earlier than usual
   b) the same time as always
   c) later than usual
   d) when the sun shines in
2. What wording does Wyndham change in her note?
   a) “bed” to “garden”
   b) “bed” to “flowers”
   c) “insects” to “flaws”
   d) “flowers” to “flaws”
3. To whom does Wyndham write the second note?
   a) Ivy
   b) Robert
   c) herself
   d) Charles and Anne
4. What does Wyndham tell Robert she wants to discuss?
   a) flowers (dahlias) (repeats s09_q5_a)
   b) raindrops (repeats s03_q5_c)
   c) envelope (repeats s05_q4_c)
   d) dollar signs (to indicate money) (repeats s11_q5_b)
5. Wyndham awaits the arrival of what?
   a) tray with teapot, teacup, shallow bowl with fruit, and egg cup
   b) bouquet of roses
   c) envelope (repeats s05_q4_c)
   d) small gift box with bow (repeats s05_q4_b)
      Segment 15—WC 95

She watched Robert among the roses, all the way through her first cup and her second, and she barely touched her fruit. He inspected them tenderly, his tan arms moving gracefully among the thorns. He moved below her, never glancing up, and she imagined herself loving him for that quality of restraint, and even more for the subtle seduction of poses struck for her benefit—the slow arching of his back as he stretched in the morning sun; the pause for a deep breath of the fragrant Damask rose; the way he removed his vest.
1. Wyndham barely touches what?
   a) her fresh fruit
   b) her tea
   c) her face
   d) the window
2. What is Robert tending while Wyndham drinks her tea?
   a) roses
   b) herbs
   c) dahlias
   d) delphinium
3. What does Wyndham imagine loving about Robert?
   a) the quality of restraint
   b) his sense of humor
   c) his tan face
   d) his gardening skill
4. What does Robert smell?
   a) Damask rose
   b) coffee cup with steam rising from it (repeats s13_q4_c)
   c) perfume atomizer (art repeats later)
   d) fish
5. What does Wyndham see Robert remove?
   a) man's vest
   b) wheelbarrow (repeats s08_q5_a)
   c) thorn(s) on a stem
   d) man's shirt
      Segment 16—WC 99

When he moved on to the herbs she moved with him, opening up the west bedroom for the first time in years to stand in her robe, unseen at the window. She had never appreciated the poetry in his routine—the rhythm of his movement as he trimmed back the rosemary, shaped the edge of thyme along the curving stone where it trailed, clipped the lavendar to hang upside down on the trellis to dry for flower arrangements.

She imagined how his hands must be scented now, with the herbs and the sun and her eyes all on them.
1. What does Wyndham open for the first time in years?
   a) an unused bedroom
   b) the window
   c) her music box
   d) a sealed envelope
2. What does Wyndham appreciate at the window?
   a) the way Robert moves
   b) the herb garden
   c) Anne and Charles
   d) an old love letter
3. What herbs are mentioned in Robert's routine?
   a) rosemary and lavendar
   b) lavendar and vanilla
   c) sage and rosemary
   d) rosemary and mint
4. Wyndham thinks about the scent of what?
   a) man's hands
   b) flowers (dahlias) (repeats s09_q5_a)
   c) white rose (repeats s04_q4_b)
   d) coffee cup with steam rising from it (repeats s13_q4_c)
5. What does Wyndham stand near as she watches Robert?
   a) window
   b) chair (repeats s10_q4_a)
   c) arched arbor (repeats s07_q4_c)
   d) door (repeats s04_q5_d)
      Segment 17—WC 97

Back in her own room, Wyndham pondered her closet. It seemed unusually drab, and what could possibly be suitable for a casual-but-not-casual meeting among dahlias?

She wished she had something common and loose, in tangerine, three light layers with two of them sheer—but she did not, and settled on a comfortable light green garden smock. She bathed and dressed without looking in the mirror, so as not to risk disappointment, relying on the feeling in her skin and eyes to give her confidence. At one minute after ten, she walked into the dahlia garden toward Robert.
1. Back in her room, Wyndham spends time pondering what?
   a) what to wear
   b) her tangerine smock
   c) her own reflection
   d) the passage of time
2. At what time does Wyndham enter the garden to meet Robert?
   a) one minute after ten
   b) ten o'clock sharp
   c) five minutes early
   d) five minutes late
3. Why does Wyndham not look in the mirror?
   a) she might be disappointed
   b) the mirror is broken
   c) it's bad luck
   d) she's in a hurry
4. How does Wyndham prepare for her rendezvous?
   a) bathtub filled with water (to indicate bathing)
   b) lipstick
   c) perfume atomizer (repeats s15_q4_c)
   d) praying hands
5. What color smock does Wyndham choose to wear?
   a) light green-colored smock
   b) tangerine-colored smock
   c) lavendar-colored smock
   d) dark red-colored smock
      Segment 18—WC 113

Robert was on his knees with his head hidden in a riot of color, tossing handfuls of young weeds into a pile behind him. She watched the movement of his hips a moment while wondering how best to get his attention.

She picked up a wooden garden stake nearby and tapped him smartly on his bottom.

He bolted upright and saw her standing there, smiling. “S-sorry, just . . . just cleaning the beds,” he sputtered, glancing at the stake still in her hand, “I didn't hear you coming.”

“That's quite alright,” Wyndham smiled, “it seems surprise is the theme, of late.”

They stood there looking at one another for a long moment. “Well.” Wyndham finally said.
1. What is Robert doing when Wyndham arrives?
   a) weeding
   b) singing
   c) sputtering
   d) dozing
2. What does Wyndham tap with the garden stake?
   a) Robert's bottom
   b) the ground
   c) the fencepost
   d) Robert's shoulder
3. What is the theme Wyndham mentions?
   a) surprise
   b) flowers
   c) color
   d) flirtation
4. What does Wyndham use to get Robert's attention?
   a) a garden stake (they are square, about 4 feet tall, with a point on the bottom) (art repeats later)
   b) flowers (dahlias) (repeats s09_q5_a)
   c) small hand bell
   d) garden trowel (repeats s08_q5_c)
5. What does Robert glance at when he speaks to Wyndham ?
   a) a garden stake (they are square, about 4 feet tall, with a point on the bottom) (repeats s18_q4_a)
   b) eyes on female face (repeats s03_q4_a)
   c) garden gate (repeats s04_q4_c)
   d) small white bird (repeats s07 q5_b)
      Segment 19—WC 113

Made nervous by her strange smile, and his backside still remembering if not stinging, Robert simply replied, “The flowers?” referring to the note on the garden shed.

“Yes,” Wyndham said. “Let's start with the Nellie Bloomhead, shall we?”

She expected him to say something, but instead he led her down the path, and she followed, until they came to her bright prized Nellie Bloomhead. He adjusted the stakes and twine, and then before he could say a word about the health of the plant or what he'd been feeding it, he felt her hand on his neck. There he stood, between Nellie and Wyndham, frozen as the sun itself on the summer solstice.
1. How does Robert feel in this interaction?
   a) nervous
   b) competent
   c) angry
   d) proud
2. Wyndham expects Robert to say something, but what does he do instead?
   a) leads her down the path
   b) snips a dahlia
   c) touches her
   d) smiles
3. What does Wyndham do when they get to the Nellie Broomhead dahlia?
   a) touches Robert
   b) adjusts the garden stakes
   c) taps Robert with a stick
   d) asks about its health
4. Where had Robert found his note from Wyndham?
   a) envelope tacked to weathered wood (garden shed)
   b) envelope tucked in bouquet
   c) mailbox
   d) envelope leaning on stone garden bench
5. Robert, in his surprise, is frozen as what?
   a) sun (repeats s03_q5_a)
   b) popsicle
   c) icycle hanging from eaves
   d) snowman
      Segment 20—WC 128

“Against the painted garden wall . . . ” Wyndham recited the first line of his poem, certain he would join in.

“Ma'am,” Robert whispered shakily.

Wyndham took a step back. “Do you know anything about a Nellie Broomhead left for me on the patio, or an Alpen Snowbird on the stone bench?”

“Yes, ma'am. Your friend Charles left them. He's taken an interest in dahlias.”

Like a fallen skater bouncing up from the ice, like a chef catching a descending tomato before it hits the floor, Wyndham's recovery was flawless.

“Tell him, please,” she said, “next time you see him, that his taste is impeccable.”

She dismissed Robert from their 10:00 meeting, and strolled down the long rows of exploding color, thinking about Charles, his long graceful hands and kind heart.
1. Why does Wyndham begin to recite the poem?
   a) so Robert will join in
   b) to remember the words
   c) to make fun of it
   d) to show appreciation
2. What does Wyndham do after she dismisses Robert?
   a) stroll through the dahlias
   b) call Charles
   c) weeps
   d) remembers the poem
3. What message does Wyndham ask Robert to pass on to Charles?
   a) his taste is impeccable
   b) to meet her at 10:00
   c) to please call her
   d) the meeting is cancelled
4. Wyndham's recovery is compared to what being caught?
   a) red tomato
   b) small white bird (repeats s04_q5_b)
   c) coin
   d) rainbow
5. When Wyndham thinks about Charles, she thinks of what?
   a) hands and heart
   b) heart and eyes
   c) eyes and hands
   d) mouth and heart
      The first response listed is always the correct response.
      Questions with picture response buttons are always numbers 4 and 5.
      The Obstacle Course
      Segment 01—WC 108

Rita's hands trembled. “Officer, there's been an accident,” she said. She held the phone in one hand and jotted notes with the other in pink highlighter, the only thing she could find after her purse had spilled its contents on the floor of her car.

“Goodwin,” she said, spelling out her last name.

Rita regained her bearings as she answered the officer's questions. She didn't seem to be hurt, just rattled. Her car, on the other hand, was badly dented and scraped—that beautiful cobalt blue custom paint. It was a birthday present that her late husband had been so proud to unveil for her in their driveway.
1. What is the first name of the woman in the story?
   a) Rita
   b) Rosa
   c) Gina
   d) Tina
2. To whom is the woman speaking?
   a) a police officer
   b) her daughter
   c) her husband
   d) the emergency room
3. What is special about Rita's car?
   a) all of these
   b) its custom color
   c) it's from her husband
   d) it's a birthday present
4. What color ink is she writing with?
   a) pink
   b) yellow
   c) blue
   d) black
5. What was damaged in the accident?
   a) a blue car
   b) a purse
   c) a silver car
   d) a hand
      Segment 02—WC 93

After a long afternoon dealing with a ruined fender, phone calls, and the tow truck that hauled her poor car off for repairs, Rita finally took a taxi home. She arrived to find that her daughter-in-law was preparing her favorite meal of stuffed game hens and asparagus salad. She thought such doting was pleasantly uncharacteristic until the meal was done and dessert was served. Then, as her son cut into the lime pie, he turned the conversation to an old sore spot.

“Mom,” he said, “we really think it's time you stopped driving.”
1. What happens with Rita's car?
   a) it's towed
   b) it's impounded
   c) she abandons it
   d) it sits in her garage
2. What is served for dessert?
   a) lime pie
   b) lemon pie
   c) lemon cake
   d) angel food cake
3. What does Rita's daughter-in-law do?
   a) makes her a nice meal
   b) gives her a ride home
   c) calls a taxi for her
   d) asks her to stop driving
4. What is Rita's favorite vegetable?
   a) asparagus
   b) artichoke
   c) broccoli
   d) pea pods
5. How does Rita get home?
   a) taxi
   b) bus
   c) blue car
   d) pedestrian sign (to signify walking)
      Segment 03—WC 109

Rita bristled. “It wasn't my fault,” she said firmly. “There was a chunk of metal in the road. I had to swerve to miss it and scraped a fire hydrant. My driving is fine. My eyesight is fine. My judgment is fine. Now goodnight. I've had a long day.”

Her son poured more tea and said he knew how strongly she felt about it, but he wasn't convinced that at age 75 her reflexes were what they used to be. He assured her he was just worried for her safety.

Rita looked at him knowingly and simply said, “What would you do with my car?”

Her son didn't answer.
1. How does Rita respond to her son's suggestion?
   a) she protests
   b) she walks away
   c) says it was a close call
   d) she cries
2. How does Rita describe the accident?
   a) she scraped a hydrant
   b) her fender fell off
   c) she hit a road obstacle
   d) she didn't see it coming
3. What does his son say he's worried about?
   a) her reflexes
   b) her driver's license
   c) her eyesight
   d) car insurance
4. What best describes Rita's feelings about this conversation?
   a) Rita's face frowning
   b) Rita's face with a straight mouth
   c) Rita's face smiling
   d) Rita's face frowning with tear drop
5. What are they drinking with dessert?
   a) a tea cup
   b) a glass of milk
   c) a wine glass
   d) a soda can
      Segment 04—WC 89

A few days later Rita sat patiently in the waiting area of Sammy's Auto Body Shop. She studied the coffee table in front of her made of stacked tires and a top of thick green glass. Among the magazines and brochures scattered on it was a small pile of yellow flyers. “Drive Like A Pro!” the heading said. “Starting October 16th—Safety Driving Course.”

She picked up a flyer and read further. “Your Car or Ours and a Proven Obstacle Course!”

Rita wondered how one proves an obstacle course.
1. What is the name of the auto body shop?
   a) Sammy's
   b) Teddy's
   c) Snappy's
   d) Goodwin's
2. What month is mentioned in the flyer?
   a) October
   b) January
   c) September
   d) August
3. What is the flyer advertising?
   a) a class
   b) a video
   c) a car
   d) a tire sale
4. What color is the flyer that Rita notices?
   a) yellow flyer
   b) pink flyer
   c) orange flyer
   d) light blue flyer
5. What does the coffee table look like?
   a) stacked tires and a top of thick green glass
   b) glass table with wooden legs
   c) wooden apple crate
   d) wooden table
      Segment 05—WC 114

As Rita tucked the flyer into her purse, a workman stepped in from the back. He held the swinging door open with his foot while he wiped his hands with a rag. Through the opening Rita saw a teenage boy bending with great concentration over a piece of painted metal, rubbing intently with a cloth. One hand moved in fast circles and the other occasionally wiped something white on the leg of his excessively roomy pants. He seemed to badly need a belt. The way these kids dress, Rita thought, the girls are too skimpy and the boys too baggy.

The man interrupted her thoughts. “Your car's ready, Mrs. Goodwin. It's out front. Sorry for the wait.”
1. What does Rita notice beyond the door?
   a) a boy
   b) a blue car
   c) a girl in skimpy clothes
   d) a glass table
2. What does the boy seem to be doing?
   a) polishing a car part
   b) changing a tire
   c) goofing off
   d) talking to a girl
3. What is Rita feeling critical of?
   a) youth
   b) slow service
   c) the rude mechanic
   d) her son
4. What does Rita feels the boy needs?
   a) a belt
   b) a wrench
   c) new shoes
   d) a soda
5. What describes the movement of the boy's work?
   a) a circle or “spring” of circles
   b) a zig zag
   c) an up-arrow
   d) a down-arrow
      Segment 06—WC 128

The following Saturday, as part of a deal with her family to prove that she was not a risk on the road, Rita was seated in the Safety Driving Course. The room smelled of onion bagels and auto grease. The October sun sliced across the middle of the whiteboard on the wall. On the board was a diagram of lines and triangles in green marker, punctuated by little car-shaped magnets.

There were 10 people in the class, of different ages and types. She noticed with some pride that she was clearly the most senior person there. Directly in front of her was a man with a shiny bald head. To his right was a woman in supposedly casual clothes that looked like they'd been prepped by a butler.
1. What day of the week is it?
   a) Saturday
   b) Tuesday
   c) Wednesday
   d) Friday
2. How many people are in the class?
   a) ten
   b) forty
   c) fourteen
   d) eight
3. What is on the whiteboard?
   a) all of these
   b) magnets
   c) green ink
   d) a diagram
4. What does she notice about the man in front of her?
   a) bald head
   b) mustache
   c) nose (profile)
   d) ear
5. What does Rita smell?
   a) onion (or bagel)
   b) cigarette with smoke
   c) perfume (atomizer)
   d) garlic
      Segment 07—WC 87

On Rita's right, a teenage boy with rather frightening orange hair was bouncing his leg nervously. Suddenly she recognized the pants and their white stains. “Pardon me, young man,” she said, “what's your name?” The boy looked at her without answering. “Your name?” she repeated.

“Marco.”

“Hello Marco. I'm Rita Goodwin. Do you work at an auto body shop?” He nodded, barely. She tried not to stare at the small silver ring in his eyebrow. “I saw you there last week. You were working like a fiend.”
1. Where is the teenager?
   a) on Rita's right
   b) behind Rita
   c) sitting on the desk
   d) in the auto body shop
2. What is the boy's name?
   a) Marco
   b) Mikey
   c) Lucas
   d) Paulo
3. What does Rita remember about the boy?
   a) his industriousness
   b) his face jewelry
   c) his name
   d) his age
4. What does she try to ignore?
   a) boy's face with a ring in eyebrow
   b) boy's face with a ring in nose
   c) boy's face with a ring in lip
   d) boy's face with three rings in one ear
5. What does Rita find a bit frightening about the boy?
   a) spiky orange hair
   b) spiky pink hair
   c) spiky blue hair
   d) spiky green hair
      Segment 08—WC 108

Marco looked cautiously at Rita. His eyes changed almost imperceptibly. “Are you the lady with the blue Cadillac?”

They were interrupted by the instructor who began his lecture.

Marco pulled a purple pencil with a big black eraser on it out of some invisible compartment in his hair and began taking notes furiously. Rita studied him from the comer of her eye. She felt repelled by the chaotic hair and dirty pants, but she was curious too. She liked contradiction, and here was a live one: an industrious teenager; a shy rebel. She noted the bouncing leg again and wondered if he was hyped up on drugs.
1. How does Marco feel about Rita?
   a) cautious
   b) suspicious
   c) cynical
   d) angry
2. Where does Marco hold his pencil?
   a) in his hair
   b) in his mouth
   c) in his pocket
   d) none of these
3. What makes Rita wonder if the teen is on drugs?
   a) bouncing leg
   b) pierced eyebrow
   c) dirty pants
   d) his lack of attention
4. What does his pencil look like?
   a) purple pencil with round black eraser
   b) purple pencil with round orange eraser
   c) black pencil with round purple eraser
   d) green pencil with round orange eraser
5. What kind of car does Marco ask about?
   a) blue Cadillac (sedan)
   b) white Cadillac (sedan)
   c) blue convertible sports car
   d) white convertible sports car
      Segment 09—WC 99

When they were dismissed for a mid-morning break, Rita turned to Marco again and said, “Yes, to answer your question, I'm the lady with the blue Cadillac. It was a gift from my husband the same year he died.”

Marco didn't know how to reply to this, and excused himself to find the vending machines. When he returned, Rita had another question for him. “I don't mean to be rude, but what is the point of this . . . ” she waved her hand at him, “. . . this outfit you have? Are you trying to scare people on purpose?” Marco sat down without answering.
1. What does Rita remember to do after the lecture?
   a) answer Marco's question
   b) get directions
   c) make a phone call
   d) find her checkbook
2. When did Rita get the car?
   a) before her husband died
   b) when she turned 65
   c) after an accident
   d) in October
3. What is Rita's question to Marco about?
   a) clothing
   b) the vending machines
   c) how old he is
   d) cars
4. What does Rita wave at Marco?
   a) a hand
   b) a handkerchief
   c) a pencil
   d) a flag
5. Where did Marco excuse himself to go?
   a) the vending machines
   b) the bathroom
   c) blue car
   d) bus
      Segment 10—WC 96

That afternoon the class moved outside and took turns practicing on the course—skids, swerves, and sudden braking. On the bleachers, watching the woman with the pressed jeans show off in her black Lamborghini, Marco finally spoke. “What are you doing in this class, anyway?” he asked Rita.

“You mean at my age?” she replied. Rita explained about the accident, and her family's request that she stop driving. She added, “They won't admit it, but they want my car for my granddaughter who just started college. I'm sure she'd trade it in for a tin can.”
1. What does the class practice in the afternoon?
   a) skids, swerves, braking
   b) swerves and slow stops
   c) turning around cones
   d) European cars
2. Rita is taking the class because she wants to do what?
   a) prove her driving skill
   b) renew her license
   c) learn to avoid accidents
   d) teach her granddaughter
3. Why does Rita say the family wants her to quit driving?
   a) they want her car
   b) they're worried about her
   b) insurance rates are high
   d) because she is too old
4. What does Rita compare compact cars to?
   a) a tin can
   b) breadbox
   c) a ladybug
   d) a cube
5. Where do Rita and Marco have a conversation?
   a) bleachers
   b) table
   c) blue car
   d) grass under a tree
      Segment 11—WC 119

“And you?” Rita said. “Why are you in this class?”

Marco blushed. He removed and redocked his pencil in his rough sea of hair. “My parents don't drive, and I need to get really good.”

“For a girl?” Rita guessed. Marco blushed, and just shrugged.

“I'm working after school and weekends for a car. My parents don't think I can save enough and afford insurance too. But I really want it, and I hope I can make enough to buy it before April.”

Rita guessed again. “For the spring prom?”

“Who are you, lady?” Marco said, annoyed, and blushed again.

The instructor promised wet roads and oil slicks for the next class, and dismissed them until the following week.
1. Why is Marco taking the class?
   a) to improve his driving
   b) to pass his license exam
   c) to satisfy his parents
   d) to earn money
2. What does Marco tell Rita about a girl?
   a) nothing
   b) her name
   c) that she doesn't drive
   d) that she's his prom date
3. How are the classes scheduled?
   a) weekly
   b) daily
   c) one weekend
   d) two weekends
4. What does Marco fiddle with out of nervousness?
   a) purple pencil with black eraser
   b) coin
   c) sunglasses
   d) wrist watch
5. What does the instructor say is ahead for the class?
   a) puddle of oil on road
   b) three orange cones
   c) graduation cap
   d) rain drops
      Segment 12—WC 72

The next week, Rita showed up with blue leather driving gloves, ready for action. Marco wore the same pants, which looked just fine with the slightly dented gray hatchback provided for him by the driving school, and Miss Lamborghini showed up in shiny black capris, a tight black sweater, and stark white running shoes. They all wore sunglasses, as recommended by the instructor who'd said to prepare for glare and reduced visibility.
1. How is Rita feeling when she shows up for class?
   a) ready for action
   b) suspicious of Marco
   c) angry at her family
   d) tired and old
2. Whose car is Marco driving?
   a) the driving school's
   b) a rental car
   c) his parents'
   d) Miss Lamborghini's
3. What is the woman who owns the Lamborghini wearing?
   a) tight black sweater
   b) French driving skirt
   c) pressed blue jeans
   d) black gloves
4. What does Rita have that shows she's ready for driving?
   a) blue gloves
   b) map
   c) sunhat
   d) orange cone
5. What did all the students bring to class?
   a) sunglasses
   b) white running shoes
   c) black gloves
   d) standard #2 pencils
      Segment 13—WC 101

On the bleachers, waiting for her turn to maneuver her way through an oil slick, Rita apologized to Marco for prying the week before.

“That's ok,” Marco said. “I guess I forget you were my age once.”

“I certainly was,” Rita said, securing a hair pin at the back of her head. “And what a great age it was. I remember the proms, and the dancing—but then, I went dancing every Saturday.”

Marco raised his eyebrows. The skin under the silver ring puckered, and Rita tried not to look at it.

“Oh yes,” she said. “Every Saturday at Sweet's Ballroom.”
1. What does Rita offer Marco?
   a) an apology
   b) some advice
   c) a stick of gum
   d) all of these
2. What is Rita feeling nostalgic about?
   a) all of these
   b) dancing
   c) a ballroom
   d) being a teenager
3. What did Rita do when she was a teenager?
   a) went dancing
   b) drove cars
   c) wore her hair down
   d) drove her father's car
4. What does Rita have in her hands?
   a) a hairpin
   b) a purse
   c) a silver ring
   d) a small oil can
5. What does Rita try not to stare at?
   a) [use enlarged detail of eyebrow in] boy's face with a ring in eyebrow
   b) spiky orange hair
   c) blue car
   d) lady's wristwatch
      Segment 14—WC 103

Her eyes sparkled. She couldn't believe Marco had never heard of the musicians and bands that had been so famous-Benny Goodman, Glenn Miller, Tommy and Jimmy Dorsey.

“I remember the mirror balls, and being right below the stage, watching the Andrews sisters—those turquoise gowns.” Rita paused.“And, oh—what was that drummer's name—oh, Gene Krupa! He got arrested for marijuana the night after I saw him, you know! At the Golden Gate Theatre.”

Marco asked if she'd had a boyfriend. “Oh yes,” she said. “Clarence. He was a true gentleman. He bought me a gardenia corsage every Saturday. 25 cents a piece.”
1. What had Marco never heard of?
   a) musicians of Rita's era
   b) ballroom dancing
   c) the Golden Gate Theatre
   d) mirror balls
2. How much did a corsage cost?
   a) a quarter
   b) fifty cents
   c) a dollar
   d) free with a dance ticket
3. What happened to Gene Krupa?
   a) he got arrested
   b) he asked Rita to dance
   c) Glenn Miller fired him
   d) he got drunk
4. What did Rita's boyfriend buy for her?
   a) gardenia with a “pearl-head” pin in stem
   b) an orange drink
   c) pack of gum
   d) bouquet of daisies
5. What does Rita remember the Andrews' sisters?
   a) turquoise gown(s)
   b) cigarettes
   c) red lips
   d) gardenia with a “pearl-head” pin in stem
      Segment 15—WC 77

The instructor called Marco up next to run the obstacle course; Rita watched him. Sudden stop for the rolling basketball. Slow correction for the oil slick. Steady soft brake on the simulated ice patch. Six orange cones, unscathed.

I hope he gains as much confidence with the girls, Rita thought. He'd be a handsome young man if he'd fix that hair and get some new pants.

The instructor's voice broke her thoughts. “Rita Goodwin. You're up next.”
1. What does Rita do while Marco drives?
   a) watches him
   b) criticizes him
   c) thinks about being young
   d) starts her car
2. How does Rita view Marco as a driver?
   a) confident
   b) cocky
   c) reckless
   d) nervous
3. What happens when the instructor tells Rita she's up next?
   a) it breaks her thoughts
   b) it frightens her
   c) it ends her conversation
   d) it excites her
4. What moving obstacle does Marco stop for?
   a) basketball
   b) bicycle
   c) orange cones
   d) railroad guard
5. With what does Marco seem to lack confidence?
   a) a girl
   b) sheet of paper with “Exam” written at top
   c) basketball
   d) steering wheel
      Segment 16—WC 116

At the end of the afternoon, certificates were handed out to eight of the ten students. Rita fished a roll of tape from her purse and mounted hers to the inside of her back windshield, with every intention, she said, of backing into the driveway when she got home so her family could see it from the dining room table. Marco tucked his in his notebook. He waved to Rita as she got in her car, and started walking toward his bus stop.

Suddenly he heard an unmistakable scraping sound, and turned around just in time to see the cobalt blue paint peeling off the back right fender, and Rita's face turn about three shades whiter.
1. How many students passed the class?
   a) eight
   b) ten
   c) twelve
   d) six
2. What does Marco hear?
   a) a scraping sound
   b) his named being called
   c) breaking glass
   d) someone crying
3. Where is the damage on the car?
   a) back right fender
   b) back bumper
   c) back left fender
   d) passenger door
4. What does Rita find in her purse?
   a) roll of scotch tape
   b) scissors
   c) keys
   d) address book
5. How does Marco plan to get home?
   a) bus
   b) blue car
   c) taxi
   d) pedestrian sign (to signify walking)
      Segment 17—WC 93

“It could happen to anybody,” Marco said, trying to quiet Rita who was now sobbing into her blue gloves. “That railing was right in your blind spot.”

“I don't know,” Rita shook her head. “Maybe my son is right. Maybe it's time to let go. Perhaps I'm not as quick as I thought.”

“What are you going to tell your family?” Marco asked.

“I think I'll just park it next to the hedge. They won't see the dent tonight,” she said, removing the certificate from the windshield. “I'll sleep on it. Maybe they're right.”
1. What does Marco say to Rita?
   a) the railing was hidden
   b) her son will be upset
   c) she'll ruin her gloves
   d) the bus isn't so bad
2. What will Rita tell the family that night?
   a) nothing
   b) she passed the class
   c) she hit a railing
   d) she'll give up driving
3. How does Rita plan to hide the damage on the car?
   a) parking by the hedge
   b) parking in the garage
   c) parking next door
   d) she's not going to
4. What best describes Rita's feelings now?
   a) Rita's face frowning with tear drop
   b) Rita's face with straight mouth
   c) Rita's face smiling
   d) Rita's face frowning
5. What does Rita remove from the car?
   a) sheet of paper with “Certificate” written at top
   b) purse
   c) sheet of paper with “Exam” written at top
   d) gloves
      Segment 18—WC 108

Rita didn't sleep well at all, in fact. The next morning, she started her blue Cadillac for the last time. She pulled out away from the hedge and into the driveway, in clear view of the front door. There she listened to the car radio and waited for her son to come out of the house on his way to work. She had her title in hand, a business card for Sammy's Auto Body Shop, and her words ready.

When her son saw her sitting there in the car, he stopped and looked a moment. Finally he came around and opened her door. “What are you doing, Mom?”
1. How does Rita feel in the night?
   a) sleepless
   b) peaceful
   c) she has a headache
   d) angry
2. What does she have ready to give her son?
   a) the title to her car
   b) her class certificate
   c) money
   d) directions
3. Why is her son confused?
   a) his mother is in her car
   b) the car is missing
   c) he's lost
   d) his wife is alarmed
4. What is Rita listening to?
   a) car radio
   b) bird singing
   c) phone
   d) raindrops
5. What can Rita see from the car?
   a) the front door of a house
   b) the sunrise
   c) a taxi
   d) a garage
      Segment 19—WC 115

Rita got out and walked around to the other side of the car. “Well, this . . . ” she started to say, indicating the place where she expected a long ugly scrape. But there was nothing—nothing but a beautiful blue fender. Not a mark. In fact, it looked especially shiny—a little shinier than the rest.

“Mom, what's up?” he said.

“Um, oh . . . nothing,” Rita said, confused. “I mean, I . . . I wanted to show you my certificate.” She opened the door to get the certificate off the front seat, and there, underneath it, was Marco's purple pencil with its big black eraser.

“Congratulations, Mom,” her son said unconvincingly, while Rita's mind reeled. Marco, she thought, crossing her arms, how in the world . . . .
1. What does Rita plan to show her son?
   a) the dent
   b) the certificate
   c) the front fender
   d) all of these
2. From where does Rita get her certificate when she shows it to her son?
   a) the front seat
   b) the rear windshield
   c) her purse
   d) the glove compartment
3. How does Rita feel when she sees the fender?
   a) confused
   b) indignant
   c) angry
   d) embarrassed
4. What does Rita find on the car seat?
   a) purple pencil with round black eraser
   b) keys
   c) purse
   d) business card with Sammy's Auto Body
5. What is different about the fender?
   a) shiny fender
   b) dented fender
   c) dirty fender
   d) fender with some paint scratched off
      Segment 20—WC 91

Early the following April, Marco returned to the shop to find an envelope addressed to him. Inside, a note said, “Hello, Marco. I hear you're still working hard for that car. I'm going on vacation for three weeks, and thought you might enjoy a loaner for the prom.” Marco stared at two silver Cadillac keys taped to a blue card.

The note continued, “No horseplay or smoking please. Otherwise, have fun and be a gentleman. Everyone loves a true gentleman. Rita.”

Marco broke into a smile.
1. Why does Rita give Marco the keys to her car?
   a) to use it for the prom
   b) to repair it
   c) to sell it
   d) to use it for class
2. What does Rita request in her note?
   a) be a gentleman
   b) no speeding
   c) no drinking
   d) all of these
3. How long will Rita be out of town?
   a) three weeks
   b) one week
   c) two weeks
   d) over the weekend
4. What color are the keys?
   a) silver keys
   b) blue keys
   c) orange keys
   d) green keys
5. What is in the envelope?
   a) two keys
   b) one key
   c) greeting card
   d) check
      The first response listed is always the correct response.
      Questions with picture response buttons are always numbers 4 and 5.
      The Spot
      Segment 1

Jeremy was an open-hearted and gregarious man. He always took the time to stop and chat with those he encountered. His three brothers often joked that you couldn't tell Jeremy anything you didn't want the whole town to know. But on one subject, Jeremy was uncharacteristically mute. trout fishing. In another family, his silence on the matter might have gone unnoticed, but the Madden family was mad for trout. As boys, Jeremy and his brothers had been avid fishermen, often skipping school to sneak away to a quiet creek. Their findings were usually unimpressive—maybe a couple of fish for supper. But when Jeremy became an adult, he stopped going out with his brothers. And at their yearly Thanksgiving gathering, where conversations centered around bait, fishing techniques, and good fishing spots, Jeremy kept quiet.
1. What best describes Jeremy?
a. gregarious
b. stubborn
c. stingy
d. humorous
2. What is Jeremy's last name?
a. Madden
b. Wilson
c. Jensen
d. Miller
3. What was the creek the brothers snuck away to like?
a. quiet
b. secret
c. wide
d. swift
4. What do the boys of the family like to talk about?
a. trout (picture of fish)
b. books (several books in a stack)
c. baseball (baseball and bat)
d. tools (hammers/nails)
5. How many fish did the boys usually catch?
a. <show 2 fish>
b. <show 6 fish>
c. <show 0 fish>
d. <show 12 fish>
   Segment 2

Jeremy wasn't the only Madden who didn't talk about fishing. The other was Jeremy's father, Martin, a soft-spoken engineer who privately felt fishing was cruel and unfair. Born and raised in Manhattan, he did not understand his sons' fascination with fishing and was deeply relieved they did not hunt. But while Martin's silence was forgiven, Jeremy's was not, for when Jeremy disappeared in his orange fishing vest he always came back within a few hours lugging a big cooler full of the fattest trout they'd ever seen. The smallest of his catch were twice as large as the largest ones his brothers had landed, and his mother always said the pink flesh tasted absolutely perfect. buttery with a hint of almond and grass.
1. What is Jeremy's father's name?
a. Martin
b. Jerry
c. Jason
d. George
2. What best describes Jeremy's father?
a. soft-spoken
b. generous
c. optimistic
d. clever
3. How does Jeremy's father consider fishing?
a. cruel
b. sporting
c. admirable
d. boring
4. What does Jeremy wear fishing?
a. a vest (orange vest)
b. galoshes (green galoshes)
c. hat (yellow fishing hat)
d. plaid coat (red and black plaid coat)
5. What does Jeremy's mother say his fish taste like?
a. almonds, grass
b. almonds, garlic
c. apple, almonds
d. apple, grass, garlic
   Segment 3

Over the years, Jeremy's brothers had tried everything to find out where Jeremy fished, from attaching a radio tracker to his coat to breaking into his truck to check the odometer. Many an afternoon had been spent on a wild goose chase. Finally, they'd given up. Jeremy's secret spot was declared the unsolvable family mystery. He wouldn't even share it with his son, Lucas, who tagged along with his uncles and cousins instead. Still, whenever his family planned an early-morning fishing trip, Jeremy was always awake to hand his sleepy son a sandwich and a thermos of hot tea. He watched from the veranda as his brothers and son packed up their rods in the bluish dawn. As they drove away, he waved to his son, and Lucas always waved back. While he waited for their return, Jeremy played chess with his father.
1. What is Jeremy's son's name?
a. Lucas
b. Matthew
c. Jim
d. Martin
2. What have Jeremy's brothers broken into?
a. his truck
b. his cooler
c. his suitcase
d. his computer
3. With whom does Lucas fish?
a. his uncles
b. Martin
c. his mother
d. Jeremy
4. Who does Jeremy pack lunch for?
a. his son (young boy with fishing rod)
b. his brothers (three men with fishing gear)
d. his father (older man with vest)
d. Himself (middle aged man with fishing rod)
5. What does Jeremy do when the brothers go fishing?
a. Plays chess (show a hand with a chess piece)
b. Sleeps (Jeremy sleeping)
c. Reads books (Jeremy reading a book)
d. Rides a bicycle (Jeremy on a bicycle)
   Segment 4

After they waved to the departing party, Martin and Jeremy sat down on the veranda steps like two mountain men, a glass of whisky lemonade in one hand, a bowl of hot porridge in the other, a thick wool blanket on each of their laps. Their chess games would often last for hours. Much of the time, they sat in a companionable silence, though they occasionally talked about their families and lives. In this way, Martin and Jeremy built a strong relationship. Jeremy considered Martin to be one of the finest men he knew. Martin felt the same way about Jeremy.
1. Who are the two chess players?
a. Martin and Jeremy
b. Lucas and Martin
c. Jeremy and his brother
d. Lucas and Jeremy
2. What adjective would Jeremy use to describe Martin?
a. fine
b. eloquent
c. attractive
d. annoying
3. What does Jeremy and his father drink?
a. whisky lemonade
b. red wine
c. apple juice
d. chicken soup
4. Where do Jeremy and his father sit?
a. veranda steps
b. sofa (shows them sitting on the sofa)
c. grass
d. stumps (shows them sitting on stumps)
5. What do Jeremy and his father eat?
a. hot porridge (show bowl of porridge)
b. crackers (plate of crackers and cheese)
c. sandwiches (sandwiches)
d. lobster
   Segment 5

Once every Thanksgiving week, Jeremy vanished like a tomcat on an adventure of his own. A few hours later, he'd reappear with a cooler full of giant, glistening trout and Lucas would feel quite proud of his father no matter how secretive he was. To Lucas, there was nothing as beautiful or mysterious as these trout from Jeremy's secret fishing spot. The small trout he'd caught were a muddy grey, but Jeremy's monsters flashed pink and the gold of their eyes was a pure, wet gold. They were so much more alive than anything he'd seen before and, although he loved trout dinner, Lucas wanted to throw them back into their depths so they could go on being immortal.
1. How does Lucas feel when he sees Jeremy's fish?
a. proud
b. jealous
c. annoyed
d. sad
2. What are the fish that Lucas catches like?
a. muddy grey
b. giant
c. beautiful
d. enormous
3. How long does Jeremy fish?
a. for a few hours
b. for a whole day
c. for days
d. all night
4. What color is the trout's eye?
a. gold
b. grey
c. white
d. black
5. What color are the fish that Jeremy catches?
a. pink (show pink fish)
b. silver and blue (show striped white and blue fish)
c. dark grey (Show grey fish)
d. slightly green
   Segment 6

Strangely enough, there was no special trout clock for Jeremy. Sometimes he'd be gone as early as five in the morning. Other times, he slept in, loitered, then vanished late in the afternoon. This year at Thanksgiving his brothers had taken to teasing Jeremy's wife, Mary, and offering outrageous bribes if she would tell them Jeremy's secret. Mary shrugged and said she preferred turkey anyhow. She guessed that her husband simply went out and bought them at the local fish stall. Maybe the farmer next door stocked his pond with trout. She was certain that he didn't catch them himself. One time, he'd left the fishing pole behind. And he'd still come back with lots of trout.
1. How does Jeremy's wife think he gets his fish?
a. from a fish stall
b. by fishing
c. at the supermarket
d. from his brother
2. At what time does Jeremy go fishing?
a. he has no set schedule
b. noon
c. 5 p.m.
d. dawn
3. What do Jeremy's brothers do to try to discover his secret?
a. offer Mary bribes
b. offer Lucas bribes
c. confront Jeremy
d. discover Jeremy's secret
4. What does Jeremy's wife prefer to eat?
a. turkey
b. trout [repeats s01_q1_a]
c. cake
d. crab
5. What did Jeremy once leave behind, though he still came back with trout?
a. fishing pole
b. fishing net
c. wading boots
d. cooler
   Segment 7

Jeremy's brothers were frustrated by the fact that Mary would not tell them anything. Mary, in turn, felt a particular gleam of revenge when one afternoon her husband brought home fifteen of the most beautiful trout the family had ever seen. That evening, she rolled the trout in hazelnuts and fried them in butter. Everyone ate in complete silence and not a scrap of trout was left. Afterwards, as each of them sat in quiet satisfaction, Jeremy's father smiled and asked the magic question: “Jeremy, just where is this trout from? Do you sing to them?” Jeremy smiled back and said, “No, I don't sing to them.”

“Well, I'm curious, that's all.”

“Are you?” asked Jeremy. His father nodded.
1. Why is everyone is quiet during dinner?
a. they are satisfied
b. they are bored
c. they are angry
d. they are puzzled
2. How does Mary prepare the fish?
a. fries them in butter
b. dips them in flour
c. fries onions and garlic
d. uses olive oil
3. What happens while they eat dinner?
a. no one speaks
b. Martin sings
c. Lucas does a magic trick
d. the brothers argue
4. What does Jeremy bring home?
a. trout [repeats s01_q1_a]
b. ice cream
c. lemon pie
d. a gift
5. Who asks Jeremy how he catches trout?
a. his father
b. his son
c. his wife
d. his mother
   Segment 8

The next morning, just before dawn, Martin was woken by someone gently shaking him by the shoulder.

“Get up, Dad. We're going.”

Martin opened his eyes. Through the blackness he could see the silhouette of his son. Jeremy, fully dressed, was holding out a thick grey sweater. Martin flicked on a lamp.

“Wear this, Dad,” Jeremy whispered.

Looking closer, Martin saw that Jeremy had a toolbox in one hand. He was wearing thigh-high wading boots. Martin glanced at his clock. It was four in the morning. The stars were still out.
1. What does Martin see when he first opens his eyes?
a. Jeremy's silhouette
b. a toolbox
c. the stars
d. his clock
2. When is Jeremy going fishing?
a. at four a.m.
b. late in the day
c. at night
d. at daybreak
3. How does Jeremy wake his father?
a. shaking him
b. turning on the lamp
c. yelling
d. setting the alarm clock
4. What is Jeremy wearing?
a. wading boots [repeats s06_q5_c]
b. a grey sweater
c. wading pants
d. a swimming cap
5. What does Jeremy hand his father?
a. a grey sweater [repeats s08_q4_b]
b. a fishing rod [repeats s06_q5_a]
c. a down coat
d. a pair of gloves
   Segment 9

“I don't usually get up at four. Why are you up?”

“This is the only way we're going to give them the slip.”

Jeremy's father blinked. “Give who the slip? Why?”

“We're going to the trout. Just the two of us.”

“Now?”

“Yes, now. I've packed breakfast. We'll be back by noon.”

“Don't fish sleep?”

“They do and they don't. Are you coming?”

“I wouldn't miss it,” Martin said. He sat up and put on his glasses. While Martin dressed, pulling on his favorite green pants and a heavy plaid shirt, Jeremy searched for Martin's rain boots. He found them in a corner of the room, shook out a spider, and handed them to Martin. Martin stepped into them and started walking toward the garage.
1. To whom does Jeremy want to give the slip?
a. his brothers
b. his father
c. the police
d. his niece
2. Martin asks if fish do what?
a. sleep
b. swim
c. bite
d. feel
3. What has Jeremy packed?
a. breakfast
b. coffee
c. lunch
d. sandwiches and hot tea
4. What does Jeremy shake out of Martin's boot?
a. spider
b. sand/dirt
c. sock
d. cockroach
5. What does Martin put on first?
a. glasses
b. a grey sweater [repeats s08_q4_b]
c. hat [repeats s02_q4_c]
d. scarf
   Segment 10

As Jeremy and Martin got in the pickup truck, Martin asked, “Are we going to the famous secret Fishing Spot?”

“Yup.” Jeremy responded.

Jeremy began to drive. Martin sat silently in the passenger seat, thinking about Jeremy and his secret Spot.

“You know your brothers would do anything to go with you,” he pointed out. “And Lucas. Why not take him?”

“I don't think he's ready for it,” Jeremy replied.

“But I don't even fish,” Martin pointed out.

“I know, but there's something I want to show you,” explained Jeremy.

“So we are going to the Spot. Your spot,” Martin repeated.

“Well, I'm going to have to blindfold you,” Jeremy joked.
1. What does Jeremy say he's going to put on Martin?
a. blindfold
b. blanket
c. life vest
d. sweater
2. Why is Jeremy taking Martin to the Spot?
a. to show him something
b. because he likes the ride
c. to blindfold him
d. to teach him to fish
3. Who is driving the car?
a. Jeremy
b. Martin
c. Mary
d. Lucas
4. What or who does Martin suggest Jeremy take fishing?
a. his son [repeats s07_q5_b]
b. his coat [repeats s08_q5_c]
c. his pickup truck
d. his wife [repeats s07_q5_c]
5. What does Jeremy drive?
a. pickup truck [repeats s10_q4_c]
b. sportscar
c. SUV
d. sedan
   Segment 11

Martin looked out the window, and saw they were passing the gas station. It was open. He hadn't realized it was open 24 hours a day.

Martin thought about asking Jeremy to stop for a cup of coffee. “How far away is it?” he asked.

“Not far,” Jeremy responded.

They drove for another minute or so then took a bend in the road. This was the part of the creek that was closest to their house, a fifteen minute walk at most. It was a nice place for a cool swim but Martin had never seen trout there. They stopped the truck.

Jeremy laid out a blanket for his father to sit on. He poured coffee from a thermos, and handed his father a cup.

“Thanks, that's just what I needed,” his father said. In the dark, Martin heard a frog croaking.
1. What does Jeremy do with the blanket?
a. lays it out
b. puts it in the truck
c. wraps it around Martin
d. wraps it around himself
2. Where does Jeremy take Martin?
a. to a creek
b. on a long drive
c. to the store
d. to a field
3. What does Martin think the creek is a good place for?
a. swimming
b. fishing
c. sunbathing
d. bird watching
4. What do Jeremy and Martin pass on the ride?
a. a gas station
b. a pickup truck [repeats s10_q4_c]
c. cows
d. a supermarket
5. What does Martin hear in the darkness?
a. a frog
b. birds
c. mosquitoes
d. a car [repeats s10_q5_d]
   Segment 12

Martin waited quietly for Jeremy to tell him what was going on, and why they were there. But Jeremy seemed to be in no hurry to explain. Instead, he sat down beside his father. He took English muffins and homemade sausages out of a bag, and handed one of each to his father. As the two men ate, the first sign of the morning light began to drive the darkness away.

Only when he had finished breakfast did Jeremy stand up. “Watch,” he said. Martin watched. Jeremy waded into the creek and stood among the green crayfish and schools of translucent minnows. Then an enormous trout swam up to him. It swam between his legs, doing a figure eight and caressing his ankles.
1. What do Martin and Jeremy have for breakfast?
a. sausage and English muffins
b. bacon and English muffins
c. sausage and toast
d. bacon and toast
2. What does the fish caress?
a. Jeremy's ankle
b. Jeremy's hand
c. Martin's leg
d. Martin's foot
3. How are the minnows in the creek?
a. in schools
b. darting wildly
c. red and brown
d. small and black
4. In what pattern does the trout swim?
a. figure eight
b. circle
c. straight line
d. square
5. What color are the crayfish?
a. green
b. black
c. blue and red
d. grey
   Segment 13

Martin's first reaction was surprise. “I've never seen a trout out here before,” he said. Then he laughed. “That fish thinks it's a cat!”

The fish swam around until Jeremy reached into the cold water. As Jeremy pulled the fish out, Martin saw just how large the trout was.

“That trout is the mother of all trouts,” said Martin admiringly. It was as thick as Martin's leg and it had a prehistoric look to it. Several hooks were tangled in its mouth, signs of the trout's victory over more than one fisherman. “It would be a pity to kill something that's lived so long.”

“I agree. We'll let it go. There are plenty of others,” Jeremy replied, as he gently lowered the trout back into the water.
1. To what does Martin compare the thickness of the first trout Jeremy catches?
a. Martin's leg
b. Jeremy's arm
c. a baseball bat
d. a tree trunk
2. How does Martin feel when he first sees the trout?
a. surprised
b. scared
c. disgusted
d. nervous
3. What does Jeremy do with the trout?
a. lets it go
b. puts it in the cooler
c. hands it to Martin
d. kills it
4. What does Martin say the fish thinks it is?
a. cat
b. dog
c. crayfish
d. turkey [repeats s06_q4_a]
5. What is noticeable about the trout?
a. hooks in mouth
b. a torn fin
c. whiskers
d. red eyes
   Segment 14

Jeremy came back onto shore and sat down on the blanket. “I have always liked to come here when something's on my mind, or just to get some time by myself,” he began quietly. “It's a place where I can work through problems. One night about ten years ago, I was out here swimming. I remember the moon was full. Suddenly, trout started coming at me from every direction. They kept coming until I could hardly see the water through the trout. But instead of feeling panicky or nervous, I felt more relaxed than I had in a long time. Since then, I come back here whenever I can.” Jeremy looked pensive. “I don't like to keep any secrets from anyone,” he said, “but somehow this feels very private. Not to mention a little weird—I mean, I like to hang out with mystical trout.”

“I guess that is pretty unusual,” Martin agreed.
1. How long ago did Jeremy begin to attract trout?
a. ten years
b. one year
c. twenty years
d. five years
2. How did Jeremy feel the first time the trout swarmed around him?
a. relaxed
b. panicked
c. nervous
d. excited
3. How often does Jeremy come to the creek?
a. whenever he can
b. twice a week
c. as rarely as possible
d. once a month
4. What does Jeremy remember seeing on the night the trout began to surround him?
a. full moon
b. frog [repeats s11_q5_a]
c. stars
d. quarter moon
5. Where is Jeremy when he tells Martin about the trout?
a. sitting on the blanket next to the creek
b. standing in the creek
c. sitting in the pickup truck
d. sitting on the veranda
   Segment 15

Jeremy looked at the sky. It was still early morning, but the sun was on its way up. “Well,” he said, “I guess it's time we caught some trout before everyone starts to wonder where we are.” He walked back into the creek. Trout came swimming toward him from who knows where. He dipped a net in the water, and four trout obligingly swam right in. Within a matter of minutes, he had bagged sixteen beautiful fish. He put the fish in the cooler, and hauled the cooler to the back of the pickup.

“Dad?” he said, as he picked up the blanket and threw it in next to the cooler.

“Yes?”

“Part of the reason that I brought you out here was because I wanted to share this secret—of the Spot—with someone I thought would understand. But I also wanted to ask your advice about Mary.”
1. What time of day is it when Jeremy decides to catch the trout?
a. early morning
b. noon
c. mid morning
d. evening
2. What does Jeremy catch?
a. sixteen fish
b. crayfish
c. crabs
d. four fish
3. Where do the trout that swim into Jeremy's net come from?
a. it's unclear
b. an underwater cave
c. upriver
d. downriver
4. Where does Jeremy put the cooler after he fills it with fish?
a. in the back of the pickup
b. on the blanket
c. in the front of the pickup
d. on the sand
5. About what or who does Jeremy want to ask his father's advice?
a. Mary [repeats s07_q5_c]
b. trout [repeats s01_q1_a]
c. Lucas [repeats s07_q5_b]
d. fishing
   Segment 16

“What's happening with Mary?” Martin said. “Don't tell me you aren't happy with her. She's so lovely.”

“No, no, nothing like that,” Jeremy replied quickly. “But she's acting a little strangely lately, and it's got me worried.”

“What's she doing?”

“She locks herself in our bathroom every night, sometimes for hours at a time.”

“Well, maybe she's taking a bath. It's hard being a mother and a wife. She may just need a break.”

“Maybe . . . But while she's in there, I can hear her typing and giggling. And she always brings the newspaper with her. She says she's reading about the Senate elections, but they've been over for two weeks and she's still reading the paper. And giggling.”

“At least you know she's not depressed, what with all that giggling.”

“That's true. I just wish she'd let me in on whatever it is that she's doing.”
1. What does Martin think about Mary?
a. she's lovely
b. she's bored
c. she's kind
d. she's picky
2. How does Jeremy say that Mary has been acting?
a. strange
b. angry
c. quiet
d. tired
3. What does Mary do while she types?
a. giggles
b. sighs
c. talks
d. eats
4. Where does Mary lock herself each night?
a. bathroom
b. kitchen
c. bedroom
d. pickup cab
5. What does Mary bring into the bathroom with her?
a. newspaper
b. book
c. soap
d. magazine
   Segment 17

“Have you tried asking her?” asked Martin. “Sometimes it pays to be straightforward.”

“I asked. She smiled and said ‘A rose is a rose is a rose’.”

“Did you ask her what that meant?”

“Yes. And she said that ‘A rose by any other name would smell as sweet.’”

“That's Shakespeare.”

“I thought so. Anyway, I asked her what that one meant and she just gave me another riddle. She told me to look under the rose. So I dug up the rose bush, but there was nothing there.”

Martin smiled. “Mary has always been clever. I guess you'll have to do some detective work to figure out her secret.”

“You don't think I'm invading her privacy?”

“I don't think she'd be giving you clues if she didn't want you to find out.”
1. Who does Mary quote?
a. Shakespeare
b. Martin
c. Milton
d. Browning
2. What does Mary do when Jeremy asks her what she does in the bathroom?
a. speaks in riddles
b. tells the truth
c. falls silent
d. starts giggling
3. What does Martin think Mary wants Jeremy to do?
a. find out her secret
b. leave her alone
c. buy her a newspaper
d. dig up the rose bush
4. What does Jeremy do when Mary tells him to look under the rose?
a. digs a hole (man digging with shovel)
b. makes a phone call
c. picks a rose (cutting rose with shears)
d. buys a gift (hand with gift)
5. What are Mary's riddles about?
a. roses
b. newspapers [repeats s16_q5_a]
c. typewriters
d. bathrooms [repeats s16_q4_a]
   Segment 18

A few days later, Jeremy and his father were sitting on the veranda steps. “I read yesterday's newspaper very carefully,” Jeremy said, “to see if I could figure out what interests Mary so much.”

“That was a good idea.” Martin replied.

“Rose came up a couple of times. There was an article about fertilizing rose bushes, and an advice column by somebody called ‘The Rambling Rose,’ and a marriage announcement of Beneford Rose to Jennifer Garner.”

Martin mulled this over for a few moments. “You know,” he said, “‘under the rose’ is the Latin translation of sub rosa. It means something that is secret or confidential.”

“Hey, that's interesting,” said Jeremy.
1. Who writes the advice column?
a. The Rambling Rose
b. Jennifer Rosell
c. The Beneford Rose
d. Jennifer Rose
2. What does Martin say when Jeremy tells him he read the newspaper carefully?
a. it was a good idea
b. it was pointless
c. it was thoughtless
d. it was invasive
3. Who is Beneford Rose marrying?
a. Jennifer Garner
b. Mary Rondell
c. Jennifer Rondell
d. Eleanor Gribsy
4. Where are Jeremy and Martin sitting as they talk about the articles in the newspaper?
a. veranda steps [repeats s04_q4_a]
b. pickup truck [repeats s10_q4_c]
c. sofa [repeats s04_q4_b]
d. kitchen table
5. What does Jeremy find an article about in the newspaper?
a. fertilizing roses (shows woman sprinkling roses)
b. raising pigs (show farmer and pigs)
c. trout fishing (show fishing gear)
d. baking scones (show mitted hand with tray of scones)
   Segment 19

When Jeremy got home, he kissed Mary hello and took off his jacket. Mary was in the kitchen, stirring a pot on the stove. “Smells delicious,” Jeremy said. “New recipe,” said Mary. “I got it out of the paper.” Jeremy looked down at the recipe. Beef stew with dumplings. His mouth was almost drooling in anticipation. Then he saw that peeking out from under the recipe was another section of the paper. the Rambling Rose advice column. He began to understand.

“What's sub rosa?” he asked her.

“Haven't you guessed yet? I'm the Rambling Rose.” Mary laughed as she said it.
1. What does Jeremy do when he first gets home?
a. kisses Mary
b. reads the newspaper
c. sits down
d. stirs a pot
2. What does Jeremy say about that the dish Mary is cooking?
a. it smells delicious
b. it looks great
c. it's tasty
d. it's too salty
3. Where does Jeremy see the Rambling Rose article?
a. under Mary's recipe
b. on the table
c. in a book
d. under the pot
4. What are Mary and Jeremy having for dinner?
a. stew with dumplings (in a pot)
b. steak and potatoes
c. asparagus and pork chops
d. salad
5. What is Mary doing when Jeremy gets home?
a. stirring a pot
b. reading a newspaper
c. looking in the fridge
d. drinking coffee
   Segment 20

“Hasn't that column been around for awhile?” he asked. “Yup. Sue Repko's been writing it for twelve years. Now that she retired, I'm the new gal,” Mary explained, as she dished the stew into three bowls.

“Why did you keep that secret from me?” Jeremy asked.

“I ladle out advice to the lovelorn. You sing to addled trout—or whatever you do. I don't ask. Everyone has a secret spot, Jeremy. In fact, there are hundreds of secret spots in each of us—each a cool dark watering hole in speckled shade. That's where we go to replenish our own reserves when we've given all we have to the people around us,” Mary explained as she set the bowls of stew on the table.

Jeremy understood perfectly.
1. Who is the original Rambling Rose?
a. Sue Repko
b. Jeremy
c. Jennifer Garner
d. Mary
2. Who is the new Rambling Rose?
a. Mary
b. Sue
c. Martin
d. Jen
3. What does Mary do in her new job?
a. give love advice
b. give financial advice
c. give cooking tips
d. advise stock buys
4. To what does Mary compare secrets?
a. a watering hole
b. exciting presents
c. beautiful flowers
d. fish in a school
5. What is Mary doing while she talks to Jeremy about writing her advice column?
a. dishing out stew (and/or setting bowls of stew on a table)
b. writing
c. reading the newspaper [repeats s19_q5_b]
d. picking roses
   The first response listed is always the correct response

Questions with picture response buttons are always numbers 4 and 5.

Urban Jungle

Segment 1

Joe licked some mustard off his hot dog and grinned at his friend. “Beautiful!” he said. Marv beamed back. He knew what Joe meant. The sun was shining in Central Park on this crystal spring day. They were sitting on the steps of the seal enclosure in the zoo. It was good to be alive, still friends after more than half a century. It was good to feel the sun warming their scalps, through Joe's white curly hair and on Marv's gleaming bald pate. It was good to stretch their legs and to see the excitement of the children gathering around for the seal feeding.
1. What's on Joe's hot dog?
   a. mustard
   b. ketchup
   c. onions
   d. sauerkraut
2. Where are Joe and Marv?
   a. the zoo
   b. the circus
   c. the beach
   d. the back yard
3. Where are they sitting?
   a. on the steps
   b. on a bench
   c. at a table
   d. on some chairs
4. What is Marv's hairstyle?
   a. bald
   b. curly grey hair
   c. short black hair
   d. long brown hair
5. What are the children excited to see?
   a. seals
   b. lions
   c. Japanese snow monkeys (repeats later)
   d. parrots
      Segment 2

Joe lived near Central Park, in a fancy apartment on the Upper West Side of Manhattan. Marv lived across the East River in Queens, near his successful auto body shop. They had been friends since World War II, when Joe was a medic and Marv a gunner in the Marines. They had lost touch after the war, and then met again in strange circumstances.

Once a month, rain or shine, they met at the zoo. They were both nearly 80. Now they watched the seals jumping for fish in their pool. Suddenly a group of young zoo workers in green shirts came running towards them and pulled out bullhorns. “Attention, people! Don't be alarmed!”
1. Where does Joe live?
   a. Manhattan
   b. Queens
   c. France
   d. Brooklyn
2. What did Joe do in the war?
   a. he was a medic
   b. he was a pilot
   c. he was a gunner
   d. he was a mechanic
3. How often do Joe and Marv meet at the zoo?
   a. once a month
   b. once a week
   c. once a year
   d. once a fortnight
4. What are the seals eating?
   a. fish (repeats later)
   b. frog (repeats later)
   c. snake (repeats later)
   d. worms
5. What color are the zoo workers' shirts?
   a. green zoo uniform shirt (repeats later)
   b. blue zoo uniform shirt
   c. brown zoo uniform shirt
   d. red zoo uniform shirt
      Segment 3

The seal feeders stopped throwing fish, and everyone turned toward the bullhorns. “We have a situation here and we could use your help, ladies and gentlemen, and especially kids. One of our Japanese snow monkeys, a small baby, has somehow gotten out of her enclosure. We are cordoning off the zoo. We are very sorry, but nobody is allowed to leave or come in until we find our monkey. Kids, please look out for this baby. If you see her, tell someone with a green zoo shirt immediately. She has light brown fur and a pink face. Don't be scared, but do NOT try to approach or touch the monkey. She is not a pet. She is a wild animal.”
1. What do the seal feeders do during the announcement?
   a. stop throwing fish
   b. start feeding seals
   c. make an announcement
   d. leave the enclosure
2. What do the zoo workers announce?
   a. a baby monkey is loose
   b. it's monkey feeding time
   c. it's seal feeding time
   d. they found a monkey
3. What kind of monkey has escaped her enclosure?
   a. a Japanese snow monkey
   b. a Japanese sand monkey
   c. a Chinese water monkey
   d. an adult snow monkey
4. What do the zoo workers ask the visitors to do?
   a. look for the monkey (show person/kid seeing monkey and pointing)
   b. catch the monkey (show hands on a monkey)
   c. feed the monkey (show hand pushing food towards monkey)
   d. hide from the monkey
5. What color is the monkey's face?
   a. pink Japanese snow monkey face
   b. grey Japanese snow monkey face
   c. black Japanese snow monkey face
   d. purple Japanese snow monkey face
      Segment 4

The crowd buzzed with excitement. Some of the mothers snatched up their babies and looked around in panic. “Oh my God!” said a young woman in a yellow shirt and bright green pants. “A wild monkey, ohmigod!”

“Cool!” said an eight-year-old boy in baggy shorts to his friend, another eight-year-old boy wearing a T-shirt with two cartoon fish on it. “A wild monkey hunt! Let's find it and capture it!”
1. What do some mothers do after the announcement?
   a. snatch up their babies
   b. feed their babies
   c. play with their babies
   d. put their babies to sleep
2. What does the young woman say after the announcement?
   a. “A wild monkey!”
   b. “A wild time!”
   c. “A wild goose chase!”
   d. “A baby monkey!”
3. Who is with the eight-year-old boy?
   a. an eight-year-old boy
   b. an eight-year-old girl
   c. his mother
   d. his younger brother
4. What is on the eight-year-old boy's T-shirt?
   a. two cartoon fish
   b. one cartoon fish
   c. two cartoon birds
   d. one baby Japanese snow monkey
5. What is the young woman wearing?
   a. a yellow shirt and green pants
   b. a green shirt and yellow pants
   c. a yellow shirt and green skirt
   d. a yellow dress
      Segment 5

Mary and Joe went over to the monkey enclosure, and made their way through a crowd that was leaning over the parapet and staring at the distraught mother monkey, who was sitting on a rock and shrieking for her missing baby. She had thick light brown fur and a bright pink face. She jumped from the rock onto a tree and looked around frantically. In the moat at her feet, a pair of black-necked swans floated peacefully by, followed by tiny cygnets.
1. Where do Marv and Joe go after the announcement?
   a. the monkey enclosure
   b. the seal tank
   c. the steps
   d. outside the zoo
2. What is the crowd leaning over the parapet looking at?
   a. the mother monkey
   b. the baby monkey
   c. the swans
   d. the zoo workers
3. What is the mother monkey doing?
   a. shrieking
   b. eating
   c. feeding her baby
   d. playing peacefully
4. Where does the mother monkey jump?
   a. onto a tree
   b. in the water
   c. onto a rock
   d. outside the enclosure
5. What floats by in the moat?
   a. black-necked swan
   b. duck
   c. frog on lilly pad
   d. paper cup floating in water
      Segment 6

“Mama, look! Piggyback!” squealed a small girl next to Marv. He looked to see where she was pointing, and sure enough, a fluffy grey baby swan was riding on one of its parent's backs, looking perfectly content and oblivious to the commotion around it.

“I remember taking my babies piggyback in this park,” said Joe, smiling sadly. Marv looked at his friend, then back to the South American black-necked swan. He felt sorry for his friend. Although his friend was wealthy after a lifetime of being a successful cosmetic and reconstructive surgeon on Park Avenue, his children lived far away and he and his wife were quite lonely. He didn't have any grandchildren; Marv had six.
1. What is the cygnet doing?
   a. riding piggyback
   b. looking for food
   c. sitting on a rock

d. swining
2. How does the cygnet seem?
   a. content
   b. upset
   c. distraught
   d. hungry
3. Where did Joe work?
   a. Park Avenue
   b. Park Boulevard
   c. Park Drive
   d. Central Park West
4. How many grandchildren does Marv have?
   a. six (show six kids' faces)
   b. five (show five kids faces)
   c. none
   d. three
5. How did Joe carry his babies in the park?
   a. piggyback (Joe carrying a small girl on his back, repeats in s19_q4_c, but with Marv)
   b. in his arms (show Joe carrying a baby in his arms)
   c. in their strollers (show Joe pushing a baby in a stroller)
   d. in a sling
      Segment 7

They moved onto the polar bear section. There, swimming in his tank, was Gus, the legendary Central Park polar bear. Gus is a famous personality, written about in magazines and newspapers, and even making the occasional TV appearance.

“Remember the psychiatrist?” Joe asked Marv, and they both chuckled. A few years back, Gus had started behaving strangely. He swam incessantly around and around his pool, and acted moody. Zoo officials had become worried about him and finally consulted a psychiatrist, who diagnosed him as depressed and bored. The papers were full of cartoons of a sad polar bear lying on an analyst's couch. Gus cheered up after his keepers gave him presents to open, a bright new orange ball, and a better-built pool with obstacles and rocks.
1. What animal is swimming in his tank?
   a. a polar bear
   b. a monkey
   c. a frog
   d. a cygnet
2. What is the bear's name?
   a. Gus
   b. Marv
   c. Joe
   d. Guy
3. What kind of doctor saw the bear?
   a. a psychiatrist
   b. a vet
   c. a surgeon
   d. a dentist
4. What was the bear's new toy?
   a. an orange ball
   b. a green ball
   c. a stuffed bear
   d. an old tire
5. What did the zookeepers put in the better-built pool?
   a. obstacles and rocks
   b. fish and seals
   c. plants and flowers
   d. stuffed animals
      Segment 8

“Yeah, I remember,” said Marv. He leaned against the wall and raised his foot to retie his shoelace. “Let's face it, the bear might look happy now, but I bet he would rather be in the snow somewhere, free to hunt and roam. A polar bear in New York—does that sound right to you?”

Joe moved aside to let a zoo worker squeeze up to the edge and lean in to look for the missing monkey, in case it had somehow got into the polar bear tank. The young man took off his sunglasses and peered into the depths of the tank.

“I know how Gus must feel,” Joe said. “I used to feel like a polar bear in New York, when I first opened my practice.”
1. Why does Marv raise his foot?
   a. to retie his shoelace
   b. to check his socks
   c. there is gum on his shoe
   d. to scratch his ankle
2. Where does Marv think the bear rather be?
   a. in the snow somewhere
   b. in the zoo
   c. in the seal tank
   d. at the doctor's office
3. What is the zoo worker doing at the polar bear tank?
   a. looking for the monkey
   b. feeding the bear
   c. talking to visitors
   d. playing with the ball
4. What does the young zoo worker take off?
   a. sunglasses
   b. shirt (repeats s02_q5_a)
   c. cap (repeats later)
   d. coat
5. What did Joe feel like when he first opened his practice?
   a. polar bear (repeats later)
   b. Japanese snow monkey (repeats later)
   c. fish (repeats s02_q4_a)
   d. frog (repeats s02_q4_b)
      Segment 9

Marv clapped his friend on the shoulder. “I bet you did!” he said. Joe was African-American, and when he opened his own practice on East 79th Street, he was a rare specimen. He had dealt with racism and bigotry. He remembered one woman who had literally run out of his office when she met him, and that was after desegregation. By the time he had retired ten years ago, things had changed a lot, but he had never forgotten his first years in the business. He had risen to the top of his profession purely because of his skill and what Marv liked to call his “chutzpah.”

“Ma, I see the monkey!” yelled a girl in a polka-dotted dress and pigtails. “There, there!” A zoo worker came running up and a crowd quickly gathered. But the little girl had only seen a common grey squirrel scurrying around the bushes. The crowd dispersed. Ida, Gus' polar bear companion, swam up to the edge and stuck her head out of the water.
1. Where does Marv pat his friend?
   a. on his shoulder
   b. on his head
   c. on his leg
   d. on his arm
2. Where was Joe's practice?
   a. on East 79th Street
   b. on West 79th Street
   c. on South 79th Street
   d. on North 79th Street
3. When did Joe retire?
   a. ten years ago
   b. five years ago
   c. seven years ago
   d. last year
4. What is the pattern on the little girl's dress?
   a. polka-dotted dress
   b. striped dress
   c. paisley dress
   d. checkered dress
5. What does the little girl see?
   a. grey squirrel
   b. polar bear (repeats s08_q5_a)
   c. Japanese snow monkey (repeats s08_q5_a)
   d. green shirt (repeats s02_q5_a)
      Segment 10

Joe and Marv moved to the rain forest house, keeping an eye out on the way for the lost snow monkey. Around them, kids raced, strollers collided, and walkie-talkies hissed and crackled as zoo employees checked in with each other about the monkey.

“I remember . . . ” began Joe. The two friends began a lot of their sentences this way. “I remember my grandma Bessie had a pet monkey in her house. She was a maid in someone's house and they had this monkey. They got sick of it and gave it to her.”
1. Where do Joe and Marv go after the polar bear tank?
   a. the rain forest house
   b. the monkey house
   c. the cafeteria
   d. outside the zoo
2. What was Joe's grandmother's name?
   a. Bessie
   b. Susie
   c. Betsy
   d. Grace
3. What did Joe's grandmother do?
   a. she was a maid
   b. she was a doctor
   c. she was a teacher
   d. she was a gardener
4. What collided around Joe and Marv?
   a. two stollers colliding
   b. two kids colliding
   c. two zoo workers colliding
   d. two monkeys colliding
5. What was Joe's grandmother's pet?
   a. rhesus monkey
   b. cat
   c. dog
   d. canary
      Segment 11

“A pet monkey in North Carolina?” Marv wanted to know. He was a New York City boy and his most exotic pet had been a white rat called Monty.

“Yes,” reminisced Joe, as they walked into the moist green tropical rain forest enclosure. “That was one naughty monkey. It was some kind of Indian monkey, called a rhesus. He used to get into the bathroom and squeeze the toothpaste out of its tube. Grandma Bessie used to get so mad. She would take that monkey—Sammy, he was called—and smack his bottom, just gently, to show him that squeezing the tube was wrong. Then she would open the window and toss him out into the hickory trees. One day she walked into the bathroom and there was Sammy, standing with the tube in his paw, toothpaste all over the floor. He looked up and saw Grandma. And then, what do you know, that monkey smacked himself on the bottom and jumped out of the window!”
1. What was Marv's most exotic pet?
   a. a white rat
   b. a white cat
   c. a light brown dog
   d. monkey
2. Where was Joe's grandmother's monkey from?
   a. India
   b. Japan
   c. Canada
   d. New York
3. What did Sammy do in the bathroom?
   a. squeeze the toothpaste
   b. brush his teeth
   c. turn on the tap
   d. close the door
4. Where did Grandma toss the monkey?
   a. hickory trees
   b. bedroom
   c. bathroom
   d. garage
5. What did Sammy do when he was caught?
   a. jumped out of the window
   b. brushed his teeth
   c. shut the door
   d. jumped on Grandma
      Segment 12

Marv laughed. They both turned their attention to the simulated rain forest all around them. They looked at the keel-billed toucan with its huge colorful beak. There were scarlet ibises and yellow and blue macaws. It was impossible not to get caught up in the excitement of the monkey chase, and all the time they were looking at the other exotic creatures, they were also looking for a tiny pink-faced monkey. A brilliant blue bird flew right by them.
1. What does Marv do when he hears Joe's story about his grandmother's monkey?
   a. he laughs
   b. he cries
   c. he walks off
   d. he argues
2. Where do Joe and Marv see the exotic birds?
   a. the rain forest section
   b. the polar bear section
   c. the cafeteria
   d. outside the zoo
3. What makes the toucan special?
   a. its colorful beak
   b. its long tail
   c. its loud cry
   d. its long wings
4. What color are the ibises?
   a. scarlet ibises
   b. blue ibises
   c. green ibises
   d. purple ibises
5. What flies right by the men?
   a. brilliant blue bird
   b. brilliant green bird
   c. bat
   d. moth
      Segment 13

“Fairy bluebird!” exclaimed Marv. “Sita talks about them. She says she would see them when she was young.” Sita was his Indian daughter-in-law, who had grown up on a tea plantation in Assam. She often spoke of the iridescent blue and black fairy bluebirds that used to swoop down and eat the wild figs near her house. She had had a swing hanging from the fig tree.
1. What is the brilliantly colored bird called?
   a. fairy bluebird
   b. mountain bluebird
   c. fairy macaw
   d. common bluebird
2. What is Marv's daughter-in-law's name?
   a. Sita
   b. Rita
   c. Sue
   d. Sally
3. Where did Marv's daughter-in-law's grow up?
   a. a tea plantation
   b. a corn farm
   c. a coffee shop
   d. a cocoa plantation
4. What did Marv's daughter-in-law's often see the birds doing?
   a. eating figs in a fig tree
   b. building nests
   c. eating worms
   d. flying into the house
5. What did Marv's daughter-in-law have in the fig tree?
   a. swing
   b. tree house
   c. ladder
   d. bird's nest
      Segment 14

They walked near the frog exhibit. Brilliant blue, yellow, green, orange and purple frogs hopped around like animated jewels. Joe and Marv both instantly thought about the frogs they had hunted as boys. Joe had chased green tree frogs and bull frogs in the marshes near his home. Marv had grown up listening to the “gick, gick, gick” sound of the cricket frogs in his garden.

“That's a blue poison frog,” a woman next to them explained to her son, who was clutching a skateboard under his arm. “No one messes with them. I read that people have seen snakes bite one, and then quickly spit it out.”
1. What are hopping around like animated jewels?
   a. frogs (may be able to repeat s02_q4_b)
   b. insects
   c. monkeys
   d. people
2. Where did Joe chase frogs?
   a. in the marshes
   b. on the beach
   c. in the backyard
   d. at the zoo
3. What did Marv hear in his garden?
   a. cricket frogs
   b. grasshoppers
   c. cicadas
   d. toads
4. What does the woman point out to her son?
   a. blue frog (may be able to repeat s02_q4_b)
   b. green frog (may be able to repeat s02_q4_b)
   c. blue snake (may be able to repeat s02_q4_c)
   d. green snake (may be able to repeat s02_q4_c)
5. What is the woman's son clutching?
   a. skateboard (repeats later)
   b. frog (repeats s02_q4_b)
   c. cap (repeats s08_q4_c)
   d. baseball
      Segment 15

“Pthoooey!” said her son, dramatically spitting in Joe and Marv's direction. They hastily moved back.

“Yes, like that,” said the mother. “Then the snake rubs its mouth against the ground and writhes around in pain. Sometimes the poison gets to it so badly that it goes into a coma!” Her son obligingly threw himself on the ground and rolled around in pretend agony before he rolled his eyes up, stuck his tongue out, and went rigid. His mother laughed, and he got up. She picked up his cap.
1. What does the boy do in Joe and Marv's direction?
   a. he spits
   b. he laughs
   c. he yells
   d. he throws something
2. What do Joe and Marv do in reaction to the boy?
   a. they move back
   b. they stay put
   c. they frown
   d. they laugh
3. What happens to some snakes that bite poison frogs?
   a. they go into comas
   b. they throw up
   c. they eat very well
   d. they turn blue
4. What is the boy pretending to be?
   a. snake (repeats s02_q4_c)
   b. frog (repeats s02_q4_b)
   c. Japanese snow monkey (repeats s08_q5_b)
   d. polar bear (repeats s08_q5_a)
5. What did the boy's mother pick up?
   a. cap (repeats s08_q4_c)
   b. skateboard (repeats s14_q5_a)
   c. keys
   d. shoes
      Segment 16

“Let's go hunt the monkey!” she said, and put her arm around her son's shoulder as they walked on. Joe and Marv looked at the giant fake trees and spotted some more creatures. There were turquoise tanagers, saffron finches and violet turacos. There was a cage with a family of colobus monkeys. The two men peered in, checking to see if the snow monkey had somehow come to visit its tropical cousins. A fruit bat whirred in front of Marv's face and he flinched.

A zoo worker with a bullhorn came and stood in front of the alligator cage and announced the missing monkey again. “Remember,” she cautioned, “it is a wild animal, it is NOT a pet.”
1. What is special about the trees?
   a. they are fake
   b. they are green
   c. they are full of moss
   d. they are very small
2. What animal family do the men see?
   a. colobus monkeys
   b. rhesus monkeys
   c. snow monkeys
   d. spotted monkeys
3. Who flinches when a fruit bat flies past?
   a. Marv
   b. Joe
   c. the boy
   d. a zoo worker
4. Where does the zoo worker stand?
   a. in front of alligator cage
   b. near a big bird
   c. in front of frog exhibit
   d. on top of a chair
5. What does the zoo worker carry?
   a. bullhorn
   b. Japanese snow monkey (repeats s08_q5_b)
   c. clipboard
   d. flashlight
      Segment 17

Joe and Marv decided to stop at the Leaping Frog café for lunch. They usually went for a walk after the zoo, but today there was a boisterous carnival atmosphere because of the missing monkey. The zoo people were worried but many of the visitors didn't really understand that the young monkey was in danger. They were just entertained and interested. They also weren't allowed to leave, so Joe and Marv went inside and ordered some food.

“I'll have a cheeseburger and fries, with a large coke,” said Marv. The woman behind the counter took his order, all the while scanning over his shoulder in case the monkey decided to come in for a bite. Joe ordered a grilled chicken sandwich and glass of lemonade. A child screamed behind them, “I want! My! Milk! Now!” and its mother shushed it. Joe and Marv talked while they waited for their food.
1. What do Joe and Marv want at the café?
   a. lunch
   b. breakfast
   c. a snack
   d. coffee
2. What does Marv order to eat?
   a. a cheeseburger and fries
   b. a hamburger and fries
   c. a hot dog and fries
   d. a chicken sandwich
3. What does Joe have to drink?
   a. lemonade
   b. coke
   c. orange juice
   d. coffee
4. Who wants milk?
   a. child
   b. man
   c. teen-aged girl
   d. woman
5. What did Joe and Marv do while they waited for their food?
   a. talk
   b. nap
   c. play cards
   d. read paper
      Segment 18

“Yeah, the shop's doing well,” said Marv. He had retired ten years ago and his son, Marv Junior, was managing the auto body shop now. The two friends often joked about how they actually had done the same thing all their lives: Joe had fixed people's bodies, and Marv had done the same for their cars. Marv stayed in touch with his business because it was still in the family. Joe, however, had sold his practice when he retired. Now he was amazed at the new developments in his field—Botox, for one, made from chemicals similar to the frog poison, which was injected into people's wrinkles to make them disappear.

“How's Sue?” he asked Marv.
1. Who is managing Marv's shop?
   a. his son
   b. his daughter
   c. his son-in-law
   d. Marv
2. What is Marv's son's called?
   a. Marv Junior
   b. Monty
   c. Junior
   d. Joe
3. What did Joe do to his practice when he retired?
   a. he sold it
   b. he left it to his partner
   c. he gave it to his son
   d. his wife ran it
4. What had Joe worked on before retiring?
   a. person (repeats s17_q4_b)
   b. car (repeats later)
   c. boat (repeats later)
   d. television set (repeats later)
5. What had Marv worked on before retiring?
   a. car (repeats s18_q4_b)
   b. person (repeats s17_q4 b)
   c. boat (repeats s18_q4_c)
   d. television set (repeats s18_q4_d)
      Segment 19

“She's great!” said Marv. Sue was his oldest daughter. When she was eight years old, Marv had taken her to the boardwalk at Coney Island. She had fallen off one of the amusement park rides and lain screaming on the ground. Out of the crowd had appeared a calm man with a black bag, saying, “Excuse me, I'm a doctor.” It had been Joe.
1. Where did Marv take Sue?
   a. Coney Island
   b. zoo
   c. circus
   d. school
2. How old was Sue when this happened?
   a. eight
   b. twelve
   c. five
   d. two
3. How did Sue get hurt?
   a. she fell off a ride
   b. she fell off the pier
   c. she tripped on a rock
   d. she was hit by a car
4. What did Sue fall off?
   a. amusement park ride
   b. tree branch
   c. Marv's back (piggyback)
   d. chair
5. What was Joe carrying?
   a. black bag
   b. brown bag
   c. stethoscope
   d. roll of gauze
      Segment 20

Now Marv and Joe walked out under the ginkgo trees and looked for a table. They passed a cluster of strollers and Marv glanced down as he maneuvered his way around them. He stopped suddenly and did a double-take.

“Hey, Joe!” he said, softly. “Check out this wild and dangerous animal!”

There, curled up and fast asleep in a black checked stroller, clutching a yellow blanket and a blue plastic teething rattle, was a small pink-faced Japanese snow monkey.
1. What trees are near the café?
   a. ginkgo
   b. oak
   c. maple
   d. hickory
2. What do Joe and Marv have to maneuver around?
   a. some strollers
   b. some people
   c. some animals
   d. some tables
3. What does Marv say?
   a. “Hey, Joe!”
   b. “Oh, no, Joe!”
   c. “Get a load of this!”
   d. “Come here, Joe!”
4. What is the baby monkey doing?
   a. Japanese snow monkey sleeping
   b. Japanese snow monkey playing
   c. Japanese snow monkey eating
   d. Japanese snow monkey climbing
5. What is the baby monkey holding?
   a. blanket and rattle
   b. ball and doll
   c. blanket and bottle
   d. teddy bear and pacifier

We claim:

1. A method for determining a psychophysical threshold for an aging adult, utilizing a computing device to present aural presentations to the adult, and to record responses from the adult, the method comprising the steps of:
initializing a first track to a first duration that is below an initial anticipated threshold, wherein the initial anticipated threshold comprises an initial estimate of a duration for frequency sweeps corresponding to a specified performance level of the adult;
initializing a second track to a second duration that is above the initial anticipated threshold;
providing a first frequency sweep which increases in frequency over time;
providing a second frequency sweep which decreases in frequency over time;
wherein both the first and second frequency sweeps are available for aural presentation to the adult;
associating the first frequency sweep with a first icon;
associating the second frequency sweep with a second icon;
aurally presenting at least two frequency sweeps to the adult utilizing either the first frequency sweep, the second frequency sweep, or a combination of the first and second frequency sweeps, in accordance with the duration of a specified one of either the first track or the second track;
requiring the adult to respond to the at least two frequency sweeps by indicating, utilizing the icons, an order in which the at least two frequency sweeps were presented;
modifying the duration of the specified track based on the adult's response;
repeating said steps of presenting, requiring, and modifying, one or more times in an iterative manner to determine respective final durations for the first track and the second track; and
determining a threshold for the adult based on the respective final durations for the first track and the second track, wherein the threshold comprises the duration associated with the specified performance level of the adult.

2. The method as recited in claim 1, wherein said modifying the duration of the specified track based on the adult's response comprises:
modifying the duration in accordance with a maximum likelihood procedure.

3. The method as recited in claim 2, wherein the maximum likelihood procedure comprises one or more of:
a QUEST (quick estimation by sequential testing) threshold procedure; or
a ZEST (zippy estimation by sequential testing) threshold procedure.

4. The method as recited in claim 2, wherein said steps of presenting, requiring, and modifying compose performing a trial, the method further comprising:
for each trial, saving one or more of:
which track was used in the trial;
duration used in the trial;
direction and order of sweeps presented to the adult in the trial;
series of icons used in the adult's response;
correctness or incorrectness of the adult's response;
mean of a posterior probability distribution function for the maximum likelihood procedure; and
standard deviation of the posterior probability distribution function for the maximum likelihood procedure.

5. The method as recited in claim 4, further comprising:
initializing one or more of:
standard deviation of a cumulative Gaussian psychometric function for the maximum likelihood procedure; and
standard deviation of a prior threshold distribution for the maximum likelihood procedure.

6. The method as recited in claim 2, wherein, for each track, said modifying the duration of the specified track based on the adult's response comprises:
increasing the duration if the adult responds incorrectly; and
decreasing the duration if the adult responds correctly.

7. The method as recited in claim 1, wherein said repeating said steps of presenting, requiring, and modifying, one or more times in an iterative manner comprises:
performing trials in the first track and the second track in an alternating manner; or
performing trials in the first track and the second track randomly with equal probability.

8. The method as recited in claim 1, wherein said repeating said steps of presenting, requiring, and modifying, one or more times in an iterative manner comprises:
repeating said steps of presenting, requiring, and modifying, until:
the durations of the first track and the second track have converged to values within a specified confidence interval, and wherein the values are within a specified distance from each other; or
a specified number of trials have been conducted for each track.

9. The method as recited in claim 1, wherein said determining a threshold for the adult based on the respective final durations for the first track and the second track comprises:
averaging the respective final durations for the first track and the second track to determine the threshold for the adult.

10. The method as recited in claim 1, wherein the initial anticipated threshold, the first duration, the second duration, and the threshold each comprises:
a respective sweep duration; and
a respective inter-stimulus-interval (ISI), comprising a time interval between successive sweeps.

11. The method as recited in claim 1, further comprising:
determining the initial anticipated threshold based on one or more of:
the age of the adult;
calibration trials performed by the adult; or
calibration trials performed by other adults.

12. The method as recited in claim 1,
wherein the first frequency sweep is referred to as UP, and the second frequency sweep is referred to as DOWN; and
wherein said step of presenting at least two frequency sweeps comprises the following possible combinations: UP-UP, UP-DOWN, DOWN-UP, and DOWN-DOWN.

13. The method as recited in claim 1, wherein the first icon is a picture of an arrow pointing up and the second icon is a picture of an arrow pointing down.

14. The method as recited in claim 1, wherein said step of associating the first frequency sweep with a first icon comprises:
aurally presenting the first frequency sweep; and
after said step of aurally presenting the first frequency sweep, highlighting the first icon to indicate to the adult the association.

15. The method as recited in claim 1, wherein said step of associating the second frequency sweep with a second icon comprises:
aurally presenting the second frequency sweep; and
after said step of aurally presenting the second frequency sweep, highlighting the second icon to indicate to the adult the association.

16. The method as recited in claim 1, wherein said step of requiring comprises:
providing a period of time in which the adult is to select the icons in the order in which the at least two frequency sweeps were presented, selection of the icons made by the adult placing a cursor over a icon and clicking a mouse, wherein each mouse click is recorded as a selection;
recording the selections made by the adult; and
recording whether the adult correctly identified the order in which the at least two frequency sweeps were presented.

17. The method as recited in claim 1, wherein said step of aurally presenting comprises:
randomly selecting at least two frequency sweeps to be presented, utilizing combinations of the first frequency sweep and the second frequency sweep.

18. The method as recited in claim 1, wherein the aural presentations are made via headphones attached to the computing device.

19. The method as recited in claim 1, further comprising:
performing a plurality of practice trials.

20. A computer readable memory medium that stores program instructions for determining a psychophysical threshold for an aging adult, utilizing a computing device to present aural presentations to the adult, and to record responses from the adult, wherein the program instructions are executable to perform:
initializing a first track to a first duration that is below an initial anticipated threshold, wherein the initial anticipated threshold comprises an initial estimate of a duration for frequency sweeps corresponding to a specified performance level of the adult;
initializing a second track to a second duration that is above the initial anticipated threshold;
providing a first frequency sweep which increases in frequency over time;
providing a second frequency sweep which decreases in frequency over time;
wherein both the first and second frequency sweeps are available for aural presentation to the adult;
associating the first frequency sweep with a first icon;
associating the second frequency sweep with a second icon;
aurally presenting at least two frequency sweeps to the adult utilizing either the first frequency sweep, the second frequency sweep, or a combination of the first and second frequency sweeps, in accordance with the duration of a specified one of either the first track or the second track;
requiring the adult to respond to the at least two frequency sweeps by indicating, utilizing the icons, an order in which the at least two frequency sweeps were presented;
modifying the duration of the specified track based on the adult's response;
repeating said steps of presenting, requiring, and modifying, one or more times in an iterative manner to determine respective final durations for the first track and the second track; and
determining a threshold for the adult based on the respective final durations for the first track and the second track, wherein the threshold comprises the duration associated with the specified performance level of the adult.

21. The memory medium as recited in claim 20, wherein said modifying the duration of the specified track based on the adult's response comprises:
modifying the duration in accordance with a maximum likelihood procedure.

22. The memory medium as recited in claim 21, wherein the maximum likelihood procedure comprises one or more of:
a QUEST (quick estimation by sequential testing) threshold procedure; or
a ZEST (zippy estimation by sequential testing) threshold procedure.

23. The memory medium as recited in claim 20, wherein said repeating said steps of presenting, requiring, and modifying, one or more times in an iterative manner comprises:
repeating said steps of presenting, requiring, and modifying, until:
the durations of the first track and the second track have converged to values within a specified confidence interval, and wherein the values are within a specified distance from each other; or
a specified number of trials have been conducted for each track.

24. The memory medium as recited in claim 20, wherein the initial anticipated threshold, the first duration, the second duration, and the threshold each comprises:
a respective sweep duration; and
a respective inter-stimulus-interval (ISI), comprising a time interval between successive sweeps.
